(19) United States
(12) Patent Application Publication
(10) Pub. No.: US 2004/0229173 A1
(43) Pub. Date: Nov. 18, 2004

(54) Photothermographic material and image forming method using the same

(76) Inventor: Takayoshi Oyamada, Kanagawa (JP)

Correspondence Address: MS. YUMI YERKS, 2111 JEFFERSON DAVIS HIGHWAY, APARTMENT #412, NORTH, ARLINGTON, VA, 22202, US

(21) Appl. No.: 10/837,674

(22) Filed: May 4, 2004

(30) Foreign Application Priority Data
May 12, 2003 (JP) 2003-132814

(51) Int. Cl. G03C 1/76; G03C 5/18

(52) U.S. Cl. 430/502; 430/523

(57) ABSTRACT

A photothermographic material including: a substrate; at least one image-forming layer, which is disposed on a surface of the substrate and includes at least a photosensitive silver halide, a non-photosensitive organic silver salt, a reducing agent and a binder; at least one surface-protective layer, which is disposed on a side of the substrate on which the at least one image-forming layer is disposed; and at least one back-surface protective layer, which is disposed on a back surface of the substrate opposite to the surface on which the at least one image-forming layer is disposed. At least one of the surface-protective layer and the back-surface protective layer satisfies the following formula (1):

B/A≧1 Formula (1)

wherein A represents a dynamic friction factor measured at a sliding velocity of 100 mm/min, and B represents a dynamic friction factor measured at a sliding velocity of 2000 mm/min.

### CROSS-REFERENCE TO RELATED APPLICATION

This application claims priority under 35USC 119 from Japanese Patent Application No. 2003-132814, the disclosure of which is incorporated by reference herein.

### BACKGROUND OF THE INVENTION

1. Field of the Invention

The present invention relates to a photothermographic material and to an image forming method using the same.

2. Description of the Related Art

In the field of medical treatment, it is strongly desired to reduce the amount of processing solution waste for environmental protection and economy of space. Consequently, technology relating to photothermographic materials for medical diagnosis and photographic applications which are capable of being efficiently exposed with laser image setters or laser imagers to form sharp and clear monochromatic images of high resolution are desired. Such photothermographic materials provide users with simpler photothermographic systems which do not require solution-type processing chemicals and therefore do not pollute the environment with liquid waste.

Although similar requirements also apply to the field of general image forming materials, images for medical treatment require detailed representation and therefore must have high image quality with excellent sharpness and granularity. In addition, for ease of diagnosis, cold black images are preferred in view of easy diagnosis. At present, various types of hard copy systems using pigment and dye such as ink jet printers and electrophotographic systems, are available as ordinary imaging systems. However, these are not satisfactory systems for forming images for medical treatment.

Photothermographic systems using organic silver salts are described in many publications (for example, see U.S. Pat. Nos. 3,152,904 and 3,457,075, and D. Klosterboer's “Thermally Processed Silver Systems” (Imaging Processes and Materials), Neblette, 8th Ed., compiled by J. Sturge, V. Walworth & A. Shepp, chap. 9, page 279, 1989). In general, photothermographic materials have an image-forming layer with a catalytically active amount of a photocatalyst (e.g., silver halide), a reducing agent, a reducible silver salt (e.g., organic silver salt), and, if necessary, a color toning agent for controlling silver tones being dispersed in a binder matrix in the layer. Photothermographic materials of this type are, after having been imagewise exposed, heated at a high temperature (for example, at 80° C. or higher) to form black silver images through redox reaction between the silver halide or the reducible silver salt (serving as an oxidizing agent) and the reducing agent therein. The redox reaction is accelerated by the catalytic action of a latent image of the exposed silver halide. Therefore, the black silver images are formed in the exposed area of the materials (for example, see U.S. Pat. No. 2,910,377 and Japanese Patent Application Publication (JP-B) No. 43-4924). Fuji Medical Dry Imager FM-DPL and DRYPIX 7000 are medical imaging systems using a photothermographic material that are commercially available.

For producing thermal imaging systems using containing organic silver salts, a method of coating a solvent to form a photosensitive layer, and a method of coating and drying a coating liquid that contains an aqueous dispersion of polymer particles serving as a main binder on a substrate are known. Since the latter method does not require solvent recovery, production equipment for the method is simple, and the method is advantageous for mass production.

Coating performance is an extremely important factor in producing the systems. Regardless of whether the solvent is an aqueous solvent or an organic solvent, there is no change in the importance of the coating performance. However, aqueous dispersions, in particular, enable simultaneous multi-layer coating and therefore enable efficient production of intended imaging systems. Improving the coating performance is a subject that is assiduously desired in the art for more effective production of imaging systems.

In producing photothermographic materials, workability and accumulability are also important factors, in addition to the coating performance. Photothermographic materials of poor workability and accumulability are difficult to handle and their productivity is low. Even after their production, the accumulability of photothermographic materials is still an important matter. Compact developing machines are desired these days, and improvement of not only devices but also photothermographic materials is desired for these.

In particular, photothermographic materials contain all chemical substances necessary for development, unlike photographic materials for liquid development. In addition, all of the constituent components remain in the developed photothermographic materials. Accordingly, it is extremely difficult to improve the surface characteristics of such photothermographic materials by means of only additives thereto. Thus, there is a difficulty peculiar to photothermographic materials in that the balance of all additives to the materials must be taken into consideration in order to improve the surface characteristics of the materials.

### SUMMARY OF THE INVENTION

Accordingly, an object of the present invention is to provide a photothermographic material having the advantages of good coatability and good workability and accumulability and capable of forming good images with few development mottles, and to provide a method for image formation on it.

The object of the invention can be attained by the following photothermographic material.

A first aspect of the invention is to provide a photothermographic material including: a substrate; at least one image-forming layer, which is disposed on a surface of the substrate and includes at least a photosensitive silver halide, a non-photosensitive organic silver salt, a reducing agent and a binder; at least one surface-protective layer, which is disposed on a side of the substrate on which the at least one image-forming layer is disposed; and at least one back-surface protective layer, which is disposed on a back surface of the substrate opposite to the surface on which the at least one image-forming layer is disposed. At least one of the surface-protective layer and the back-surface protective layer satisfies the following formula (1).

B/A≧1 Formula (1)

Here, A represents a dynamic friction factor measured at a sliding velocity of 100 mm/min, and B represents a dynamic friction factor measured at a sliding velocity of 2000 mm/min.

A second aspect of the invention is to provide a method for forming an image on the photothermographic material of the first aspect. The method includes exposing the photothermographic material and thermally developing the photothermographic material. A transfer linear velocity of the photothermographic material during thermal developing of the photothermographic material is 30 mm/sec or more.

In order to attain the subject matter of the invention that is to improve the coatability, the workability and the accumulability of photothermographic materials and to improve the image formability thereof to give good images with no mottles, we, the present inventors have selected substances that are the most suitable for the outermost layers, back-surface protective layer and surface-protective layer of photothermographic materials. This is because these layers are to be in direct contact with processing devices while the materials are conveyed in them.

As a result of assiduous studies, we have specifically noted the dynamic friction factor of photothermographic materials, and have reached the present invention.

We have found that, when the dynamic friction factor of a photothermographic material is larger at a sliding velocity higher than a specific sliding velocity, then the coatability, the workability, the accumulability, and the image formability with few mottles of the material are all dramatically improved. Based on the new finding, we have discovered a technique of providing a photothermographic material having good properties as above, merely by measuring the specific parameter, the dynamic friction factor of the material.

### BRIEF DESCRIPTION OF THE DRAWING

FIG. 1 is a schematic view of a photothermographic recording device of the present invention with a laser recording unit mounted thereon.

### DETAILED DESCRIPTION OF THE INVENTION

The photothermographic material of the present invention includes a substrate; at least one image-forming layer that includes at least a photosensitive silver halide, a non-photosensitive organic silver salt, a reducing agent and a binder; at least one surface-protective layer; and at least one back-surface protective layer. The image-forming layer is disposed on a surface of the substrate. The surface-protective layer is disposed on a side of the substrate on which the image-forming layer is disposed. The back-surface protective layer is disposed on a back surface of the substrate opposite to the surface on which the at least one image-forming layer is disposed.

The invention is characterized in that at least one of the surface-protective layer and the back-surface protective layer satisfies the relationship of the following formula (1), and is not specifically limited except for it.

B/A≧1 (1)

In formula (1), A represents the dynamic friction factor of the material measured at a sliding velocity of 100 mm/min, B represents the dynamic friction factor of the material measured at a sliding velocity of 2000 mm/min.

The invention is described in detail hereunder.

<Regarding Formula (1)>

Formula (1) is described in detail.

B/A≧1 (1)

In formula (1), A represents the dynamic friction factor of the material measured at a sliding velocity of 100 mm/min, B represents the dynamic friction factor of the material measured at a sliding velocity of 2000 mm/min. A and B are measured with the same material. The dynamic friction factor is measured according to Japanese Industrial Standard JIS K7125, the disclosure of which is incorporated by reference herein. Concretely, the photothermographic material to be analyzed is conditioned at 25° C. and 60% RH for 2 hours. Next, a slidable piece of SUS 316 (worked for surface polishing according to JIS B0659 to finish code ∇∇∇1.6-S having a surface roughness of Roughness Number SN-5) and a test piece of the material are attached to a tool capable of controlling the temperature of the material. 30 seconds after their attachment, the dynamic friction factor of the material is measured at a sliding velocity of 100 mm/min or 2000 mm/min. During the measurement, the temperature is controlled to be 25° C. or 90° C.

The value of B/A is preferably from 1 to 5, more preferably from 1 to 3, even more preferably from 1 to 2.

At least one of the surface-protective layer and the back-surface protective layer must satisfy the formula (1), but preferably, both the two layers satisfy the formula (1).

For making the material have the dynamic friction factor as above, the method is not specifically defined. For example, it is effective to add a sliding agent, an antistatic agent, a matting agent, a surfactant and the like additives to the layers so as to optimize them. The value may also be reached by changing the type and the content of the binder in the layers. Since it is possible to reach the value of the formula (1) by combining these additives in any desired manner, the combination of the additives is not limited. Concrete examples of some preferred embodiments of the combination are mentioned below.

For reaching the value of the formula (1), it is desirable to coat a sliding agent in an amount of 1 mg/m² to 500 mg/m², and more preferably 5 mg/m² to 200 mg/m². For the antistatic agent, preferred are metal oxides; and for the surfactant, preferred are fluorine-containing surfactants. Also preferably, the matting agent has a mean sphere-corresponding radius of from 0.1 μm to 10 μm, and it is coated in an amount of 5 mg/m² to 200 mg/m².

The binder, the sliding agent, the antistatic agent, the surfactant and others for satisfying the formula (1) are mentioned below.

<Binder>

The binder is preferably gelatin, hydrophobic polymer latex, a water-soluble polymer, and a hydrophobic polymer.

### Description of Polymer Latex

Preferred embodiments of the latex polymer for use in at least one of the surface-protective layer and the back-surface protective layer are hydrophobic polymers such as acrylic polymers, poly(esters), rubbers (e.g., SBR resin), poly(urethanes), poly(vinyl chlorides), poly(vinyl acetates), poly(vinylidene chlorides), poly(olefins). These polymers may be linear polymers, branched polymers or crosslinked polymers, and may be homopolymers formed through polymerization of single monomer, or copolymers formed through polymerization of two or more different monomers. The copolymers may be random copolymers, or block copolymers.

For the hydrophobic polymer for use in the invention, especially preferred is cellulose acetate butyrate. Cellulose acetate butyrate is a butyrate ester of partially-acetylated cellulose, and is characterized in that it hardly deforms.

The number-average molecular weight of these polymers may be from 5,000 to 1,000,000, but preferably from 10,000 to 200,000. Polymers having a too small molecular weight and those having a too large molecular weight are unfavorable, since the mechanical strength of the layer containing a latex of the former is insufficient and since the film formability of the latter is not good. Crosslinkable polymer latex is especially preferred for use in the invention.

The polymer latex that may be used as a binder in the photothermographic material of the invention is a dispersion prepared by dispersing fine particles of a water-insoluble hydrophobic polymer in a water-soluble dispersion medium. Regarding the dispersion condition, the polymer may be emulsified in a dispersion medium, or the polymer may be formed in a mode of emulsion polymerization, or the polymer may be dispersed as micelles, or the polymer molecules may have a partially hydrophilic structure and the molecular chains themselves may be dispersed in a mode of molecular dispersion.

The partially hydrophilic structure of polymer molecules is effective for stabilizing the latex dispersion condition. The structure is, for example, an anionic, cationic or nonionic structure.

The polymer latex is described in, for example, Synthetic Resin Emulsions (by Taira Okuda & Hiroshi Inagaki, the Polymer Publishing Association of Japan, 1978); Applications of Synthetic Latexes (by Takaaki Sugimura, Yasuo Kataoka, Sohichi Suzuki & Keiji Kasahara, the Polymer Publishing Association of Japan, 1993); Chemistry of Synthetic Latexes (by Sohichi Muroi, the Polymer Publishing Association of Japan, 1970); and JP-A No. 64-538.

Preferably, the mean particle size of the dispersion particles is from 1 to 50,000 nm, more preferably from 5 to 1,000 nm or so. The particle size distribution of the dispersion particles is not specifically defined. The dispersion particles may have a broad particle size distribution, or may have a particle size distribution of monodispersion.

The glass transition temperature (Tg) of the latex polymer that may be in at least one of the surface-protective layer and the back-surface protective layer in the invention preferably is in a range of −30° C. to 40° C., more preferably −30° C. to 30° C., even more preferably −30° C. to 20° C. If the Tg is higher than 40° C., then the polymer may lose elasticity and the material may be processed unevenly.

In this description, Tg is calculated according to the following formula:

1/Tg=Σ(Xi/Tgi)

The polymer of which the glass transition temperature Tg is calculated as in the above comprises n's monomers copolymerized (i represents the number of the monomers copolymerized, in a range of 1 to n); Xi represents the mass fraction of i'th monomer (ΣXi=1); Tgi represents the glass transition temperature (in terms of the absolute temperature) of the homopolymer of i'th monomer alone; and Σ represents the sum total of i in a range of 1 to n. For the glass transition temperature (Tgi) of the homopolymer of each monomer alone, referred to is the description in Polymer Handbook (3rd edition) (written by J. Brandrup, E. H. Immergut (Wiley-Interscience, 1989)).

If desired, two or more different types of binders may be combined and used herein. Those having a glass transition temperature not falling within the above-mentioned range may also be combined. In case where at least two polymers that differ in Tg are blended for use herein, it is desirable that the weight-average Tg of the resulting blend falls within the range defined in the above.

Preferably, the latex polymer for use in the invention has a value I/O of from 0.1 to 1.0. The value I/O is obtained by dividing the inorganic property value by the organic property value based on an organic conceptual view. This may be obtained according to the method described in Organic Conceptual View—Bases and Applications—(by Yoshio Kohda, 1984, Sankyo Publishing).

The organic conceptual view is described. The properties of compounds are divided into an organic property indicating a property of covalent bond, and an inorganic property indicating a property of ionic bond, and all organic compounds are positioned individually on one point on rectangular coordinates of an organic axis and an inorganic axis. Based on this, the inorganic property value is to indicate the inorganic property of a compound. Concretely, the degree of the influence of various substituents on the boiling point of compounds is determined on the basis of a hydroxyl group. The distance between the boiling point curve of linear alcohols and the boiling point curve of linear paraffins at around the number of carbon atoms of 5, then it is about 100° C. Accordingly, the influence power of one hydroxyl group is defined as 100. On the other hand, the organic property value is as follows: Based on a unit of a methylene group in a molecule, the degree of the organic property of a compound may be determined on the basis of the number of carbon atoms representative of the methylene group. Regarding the numerical value of one carbon atoms to be the basis for it, the mean value of the boiling point increase to be caused by addition of one carbon atom at around the number of carbon atoms of from 5 to 10 of a linear compound is 20° C. Based on this, the value is defined as 20. The inorganic property value and the organic property value are so defined that they may correspond to each other in a ratio of 1/1 on the graph. The value I/O is calculated from these values.

Examples of polymer latex for use herein are mentioned below. They are expressed by the constituent monomers, in which each numeral parenthesized represents the proportion, in terms of % by mass, of the monomer unit, and the molecular weight of each constituent monomer is in terms of the number-average molecular weight thereof Polyfunctional monomers form a crosslinked structure in polymer latex comprising them, to which, therefore, the concept of molecular weight does not apply. The polymer latex of the type is referred to as “crosslinked”, and the molecular weight of the constituent monomers is omitted. Tg represents the glass transition temperature of the polymer latex.

P-1: Latex of -MMA(70)-EA(27)-MAA(3)-(molecular weight 37000, Tg 61° C.)

P-2: Latex of -MMA(70)-2EHA(20)-St(5)-AA(5)-(molecular weight 40000, Tg 59° C.)

P-3: Latex of -St(50)-Bu(47)-MAA(3)-(crosslinked, Tg −17° C.)

P-4: Latex of -St(68)-Bu(29)-AA(3)-(crosslinked, Tg 17° C.)

P-5: Latex of -St(71)-Bu(26)-AA(3)-(crosslinked, Tg 24° C.)

P-6: Latex of -St(70)-Bu(27)-IA(3)-(crosslinked)

P-7: Latex of -St(75)-Bu(24)-AA(1)-(crosslinked, Tg 29° C.)

P-8: Latex of -St(60)-Bu(35)-DVB(3)-MAA(2)-(crosslinked)

P-9: Latex of -St(70)-Bu(25)-DVB(2)-AA(3)-(crosslinked)

P-10: Latex of -VC(50)-MMA(20)-EA(20)-AN-(5)-AA(5)-(molecular weight 80000)

P-11: Latex of -VDC(85)-MMA(5)-EA(5)-MAA(5)-(molecular weight 67000)

P-12: Latex of -Et(90)-MAA(10)-(molecular weight 12000)

P-13: Latex of -St(70)-2EHA(27)-AA(3)-(molecular weigh: 130000, Tg 43° C.)

P-14: Latex of -MMA(63)-EA(35)-AA(2)-(molecular weight 33000, Tg 47° C.)

P-15: Latex of -St(70.5)-Bu(26.5)-AA(3)-(crosslinked, Tg 23° C.)

P-16: Latex of -St(69.5)-Bu(27.5)-AA(3)-(crosslinked, Tg 20.5° C.)

Abbreviations of the constituent monomers are as follows:

MMA: methyl methacrylate

EA: ethyl acrylate

MAA: methacrylic acid

2EHA: 2-ethylhexyl acrylate

St: styrene

Bu: butadiene

AA: acrylic acid

DVB: divinylbenzene

VC: vinyl chloride

AN: acrylonitrile

VDC: vinylidene chloride

Et: ethylene

IA: itaconic acid

The polymer latexes mentioned above are available on the market. Some commercial products employable herein are mentioned below. Examples of acrylic polymers are CEBIAN A-4635, 4718, 4601 (all from Daicel Chemical Industries), and NIPOL Lx811, 814, 821, 820, 855 (P-17: Tg 36° C.), 857×2 (P-18: Tg 43° C.) (all from Nippon Zeon), VONCOAT R3370 (P-19: Tg 25° C.), 4280 (P-20: Tg 15° C.) (all from Dai-Nippon Ink & Chemicals), JULIMER ET-410 (P-21: Tg 44° C.) (from Nippon Jun-yaku), AE116 (P-22: Tg 50° C.), AE119 (P-23: Tg 55° C.) AE121 (P-24: Tg 58° C.), AE125 (P-25: Tg 60° C.), AE134 (P-26: Tg 48° C.), AE137 (P-27: Tg 48° C.), AE140 (P-28: Tg 53° C.), AE173 (P-29: Tg 60° C.) (all from JSR), ARON A-104 (P-30: Tg 45° C.) (from Toa Gosei); examples of poly(esters) are FINETEX ES650, 611,675, 850 (all from Dai-Nippon Ink & Chemicals), and WD-size, WMS (both from Eastman Chemical); examples of poly(urethanes) are HYDRAN AP10 (P-31: Te 37° C.), 20, 30, 40 (P-32: Tg 55° C.), 101H, VONDIC 1320NS, 161ONS (all from Dai-Nippon Ink & Chemicals); examples of rubbers are LACSTAR 7310K, 3307B (P-33: Tg 13° C.), 4700H, 7132C (P-34: Tg 70° C.) (all from Dai-Nippon Ink & Chemicals), and NIPOL Lx416 (P-35: Tg 50° C.), 410, 430, 435, 110, 415A (P-36: Tg 27° C.), 438C, 2507H (P-37: Tg 58° C.), 303A (P-38: Tg 100° C.) (all from Nippon Zeon); examples of poly(vinyl chlorides) are G35 1, G576 (both from Nippon Zeon); examples of poly(vinylidene chlorides) are L502, L513 (both from Asahi Kasei) D-5071 (P-39: Tg 36° C.) (from Dai-Nippon Ink & Chemicals); and examples of poly(olefins) are CHEMIPEARL S120, SA100, V300 (P-40: Tg 80° C.) (all from Mitsui Petrochemical), VONCOAT 2830 (P-41: Tg 38° C.), 2210 2960 (all from Dai-Nippon Ink & Chemicals).

For controlling the lowermost film-forming temperature of the polymer latex, a film formation aid may be added to it. The film formation aid may be referred to also as a temporary plasticizer, and it is an organic compound (generally an organic solvent) that lowers the lowermost film-forming temperature of polymer latex. This is described in detail in Chemistry of Synthetic Latexes (by Sohichi Muroi, the Polymer Publishing Association of Japan, 1970). Preferred examples of the film formation aid for use herein are mentioned below, to which, however, the invention is not limited.

Z-1: benzyl alcohol

Z-2: 2,2,4-trimethylpentanediol 1,3-monoisobutyrate

Z-3: 2-dimethylaminoethanol

Z-4: diethylene glycol

Adding the film formation aid is especially preferred, and its amount is preferably from 1 to 30% by mass, more preferably from 5 to 20% by mass of the solid content of the polymer latex in the coating liquid for the protective layers.

### Description of Water-Soluble Polymer

The water-soluble polymer for use in the invention may be any of animal protein-derived polymers or other polymers not derived from animal protein.

The animal protein-derived polymers of the invention are water-soluble polymers derived from natural animal protein, including, for example, glue, casein, gelatin, albumen. These may be chemically modified.

Other water-soluble polymers not derived from animal protein of the invention are natural polymers except animal protein such as gelatin (polysaccharide polymers, microorganisms-derived polymers, animal polymers), semi-synthetic polymers (cellulose polymers, starch polymers, alginic acid polymers) and synthetic polymers (vinyl polymers and others). Synthetic polymers such as polyvinyl alcohols mentioned below, and natural or semi-synthetic polymers from vegetable-derived celluloses are water-soluble polymers usable herein. Preferred for use herein are polyvinyl alcohols, and acrylic acid-vinyl alcohol copolymers.

1) Gelatin:

The animal protein-derived polymer is preferably gelatin. Gelatin includes acid-processed gelatin and alkali-processed gelatin (e.g., lime-processed gelatin) that are grouped depending on the method for producing them, and any of these are preferred for use herein. Preferably, gelatin for use herein has a molecular weight of from 10,000 to 1,000,000. Also usable herein are modified gelatins, for which gelatin is modified on its amino group or carboxyl group (e.g., phthalated gelatin).

2) Polyvinyl Alcohols:

For the water-soluble polymer not derived from animal protein of the invention, polyvinyl alcohols may be used herein.

Preferred examples of polyvinyl alcohols (PVA) for use in the invention are mentioned below. They have a different degree of saponification, a different degree of polymerization and a different degree of neutralization, and are, if necessary, modified in a different manner, or are, if necessary, copolymerized with various comonomers.

Completely saponified PVAs may be selected from PVA-105 [having a polyvinyl alcohol (PVA) content of at least 94.0% by mass, a degree of saponification of 98.5±0.5 mol %, a sodium acetate content of at most 1.5% by mass, a volatile content of at most 5.0% by mass, a viscosity (4% by mass, 20° C.) of 5.6±0.4 CPS]; PVA-110 [having a polyvinyl alcohol (PVA) content of 94.0% by mass, a degree of saponification of 98.5±0.5 mol %, a sodium acetate content of 1.5% by mass, a volatile content of 5.0% by mass, a viscosity (4% by mass, 20° C.) of 11.0±0.8 CPS]; PVA-117 [having a polyvinyl alcohol (PVA) content of 94.0% by mass, a degree of saponification of 98.5±0.5 mol %, a sodium acetate content of 1.0% by mass, a volatile content of 5.0% by mass, a viscosity (4% by mass, 20° C.) of 28.0±3.0 CPS]; PVA-1 17H [having a PVA content of 93.5% by mass, a degree of saponification of 99.6±0.3 mol %, a sodium acetate content of 1.85% by mass, a volatile content of 5.0% by mass, a viscosity (4% by mass, 20° C.) of 29.0±3.0 CPS]; PVA-120 [having a PVA content of 94.0% by mass, a degree of saponification of 98.5±0.5 mol %, a sodium acetate content of 1.0% by mass, a volatile content of 5.0% by mass, a viscosity (4% by mass, 20° C.) of 39.5±4.5 CPS]; PVA-124 [having a PVA content of 94.0% by mass, a degree of saponification of 98.5±0.5 mol %, a sodium acetate content of 1.0% by mass, a volatile content of 5.0% by mass, a viscosity (4% by mass, 20° C.) of 60.0±6.0 CPS]; PVA-124H [having a PVA content of 93.5% by mass, a degree of saponification of 99.6±0.3 mol %, a sodium acetate content of 1.85% by mass, a volatile content of 5.0% by mass, a viscosity (4% by mass, 20° C.) of 61.0±6.0 CPS]; PVA-CS [having a PVA content of 94.0% by mass, a degree of saponification of 97.5±0.5 mol %, a sodium acetate content of 1.0% by mass, a volatile content of 5.0% by mass, a viscosity (4% by mass, 20° C.) of 27.5±3.0 CPS]; PVA-CST [having a PVA content of 94.0% by mass, a degree of saponification of 96.0±0.5 mol %, a sodium acetate content of 1.0% by mass, a volatile content of 5.0% by mass, a viscosity (4% by mass, 20° C.) of 27.0±3.0 CPS]; PVA-HC [having a PVA content of 90.0% by mass, a degree of saponification of at least 99.85 mol %, a sodium acetate content of 2.5% by mass, a volatile content of 8.5% by mass, a viscosity (4% by mass, 20° C.) of 25.0±3.5 CPS] (all trade names of Kuraray).

Partially saponified PVAs may be selected from PVA-203 [having a PVA content of 94.0% by mass, a degree of saponification of 88.0±1.5 mol %, a sodium acetate content of 1.0% by mass, a volatile content of 5.0% by mass, a viscosity (4% by mass, 20° C.) of 3.4±0.2 CPS]; PVA-204 [having a PVA content of 94.0% by mass, a degree of saponification of 88.0±1.5 mol %, a sodium acetate content of 1.0% by mass, a volatile content of 5.0% by mass, a viscosity (4% by mass, 20° C.) of 3.9±0.3 CPS]; PVA-205 [having a PVA content of 94.0% by mass, a degree of saponification of 88.0±1.5 mol %, a sodium acetate content of 1.0% by mass, a volatile content of 5.0% by mass, a viscosity (4% by mass, 20° C.) of 5.0±0.4 CPS]; PVA-2 10 [having a PVA content of 94.0% by mass, a degree of saponification of 88.0±1.0 mol %, a sodium acetate content of 1.0% by mass, a volatile content of 5.0% by mass, a viscosity (4% by mass, 20° C.) of9.0±1.0 CPS]; PVA-217 [having a PVA content of 94.0% by mass, a degree of saponification of 88.0±1.0 mol %, a sodium acetate content of 1.0% by mass, a volatile content of 5.0% by mass, a viscosity (4% by mass, 20° C.) of 22.5±2.0 CPS]; PVA-220 [having a PVA content of 94.0% by mass, a degree of saponification of 88.0±1.0 mol %, a sodium acetate content of 1.0% by mass, a volatile content of 5.0% by mass, a viscosity (4% by mass, 20° C.) of 30.0±3.0 CPS]; PVA-224 [having a PVA content of 94.0% by mass, a degree of saponification of 88.0±1.5 mol %, a sodium acetate content of 1.0% by mass, a volatile content of 5.0% by mass, a viscosity (4% by mass, 20° C.) of 44.0±4.0 CPS]; PVA-228 [having a PVA content of 94.0% by mass, a degree of saponification of 88.0±1.5 mol %, a sodium acetate content of 1.0% by mass, a volatile content of 5.0% by mass, a viscosity (4% by mass, 20 C.) of 65.0±5.0 CPS]; PVA-235 [having a PVA content of 94.0% by mass, a degree of saponification of 88.0±1.5 mol %, a sodium acetate content of 1.0% by mass, a volatile content of 5.0% by mass, a viscosity (4% by mass, 20° C.) of 95.0±15.0 CPS]; PVA-217EE [having a PVA content of 94.0% by mass, a degree of saponification of 88.0±1.0 mol %, a sodium acetate content of 1.0% by mass, a volatile content of 5.0% by mass, a viscosity (4% by mass, 20° C.) of 23.0±3.0 CPS]; PVA-217E [having a PVA content of 94.0% by mass, a degree of saponification of 88.0±1.0 mol %, a sodium acetate content of 1.0% by mass, a volatile content of 5.0% by mass, a viscosity (4% by mass, 20° C.) of 23.0±3.0 CPS]; PVA-220E [having a PVA content of 94.0% by mass, a degree of saponification of 88.0±1.0 mol %, a sodium acetate content of 1.0% by mass, a volatile content of 5.0% by mass, a viscosity (4% by mass, 20° C.) of 31.0±4.0 CPS]; PVA-224E [having a PVA content of 94.0% by mass, a degree of saponification of 88.0±1.0 mol %, a sodium acetate content of 1.0% by mass, a volatile content of 5.0% by mass, a viscosity (4% by mass, 20° C.) of 45.0±5.0 CPS]; PVA-403 [having a PVA content of 94.0% by mass, a degree of saponification of 80.0±1.5 mol %, a sodium acetate content of 1.0% by mass, a volatile content of 5.0% by mass, a viscosity (4% by mass, 20° C.) of 3.1±0.3 CPS]; PVA-405 [having a PVA content of 94.0% by mass, a degree of saponification of 81.5±1.5 mol %, a sodium acetate content of 1.0% by mass, a volatile content of 5.0% by mass, a viscosity (4% by mass, 20° C.) of 4.8±0.4 CPS]; PVA-420 [having a PVA content of 94.0% by mass, a degree of saponification of 79.5±1.5 mol %, a sodium acetate content of 1.0% by mass, a volatile content of 5.0% by mass]; PVA-613 [having a PVA content of 94.0% by mass, a degree of saponification of 93.5±1.0 mol %, a sodium acetate content of 1.0% by mass, a volatile content of 5.0% by mass, a viscosity (4% by mass, 20° C.) of 16.5±2.0 CPS]; L-8 [having a PVA content of 96.0% by mass, a degree of saponification of 71.0±1.5 mol %, a sodium acetate content of 1.0% by mass (ash), a volatile content of 3.0% by mass, a viscosity (4% by mass, 20° C.) of 5.4±0.4 CPS] (all trade names of Kuraray).

The above-mentioned data are obtained according to JISK-6726-1977.

Modified polyvinyl alcohols may be selected from cation-modified ones, anion-modified ones, those modified with —SH compound, those modified with alkylthio compound, and those modified with silanol. In addition, other modified polyvinyl alcohols described in Poval (by Koichi Nagano et al., Kobunshi Kanko-kai) are also usable herein.

Such modified polyvinyl alcohols (modified PVA) are C polymers such as C-118, C-318, C-318-2A, C-506 (all trade names of.Kuraray); HL polymers such as HL-12E, HL-1203 (both trade names by Kuraray); HM polymers such as HM-03, HM-N-03 (both trade names by Kuraray); K polymers such as KL-118, KL-318, KL-506, KM-118T, KM-618 (all trade names by Kuraray); M polymers such as M-115 (trade name of Kuraray); MP polymers such as MP-102, MP-202, MP-203 (all trade names of Kuraray); MPK polymers such as MPK-1, MPK-2, MPK-3, MPK-4, MPK-5, MPK-6 (all trade names of Kuraray); R polymers such as R-1130, R-2105, R-2130 (all trade names of Kuraray); V-polymers such as V-2250 (trade name of Kuraray).

The viscosity of polyvinyl alcohol may be controlled or stabilized by adding a very small quantity of solvent or inorganic salt to the aqueous solution of the polymer. Precisely, those described in Poval (by Koichi Nagano et al., Kobunshi Kanko-kai), pp. 144-154 may be used. One typical example is boric acid, and it is effective for increasing the area to be coated. Preferably, the amount of boric acid to be added is from 0.01 to 40% by mass of polyvinyl alcohol.

When polyvinyl alcohol is heated, its crystallinity increase, and its water resistance also increase. This is described in the above-mentioned reference, Poval. Accordingly, when materials are heated while they are coated and dried or when dried materials are additionally heated, then their water resistance is improved. Therefore, polyvinyl alcohol is especially preferred for the water-soluble polymer for use in the invention.

For further increasing the water resistance of the coated materials, it is desirable to add thereto a waterproofness enhancer such as those described in the reference, Poval, pp. 256-261. For example, the waterproofness enhancer includes aldehydes, methylol compounds (N-methylolurea, N-methylolmelamine), activated vinyl compounds (e.g., divinyl sulfone and its derivatives), bis(β-hydroxyethyl sulfone), epoxy compounds (e.g., epichlorohydrin and its derivatives), polycarboxylic acids (e.g., dicarboxylic acids, polycarboxylic acids such as polyacrylic acid, methyl vinyl ether-maleic acid copolymer, isobutylene-maleic anhydride copolymer), diisocyanates, inorganic crosslinking agents (e.g., compounds with Cu, B, Al, Ti, Zr, Sn, V, Cr).

Inorganic crosslinking agents are preferred for the waterproofness enhancer for use in the invention. In particular, boric acid and its derivatives are more preferred, and boric acid is even more preferred. Examples of boric acid derivatives are mentioned below.

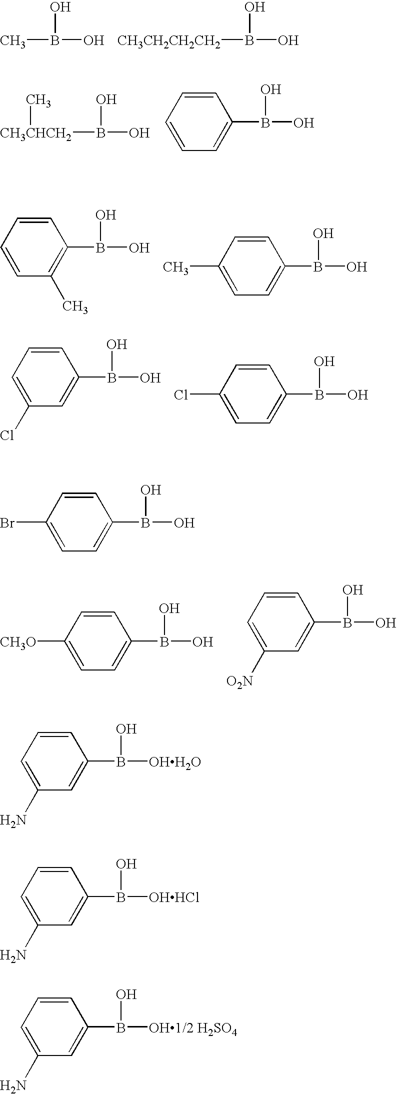

The amount of the waterproofness enhancer to be added is preferably from 0.01 to 40% by mass of polyvinyl alcohol.

3) Other Water-Soluble Polymers:

In addition to the substances mentioned above, the following are further mentioned for still other water-soluble polymers not derived from animal protein for use in the invention Concretely mentioned are vegetable polysaccharides such as gum arabic, k-carrageenan, l-carrageenan, λ-carrageenan, guar gum (e.g., Squalon's SUPERCOL), locust bean gum, pectin, tragacanth, corn starch (e.g., National Starch & Chemical's PURITY-21), phosphorylated starch (e.g., National Starch & Chemical's NATIONAL 78-1898).

Further mentioned are microorganisms-derived polysaccharides such as xanthane gum (e.g., Kelco's KELTROL T), dextrin (e.g., National Starch & Chemical's NADEX 360);and animal polysaccharides such as sodium chondroitin sulfate (e.g., Croda's CROMOIST CS).

Also usable are cellulose polymers such as ethyl cellulose (e.g., ICI's CELLOFAS WLD), carboxymethyl cellulose (e.g., Daicel's CMC), hydroxyethyl cellulose (e.g., Daicel's HEC), hydroxypropyl cellulose (e.g., Aqualon's KLUCEL), methyl cellulose (e.g., Henkel's VISCONTRAN), nitrocellulose (e.g., Hercules' ISOPROPYL WET), cationated cellulose (e.g., Croda's CRODACEL QM). Also usable are alginic acid polymers such as sodium alginate (e.g., Kelco's KELTONE), alginic acid propylene glycol. Others that are also usable herein are cationated guar gum (e.g., Alcolac's HI-CARE1000), sodium hyaluronate (e.g., Lifecare Biomedial's HYALURE).

Still usable are agar, furcellaran, guar gum, karaya gum, larch gum, guar seed gum, psyllium seed gum, kins seed gum, tamarind gum, gellan gum, cod gum. Of these polymers, preferred are those highly soluble in water. Concretely preferred are those capable of undergoing sol-gel conversion to give aqueous solutions through temperature change in a range between 5° C. and 95° C. within 24 hours.

Synthetic polymers are also usable herein, including, for example, acrylic polymers such as sodium polyacrylate, polyacrylic acid copolymers, polyacrylamide, polyacrylamide copolymers; vinylic polymers such as polyvinylpyrrolidone, polyvinylpyrrolidone copolymers; and other polymers such as polyethylene glycol, polypropylene glycol, polyvinyl ether, polyethylenimine, polystyrenesulfonic acid and its copolymers, polyvinylsulfonic acid and its copolymers, polyacrylic acid and its copolymers, acrylic acid and its copolymers, maleic acid copolymers, maleic monoester copolymers, acryloylmethylpropanesulfonic acid and its copolymers.

Further usable herein are high-absorbent polymers as in U.S. Pat. No. 4,960,681, JP-A No. 62-245260, for example, homopolymers of vinyl monomers having —COOM or —SO₃M (where M represents a hydrogen atom or an alkali metal) as well as copolymers of such monomers or copolymers of such monomer with any other vinyl monomer (e.g., sodium methacrylate, ammonium methacrylate, Sumitomo Chemical's SUMIKAGEL L-5H.

Of those water-soluble polymers, especially preferred is Sumitomo Chemical's SUMIKAGEL L-5H.

### Relationship between Binder and Formula (I)

Regarding the relationship between the type of the binder and the dynamic friction factor, B/A in formula (1) could be less than 1 when the mean Tg of the binder is not higher than the temperature at which the dynamic friction factor is measured.

Regarding the relationship between the coating amount of the binder and the dynamic friction factor, it is desirable that the coating amount of the binder is from 0.2 to 5 g/m². If it is smaller than 0.2 g/m², the binder may be peeled off under friction; but if larger than 5 g/m², then B/A would often be less than 1.

Accordingly, for the preferred combination of the type and the coating amount of the binder in the back-surface protective layer and the surface-protective layer to satisfy the formula (1), the mean Tg is not lower than the temperature at which the dynamic friction factor is measured.

Concretely, the coating amount of the binder (per m² of the substrate) is preferably from 0.2 to 5 g/m², more preferably from 0.4 to 4 g/m².

<Sliding Agent>

The sliding agent for use in the invention is not specifically defined. For example, it includes paraffin, isoparaffin, naphthene, fatty acid esters, silicone oils. Of those, preferred are liquid paraffin, monofatty acid esters of polyalcohols, and polyfatty acid esters of monoalcohols.

It is desirable that the sliding agent is added in the invention, and it may be added to any layer. Preferably, it is added to at least one of the surface-protective layer and the back-surface protective layer, more preferably to both the surface-protective layer and the back-surface protective layer.

One or more different types of sliding agents may be used in the invention either singly or as combined.

Regarding the relationship between the type of the sliding agent and the dynamic friction factor, B/A may be less than 1 when the amount of the sliding agent is too much.

Accordingly, the preferred coating amount of the sliding agent in the surface-protective layer and the back-surface protective layer to satisfy the formula (1) is from 1 to 500 mg/M², more preferably from 5 to 200 mg/m².

Preferably, the sliding agent to be used in the invention is as follows: <1> It is liquid at normal temperature, and its reduction under heat at 120° C. for 1 hour is not more than 0.5% by weight when its weight change is measured with a thermal balance; <2> its melting point falls between 40° C. and 80° C., and it is at least one selected from a group consisting of paraffin and fatty acid esters; <3> its ratio of swelling conveyor rollers in thermal developing machine is not more than 6% by mass; <4> its molecular weight is 1250 or more.

The sliding agent <1> is described.

The definition “liquid at room temperature” as referred to herein means that the substance is fluid at 25° C. In order to convert a compound that is solid at room temperature into another that is liquid at room temperature, the compound may be mixed with some other compound having a similar structure. The technique of using such a mixed liquid is within the scope of the invention.

The weight change under heat at 120° C. for 1 hour may be measured by the use of a thermal balance as follows: Using a commercially-available thermal balance (Seiko Instruments' TG/GTA220 Model), the sample to be analyzed is heated from 30° C. up to 120° C. at a heating rate of 5° C./min in a nitrogen stream condition at 200 ml/min, and then kept at 120° C. whereupon the weight reduction during one hour is evaluated in terms of percent by weight based on the weight of the original sample (about 10 mg).

Sliding agents having a low volatile content are favorable in point of their ability to improve the slidability of conveyors since they soil little the area around thermal developing units. Liquid sliding agents are also favorable, since they may readily disperse in coating liquids and therefore the necessary amount of surfactant may be reduced. Accordingly, photothermographic materials containing such a liquid sliding agent are preferred to others for which a solid sliding agent melted at high temperature is added to the coating liquids along with a large amount of surfactant thereto, since the former have better storage stability.

Specific examples of the sliding agent <1> are mentioned below, to which, however, the invention should not be limited. The value of each example means the volatile content (% by mass) measured according to the above-mentioned method.

S-4: Matsumura Petroleum Laboratory's MORESCOWHITE P-350P, 0.12

S-5: Matsumura Petroleum Laboratory's MORESCOWHITE P-500, 0.01

S-6: Sanko Chemical Industry's liquid paraffin 260-S, 0.11

S-7: Sanko Chemical Industry's liquid paraffin 380-S, 0.04

S-8: Nikko Chemicals' TRIALAN 308, 0.16

S-9: Nikko Chemicals' TRIALAN 318H, 0.002

S-10: Nippon Yushi's UNISTAR H-381R, 0.03

S-11: Nippon Yushi's UNISTAR H-481R, 0.04

S-12: Takemoto Yushi's PIONIN E-5310, 0.12

S-13: Takemoto Yushi's PIONIN E-5312, 0.09

S-14: Nippon Seika Kogyo's NS-408, 0.02

S-15: Nippon Seika Kogyo's NS-318S, 0.00

S-16: CRODA CRODAMOL PTIS, 0.05

S-17: Nisshin Oillio's SARACOS 6318, 0.02

S-18: Nisshin Oillio's SARACOS 6318R, 0.01

S-19: Higher Alcohol Industry's KAK PTI, 0.17

S-20: Higher Alcohol Industry's KAK TTI, 0.04

2) Preferred Structures:

Preferred structure of the sliding agent <1> are represented by the following formula (S—I), (S—II) or (S—III):

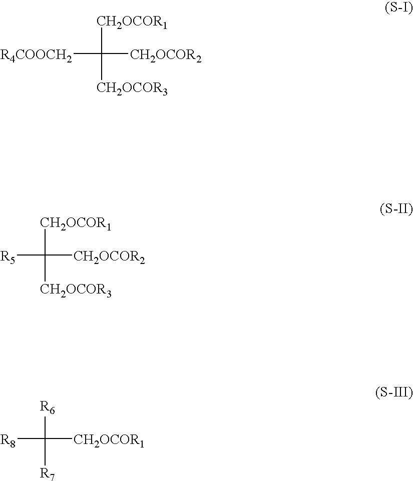

In formulae (S—I), (S—II) and (S—III), R₁, R₂ and R₃ each independently represents an alkyl, alkenyl, alkynyl, cycloalkyl or aryl group having from 6 to 30 carbon atoms.

R₄ represents an alkyl group having from 1 to 30 carbon atoms. R₅ represents an alkyl group having from 1 to 30 carbon atoms. R₆, R₇ and R₈ each represent a methylol group or an alkyl group having from 1 to 30 carbon atoms, and these groups may be substituted with an ester group.

In order that the compounds of formulae (S—I), (S—II) and (S—III) are liquid at room temperature, it is desirable that the group of R₁ to R₃ has a double bond or a branched structure. To the same effect, it is also desirable that the alkyl group of R₆ to R₈ has a double bond or a branched structure. Also preferably, the group of R₆ to R₈ is substituted with an ester group in order that the compounds are liquid at room temperature.

In formulae (S—I) to (S—III), it is desirable that R₁ to R₃ each are a branched alkyl or alkenyl group having from 6 to 30 carbon atoms, more preferably from 8 to 24 carbon atoms, even more preferably from 12 to 20 carbon atoms. Concretely mentioned are a 1-ethylpentyl group, a heptyl group, an undecyl group, a 2-hexylnonyl group, a 15-methylhexadeyl group, and an 8-heptadecenyl group. Of those, more preferred are a 15-methylhexadecyl group and an 8-heptadecenyl group.

R₅ is preferably an alkyl group having from 1 to 30 carbon atoms, more preferably an alkyl group having from 1 to 8, even more preferably from 1 to 3 carbon atoms. Concretely mentioned are a methyl group, an ethyl group, a propyl group, a butyl group, an octyl group and a hexadecyl group. Of those, more preferred are a methyl group and an ethyl group; and most preferred is an ethyl group.

Preferably, R₆ to R₈ each are a methylol group or an alkyl group having from 1 to 30 carbon atoms, which may be substituted with an ester group. More preferably, they are a methylol group, or an ester group-substituted alkyl group.

Specific structures of preferred compounds of the sliding agent for use in the invention are mentioned below, to which, however, the invention should not be limited.

| | |
|---|---|
| 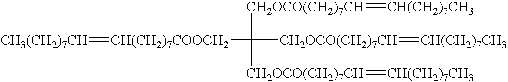 | (S-21) |
| 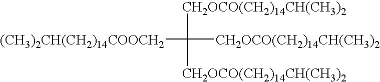 | (S-22) |
| 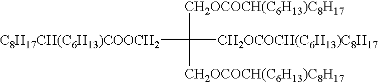 | (S-23) |
| 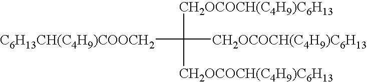 | (S-24) |
| 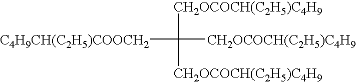 | (S-25) |
| 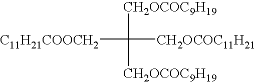 | (S-26) |
| 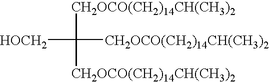 | (S-27) |
| 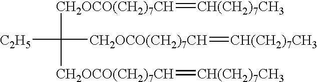 | (S-28) |
| 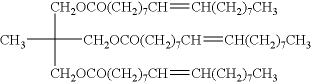 | (S-29) |
| 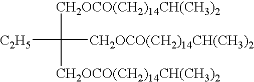 | (S-30) |
| 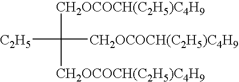 | (S-31) |
| 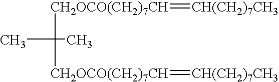 | (S-32) |
| 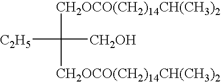 | (S-33) |

The sliding agent <1> may be emulsified and dispersed in an aqueous gelatin solution along with an anionic surfactant such as sodium dodecylbenzenesulfonate or sodium oleoylmethyltaurine, and the resulting emulsifide dispersion may be added to coating liquids. The emulsification and dispersion may be effected in any known method, using a homogenizer, a dissolver, a Manton-Gaulin emulsifier or the like. For the emulsification and dispersion, any other additive such as auxiliary solvent and preservative may be used in addition to the surfactant. Preferably, however, an auxiliary solvent is not used in the emulsification in the invention. This is because the sliding agent for use in the invention is liquid and therefore it can be emulsified and dispersed not using an auxiliary solvent. Since the sliding agent is liquid and therefore does not require an auxiliary solvent, it is free from problems of storage stability which may often occur while emulsions are stored, for example, particle size fluctuation, formation of coarse particles and precipitation of crystals to worsen filterability.

The sliding agent <2> is described.

Regarding its structure, the sliding agent <2> is at least one of paraffin and fatty acid esters. For the paraffin, preferred is linear paraffin; and for the fatty acid esters, preferred are monofatty acid esters of monoalcohols, monofatty acid esters of polyalcohols and polyfatty acid esters of monoalcohols. Of those, most preferred siding agents are monofatty acid esters of polyalcohols and polyfatty acid esters of monoalcohols.

The melting point of the sliding agent of the type may be from 40° C. to 80° C., more preferably from 43° C. to 75° C., even more preferably from 45° C. to 70° C., still more preferably from 50° C. to 65° C.

The sliding agent is characterized in that its melting point falls between 40° C. and 80° C., and it becomes low-viscous liquid at a temperature higher by at least 5° C. than its melting point. Accordingly, it is characterized in that it can be readily dispersed in an aqueous solution that contains a protective colloid such as gelatin, at relatively low temperatures, and its dispersion is stable. Compared with ordinary solid esters, it does not require a large quantity of dispersant and surfactant, and is therefore good since its influence on the outputted images is small.

Specific examples of the sliding agent <2> are mentioned below, to which, however, the invention should not be limited. The temperature of each example is the melting point thereof.

T-1: Wako Pure Chemical's paraffin, 42-44° C.

T-2: Wako Pure Chemical's paraffin, 50-52° C.

T-3: Wako Pure Chemical's paraffin, 60-62° C.

T-4: Wako Pure Chemical's paraffin, 68-70° C.

T-5: C₁₃H₂₇COOC₁₄H₂₉, 44° C.

T-6: C₁₅H₃₁COOC₁₄H₂₉, 48.5° C.

T-7: C₁₅H₃₁COOC₁₆H₃₃, 53° C.

T-8: C₁₅H₃₁COOC₁₈H₃₇, 59.5° C.

T-9: C₁₇H₃₅COOC₁₂H₂₅, 42.0° C.

T-10: C₁₇H₃₅COOC₁₆H₃₃, 58.5° C.

T-11: C₁₇H₃₅COOC₁₈H₃₇, 62.5° C.

T-12: C₂lH₄₃COOC₂₂H₄₅, 70° C.

T-13: C₁₆H₃₃OCOCH₂CH₂COOC₁₆H₃₃, 54-58° C.

T-14: C₁₇H₃₅COOCH₂CH₂OCOC₁₇H₃₅, 57-64° C.

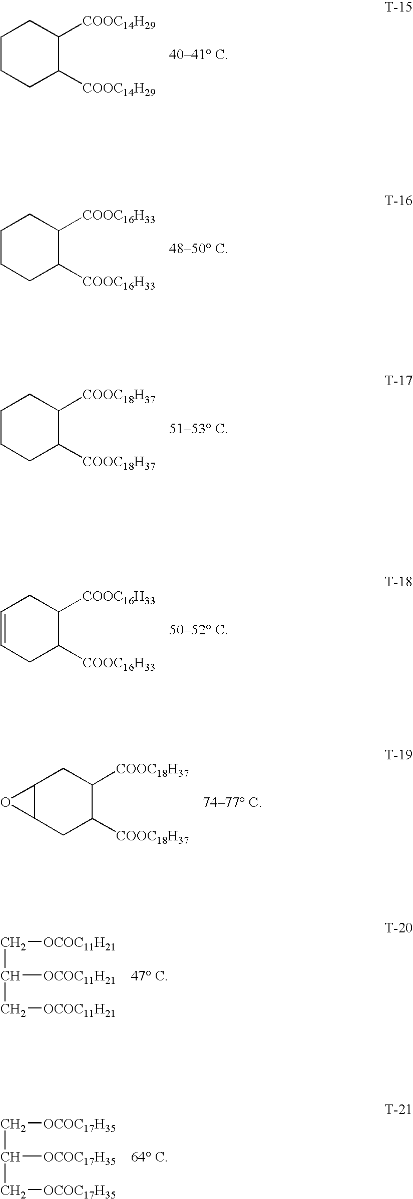

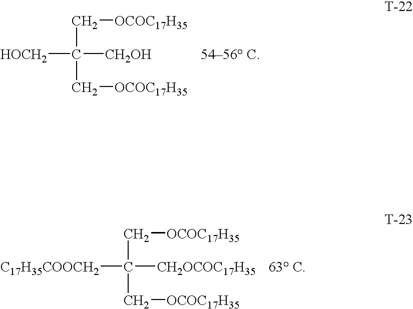

The compound of the invention may be emulsified and dispersed in an aqueous gelatin solution along with an anionic surfactant such as sodium dodecylbenzenesulfonate or sodium oleoylmethyltaurine, and the resulting emulsifide dispersion may be added to coating liquids. The emulsification and dispersion may be effected in any known method, using a homogenizer, a dissolver, a Manton-Gaulin emulsifier or the like. For the emulsification and dispersion, any other additive such as auxiliary solvent and preservative may be used in addition to the surfactant. Preferably, however, an auxiliary solvent is not used in the emulsification in the invention. This is because the compound for use in the invention has a low melting point and therefore it can be emulsified and dispersed at a temperature higher by at least 5° C. than the melting point thereof, not using an auxiliary solvent. In the invention, the temperature preferred for emulsification falls between a temperature higher by at least 5° C. than the melting point of the sliding agent used and 85° C., more preferably between a temperature higher by at least 7° C. than the melting point and 75° C., even more preferably between a temperature higher by at least 10° C. than the melting point and 65° C. Since the compound for use in the invention is has a low melting point and therefore does not require an auxiliary solvent, it is free from problems of storage stability which may often occur while emulsions are stored, for example, particle size fluctuation and formation of coarse particles.

The sliding agent <3> is described.

The sliding agent <3> may have any structure so far as its ratio of swelling conveyor rollers is not more than 6% by mass.

The ratio of swelling conveyor rollers is measured as follows: A part having a size of 1 cm (length)×1 cm (width)×0.2 cm (thickness) is cut out of a conveyor roller to be used in thermal development systems in the manner that the length and width directions correspond to those of the surface of the conveyor roller. The roller part is dipped in a solution of the sliding agent (100%) heated at 120° C. for 2 hours, and then the sliding agent having adhered to the part is clearly wiped off, and the weight of the part is measured. The increased weight is evaluated in terms of percentage relative the weight of the original sample.

One and the same sliding agent shall naturally have a different swelling ratio for different conveyor rollers formed of different materials for thermal development systems. Specifically, measuring the above-mentioned swelling ratio makes it possible to select sliding agents suitable to the thermal development systems to be used, and using the thus-selected sliding agent in photothermographic materials significantly reduces the frequency of conveyance failure in processing the materials.

The sliding agent for use in the invention has a swelling ratio of at most 6% by mass, preferably at most 4% by mass, more preferably at most 2% by mass.

Specific examples of the sliding agent <3> are mentioned below, to which, however, the invention should not be limited. The value mentioned below is the swelling ratio of each compound to Kensetsu Rubber's KSI-6000.

U-1: Waku Pure Chemical's paraffin, m.p. 68-70° C., 4.0% by mass

U-2: C₁₅H₃₁COOC₁₈H₃₇, 5.4% by mass

U-3: C₁₇H₃₅COOC₁₈H₃₇, at most 4.0% by mass

U-4: C₂₁H₄₃COOC₂₂H₄₅, at most 4.0% by mass

U-5: C₁₆H₃₃OCOCH₂CH₂COOC₁₆H₃₃, at most 4.0% by mass

U-6: C₁₇H₃₅COOCH₂CH₂OCOC₁₇H₃₅, at most 4.0% by mass

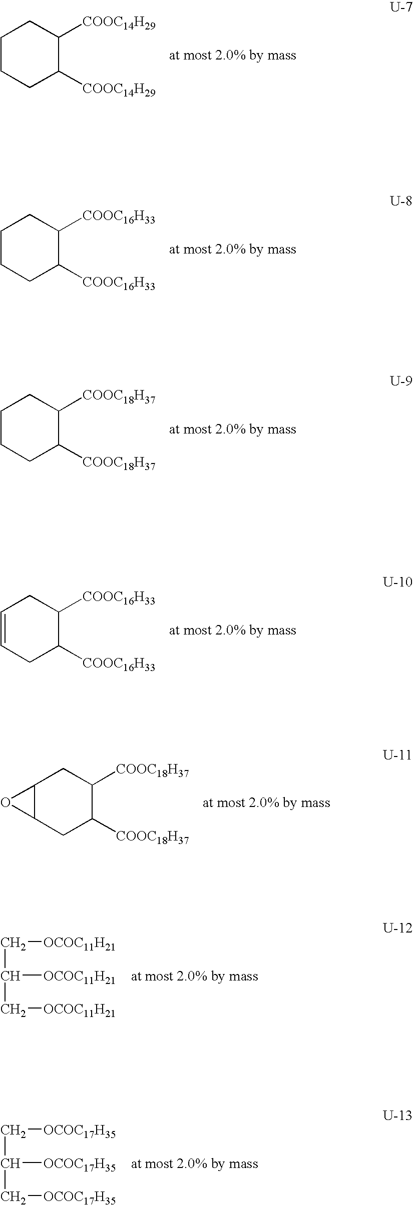

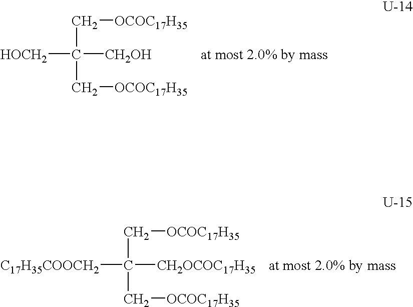

The sliding agent <3> may be used in the same manner as that for <1> and <2>. The sliding agent liquid at room temperature may be emulsified and dispersed in the same manner as that for <1 >; and the solid sliding agent may be emulsified and dispersed in the same manner as that for <2>.

The sliding agent <4> is described.

The sliding agent <4> is not specifically defined in point of its structure so far as its molecular weight is at least 1250. For it, preferred are paraffin, fatty acid esters and silicone oils. Of those, more preferred are fatty acid esters, and even more preferred are fatty acid esters of polyalcohols. Fatty acid esters of polyalcohols may be completely esterified, or some alcohol residues may remain therein. Preferably, the sliding agent of the type has at least 4 ester residues in one molecule, more preferably at least 5 ester residues. The alcohol residues, if any, in the sliding agent preferably have a branched hydrocarbon group, such as isopropyl, t-butyl or t-amyl group.

Regarding its form, the sliding agent may be liquid, pasty or solid at room temperature, but is preferably liquid or pasty, more preferably pasty. For obtaining pasty sliding agents, for example, employable is a method of introducing both a linear fatty acid and a branched fatty acid in one molecule while controlling the blend ratio of the two; a method of introducing both a saturated fatty acid and an unsaturated fatty acid in one molecule; a method of introducing two or more different fatty acids having a different chain length; a method of introducing a hydroxyl group-having fatty acid and a fatty acid not having a hydroxyl group; or a combination of any of these methods. For example, it may be attained by mixing isostearic acid and n-stearic acid.

Preferably, these have a melting point falling between 25° C. and 60° C., more preferably between 30° C. and 50° C.

Preferably, the sliding agent <4> is added to photothermographic materials in the form of a emulsifide dispersion containing it. In preparing the emulsifide dispersion, the type of the dispersion medium, the binder concentration, the viscosity, the stirring condition, the dispersion time and the dispersion temperature are suitably controlled so as to make the dispersion have a more uniform particle size. However, some but a few coarse particles may remain in the emulsifide, or the particles may aggregate into coarse particles while the emulsifide is stored, and such coarse particles often worsen the coated surface states of photothermographic materials.

To prevent the formation of such coarse particles, it is desirable that the sliding agent <4> has a molecular weight of at least 1250. More preferably, its molecular weight is at least 1400, even more preferably at least 1600. The uppermost limit of the molecular weight is not specifically defined so far as it may attain the object of the invention. Preferably, however, the molecular weight is at most 10,000, more preferably at most 7,000, even more preferably at most 5,000.

For the sliding agent that has a structure of a fatty acid ester of a polyalcohol for use in the invention, preferred are those of the following formula (L1) or (L2).

(R⁰¹OCH₂)₃—CCH₂OCH₂(C(CH₂OR⁰¹)₂CH₂OCH₂)ₙC—(CH₂OR⁰¹)₃ (L1)

In the formula, R⁰¹ represents a fatty acid residue or a hydrogen atom, and R⁰¹'s may be the same or different. n represents 0 or 1. The fatty acid residue is a group derived from a fatty acid by removing an alkoxy group from the ester moiety thereof.

The fatty acid residue for R⁰¹ is preferably an acil group having from 4 to 50 carbon atoms, more preferably from 6 to 50 carbon atoms, even more preferably from 8 to 50 carbon atoms. The fatty acid residue may be linear or branched, and may be substituted. The substituent for it is preferably a hydroxyl group or an amino group. The substituent, hydroxyl group is more preferably unsubstituted.

Specific examples of the compounds of formula (L1) of the invention are mentioned below, to which, however, the invention should not be limited. The degree of substitution is in terms of mol % based on the molecule.

TABLE 1

| | | | degree of | | degree of | | degree of | molecular |
|---|---|---|---|---|---|---|---|---|
| L1 | n | R⁰¹ | substitution | R⁰¹ | substitution | R⁰¹ | substitution | weight |
| 101 | 0 | isostearic acid residue | 100 | — | — | — | — | 1871 |
| 102 | 0 | isostearic acid residue | 83 | hydrogen atom | 17 | — | — | 1605 |
| 103 | 0 | isostearic acid residue | 67 | hydrogen atom | 33 | — | — | 1339 |
| 104 | 0 | isostearic acid residue | 50 | isooctylic acid residue | 50 | — | — | 1451 |
| 105 | 0 | isostearic acid residue | 50 | stearic acid residue | 50 | — | — | 1871 |
| 106 | 0 | hydroxystearic acid | 67 | stearic acid residue | 25 | resin acid | 8 | 1944 |
| | | residue | | | | residue | | |
| 107 | 0 | hydroxystearic acid | 33 | isostearic acid residue | 33 | hydrogen atom | 34 | 1371 |
| | | residue | | | | | | |
| 108 | 0 | hydroxystearic acid | 50 | isostearic acid residue | 50 | — | — | 1919 |
| | | residue | | | | | | |
| 109 | 0 | isostearic acid residue | 50 | myristic acid residue | 50 | — | — | 1703 |
| 110 | 0 | isostearic acid residue | 83 | isononanoic acid residue | 17 | — | — | 1745 |
| 111 | 0 | isooctylic acid residue | 50 | myristic acid residue | 50 | — | — | 1283 |
| 112 | 0 | hydroxystearic acid | 67 | oleic acid residue | 33 | — | — | 1931 |
| | | residue | | | | | | |
| 113 | 0 | isostearic acid residue | 67 | oleic acid residue | 17 | hydrogen atom | 16 | 1603 |
| 114 | 0 | isostearic acid residue | 50 | behenic acid residue | 17 | hydrogen atom | 33 | 1395 |
| 115 | 1 | isostearic acid residue | 100 | — | — | — | — | 2500 |
| 116 | 1 | isostearic acid residue | 83 | hydrogen atom | 17 | — | — | 2138 |
| 117 | 1 | isostearic acid residue | 67 | hydrogen atom | 33 | — | — | 1806 |
| 118 | 1 | isostearic acid residue | 50 | isooctanoic acid residue | 50 | — | — | 1940 |
| 119 | 1 | isooctylic acid residue | 50 | myristic acid residue | 50 | — | — | 1708 |
| 120 | 1 | hydroxystearic acid | 67 | oleic acid residue | 33 | — | — | 2625 |
| | | residue | | | | | | |

General Production Method:

The compounds of formula L1 for use in the invention may be produced through ordinary esterification of reacting dipentaerythritol with a carboxylic acid in the presence of an acid catalyst or the like.

Compounds of formula (L2) are described.

R⁰²OCH₂CH(OR⁰²)CH₂O(CH₂CH(OR⁰²)CH₂O)ₙCH₂CH(OR⁰²)CH20R⁰² (L2)

In the formula, R⁰² represents a fatty acid residue or a hydrogen atom, and R⁰²'s may be the same or different. n represents 0 or an integer.

The fatty acid residue for R⁰² is preferably an acil group having from 4 to 50 carbon atoms, more preferably from 6 to 50 carbon atoms, even more preferably from 8 to 50 carbon atoms. The fatty acid residue may be linear or branched, and may be substituted. The substituent for it is preferably a hydroxyl group or an amino group. The substituent, hydroxyl group is more preferably unsubstituted. n represents 0 or an integer. Preferably, it is from 0 to 20, more preferably from 1 to 15, even more preferably from 1 to 10.

Specific examples of the compounds of formula (L2) of the invention are mentioned below, to which, however, the invention should not be limited. The degree of substitution is in terms of mol % based on the molecule.

TABLE 2

| | | degree of | | degree of | | molecular |
|---|---|---|---|---|---|---|
| L2 | R⁰² | substitution | R⁰² | substitution | n | weight |
| 201 | isostearic acid residue | 100 | — | — | 1 | 1570 |
| 202 | isostearic acid residue | 100 | — | — | 2 | 1910 |
| 203 | isostearic acid residue | 57 | hydrogen atom | 43 | 3 | 1452 |
| 204 | isostearic acid residue | 60 | isooctanoic acid residue | 40 | 1 | 1416 |
| 205 | isostearic acid residue | 50 | stearic acid residue | 50 | 2 | 1910 |
| 206 | hydroxystearic acid residue | 57 | hydrogen atom | 43 | 3 | 1516 |
| 207 | hydroxystearic acid residue | 50 | isostearic acid residue | 50 | 2 | 1958 |
| 208 | isostearic acid residue | 43 | hydrogen atom | 57 | 10 | 2354 |
| 209 | isostearic acid residue | 50 | hydrogen atom | 50 | 4 | 1526 |
| 210 | isostearic acid residue | 50 | isononanoic acid residue | 50 | 2 | 1532 |
| 211 | hydroxystearic acid residue | 50 | isostearic acid residue | 50 | 0 | 1262 |
| 212 | hydroxystearic acid residue | 40 | oleic acid residue | 60 | 1 | 1596 |
| 213 | isostearic acid residue | 60 | oleic acid residue | 40 | 1 | 1566 |
| 214 | isostearic acid residue | 75 | behenic acid residue | 25 | 0 | 1286 |
| 215 | isostearic acid residue | 100 | — | — | 6 | 3247 |
| 216 | isostearic acid residue | 100 | — | — | 10 | 3928 |

The compounds of formula (L2) for use in the invention may be produced through ordinary esterification of reacting a polyglycerin with a carboxylic acid in the presence of an acid catalyst or the like.

Except the compounds of formulae (L1) and (L2), the following compounds are also usable in the invention.

(R⁰³O—CH₂)₄—C (L3)

wherein R⁰³ represents a fatty acid residue, and R⁰³'s may be the same or different.

The fatty acid residue for R⁰³ is preferably an acil group having from 18 to 50 carbon atoms, more preferably from 20 to 50 carbon atoms, even more preferably from 22 to 50 carbon atoms. The fatty acid residue may be linear or branched, and may be substituted. The substituent for it is preferably a hydroxyl group or an amino group. The substituent, hydroxyl group is more preferably unsubstituted.

Specific examples of the compounds of formula (L3) of the invention are mentioned below, to which, however, the invention should not to be limited.

TABLE 3

| Compound No. | R⁰³ | molecular weight |
|---|---|---|
| 301 | nonadecanoic acid | 1258 |
| 302 | arachidic acid | 1314 |
| 303 | behenic acid | 1425 |
| 304 | behenic acid/isostearic | 1314 |
| | acid = 50/50 (by mol) | |

The compounds of formula (L3) for use in the invention may be produced through ordinary esterification of reacting pentaerythritol with a carboxylic acid in the presence of an acid catalyst or the like.

The sliding agent <4> may be used in the same manner as that for <1> and <2>. The sliding agent liquid at room temperature may be emulsified and dispersed in the same manner as that for <1>; and the solid sliding agent may be emulsified and dispersed in the same manner as that for <2>.

<Antistatic Agent>

The photothermographic material of the invention preferably has an electroconductive layer that contains a metal oxide or an electroconductive polymer, in which the layer is referred to as an antistatic layer. In this, the antistatic layer may serve also as an undercoat layer or a back-surface protective layer, but may be disposed separately from them.

For the electroconductive polymer, for example, usable are polyvinylbenzenesulfonic acid salts, polyvinylbenzyltrimethylammonium chloride; quaternary salt polymers as in U.S. Pat. Nos. 4,108,802, 4,118,231, 4,126,467 and 4,137,217; and polymer latexes as in U.S. Pat. No. 4,070,189, OLS No. 2,830,767, JP-A Nos. 61-296352 and 61-62033.

Most preferably, the electroconductive layer contains an electroconductive metal oxide as it may fully lower the surface resistivity of the photothermographic material of the invention. Preferred examples of the metal oxide include ZnO, TiO₂ and SnO₂. It is preferred to add Al or In to ZnO, add Sb, Nb, P or a halogen element to SnO₂, and add Nb or Ta to TiO₂. In particular, SnO₂ with Sb added thereto is preferred. The amount of the different metal atom added is preferably from 0.01 to 30 mol %, more preferably from 0.1 to 10 mol %. The shape of the metal oxide may be any one of spherical form, needle-like form and plate-like form but in view of its electroconductivity, a needle-like particle having a major axis/minor axis ratio of 2.0 or more, preferably from 3.0 to 50 is preferred.

The amount of the antistatic agent to be used is preferably from 60 mg/m² to 150 mg/m², more preferably from 80 mg/m² to 150 mg/m².

Specific examples of the antistatic layer that may be in the photothermographic material of the invention are described in JP-A No. 11-65021, paragraph [0135]; JP-A Nos. 56-143430, 56-143431, 58-62646 and 56-120519; JP-A No. 11-84573, paragraphs [0040] to [0051]; U.S. Pat. No. 5,575,957; and JP-A No. 11-223898, paragraphs [0078] to [0084].

<Surfactant>

The photothermographic material of the invention preferably contains a fluorine-containing surfactant. Examples of fluorine-containing surfactants that are preferred for use herein are given, for example, in JP-A Nos. 10-197985, 2000-19680 and 2000-214554. Also preferred for use herein are fluorine-containing polymer surfactants such as those in JP-A No. 9-281636. In the invention, especially preferred are the fluorine-containing surfactants described in JP-A Nos. 2002-82411, 2003-057780 and 2003-149766. In particular, the fluorine-containing surfactants described in JP-A Nos. 2003-057780 and 2003-149766 are especially preferred in preparing aqueous coating liquids and in coating with them, since their ability to control the charging level, to stabilize the coated surface condition and to improve the lubrication of the coated surface is good. Most preferred are the fluorine-containing surfactants described in JP-A No. 2003-149766, as their ability to control the charging level is excellent and their amount to be used may be small.

The surfactant may be used in any of the face of the image-forming layer or the back face of the photothermographic material of the invention, but is preferably used in both faces of the material. The surfactant may be added to any layer, but is preferably added to the outermost layer, surface-protective layer or back-surface protective layer. Also preferably, the surfactant is combined with the above-mentioned metal oxide-containing conductive layer. In this case, even when the amount of the fluorine-containing surfactant in the conductive layer-coated face is reduced or removed, the photothermographic material of the invention still has good properties.

Regarding the relationship between the type of the surfactant and the dynamic friction factor, adding a fluorine-containing surfactant to the protective layer may increase B/A to 1 or more. In view of the dynamic friction factor, it is desirable that the amount of the surfactant to be in the layer is from 0.1 mg/m² to 100 mg/m².

Accordingly, the preferred combination of the type and the amount of the surfactant to be in the back-surface protective layer and/or the surface-protective layer for satisfying the formula (1) is to add a fluorine-containing surfactant to the layer in an amount of 0.1 mg/m² to 100 mg/m².

Especially preferred for use in the invention are fluorine-containing compounds that have a fluoroalkyl group having at least 2 carbon atoms and at most 13 fluorine atoms.

The fluorine-containing compounds may have any desired structure so far as they have the above-mentioned fluoroalkyl group (the fluorine-substituted alkyl group is hereinafter referred to as “Rf”). The fluorine-containing compounds shall have at least one Rf, but may have two or more Rf's.

Specific examples of Rf are mentioned below, to which, however, the invention should not be limited.

—C₂F₅, —C₃F₇, —C₄F₉, —C₅F₁₁, —CH₂—C₄F₉, —C₄F₈—H, —C₂H₄—C₄F₉, —C₄H₈—C₄F₉, —C₆H₁₂—C₄F₉, —C₈H₁₆—C₄F₉, —C₄H₈—C₂F₅, —C₄H₈—C₃F₇, —C₄H₈—C₅F₁₁, —C₈H₁₆—C₂F₅, —C₂H₄—C₄F₈—H, —C₄H₈—C₄F₈—H, —C₆H₁₂—C₄F₈—H, —C₆H₁₂—C₂F₄—H, —C₈H₁₆—C₂F₄—H, —C₆H₁₂—C₄F₈—CH₃, —C₂H₄—C₃F₇, —C₂H₄—C₅F₁₁, —C₄H₈—CF(CF₃)₂, —CH_{S}CF₃, —C₄H₈—CH(C₂F₅)₂, CH(C₂F₅)₂, —C₄H₈—CH(CF₃)₂, —C₄H₈—C(CF₃)₃, —CH₂—C₄F₈—H, —CH₂—C₆F₁₂—H, —CH₂—C₆F₁₃, —C₂H₄—C₆F₁₃, —C₄H₈—C₆F₁₃, —C₆H₁₂—C₆F₁₃, —C₈H₁₆—C₆F₁₃.

Rf has at most 13 fluorine atoms, but preferably at most 12, more preferably from 3 to 11, even more preferably from 5 to 9 fluorine atoms. It has at least 2 carbon atoms, but preferably from 4 to 16, more preferably from 5 to 12 carbon atoms.

Rf is not specifically defined in point of its structure so far as it has at least 2 carbon atoms and at most 13 fluorine atoms, but is preferably represented by the following formula (A):

—Rc—Re—W Formula (A)

More preferably, the fluorine-containing compound has at least two fluoroalkyl groups of formula (A).

In formula (A), Rc represents an alkylene group having from 1 to 4 carbon atoms, but preferably from 1 to 3, more preferably 1 or 2 carbon atoms. The alkylene group for Rc may be linear or branched.

Re represents a perfluoroalkylene group having from 2 to 6 carbon atoms, preferably from 2 to 4 carbon atoms. The perfluoroalkylene group is meant to indicate an alkylene group where all hydrogen atoms are substituted with fluorine atoms. The perfluoroalkylene group may be linear or branched, or may have a cyclic structure.

W represents a hydrogen atom, a fluorine atom, or an alkyl group, but is preferably a hydrogen atom or a fluorine atom. More preferably, it is a fluorine atom.

The fluorine-containing compound may have a cationic hydrophilic group.

The cationic hydrophilic group is meant to indicate a group capable of being a cation when dissolved in water. Concretely, it includes quaternary ammoniums, alkylpyridiniums, alkylimidazoliniums, and primary to tertiary aliphatic amines.

Preferably, the cation is an organic cationic substituent, more preferably a nitrogen or phosphorus atom-containing organic cationic group. Even more preferably, it is a pyridinium cation or an ammonium cation.

The anion to form salts may be an inorganic anion or an organic anion. Preferred examples of the inorganic anion are an iodide ion, a bromide ion, and a chloride ion. Preferred examples of the organic anion are a p-toluenesulfonate ion, a benzenesulfonate ion, a methanesulfonate ion, and a trifluoromethanesulfonate ion.

Cationic fluorine-containing compounds of the following formula (1) are preferably used in the invention.

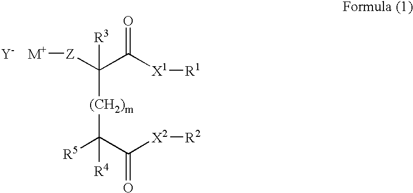

In the formula, R¹ and R² each independently represent a substituted or unsubstituted alkyl group, but at least one of R¹ and R² is the above-mentioned fluoroalkyl group (Rf). Preferably, both of R¹ and R² are Rf. R³, R⁴ and R⁵ each independently represent a hydrogen atom or a substituent; X¹, X² and Z each independently represent a divalent linking group or a single bond; and M⁺ represents a cationic substituent. Y⁻ represents a counter anion, but it may be absent when the charge of the molecule is 0. m is 0 or 1.

In formula (1), when R¹ and R² each independently represent a substituted or unsubstituted alkyl group except Rf, then the alkyl group has at least one carbon atom and may be linear, branched or cyclic. The substituent includes, for example, a halogen atom, an alkenyl group, an aryl group, an alkoxy group, a halogen atom except fluorine, a carboxylate group, a carbonamido group, a carbamoyl group, an oxycarbonyl group, and a phosphate group.

When R¹ or R² is an alkyl group except Rf, or that is, an alkyl group not substituted with a fluorine atom, then the alkyl group may be a substituted or unsubstituted alkyl group having from 1 to 24 carbon atoms, preferably having from 6 to 24 carbon atoms. Preferred examples of the unsubstituted alkyl group having from 6 to 24 carbon atoms are n-hexyl, n-heptyl, n-octyl, tert-octyl, 2-ethylhexyl, n-nonyl, 1,1,3-trimethylhexyl, n-decyl, n-dodecyl, cetyl, hexadecyl, 2-hexyldecyl, octadecyl, eicosyl, 2-octyldodecyl, docosyl, tetracosyl, 2-decyltetradecyl, tricosyl and cyclohexyl, cycloheptyl groups. Preferred examples of the substituted alkyl group having from 6 to 24 carbon atoms in total are 2-hexenyl, oleyl, linoleyl, linolenyl, benzyl, β-phenethyl, 2-methoxyethyl, 4-phenylbutyl, 4-acetoxyethyl, 6-phenoxyhexyl, 12-phenyldodecyl, 18-phenyloctadecyl, 12-(p-chlorophenyl)dodecyl and 2-(diphenyl phosphate)ethyl group.

The alkyl group except Rf that is independently represented by R¹ and R² is more preferably a substituted or unsubstituted alkyl group having from 6 to 18 carbon atoms. Preferred examples of the unsubstituted alkyl group having from 6 to 18 carbon atoms are n-hexyl, cyclohexyl, n-heptyl, n-octyl, 2-ethylhexyl, n-nonyl, 1,1,3-trimethylhexyl, n-decyl, n-dodecyl, cetyl, hexadecyl, 2-hexyldecyl, octadecyl and 4-tert-butylcyclohexyl groups. Preferred examples of the substituted alkyl group having from 6 to 18 carbon atoms in total are phenethyl, 6-phenoxyhexyl, 12-phenyldodecyl, oleyl, linoleyl and linolenyl groups.

Especially preferably, the alkyl group except Rf that is independently represented by R¹ and R² is any of n-hexyl, cyclohexyl, n-heptyl, n-octyl, 2-ethylhexyl, n-nonyl, 1,1,3-trimethylhexyl, n-decyl, n-dodecyl, cetyl, hexadecyl, 2-hexyldecyl, octadecyl, oleyl, linoleyl and linolenyl groups. Most preferably, it is a linear, cyclic or branched unsubstituted alkyl group having from 8 to 16 carbon atoms.

In formula (1), R³, R⁴ and R⁵ each independently represent a hydrogen atom or a substituent. The substituent includes, for example, an alkyl group (preferably having from 1 to 20, more preferably from 1 to 12, even more preferably from 1 to 8 carbon atoms, e.g., methyl, ethyl, isopropyl, tert-butyl, n-octyl, n-decyl, n-hexadecyl, cyclopropyl, cyclopentyl, cyclohexyl), an alkenyl group (preferably having from 2 to 20, more preferably from 2 to 12, even more preferably from 2 to 8 carbon atoms, e.g., vinyl, allyl, 2-butenyl, 3-pentenyl), an alkynyl group (preferably having from 2 to 20, more preferably from 2 to 12, even more preferably from 2 to 8 carbon atoms, e.g., propargyl, 3-pentynyl), an aryl group (preferably having from 6 to 30, more preferably from 6 to 20, even more preferably from 6 to 12 carbon atoms, e.g., phenyl, p-methylphenyl, naphthyl), a substituted or unsubstituted amino group (preferably having from 0 to 20, more preferably from 0 to 10, even more preferably from 0 to 6 carbon atoms, e.g., unsubstituted amino, methylamino, dimethylamino, diethylamino, dibenzylamino), an alkoxy group (preferably having from 1 to 20, more preferably from 1 to 12, even more preferably from 1 to 8 carbon atoms, e.g., methoxy, ethoxy, butoxy), an aryloxy group (preferably having from 6 to 20, more preferably from 6 to 16, even more preferably from 6 to 12 carbon atoms, e.g., phenyloxy, 2-naphthyloxy), an acyl group (preferably having from 1 to 20, more preferably from 1 to 16, even more preferably from 1 to 12 carbon atoms, e.g., acetyl, benzoyl, formyl, pivaloyl), an alkoxycarbonyl group (preferably having from 2 to 20, more preferably from 2 to 16, even more preferably from 2 to 12 carbon atoms, e.g., methoxycarbonyl, ethoxycarbonyl), an aryloxycarbonyl group (preferably having from 7 to 20, more preferably from 7 to 16, even more preferably from 7 to 10 carbon atoms, e.g., phenyloxycarbonyl), an acyloxy group (preferably having from 2 to 20, more preferably from 2 to 16, even more preferably from 2 to 10 carbon atoms, e.g., acetoxy, benzoyloxy), an acylamino group (preferably having from 2 to 20, more preferably from 2 to 16, even more preferably from 2 to 10 carbon atoms, e.g., acetylamino, benzoylamino), an alkoxycarbonylamino group (preferably having from 2 to 20, more preferably from 2 to 16, even more preferably from 2 to 12 carbon atoms, e.g., methoxycarbonylamino), an aryloxycarbonylamino group (preferably having from 7 to 20, more preferably from 7 to 16, even more preferably from 7 to 12 carbon atoms, e.g., phenyloxycarbonylamino), a sulfonylamino group (preferably having from 1 to 20, more preferably from 1 to 16, even more preferably from 1 to 12 carbon atoms, e.g., methanesulfonylamino, benzenesulfonylamino), a sulfamoyl group (preferably having from 0 to 20, more preferably from 0 to 16, even more preferably from 0 to 12 carbon atoms, e.g., sulfamoyl, methylsulfamoyl, dimethylsulfamoyl, phenylsulfamoyl), a carbamoyl group (preferably having from 1 to 20, more preferably from 1 to 16, even more preferably from 1 to 12 carbon atoms, e.g., unsubstituted carbamoyl, methylcarbamoyl, diethylcarbamoyl, phenylcarbamoyl), an alkylthio group (preferably having from 1 to 20, more preferably from 1 to 16, even more preferably from 1 to 12 carbon atoms, e.g., methylthio, ethylthio), an arylthio group (preferably having from 6 to 20, more preferably from 6 to 16, even more preferably from 6 to 12 carbon atoms, e.g., phenylthio), a sulfonyl group (preferably having from 1 to 20, more preferably from 1 to 16, even more preferably from 1 to 12 carbon atoms, e.g., mesyl, tosyl), a sulfinyl group (preferably having from 1 to 20, more preferably from 1 to 16, even more preferably from 1 to 12 carbon atoms, e.g., methanesulfinyl, benzenesulfinyl), an ureido group (preferably having from 1 to 20, more preferably from 1 to 16, even more preferably from 1 to 12 carbon atoms, e.g., unsubstituted ureido, methylureido, phenylureido), a phosphoramido group (preferably having from 1 to 20, more preferably from 1 to 16, even more preferably from 1 to 12 carbon atoms, e.g., diethylphosphoramido, phenylphosphoramido), a hydroxyl group, a mercapto group, a halogen atom (e.g., fluorine, chlorine, bromine, iodine), a cyano group, a sulfo group, a carboxyl group, a nitro group, a hydroxamic acid group, a sulfino group, a hydrazino group, an imino group, a heterocyclic group (preferably having from 1 to 30, more preferably from 1 to 12, for example, a heterocyclic group having hetero atom(s) of nitrogen, oxygen and/or sulfur atoms, e.g., imidazolyl, pyridyl, quinolyl, furyl, piperidyl, morpholino, benzoxazolyl, benzimidazolyl, benzothiazolyl), a silyl group (preferably having from 3 to 40, more preferably from 3 to 30, even more preferably from 3 to 24 carbon atoms, e.g., trimethylsilyl, triphenylsilyl). These substituents may be further substituted. When the compound has two or more substituents, they may be the same or different. If possible, they may bond to each other to form a ring.

Preferably, R³, R⁴ and R⁵ each are an alkyl group or a hydrogen atom, more preferably all hydrogen atoms.

In the formula, X¹ and X² each independently represent a divalent linking group or a single bond. The divalent linking group is not specifically defined, but is preferably an arylene group, —O—, —S—, or —NR³¹— (where R³¹ represent a hydrogen atom or a substituent, and the substituent may be the same as that represented by R³, R⁴ and R⁵; R³¹ is preferably an alkyl group, Rf mentioned above, or a hydrogen atom, more preferably a hydrogen atom) alone or is a combination of any of them. More preferably, it is —O—, —S— or —NR³¹—. X¹ and X² are more preferably —O— or —NR³¹—, even more preferably —O— or —NH—, still more preferably —O—.

In the formula, Z represents a divalent linking group or a single bond. The divalent linking group is not specifically defined, but is preferably an alkylene group, an arylene group, —C(═O)—, —O—, —S—, —S(═O)—, —S(═O)₂— or —NR³²— (where R³² represent a hydrogen atom or a substituent, and the substituent may be the same as that represented by R³, R⁴ and R⁵; R³² is preferably an alkyl group or a hydrogen atom, more preferably a hydrogen atom) alone or is a combination of any of them. More preferably, it is an alkylene group having from 1 to 12 carbon atoms, an arylene group having from 6 to 12 carbon atoms, —C(═O)—, —O—, —S—, —S(═O)—, —S(═O)₂— or —NR³²— alone or is a combination of any of them. Even more preferably, Z is an alkylene group having from 1 to 8 carbon atoms, —C(═O)—, —O—, —S—, —S(═O)—, —S(═O)₂— or —NR³²— alone or is a combination of any of them. For example, it includes the following:

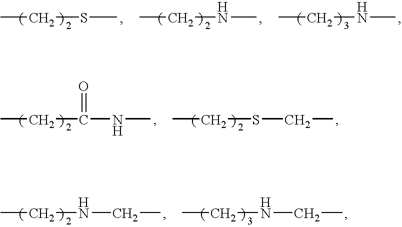

In the above-mentioned formula, M⁺ represents a cationic substituent, preferably an organic cationic substituent, more preferably an organic cationic substituent that contains a nitrogen or phosphorus atom. Even more preferably, it is a pyridinium cation or an ammonium cation. Still more preferably, it is a trialkylammonium cation of the following formula (2):

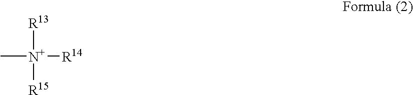

In the formula, R¹³, R¹⁴ and R¹⁵ each independently represent a substituted or unsubstituted alkyl group. The substituent may be the same as those mentioned hereinabove for the substituent of R³, R⁴ and R₅. If possible, R¹³, R¹⁴ and R¹⁵ may bond to each other to form a ring. Preferably, R¹³, R¹⁴ and R¹⁵ each are an alkyl group having from 1 to 12 carbon atoms, more preferably having from 1 to 6 carbon atoms, even more preferably a methyl group, an ethyl group or a methylcarboxyl group, still more preferably a methyl group.

In the formula, Y⁻ represents a counter anion, and it may be an inorganic anion or an organic anion. When the charge of the molecule is 0, Y⁻ may be absent. The inorganic anion is preferably an iodide ion, a bromide ion or a chloride ion. The organic anion is preferably a p-toluenesulfonate ion, a benzenesulfonate ion, a methanesulfonate ion, or a trifluoromethanesulfonate ion. Y⁻ is more preferably an iodide ion, a p-toluenesulfonate ion, or a benzenesulfonate ion, even more preferably a p-toluenesulfonate ion.

In the formula, m is 0 or 1, preferably 0.

Of the compounds of formula (1), more preferred are those of the following formula (1-a):

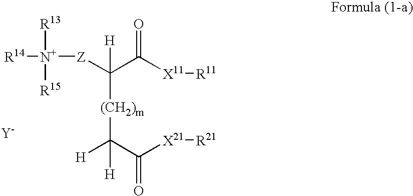

In the formula, R¹¹ and R²¹ each independently represent a substituted or unsubstituted alkyl group, but at least one of R¹¹ and R²¹ is the above-mentioned Rf, and the total of the carbon atoms that constitute the group of R¹¹ and R²¹ is at most 19. R¹³, R¹⁴ and R¹⁵ each independently represent a substituted or unsubstituted alkyl group, and may bond to each other to form a ring. X¹¹ and X²¹ each independently represent —O—, —S— or —NR³¹—; R³¹ represents a hydrogen atom or a substituent; and Z represents a divalent linking group or a single bond. Y⁻ represents a counter anion, but it may be absent when the charge of the molecule is 0.

m is 0 or 1. In the formula, Z and Y⁻ each independently have the same meanings as in formula (1), and their preferred ranges are also the same as in formula (1). R¹³, R¹⁴, R¹⁵ and m have the same meanings as in formula (1), and their preferred ranges are also the same as in formula (1).

In the formula, X¹¹ and X²¹ each independently represent —O—, —S— or —NR³¹— where R³¹ represents a hydrogen atom or a substituent. The substituent may be the same as that mentioned hereinabove for R³, R⁴ and R⁵. R³¹ is preferably an alkyl group, the above-mentioned Rf, or a hydrogen atom, more preferably a hydrogen atom. More preferably, X¹¹ and X²¹ each are —O— or —NH—, even more preferably —O—.

R¹¹ and R²¹ each independently have the same meanings as those of R¹ and R² in formula (1), and their preferred ranges are also the same as those for R¹ and R². However, the total of the carbon atoms that constitute the group of R¹¹ and R²¹ is at most 19. m is 0 or 1.

Specific examples of the compounds of formula (1) are mentioned below, to which, however, the invention should not be limited. Unless otherwise specifically indicated, the alkyl group and the perfluoroalkyl group in the structures of the following compounds are linear. The abbreviation 2EH mentioned below represents 2-ethylhexyl.

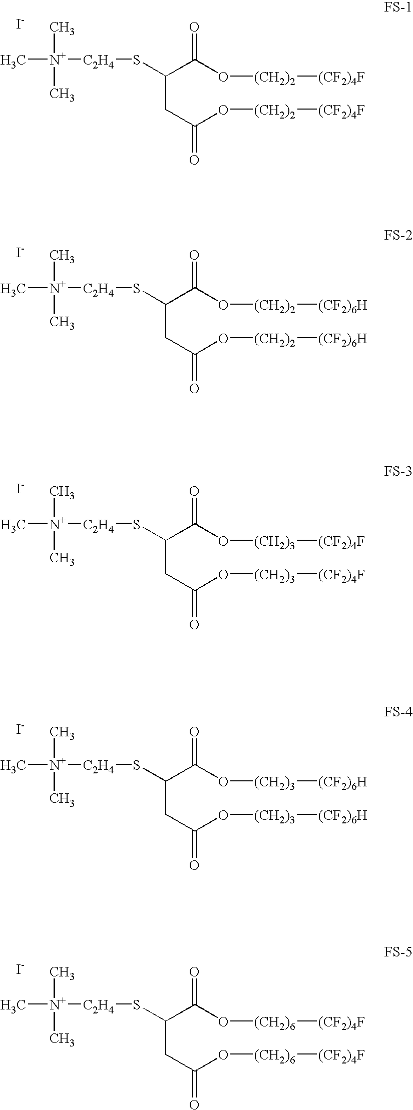

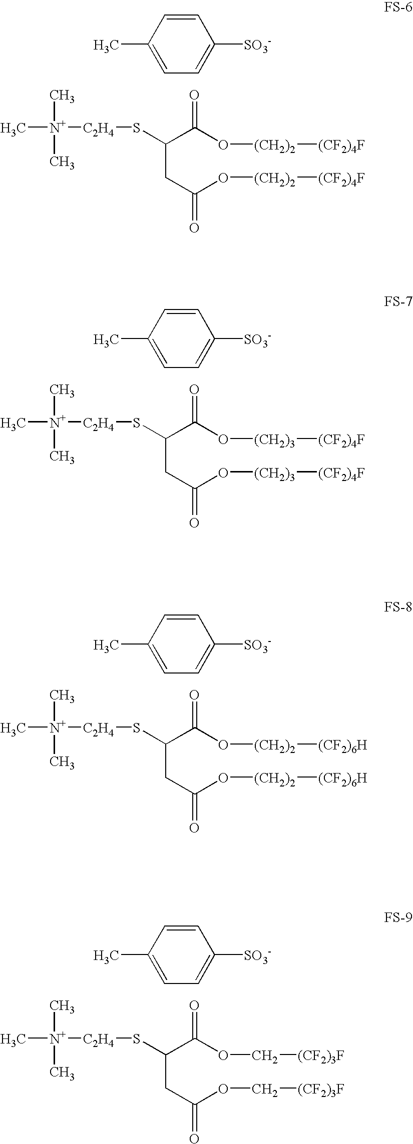

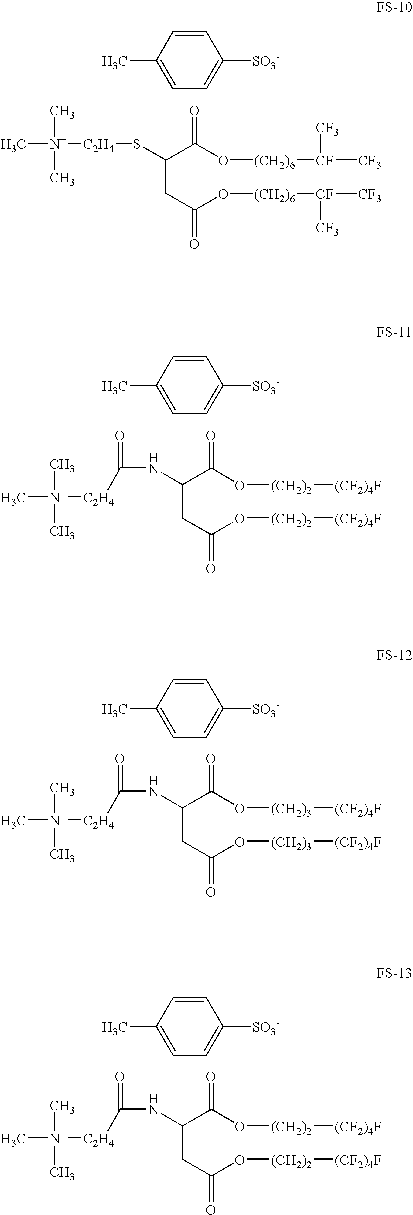

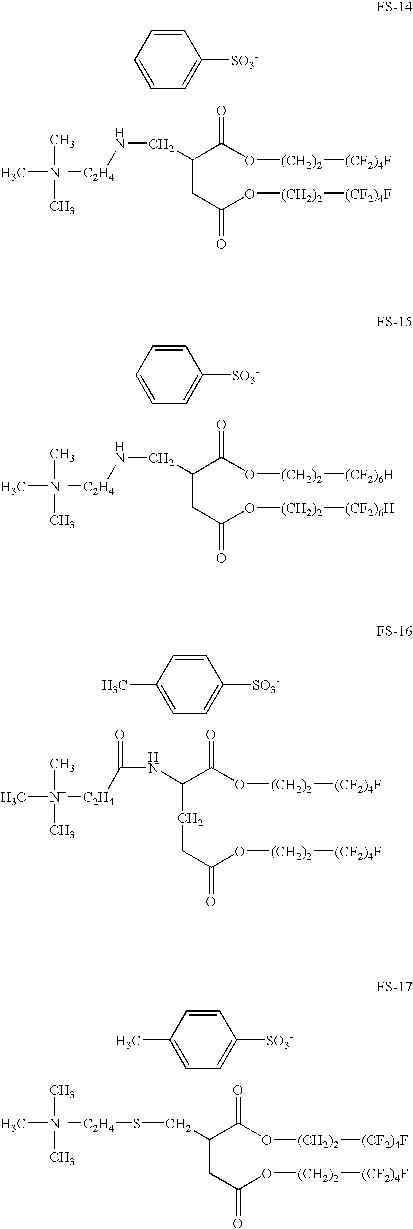

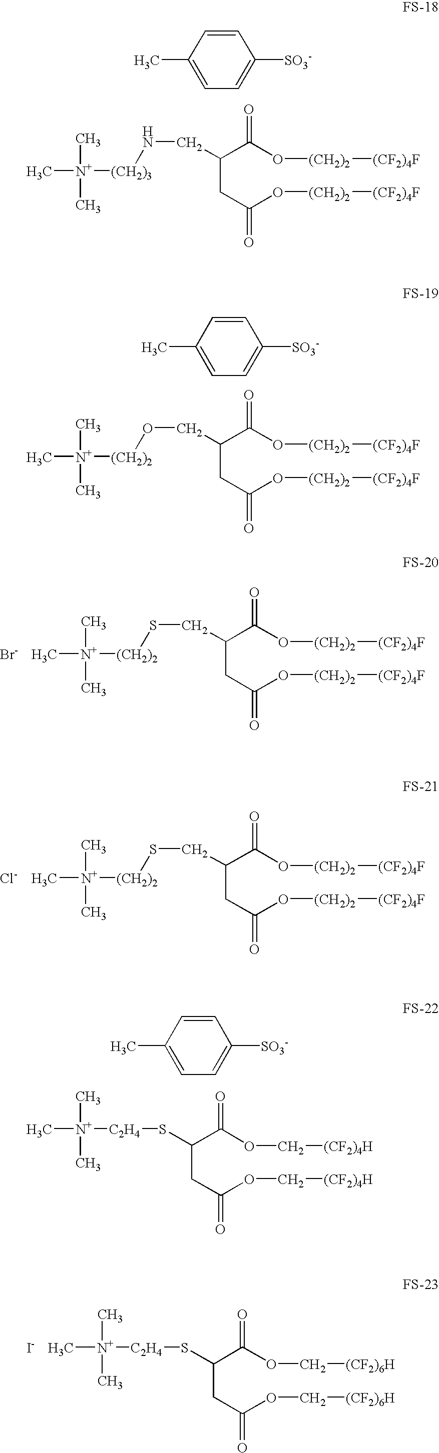

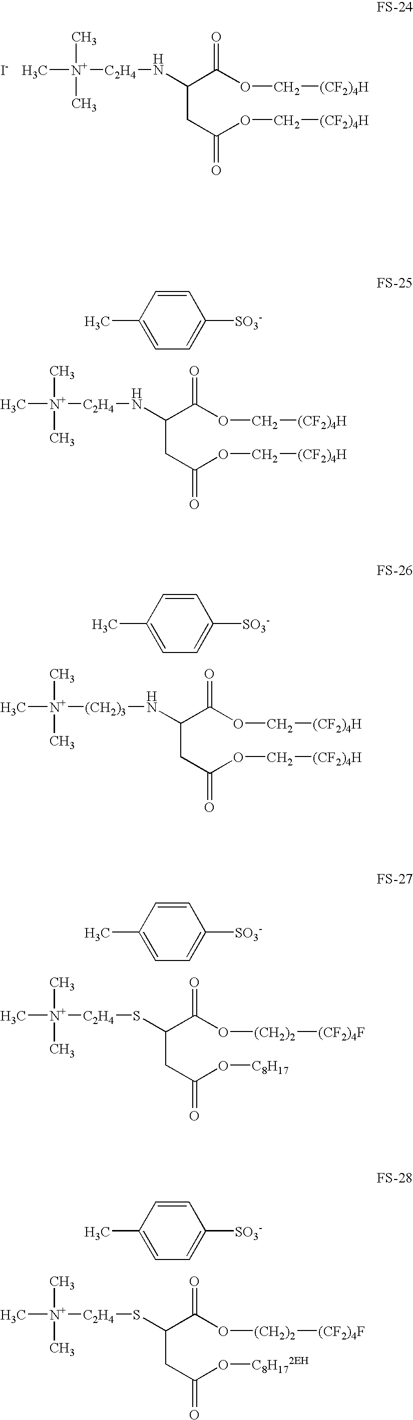

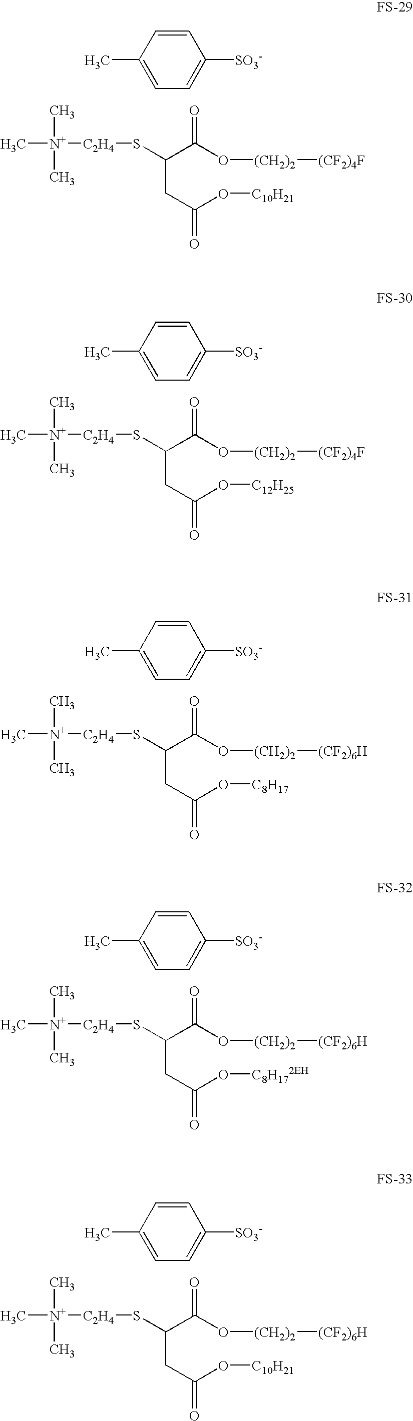

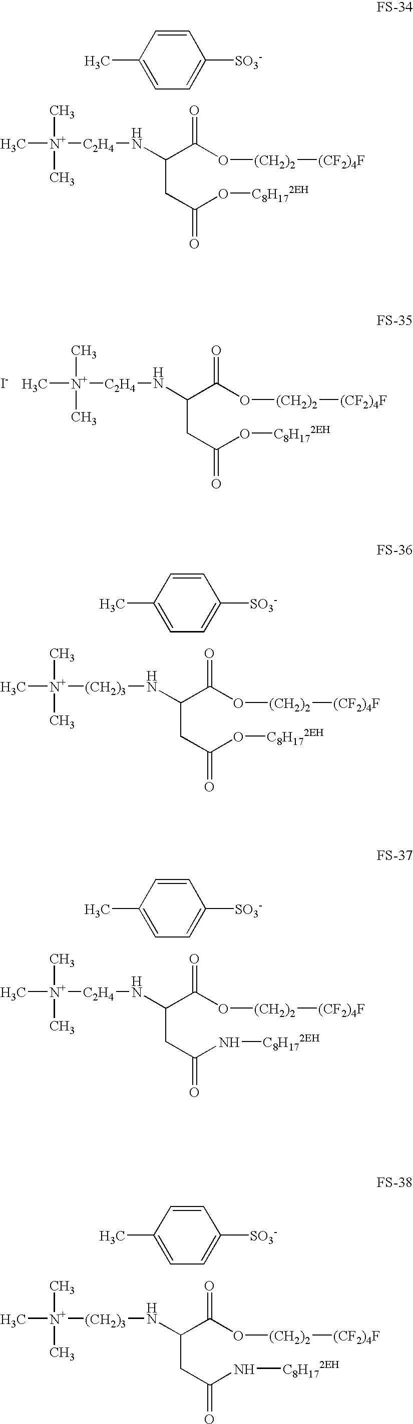

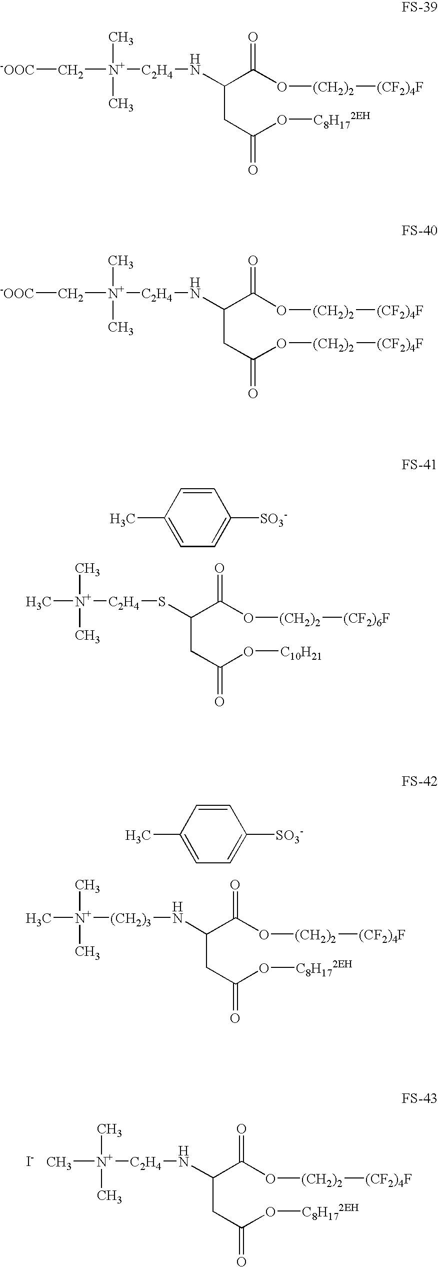

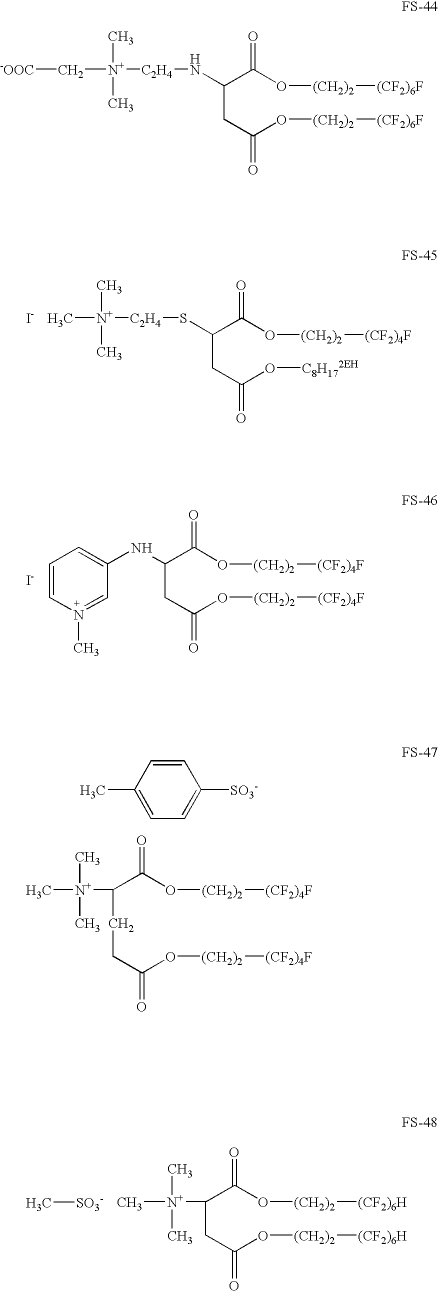

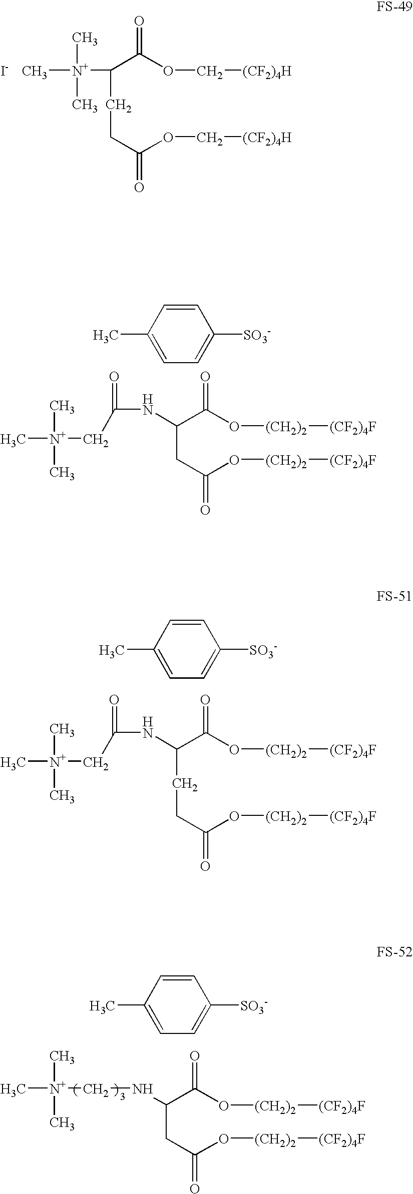

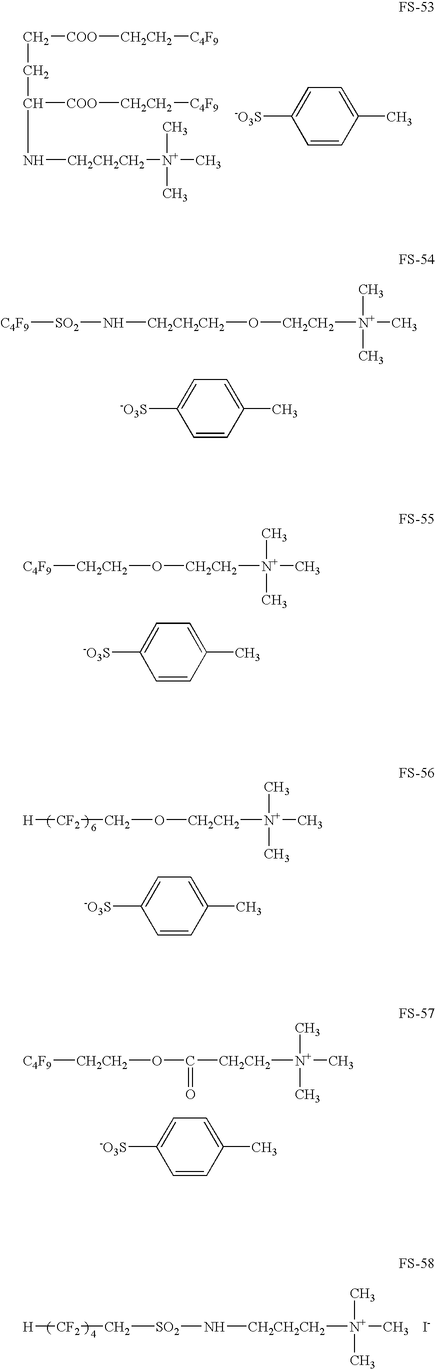

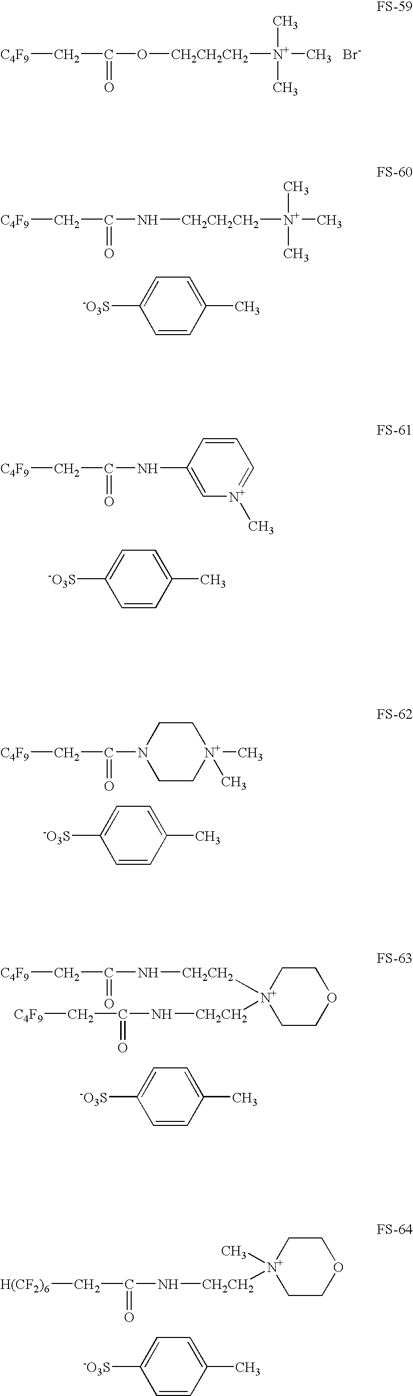

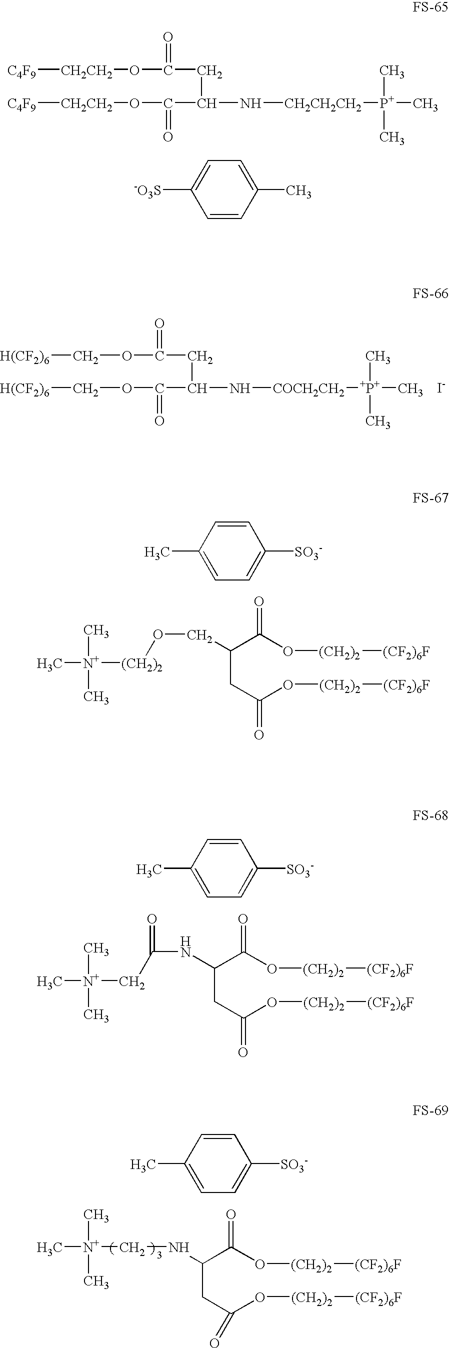

One example of production of the compounds of formulae (1) and (1-a) for use in the invention is described below, to which, however, the invention should not be limited.

The compounds for use in the invention may be produced from starting material of fumaric acid derivatives, maleic acid derivatives, itaconic acid derivatives, glutamic acid derivatives or aspartic acid derivatives. For example, when fumaric acid derivatives, maleic acid derivatives or itaconic acid derivatives are used as the starting material for them, the double bond in the derivative is exposed to Michel addition reaction with a nucleophilic compound and then cationated with an alkylating agent to give the intended compounds.

The fluorine-containing compounds may have an anionic hydrophilic group.

The anionic hydrophilic group is an acid group having pKa of at most 7, as well as its alkali metal salt or ammonium salt. Concretely, it includes a sulfo group, a carboxyl group, a phosphonic acid group, a carbamoylsulfamoyl group, a sulfamoylsulfamoyl group, an acylsulfamoyl group and their salts. Of those, preferred are a sulfo group, a carboxyl group, a phosphonic acid group and their salts; and more preferred are a sulfo group and their salts. The cation to form the salts includes lithium, sodium, potassium, cesium, ammonium, tetramethylammonium, tetrabutylammonium, methylpyridinium, preferably lithium, sodium, potassium and ammonium.

Preferred examples of the fluorine-containing compound having an anionic hydrophilic group for use in the invention are represented by the following formula (3):

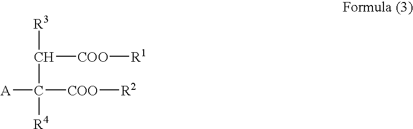

In the formula, R¹ and R² each independently represent an alkyl group, but at least one of them is Rf. When R¹ and R² are an alkyl group that is not a fluoroalkyl group, then the alkyl group preferably has from 2 to 18 carbon atoms, more preferably from 4 to 12 carbon atoms. R³ and R⁴ each independently represent a hydrogen atom, or a substituted or unsubstituted alkyl group.

Specific examples of the fluoroalkyl group for R¹ and R² may be the same as those mentioned hereinabove, and their preferred structures are also those of the above-mentioned formula (A). More preferred examples of their structures are also the same as those mentioned hereinabove for the above-mentioned fluoroalkyl group. Preferably, the alkyl groups of R¹ and R² are both the above-mentioned fluoroalkyl groups.

The substituted or unsubstituted alkyl group for R³ and R⁴ may be linear or branched, or may have a cyclic structure. The substituent is not specifically defined, but is preferably an alkenyl group, an aryl group, an alkoxy group, a halogen atom (preferably C1), a carboxylate group, a carbonamido group, a carbamoyl group, an oxycarbonyl group or a phosphate group.

A represents —L_{b}—SO₃M, and M represents a cation. Preferred examples of the cation for M are an alkali metal ion (e.g., lithium, sodium, potassium), an alkaline earth metal ion (e.g., barium, calcium), and an ammonium ion. Of those, more preferred are lithium, sodium, potassium and ammonium ions; and even more preferred are lithium, sodium and potassium ions. The ion may be suitably selected, depending on the total number of the carbon atoms constituting the compound of formula (3), the substituents of the compound, and the degree of branching of the alkyl group in the compound. When the total of the carbon atoms of R¹, R², R³ and R⁴ is 16 or more and when M is a lithium ion, then the compounds are good in point of the balance of the solubility (especially in water), the antistatic property and the uniform coatability thereof.

L_{b} represents a single bond, or a substituted or unsubstituted alkylene group. The substituent is preferably that mentioned hereinabove for R³. When L_{b} is an alkylene group, the number of its carbon atoms is preferably at most 2. Preferably, L_{b} is a single bond or —CH₂—, most preferably —CH₂—.

In formula (3), it is more desirable that the preferred embodiments mentioned above are combined.

Specific examples of the anionic hydrophilic group-having fluorine-containing compounds for use in the invention are mentioned below, to which, however, the invention should not be limited.

Unless otherwise specifically indicated, the alkyl group and the perfluoroalkyl group in the following structures are linear.

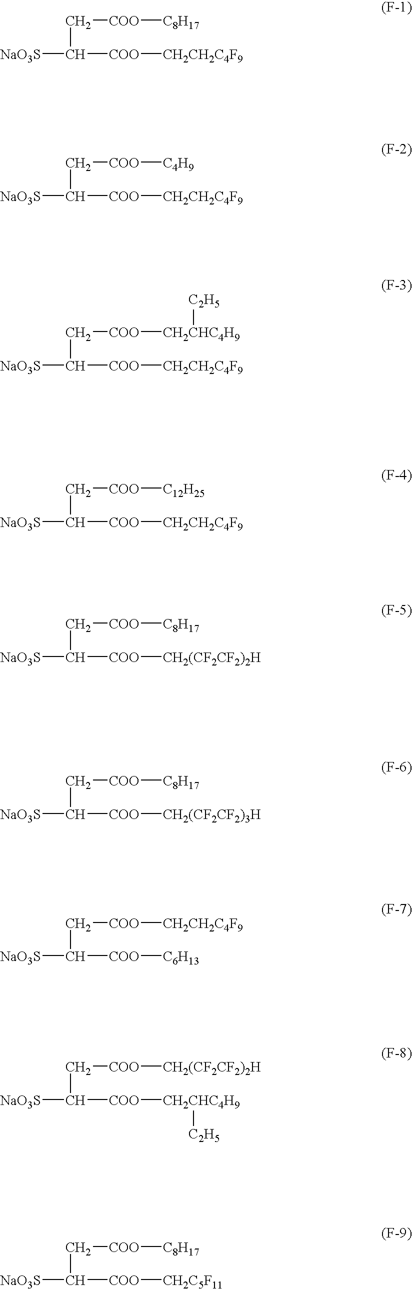

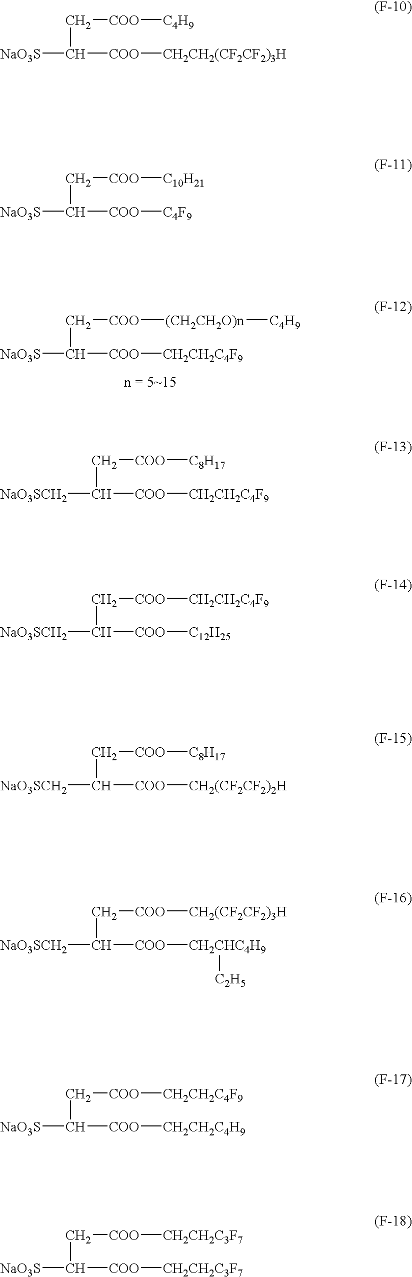

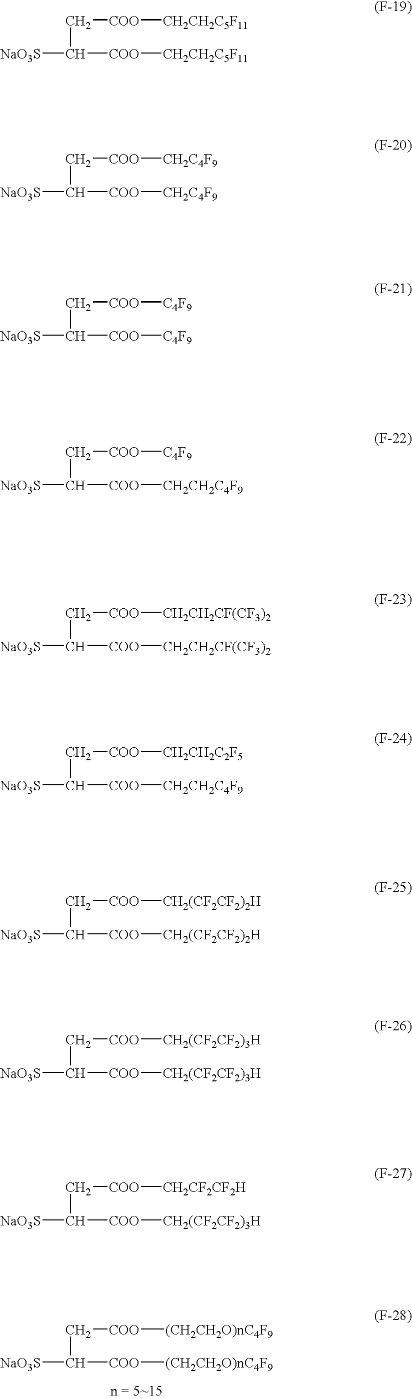

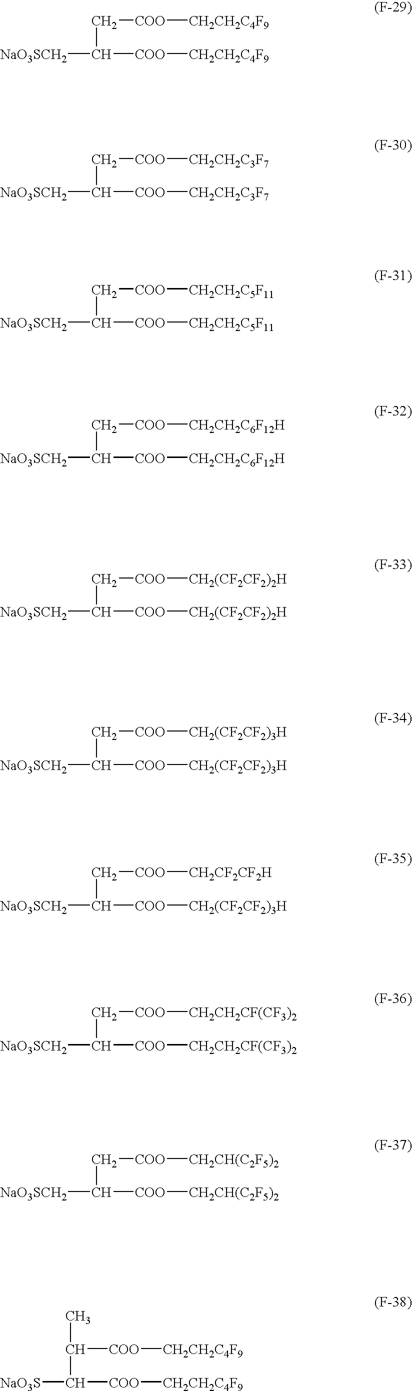

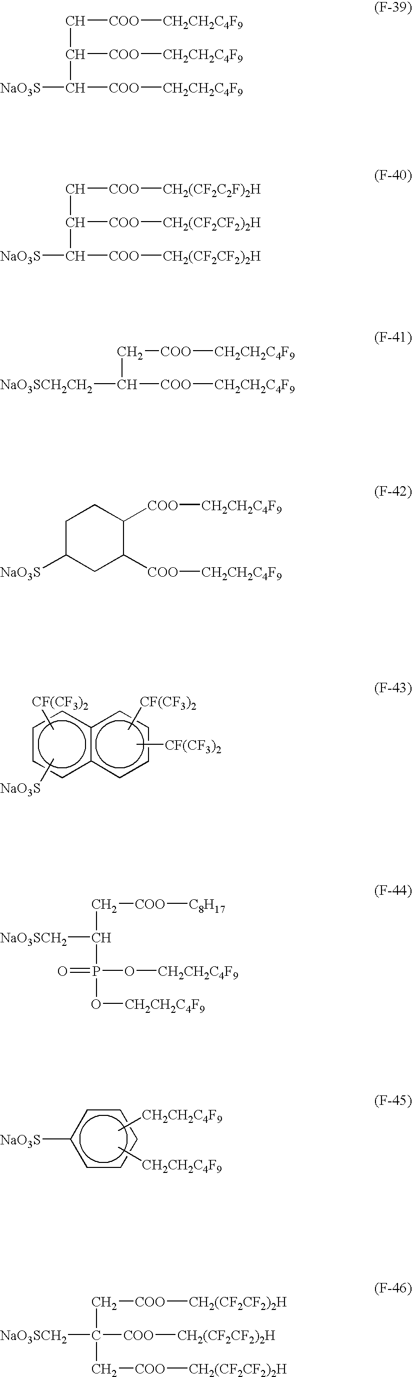

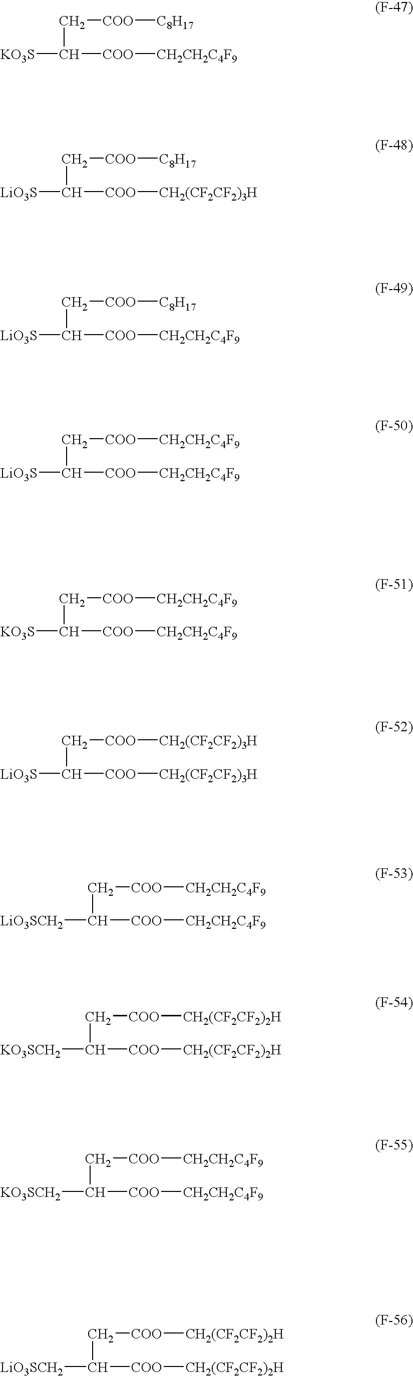

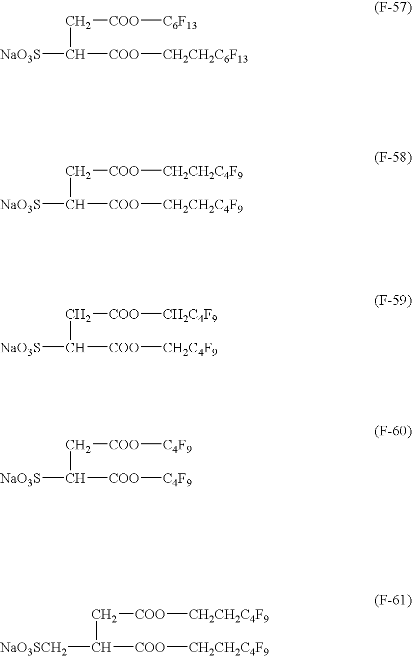

The fluorine-containing compounds may have a nonionic hydrophilic group.

The nonionic hydrophilic group is a group that dissolves in water not dissociating into an ion. Concretely, it includes poly(oxyethylene) alkyl ethers and polyalcohols, to which, however, the invention should not be limited.

Preferred examples of the non-ionic fluorine-containing compounds for use in the invention are represented by the following formula (4):

Rf—X—((CH₂)ₙ—O)ₘ—R Formula (4)

In formula (4), Rf is the above-mentioned fluoroalkyl group. Specific examples of Rf are mentioned above, and their preferred structures are also those of the above-mentioned formula (A). More preferred examples of their structures are also the same as those mentioned hereinabove for Rf.

In formula (4), X represents a divalent linking group. Not specifically defined, its examples are as follows:

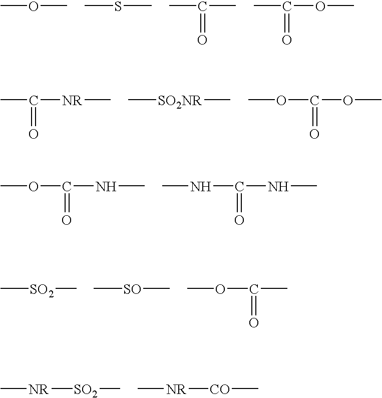

In formula (4), n is 2 or 3, and m is an integer of from 1 to 30. R represents a hydrogen atom, an alkyl group, an aryl group, a heterocyclic group, Rf, or a group having at least one Rf as its substituent.

Specific examples of the nonionic fluorine-containing compounds for use in the invention are mentioned below, to which, however, the invention should not be limited.

FN-1 C₄F₉CH₂CH₂O—(CH₂CH₂O)ₙ—H n=5˜15

FN-2 H(CF₂)₆CH₂O—(CH₂CH₂O)ₙ—H n=5˜15

FN-3 C₄F₉CH₂COO—(CH₂CH₂O)ₙ—H n=5˜15

FN-4 C₄F₉CH₂CONH—(CH₂CH₂O)ₙ—H n=5˜15

FN-5 C₄F₉CH₂SO₂NH—(CH₂CH₂O)ₙ—H n=5˜15

FN-6 C₄F₉CH₂CH₂NHCOO—(CH₂CH₂O)ₙ—H n=5˜15

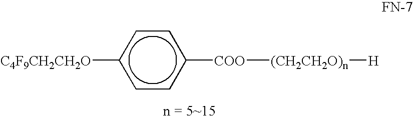

FN-8 H(CF₂)₄CH₂O—(CH₂CH₂CH₂O)ₙ—H n=5˜15

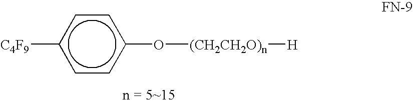

FN-10

C₄F₉CH₂CH₂O—(CH₂CH₂O)ₙ₁—(CH₂CH₂CH₂O)ₙ₂—(CH₂CH₂O)ₙ₃—H

n1=5˜10

n2=5˜10

n3=5˜10

FN-11 C₄F₉CH₂CH₂O—(CH₂CH₂O)ₙ—CH₃ n=10˜20

FN-12 C₄F₉CH₂CH₂O—(CH₂CH₂O)ₙ—C₄H₉ n=10˜20

FN-13 C₄F₉CH₂CH₂O—(CH₂CH₂O)ₙ—CH₂CH₂C₄H₉ n=10˜20

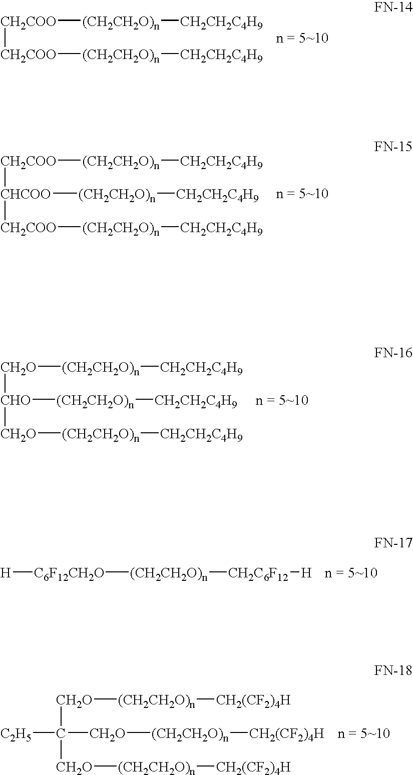

FN-19 C₆F₁₃CH₂CH₂O—(CH₂CH₂O)ₙ—H n=5˜15

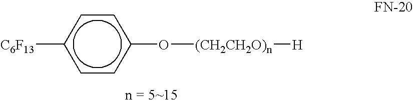

FN-21 C₆F₁₃CH₂CH₂O—(CH₂CH₂O)ₙ—CH₂CH₂C₆F₁₃ n=10˜20

Serving as a surfactant, the specific fluoroalkyl group-having compound is preferably in the coating compositions to form the layers that constitute the photothermographic material of the invention (especially the protective layer, the undercoat layer, backing layer or the like of the material). In particular, the compound is used in forming the outermost layer of the photothermographic material for attaining more effective static charging prevention and more uniform coatability. In addition, we the present inventors have found that the compounds having the specific structure as in the invention are more effective for improving the storage stability and the service environment dependency of the photothermographic material of the invention. To ensure the effect, it is desirable that the specific fluorine-containing compound of the invention is used in the outermost layer of the image-forming layer or the back layer. When the compound is used in an undercoat layer on a substrate, it realizes the same effect.

One or more such specific fluorine-containing compounds may be used in the invention either singly or as combined. If desired, the specific fluorine-containing compound may be combined with any other surfactant.

<Surface-Protective Layer>

Regarding the constitution of the surface-protective layer except the matter mentioned above, referred to are the descriptions of JP-A No. 11-65021, paragraphs [0119] to [0120], and JP-A No.2000-171936. The surface-protective layer may be single-layered or multi-layered.

<Back-surface Protective Layer>

Regarding the constitution of the back-surface protective layer except the matter mentioned above, referred to are the descriptions of Japanese Patent Application Nos. 2002-354622 and 2002-361317. The back-surface protective layer may be single-layered or multi-layered.

<Image-Forming Layer>

In the invention, the image-forming layer comprises one or more layers formed on a substrate. When the layer is a single layer, it contains an organic silver salt, a photosensitive silver halide, a reducing agent and a binder, and, if necessary, contains any additional components such as a color toning agent, a coating aid and other auxiliary agents. When the layer has a multi-layered structure, the first image-forming layer (in general, this is adjacent to the substrate) contains an organic silver salt and a photosensitive silver halide, and the second image-forming layer or the two layers must contain some other components. Regarding its constitution, the multi-color photothermographic material may have combinations of two layers for different colors, or may contain all the necessary ingredients in a single layer, for example, as in U.S. Pat. No. 4,708,928. When the photothermographic material of the invention is a multi-color photothermographic material with different dyes therein, the individual photosensitive emulsion layers are differentiated and spaced from the others via a functional or non-functional barrier layer between the adjacent emulsion layers, for example, as in U.S. Pat. No. 4,460,681.

The essential compositions for the image-forming layer are described in detail hereinunder.

### Description of Organic Silver Salt

1) Composition:

The organic silver salt for use in the invention is relatively stable to light, but, when heated at 80° C. or higher in the presence of an exposed photosensitive silver halide and a reducing agent, it serves as a silver ion donor and forms a silver image. The organic silver salt may be any and every organic substance capable of donating a silver ion that may be reduced by a reducing agent. Some non-photosensitive organic silver salts of that type are described, for example, in JP-A No. 10-62899, paragraphs [0048] to [0049]; EP-A No. 0803764A1, from page 18 line 24 to page 19, line 37; EP-A No. 0962812A1; JP-A Nos. 11-349591, 2000-7683 and 2000-72711. Preferred for use herein are silver salts of organic acids, especially silver salts of long-chain (C10 to C30, preferably C15 to C28) aliphatic carboxylic acids. Preferred examples of silver salts of fatty acids are silver lignocerate, silver behenate, silver arachidate, silver stearate, silver oleate, silver laurate, silver caproate, silver myristate, silver palmitate, silver erucate, and their mixtures. Of the silver salts of fatty acids, especially preferred are those having a silver behenate content of from 50 mol % to 100 mol %, more preferably from 85 mol % to 100 mol %, even more preferably from 95 mol % to 100 mol % in the invention. Also preferred are silver salts of fatty acids having a silver erucate content of at most 2 mol %, more preferably at most 1 mol %, even more preferably at most 0.1 mol %.

Also preferably, the silver stearate content of the organic silver salts is at most 1 mol %. Organic silver salts of the type having a silver stearate content of at most 1 mol % enable the photothermographic material of the invention to have low Dmin, high sensitivity and good image storability. The silver stearate content is more preferably at most 0.5 mol %, even more preferably substantially zero.

In case where the organic silver salt contains silver arachidate, it is desirable that the silver arachidate content thereof is at most 6 mol %, more preferably at most 3 mol % in order that the photothermographic material may have lower Dmin and better image storability.

2) Morphology:

The organic silver salt for use in the invention is not specifically defined for its morphology, and may be in any form of acicular, rod-like, tabular or scaly grains.

Scaly organic silver salts are preferred for use in the invention. Also preferred are short acicular, rectangular-parallelepiped or cubic grains having an aspect ratio, major axis/minor axis of smaller than 5, and irregular grains such as potato-like grains. These organic silver salt grains are characterized in that they are more effective for preventing fog in thermal development of photothermographic materials than long acicular grains having an aspect ratio, major axis/minor axis of 5 or more. In particular, the grains having an aspect ratio, major axis/minor axis of at most 3 are preferred since the mechanical stability of the coated films is good. The flaky organic silver salt in the specification is defined as follows: A sample of an organic silver salt to be analyzed is observed with an electronic microscope, and the grains of the salt seen in the field are approximated to rectangular parallelopipedons. The three different edges of the thus-approximated, one rectangular parallelopipedone are represented by a, b and c. a is the shortest, c is the longest, and c and b may be the same. From the shorter edges a and b, x is obtained according to the following equation:

x=b/a.

About 200 grains seen in the field are analyzed to obtain the value x, and the data of x are averaged. Samples that satisfy the requirement of x (average) ≧1.5 are scaly. For scaly grains, preferably, 30≧x (average) ≧1.5, more preferably 15≧x (average) ≧1.5. In this connection, the value x of acicular grains falls within a range of 1≦x (average) <1.5.

In the scaly grains, it is understood that a corresponds to the thickness of tabular grains of which the main plane is represented by b×c. In the scaly organic silver salt grains for use herein, a (average) preferably falls between 0.01 μm and 0.3 μm, more preferably between 0.1 μm and 0.23 μm; and c/b (average) preferably falls between 1 and 9, more preferably between 1 and 6, even more preferably between 1 and 4, most preferably between 1 and 3.

When the sphere-corresponding diameter of the organic silver salt grains for use in the invention is from 0.05 μm to 1 μm, then the grains hardly aggregate in the photothermographic material and the image storability of the material is therefore good. The sphere-corresponding diameter is more preferably from 0.1 μm to 1 μm. In the invention, the sphere-corresponding diameter of the grains may be determined as follows: Using an electronic microscope, a sample of an organic silver salt to be analyzed is directly photographed, and the resulting negative picture is processed and analyzed.

A ratio of sphere-corresponding diameter/a of the flaky grains is defined as an aspect ratio. The aspect ratio of the flaky grains preferably falls between 1.1 and 30, more preferably between 1.1 and 15, since the grains of the type hardly aggregate in the photothermographic material and the image storability of the material is therefore good.

Regarding its grain size distribution, the organic silver salt is preferably a mono-dispersed one. Mono-dispersion of grains referred to herein is such that the value (in terms of percentage) obtained by dividing the standard deviation of the minor axis and the major axis of each grain by the minor axis and the major axis thereof, respectively, is preferably at most 100%, more preferably at most 80%, even more preferably at most 50%. To determine its morphology, a dispersion of the organic silver salt may be analyzed on its image taken by the use of a transmission electronic microscope. Another method for analyzing the organic silver salt for mono-dispersion morphology comprises determining the standard deviation of the volume weighted mean diameter of the salt grains. In the method, the value in terms of percentage (coefficient of variation) obtained by dividing the standard deviation by the volume weighted mean diameter of the salt grains is preferably at most 100%, more preferably at most 80%, even more preferably at most 50%. Concretely, for example, a sample of the organic silver salt is dispersed in a liquid, the resulting dispersion is exposed to a laser ray, and the self-correlation coefficient of the salt grains relative to the time-dependent change of the degree of fluctuation of the scattered ray is obtained. Based on this, the grain size (volume weighted mean diameter) of the salt grains is obtained.

3) Preparation:

For preparing and dispersing the organic silver salts for use in the invention, employable is any known method. For it, for example, referred to are JP-A No. 10-62899; EP-A Nos. 0803763A1 and 0962812A1; JP-A Nos. 11-349591, 2000-7683, 2000-72711, 2001-163889, 2001-163890, 2001-163827, 2001-33907, 2001-188313, 2001-83652, 2002-6442, 2002-49117, 2002-31870, and 2002-107868.

It is desirable that the organic silver salt is dispersed substantially in the absence of a photosensitive silver salt, since the photosensitive silver salt, if any in the dispersing system, will be fogged and its sensitivity will be significantly lowered. For the photothermographic material of the invention, the amount of the photosensitive silver salt that may be in the aqueous dispersion of the organic silver salt is preferably at most 1 mol %, more preferably at most 0.1 mol % based on one mol of the organic silver salt therein, and even more preferably, any photosensitive silver salt is not positively added to the aqueous dispersion.

An aqueous, organic silver salt dispersion may be mixed with an aqueous, photosensitive silver salt dispersion to prepare a coating liquid for the photothermographic material of the invention. The blend ratio of the organic silver salt to the photosensitive silver salt in the mixture may be suitably determined depending on the object of the invention. Preferably, the blend ratio of the photosensitive silver salt to the organic silver salt in the mixture falls between 1 and 30 mol %, more preferably between 2 and 20 mol %, even more preferably between 3 and 15 mol %. Mixing two or more different types of aqueous, organic silver salt dispersions with two or more different types of aqueous, photosensitive silver salt dispersions is preferred for controlling the photographic properties of the resulting mixture.

4) Amount of Organic Silver Salt:

The amount of the organic silver salt to be in the photothermographic material of the invention is not specifically defined, and may be any desired one. Preferably, the total amount of all salts including silver halide that may be in the material falls between 0.1 and 5.0 g/m², more preferably between 0.3 and 3.0 g/m², even more preferably between 0.5 and 2.0 g/m², still more preferably between 1.1 and 1.9 g/m² in terms of the amount of silver in the salts. For better image storability of the photothermographic material, the total silver amount is preferably at most 1.8 g/m², more preferably at most 1.6 g/m². Using the preferred reducing agent in the invention makes it possible to obtain sufficient image density even though the silver amount in the material falls within such a low range.

### Description of Reducing Agent

The photothermographic material of the invention preferably contains a reducing agent that acts as a heat-developing agent for the organic silver salt therein. The reducing agent for the organic silver salt may be any and every substance capable of reducing silver ions into metal silver, but is preferably an organic substance. Some examples of the reducing agent are described in JP-A No. 11-65021, paragraphs [0043] to [0045] and in EP-A No. 0803764A1, from page 7, line 34 to page 18, line 12.

Preferred for the reducing agent for use in the invention are hindered phenols having an ortho-substituent relative to the phenolic hydroxyl group therein, or bisphenols; and more preferred are compounds of the following formula (R):

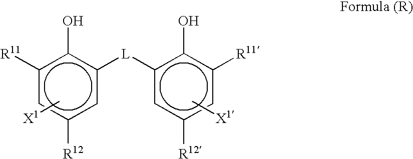

In formula (R), R¹¹ and R^{11′} each independently represent an alkyl group having from 1 to 20 carbon atoms; R¹² and R^{12′} each independently represent a hydrogen atom, or a substituent substitutable to the benzene ring; L represents a group of —S— or —CHR¹³—; R¹³ represents a hydrogen atom or an alkyl group having from 1 to 20 carbon atoms; X¹ and X^{1′} each independently represent a hydrogen atom, or a substituent substitutable to the benzene ring.

Compounds of formula (R) are described in detail.

1) R¹¹ and R^{11′}:

R¹¹ and R^{11′} each independently represent a substituted or unsubstituted alkyl group having from 1 to 20 carbon atoms. The substituent for the alkyl group is not specifically defined, but preferably includes, for example, an aryl group, a hydroxyl group, an alkoxy group, an aryloxy group, an alkylthio group, an arylthio group, an acylamino group, a sulfonamido group, a sulfonyl group, a phosphoryl group, an acyl group, a carbamoyl group, an ester group, an ureido group, an urethane group, and a halogen atom.

2) R¹² and R^{12′}, X¹ and X^{1′}:

R¹² and R^{12′} each independently represent a hydrogen atom, or a substituent substitutable to the benzene ring; and X¹ and X^{1′} each independently represent a hydrogen atom, or a substituent substitutable to the benzene ring. Preferred examples of the substituent substitutable to the benzene ring are an alkyl group, an aryl group, a halogen atom, an alkoxy group, and an acylamino group.

3) L:

L represents a group of —S— or —CHR¹³—. R¹³ represents a hydrogen atom or an alkyl group having from 1 to 20 carbon atoms. The alkyl group may be substituted. Examples of the unsubstituted alkyl group for R¹³ are methyl, ethyl, propyl, butyl, heptyl, undecyl, isopropyl, 1-ethylpentyl and 2,4,4-trimethylpentyl groups. Examples of the substituent for the alkyl group may be the same as those for R¹¹, including, for example, a halogen atom, an alkoxy group, an alkylthio group, an aryloxy group, an arylthio group, an acylamino group, a sulfonamido group, a sulfonyl group, a phosphoryl group, an oxycarbonyl group, a carbamoyl group, and a sulfamoyl group.

4) Preferred Substituents:

For R¹¹ and R^{11′}, preferred is a secondary or tertiary alkyl group having from 3 to 15 carbon atoms, including, for example, isopropyl, isobutyl, t-butyl, t-amyl, t-octyl, cyclohexyl, cyclopentyl, 1-methylcyclohexyl and 1-methylcyclopropyl groups. For R¹¹ and R^{11′}, more preferred is a tertiary alkyl group having from 4 to 12 carbon atoms; even more preferred are t-butyl, t-amyl and 1-methylcyclohexyl groups; and most preferred is a t-butyl group.

For R¹² and R^{12′}, preferred is an alkyl group having from 1 to 20 carbon atoms, including, for example, methyl, ethyl, propyl, butyl, isopropyl, t-butyl, t-amyl, cyclohexyl, 1-methylcyclohexyl, benzyl, methoxymethyl and methoxymethyl groups. More preferred are methyl, ethyl, propyl, isopropyl and t-butyl groups.

For X¹ and X^{1′}, preferred are a hydrogen atom, a halogen atom and an alkyl group; and more preferred is a hydrogen atom.

L is preferably —CHR¹³—.

R¹³ is preferably a hydrogen atom or an alkyl group having from 1 to 15 carbon atoms. For the alkyl group, preferred are methyl, ethyl, propyl, isopropyl and 2,4,4-trimethylpentyl groups. More preferably, R¹³ is a hydrogen atom, a methyl group, an ethyl group a propyl group or an isopropyl group.

In case where R¹³ is a hydrogen atom, R¹² and R^{12′} each are preferably an alkyl group having from 2 to 5 carbon atoms, more preferably an ethyl or propyl group, most preferably an ethyl group.

In case where R¹³ is a primary or secondary alkyl group having from 1 to 8 carbon atoms, R¹² and R^{12′} are preferably both methyl groups. For the primary or secondary alkyl group having from 1 to 8 carbon atoms for R¹³, preferred are methyl, ethyl, propyl and isopropyl groups; and more preferred are methyl, ethyl and propyl groups.

In case where R¹¹, R^{11′}, R¹² and R^{12′} are all methyl groups, R¹³ is preferably a secondary alkyl group. The secondary alkyl group for R¹³ is preferably an isopropyl, isobutyl or 1-ethylpentyl group, and more preferably an isopropyl group.

Depending on the combination of the groups R¹¹, R^{11′}, R¹², R^{12′} and R¹³ therein, the reducing agents exhibit different heat-developability and produce different silver tone. Combining two or more different types of the reducing agents makes it possible to control the heat-developability to produce a controlled silver tone. Therefore, combining two or more different types of the reducing agents in the photothermographic material is preferred, depending on the object of the material.

Specific examples of the compounds of formula (R) and other reducing agents for use in the invention are mentioned below, to which, however, the invention should not be limited.

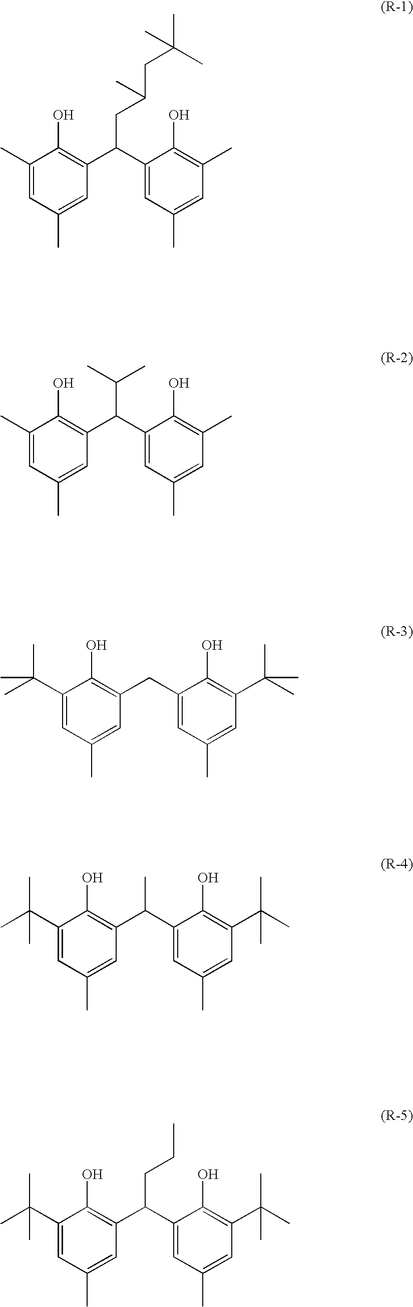

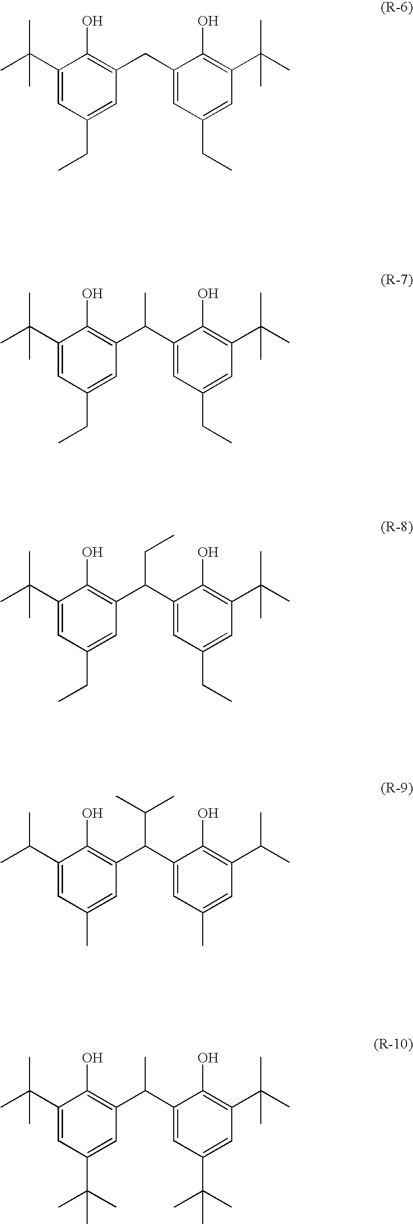

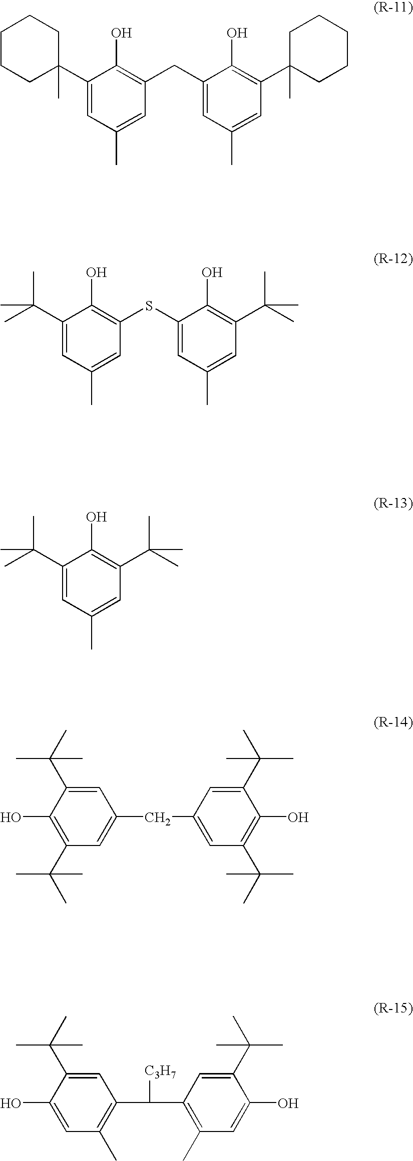

In addition to the above, compounds described in JP-A Nos. 2001-188314, 2001-209145, 2001-350235 and 2002-156727 are also preferred examples of the reducing agent for use in the invention.

In the photothermographic material of the invention, the amount of the reducing agent preferably falls between 0.1 and 3.0 g/m², more preferably between 0.2 and 1.5 g/m², even more preferably between 0.3 and 1.0 g/m². Also preferably, the amount of the reducing agent to be therein falls between 5 and 50 mol %, more preferably between 8 and 30 mol %, even more preferably between 10 and 20 mol %, per mol of silver existing in the face of the image-forming layer of the material. Still preferably, the reducing agent is present in the image-forming layer of the material.

The reducing agent may be in any form of solution, emulsifide dispersion or fine solid particle dispersion, and may be added to the coating liquid in any known method so as to be incorporated into the photothermographic material of the invention.

One well known method of emulsifying the reducing agent to prepare its dispersion comprises dissolving the reducing agent in an auxiliary solvent such dibutyl phthalate, tricresyl phosphate, glyceryl triacetate, diethyl phthalate or the like oily solvent, or in ethyl acetate or cyclohexanone, followed by mechanically emulsifying it into a dispersion.

For preparing a fine solid particle dispersion of the reducing agent, for example, employable is a method that comprises dispersing a powder of the reducing agent in water or in any other suitable solvent by the use of a ball mill, a colloid mill, a shaking ball mill, a sand mill, a jet mill or a roller mill, or ultrasonically dispersing it therein to thereby prepare the intended solid dispersion of the reducing agent. In this method, optionally used is a protective colloid (e.g., polyvinyl alcohol), and a surfactant (e.g., anionic surfactant such as sodium triisopropylnaphthalenesulfonate—this is a mixture of the salts in which the three isopropyl groups are all in different positions). In these mills, generally used are beads of zirconia or the like that serve as a dispersion medium. Zr or the like may dissolve out of the beads and will often contaminate the dispersion formed. Though varying depending on the dispersion condition, the contaminant content of the dispersion formed may generally fall between 1 ppm and 1000 ppm. So far as the Zr content of the photothermographic material finally fabricated herein is not larger than 0.5 mg per gram of silver in the material, the contaminant will cause no practical problem.

Preferably, the aqueous dispersion contains a preservative (e.g., sodium benzoisothiazolinone).

Especially preferred in the invention is preparing a solid particle dispersion of the reducing agent, in which the mean particle size of the reducing agent particles is preferably from 0.01 μm to 10 μm, more preferably from 0.05 μm to 5 μm, even more preferably from 0.1 μm to 2 μm. In the invention, it is desirable that the particle sizes of the other solid dispersions also fall within the range.

### Description of Development Promoter

Preferably, the photothermographic material of the invention contains a development promoter. Preferred examples of the development promoter are sulfonamidophenol compounds of formula (A) in JP-A Nos. 2000-267222 and 2000-330234; hindered phenol compounds of formula (II) in JP-A No. 2001-92075; compounds of formula (I) in JP-A Nos. 10-62895 and 11-15116; hydrazine compounds of formula (D) in JP-A No. 2002-156727 and formula (1) in JP-A No. 2002-278017; and phenol or naphthol compounds of formula (2) in JP-A No. 2001-264929. The amount of the development promoter to be in the material may fall between 0.1 and 20 mol %, but preferably between 0.5 and 10 mol %, more preferably between 1 and 5 mol % based on the reducing agent therein. The development promoter may be introduced into the material like the reducing agent thereinto. Preferably, however, it is added to the material in the form of its solid dispersion or emulsifide dispersion. In case where it is added to the material in the form of its emulsifide dispersion, the emulsifide dispersion thereof is preferably prepared by emulsifying and dispersing the development promoter in a mixed solvent of a high-boiling point solvent that is solid at room temperature and an auxiliary solvent having a low boiling point; or the emulsifide dispersion is preferably an oilless dispersion with no high-boiling-point solvent therein.

For the development promoter for use in the invention, especially preferred are hydrazine compounds of formula (D) in JP-A No. 2002-156727, and phenol or naphthol compounds of formula (2) in JP-A No. 2001-264929.

Preferred examples of the development promoter for use in the invention are compounds of the following formulae (A-1) and (A-2):

Q₁—NHNH—Q₂ Formula (A-1)

wherein Q₁ represents an aromatic or heterocyclic group bonding to —NHNH—Q₂ via its carbon atom; Q₂ represents a carbamoyl group, an acyl group, an alkoxycarbonyl group, an aryloxycarbonyl group, a sulfonyl group, or a sulfamoyl group.

In formula (A-1), the aromatic or heterocyclic group for Q₁ is preferably a 5- to 7-membered unsaturated cyclic group. Preferred examples for it are benzene ring, pyridine ring, pyrazine ring, pyrimidine ring, pyridazine ring, 1,2,4-triazine ring, 1,3,5-triazine ring, pyrrole ring, imidazole ring, pyrazole ring, 1,2,3-triazole ring, 1,2,4-triazole ring, tetrazole ring, 1,3,4-thiadiazole ring, 1,2,4-thiadiazole ring, 1,2,5-thiadiazole ring, 1,3,4-oxadiazole ring, 1,2,4-oxadiazole ring, 1,2,5-oxadiazole ring, thiazole ring, oxazole ring, isothiazole ring, isoxazole ring, and thiophene ring; and also preferred are condensed rings of those rings.

These rings may be substituted, and when they have 2 or more substituents, the substituents may be the same or different. Examples of the substituents are a halogen atom, an alkyl group, an aryl group, a carbonamido group, an alkylsulfonamido group, an arylsulfonamido group, an alkoxy group, an aryloxy group, an alkylthio group, an arylthio group, a carbamoyl group, a sulfamoyl group, a cyano group, an alkylsulfonyl group, an arylsulfonyl group, an alkoxycarbonyl group, an aryloxycarbonyl group, and an acyl group. When these substituents are substitutable ones, then they may have further substituents. Preferred examples of the substituents are a halogen atom, an alkyl group, an aryl group, a carbonamido group, an alkylsulfonamido group, an arylsulfonamido group, an alkoxy group, an aryloxy group, an alkylthio group, an arylthio group, an acyl group, an alkoxycarbonyl group, an aryloxycarbonyl group, a carbamoyl group, a cyano group, a sulfamoyl group, an alkylsulfonyl group, an arylsulfonyl group, and an acyloxy group.

The carbamoyl group for Q₂ preferably has from 1 to 50 carbon atoms, more preferably from 6 to 40 carbon atoms. For example, it includes unsubstituted carbamoyl, methylcarbamoyl, N-ethylcarbamoyl, N-propylcarbamoyl, N-sec-butylcarbamoyl, N-octylcarbamoyl, N-cyclohexylcarbamoyl, N-tert-butylcarbamoyl, N-dodecylcarbamoyl, N-(3-dodecyloxypropyl)carbamoyl, N-octadecylcarbamoyl, N-{3-(2,4-tert-pentylphenoxy)propyl}carbamoyl, N-(2-hexyldecyl)carbamoyl, N-phenylcarbamoyl, N-(4-dodecyloxyphenyl) carbamoyl, N-(2-chloro-5-dodecyloxycarbonylphenyl)carbamoyl, N-naphthylcarbamoyl, N-3-pyridylcarbamoyl, and N-benzylcarbamoyl.

The acyl group for Q₂ preferably has from 1 to 50 carbon atoms, more preferably from 6 to 40 carbon atoms. For example, it includes formyl, acetyl, 2-methylpropanoyl, cyclohexylcarbonyl, octanoyl, 2-hexyldecanoyl, dodecanoyl, chloroacetyl, trifluoroacetyl, benzoyl, 4-dodecyloxybenzoyl, and 2-hydroxymethylbenzoyl. The alkoxycarbonyl group for Q₂ preferably has from 2 to 50 carbon atoms, more preferably from 6 to 40 carbon atoms. For example, it includes methoxycarbonyl, ethoxycarbonyl, isobutyloxycarbonyl, cyclohexyloxycarbonyl, dodecyloxycarbonyl, and benzyloxycarbonyl.

The aryloxycarbonyl group for Q₂ preferably has from 7 to 50 carbon atoms, more preferably from 7 to 40 carbon atoms. For example, it includes phenoxycarbonyl, 4-octyloxyphenoxycarbonyl, 2-hydroxymethylphenoxycarbonyl, and 4-dodecyloxyphenoxycarbonyl. The sulfonyl group for Q₂ preferably has from 1 to 50 carbon atoms, more preferably from 6 to 40 carbon atoms. For example, it includes methylsulfonyl, butylsulfonyl, octylsulfonyl, 2-hexadecylsulfonyl, 3-dodecyloxypropylsulfonyl, 2-octyloxy-5-tert-octylphenylsulfonyl, and 4-dodecyloxyphenylsulfonyl.

The sulfamoyl group for Q₂ preferably has from 0 to 50 carbon atoms, more preferably from 6 to 40 carbon atoms. For example, it includes unsubstituted sulfamoyl, N-ethylsulfamoyl, N-(2-ethylhexyl)sulfamoyl, N-decylsulfamoyl, N-hexadecylsulfamoyl, N-{3-(2-ethylhexyloxy)propyl}sulfamoyl, N-(2-chloro-5-dodecyloxycarbonylphenyl)sulfamoyl, and N-(2-tetradecyloxyphenyl)sulfamoyl. The groups for Q₂ may be, if necessary, substituted at their substitutable position with any of those mentioned hereinabove for the substituents for the 5- to 7-membered unsaturated rings for Q₁. When they have 2 or more such substituents, the substituents may be the same or different.

Preferred embodiments of the compounds of formula (A-1) are mentioned below. Q₁ is preferably a 5- or 6-membered unsaturated cyclic group, for which more preferred are benzene ring, pyrimidine ring, 1,2,3-triazole ring, 1,2,4-triazole ring, tetrazole ring, 1,3,4-thiadiazole ring, 1,2,4-thiadiazole ring, 1,3,4-oxadiazole ring, 1,2,4-oxadiazole ring, thiazole ring, oxazole ring, isothiazole ring, isoxazole ring, and condensed rings of those rings with benzene ring or unsaturated hetero ring. Also preferably, Q² is a carbamoyl group, more preferably a carbamoyl group having a hydrogen atom on the nitrogen ring.

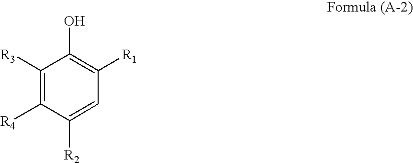

In formula (A-2), R₁ represents an alkyl group, an acyl group, an acylamino group, a sulfonamido group, an alkoxycarbonyl group, or a carbamoyl group. R₂ represents a hydrogen atom, a halogen atom, an alkyl group, an alkoxy group, an aryloxy group, an alkylthio group, an arylthio group, an acyloxy group, or a carbonate group. R₃ and R₄ each represent a group substitutable on the benzene ring such as those mentioned hereinabove for the substituents in formula (A-1). R₃ and R₄ may bond to each other to form a condensed ring.

R₁ is preferably an alkyl group having from 1 to 20 carbon atoms (e.g., methyl, ethyl, isopropyl, butyl, tert-octyl, cyclohexyl), an acylamino group (e.g., acetylamino, benzoylamino, methylureido, 4-cyanophenylureido), or a carbamoyl group (e.g., n-butylcarbamoyl, N,N-diethylcarbamoyl, phenylcarbamoyl, 2-chlorophenylcarbamoyl, 2,4-dichlorophenylcarbamoyl), and is more preferably an acylamino group (including an ureido group and an urethane group). R₂ is preferably a halogen atom (more preferably, chlorine atom, bromine atom), an alkoxy group (e.g., methoxy, butoxy, n-hexyloxy, n-decyloxy, cyclohexyloxy, benzyloxy), or an aryloxy group (e.g., phenoxy, naphthoxy).

R₃ is preferably a hydrogen atom, a halogen atom, an alkyl group having from 1 to 20 carbon atoms, and is most preferably a halogen atom. R₄ is preferably a hydrogen atom, an alkyl group, or an acylamino group, more preferably an alkyl group or an acylamino group. Examples of these preferred substituents may be the same as those for R₁. When R₄ is an acylamino group, it is also desirable that R₄ bonds to R₃ to form a carbostyryl ring.

In formula (A-2), when R₃ and R₄ bond to each other to form a condensed ring, the condensed ring is especially preferably a naphthalene ring. The naphthalene ring may be substituted with any substituents of those mentioned hereinabove for formula (A-1). When the compound of formula (A-2) is a naphthol compound, then R₁ is preferably a carbamoyl group, more preferably a benzoyl group. R₂ is preferably an alkoxy group, or an aryloxy group, more preferably an alkoxy group.

Preferred examples of the development promoter for use in the invention are mentioned below, to which, however, the invention is not limited.

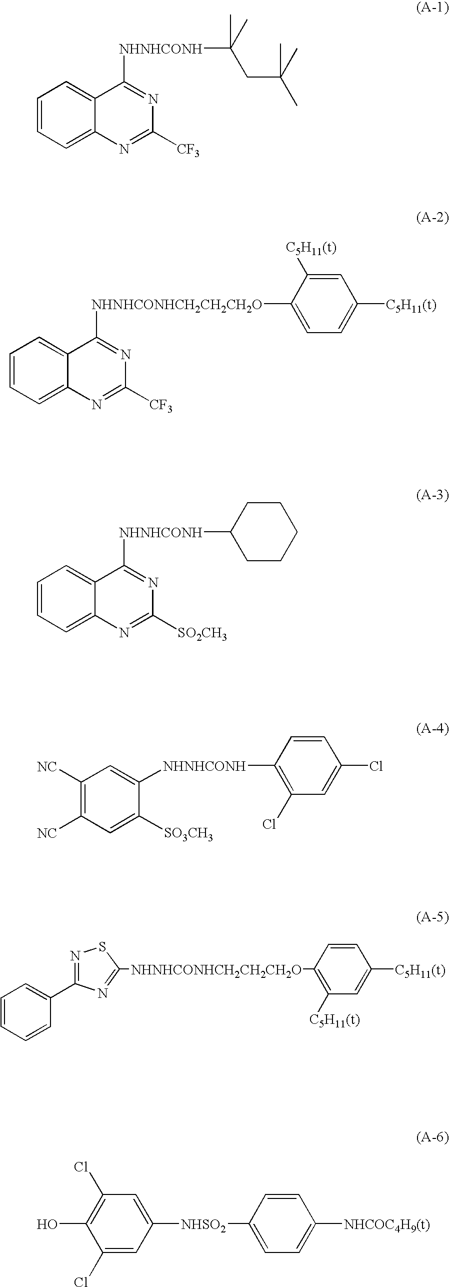

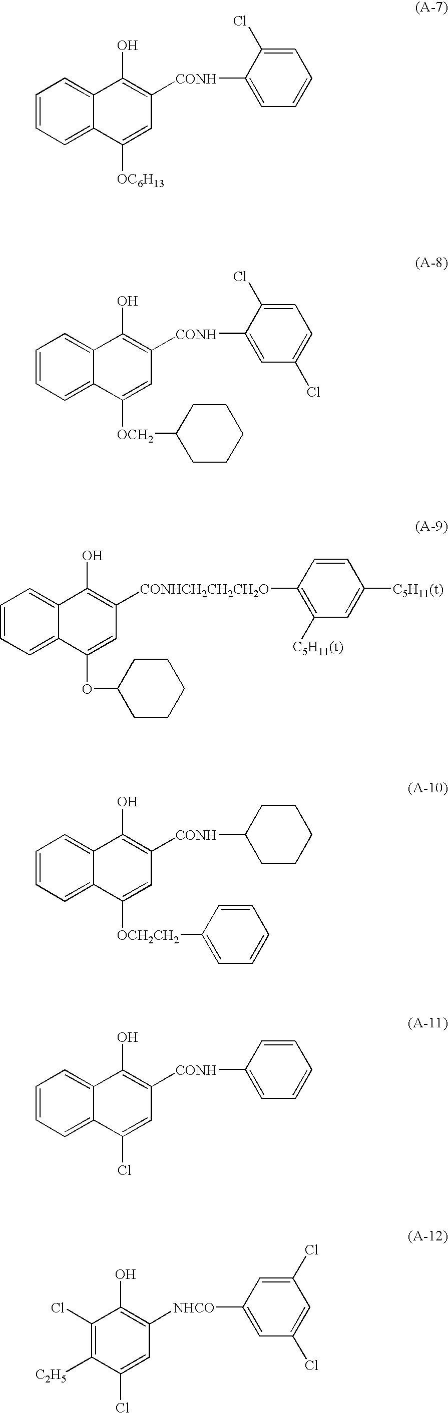

Hydrogen Bond-forming Compound

When a reducing agent in the invention has an aromatic hydroxyl group (—OH) or amino group (—NHR, wherein R is hydrogen atom or alkyl group), in particular, the aforementioned bisphenol, it is preferable to use a non-reductive compound having a group which can form a hydrogen bond with these groups in combination.

Examples of a group which forms a hydrogen bond with a hydroxyl group or an amino group include a phosphoryl group, a sulfoxide group, a sulfonyl group, a carbonyl group, an amido group, an ester group, an urethane group, an ureido group, a tertiary amino group, and a nitrogen-containing aromatic group. Among them, preferable is a compound having a phosphoryl group, a sulfoxide group, an amido group (which has no >N—H group and is blocked like >N—Ra (Ra is a substituent other than H)), an urethane group (which has no >N—H group and is blocked like >N—Ra (Ra is a substituent other than H), or an ureido group (which has no >N—H group and is blocked like >N—Ra (Ra is a substituent other than H)).

In the invention, a particularly preferable hydrogen bond-forming compound is a compound represented by the following formula (D):

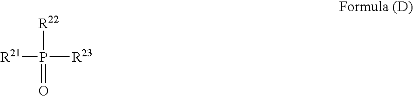

In the formula (D), R²¹ to R²³ each independently represent an alkyl group, an aryl group, an alkoxy group, an aryloxy group, an amino group or a heterocyclic group, and these groups may be unsubstituted or may have a substituent.

Examples of substituents when R²¹ to R²³ have substituents include a halogen atom, an alkyl group, an aryl group, an alkoxy group, an amino group, an acyl group, an acylamino group, an alkylthio group, an arylthio group, a sulfonamido group, an acyloxy group, an oxycarbonyl group, a carbamoyl group, a sulfamoyl group, a sulfonyl group, and a phosphoryl group, and examples of a preferable substituent include an alkyl group or an aryl group, such as a methyl group, an ethyl group, an isopropyl group, a t-butyl group, a t-octyl group, a phenyl group, a 4-alkoxyphenyl group, and a 4-acyloxyphenyl group.

Examples of an alkyl group of R²¹ to R²³ include a methyl group, an ethyl group, a butyl group, an octyl group, a dodecyl group, an isopropyl group, a t-butyl group, a t-amyl group, a t-octyl group, a cyclohexyl group, a 1-methylcyclohexyl group, a benzyl group, a phenethyl group, and a 2-phenoxypropyl group.

Examples of an aryl group include a phenyl group, a cresyl group, a xylyl group, a naphthyl group, a 4-t-butylphenyl group, a 4-t-octylphenyl group, a 4-anisidinyl group, and a 3,5-dichlorophenyl group.

Examples of an alkoxy group include a methoxy group, an ethoxy group, a butoxy group, an octyloxy group, a 2-ethylhexyloxy group, a 3,5,5-trimethylhexyloxy group, a dodecyloxy group, a cyclohexyloxy group, a 4-methylcyclohexyloxy group, a benzyloxy group and the like.

Examples of an aryloxy group include a phenoxy group, a cresyloxy group, an isopropylphenoxy group, a 4-t-butylphenoxy group, a naphthoxy group, a biphenyloxy group and the like.

Examples of an amino group include a dimethylamino group, a diethylamino group, a dibutylamino group, a dioctylamino group, a N-methyl-N-hexylamino group, a dicyclohexylamino group, a diphenylamino group, a N-methyl-N-phenylamino group and the like.

As R²¹ to R²³, an alkyl group, an aryl group, an alkoxy group, and an aryloxy group are preferable. In respect of the effect of the invention, it is preferable that at least one of R²¹ to R²³ is an alkyl group or an aryl group, and it is more preferable that two or more of R²¹ to R²³ are an alkyl group or an aryl group. In addition, from the viewpoint of inexpensive availability, it is preferable that R²¹ to R²³ are the same group.

Examples of a hydrogen bond-forming compound including a compound of the formula (D) in the invention will be shown below, but the invention is not limited by them.

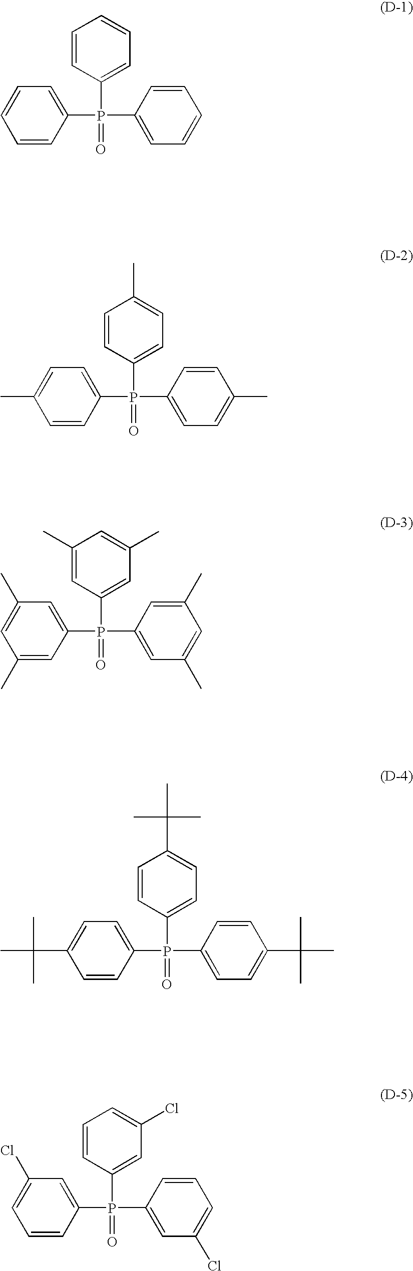

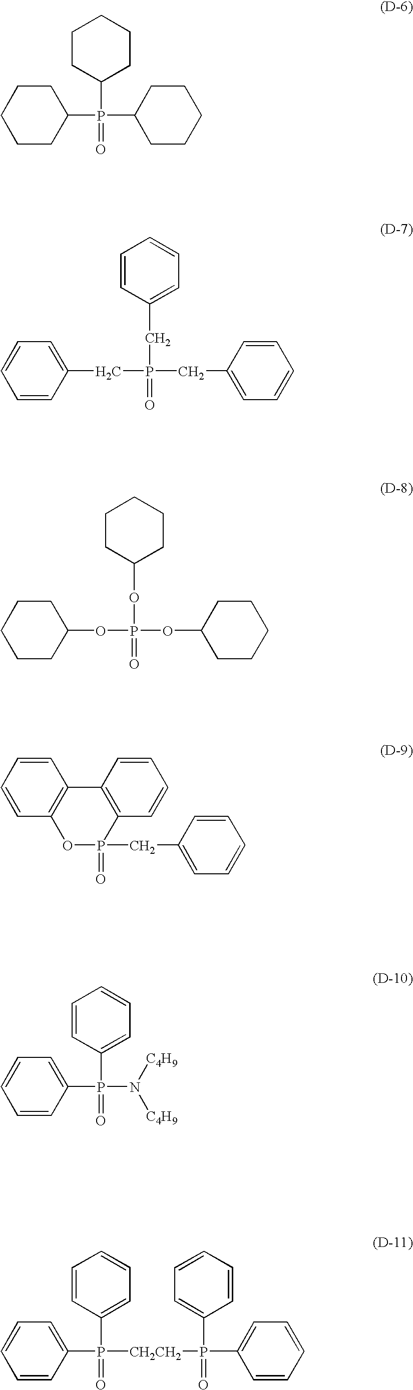

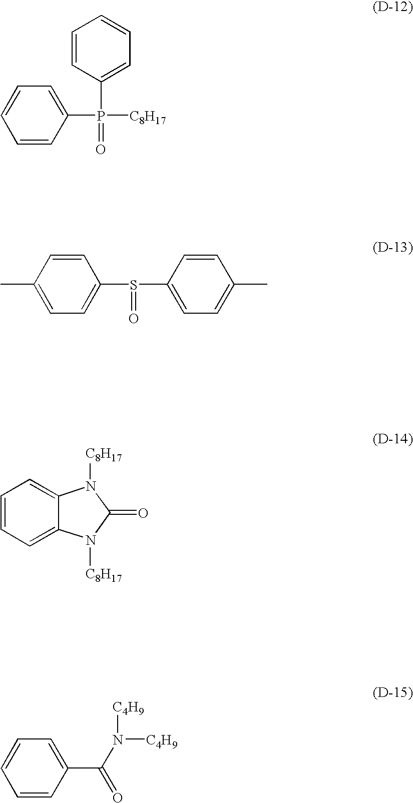

Examples of the hydrogen bond-forming compound include those described in EP No. 1096310, JP-A Nos. 2002-156727 and 2002-318431.

The compound of the formula (D) of the invention can be made to be contained in a coating solution in the solution form, the emulsified dispersion form or the solid-dispersed fine particle dispersion form like a reducing agent, and can be used in a photosensitive material. It is preferable to use as a solid dispersion. The compound of the invention forms a hydrogen bond-forming complex with a compound having a phenolic hydroxyl group or an amino group in the solution state, and can be isolated as a complex in the crystal state depending on a combination of a reducing agent and the compound of the formula (D) of the invention.

It is particularly preferable to use the thus isolated crystal powder as a solid dispersed fine particle dispersion in order to obtain the stable performance. In addition, a method of mixing a reducing agent and the compound of formula (D) of the invention in the form of a powder, and forming a complex at dispersing with a sand grinder mill or the like using an appropriate dispersing agent may be also preferably used.

The compound of the formula (D) of the invention is used in a range of, preferably 1 to 200% by mol, more preferably in a range of 10 to 150% by mol, further preferably in a range of 20 to 100% by mol based on a reducing agent.

### Description of Silver Halide

1) Halogen Composition:

The photosensitive silver halide for use in the invention is not specifically defined in point of its halogen composition, and may be any of silver chloride, silver chlorobromide, silver bromide, silver iodobromide, silver iodochlorobromide, or silver iodide. Above all, preferred are silver bromide, silver iodobromide and silver iodide, and more preferred is silver iodide. The silver iodide content of the photosensitive silver halide is preferably at least 5 mol %, more preferably at least 40 mol %.

Regarding the halogen composition distribution in each silver halide grain, the composition may be uniform throughout the grain, or may stepwise vary, or may continuously vary. Core/shell structured silver halide grains are preferred for use herein. Preferably, the core/shell structure of the grains has from 2 to 5 layers, more preferably from 2 to 4 layers. A technique of localizing silver bromide or silver iodide in the surfaces of silver chloride, silver bromide or silver chlorobromide grains is also preferably employed herein.

2) Method of Grain Formation:

Methods of forming the photosensitive silver halides are well known in the art, for example, as in Research Disclosure 17029 (June 1978), and U.S. Pat. No. 3,700,458, and any known method is employable in the invention. Concretely, a silver source compound and a halogen source compound are added to gelatin or any other polymer solution to prepare a photosensitive silver halide, and it is then mixed with an organic silver salt. This method is preferred for the invention. Also preferred are the method described in JP-A No. 11-119374, paragraphs [0217] to [0224]; and the methods described in JP-A Nos. 11-352627 and 2000-347335.

3) Mean Grain Size:

The grain size of the photosensitive silver halide is preferably small in order to prevent the formed images from becoming cloudy. Concretely, it is preferably at most 0.20 μm, more preferably from 0.01 μm to 0.15 μm, even more preferably from 0.02 μm to 0.12 μm. The grain size as referred to herein is meant to indicate the diameter of the circular image having the same area as the projected area of each silver halide grain (for tabular grains, the main face of each grain is projected to determine the projected area of the grain).

4) Grain Morphology:

The silver halide grains may have different types of morphology, including, for example, cubic grains, octahedral grains, tabular grains, spherical grains, rod-like grains, and potato-like grains. Cubic grains are especially preferred for use in the invention. Also preferred are corner-rounded silver halide grains. The surface index (Miller index) of the outer surface of the photosensitive silver halide grains for use in the invention is not specifically defined, but is desirably such that the proportion of [100] plane, which ensures higher spectral sensitization when it has adsorbed a color-sensitizing dye, in the outer surface is larger. Preferably, the proportion of [100] plane in the outer surface is at least 50%, more preferably at least 65%, even more preferably at least 80%. The Miller index indicated by the proportion of [ 100] plane can be identified according to the method described by T. Tani in J. Imaging Sci., 29, 165 (1985), based on the adsorption dependency of sensitizing dye onto [111] plane and [100] plane.

5) Heavy Metal:

The photosensitive silver halide grains for use in the invention may contain a metal or metal complex of Groups 8 to 10 of the Periodic Table that includes Groups 1 to 18. The metal of Groups 8 to 10, or the center metal of the metal complex is preferably rhodium, ruthenium or iridium. In the invention, one metal complex may be used alone, or two or more metal complexes of one and the same type of metal or different types of metals may also be used herein as combined. The metal or metal complex content of the grains preferably falls between 1×10⁻⁹ mols and 1×10⁻³ mols per mol of silver. Such heavy metals and metal complexes, and methods of adding them to silver halide grains are described in, for example, JP-A No.7-225449; JP-A No.11-65021, paragraphs [0018] to [0024]; and JP-A No. 1 1-119374, paragraphs [0227] to [0240].

Silver halide grains having a hexacyano-metal complex in their outermost surfaces are preferred for use in the invention. The hexacyano-metal complex includes, for example, [Fe(CN)₆]⁴⁻, [Fe(CN)₆]³⁻, [Ru(CN)₆]⁴⁻, [Os(CN)₆]⁴⁻, [Co(CN)₆]³⁻, [Rh(CN)₆]³⁻, [Ir(CN)₆]³⁻, [Cr(CN)₆]³⁻, and [Re(CN)₆]³⁻. The hexacyano-Fe complexes are preferred for the grains for use in the invention.

As hexacyano-metal complexes exist in the form of ions in their aqueous solutions, their counter cations are of no importance. Preferably, however, the counter cations for the complexes are any of alkali metal ions such as sodium, potassium, rubidium, cesium and lithium ions; ammonium ions, and alkylammonium ions (e.g., tetramethylammonium, tetraethylammonium, tetrapropylammonium and tetra(n-butyl)ammonium ions), as they are well miscible with water and are favorable to the operation of precipitating silver halide emulsions.

The hexacyano-metal complex may be added to silver halide grains in the form of a solution thereof in water or in a mixed solvent of water and an organic solvent miscible with water (for example, alcohols, ethers, glycols, ketones, esters, amides), or in the form of a mixture thereof with gelatin.

The amount of the hexacyano-metal complex to be added to the silver halide grains preferably falls between 1×10⁻⁵ mols and 1×10⁻² mols, per mol of silver of the grains, more preferably between 1×10^{31 4} mols and 1×10⁻³ mols.

In order to make the hexacyano-metal complex exist in the outermost surface of the silver halide grains, the complex is added to an aqueous silver nitrate solution from which are formed the silver halide grains, after the solution has been added to a reaction system to give the grains but before the grains having been formed are finished for chemical sensitization such as chalcogen sensitization with sulfur, selenium or tellurium or noble metal sensitization with gold or the like, or is directly added to the grains while they are rinsed or dispersed but before they are finished for such chemical sensitization. To prevent the fine silver halide grains formed from growing too much, it is desirable that the hexacyano-metal complex is added to the grains immediately after they are formed. Preferably, the complex is added thereto before the grains formed are finished for post-treatment.

Adding the hexacyano-metal complex to the silver halide grains may be started after 96% by mass of the total of silver nitrate, from which are formed the grains, has been added to a reaction system to give the grains, but is preferably started after 98% by mass of silver nitride has been added thereto, more preferably after 99% by mass thereof has been added thereto.

The hexacyano-metal complex added to the silver halide grains after an aqueous solution of silver nitrate has been added to the reaction system to give the grains but just before the grains are completely formed is well adsorbed by the grains formed, and may well exist in the outermost surfaces of the grains. Most of the complex added in that manner forms a hardly-soluble salt with the silver ions existing in the surfaces of the grains. The silver salt of hexacyano-iron(II) is more hardly soluble than AgI, and the fine grains formed are prevented from re-dissolving and aggregating into large grains. Accordingly, the intended fine silver halide grains having a small grain size can be formed.

The metal atoms (e.g., in [Fe(CN)₆]⁴⁻) that may be added to the silver halide grains for use in the invention, as well as the methods of desalting or chemical sensitization of the silver halide emulsions are described, for example, in JP-A No. 11-84574, paragraphs [0046] to [0050], JP-A No. 11-65021, paragraphs [0025] to [0031], and JP-A No. 11-119374, paragraphs [0242] to [0250].

6) Gelatin:

Gelatin of different types may be used in preparing the photosensitive silver halide emulsions for use in the invention. For better dispersion of the photosensitive silver halide emulsion in an organic silver salt-containing coating liquid in producing the photothermographic material of the invention, preferred is gelatin having a molecular weight of from 10,000 to 1,000,000. Also preferably, the substituent in gelatin is phthalated. Gelatin may be used in forming the silver halide grains or in dispersing the grains after the grains have been desalted. Preferably, it is used in forming the grains.

7) Sensitizing Dye:

Sensitizing dyes usable in the invention are those which, after adsorbed by silver halide grains, can spectrally sensitize the grains within a desired wavelength range. Depending on the spectral characteristics of the light source to be used for exposure, favorable sensitizing dyes having good spectral sensitivity are selected for use in the photothermographic material of the invention. For the details of sensitizing dyes usable herein and methods for adding them to the photothermographic material of the invention, referred to are paragraphs [0103] to [0109] in JP-A No. 11-65021; compounds of formula (II) in JP-A No. 10-186572; dyes of formula (I) and paragraph [0106] in JP-A No. 11-119374; dyes described in U.S. Pat. Nos. 5,510,236, 3,871,887 (Example 5); dyes described in JP-A Nos. 2-96131 and 59-48753; from page 19, line 38 to page 20, line 35 of EP-A No. 0803764A1; JP-A Nos. 2001-272747, 2001-290238 and 2002-23306. One or more such sensitizing dyes may be used herein either singly or as combined. Regarding the time at which the sensitizing dye is added to the silver halide emulsion in the invention, it is desirable that the sensitizing dye is added thereto after the desalting step but before the coating step, more preferably after the desalting step but before the termination of the chemical ripening step.

The amount of the sensitizing dye to be in the photothermographic material of the invention varies, depending on the sensitivity and the fogging resistance of the material. In general, it preferably falls between 10⁻⁶ and 1 mol, more preferably between 10⁻⁴ and 10⁻¹ mols, per mol of the silver halide in the photosensitive layer of the material.

For its better spectral sensitization, the photothermographic material of the invention may contain a supersensitizer. For the supersensitizer in the invention, for example, usable are the compounds described in EP-A No. 587,338, U.S. Pat. Nos. 3,877,943 and 4,873,184, and JP-A Nos. 5-341432, 11-109547 and 10-111543.

8) Chemical Sensitization:

Preferably, the photosensitive silver halide grains for use in the invention are chemically sensitized with, for example, sulfur, selenium or tellurium. For such sulfur, selenium or tellurium sensitization, any known compounds are usable. For example, preferred are the compounds described in JP-A No. 7-128768. The grains for use in the invention are especially preferably sensitized with tellurium, for which more preferred are the compounds described in JP-A No. 11-65021, paragraph [0030], and the compounds of formulae (II), (III) and (IV) given in JP-A No. 5-313284.

Preferably, the photosensitive silver halide grains for use in the invention are chemically sensitized with gold alone or with gold combined with chalcogen. Gold in the gold sensitizer for them preferably has a valence of +1 or +3. Any ordinary gold compounds for gold sensitization are usable herein. Preferred examples of the gold sensitizer for use herein are chloroauric acid, bromoauric acid, potassium chloroaurate, potassium bromoaurate, auric trichloride, potassium auric thiocyanate, potassium iodoaurate, tetracyanoauric acid, ammonium aurothiocyanate, pyridyltrichlorogold. Also preferred for use herein are the gold sensitizers described in U.S. Pat. No. 5,858,637, and JP-A No. 2002-278016.

In the invention, the photosensitive silver halides may be chemically sensitized in any stage after their formation but before their coating. For example, they may be chemically sensitized after desalted, but (1) before spectral sensitization, or (2) along with spectral sensitization, or (3) after spectral sensitization, or (4) just before coating.

The amount of the sulfur, selenium or tellurium sensitizer for such chemical sensitization in the invention varies, depending on the type of the photosensitive silver halide grains to be sensitized therewith and the condition for chemically ripening the grains, but may fall generally between 10⁻⁸ and 10⁻² mols, preferably between 10⁻⁷ and 10₋₃ mols or so, per mol of the silver halide.

The amount of the gold sensitizer to be added to the silver halide grains also varies depending on various conditions. In general, it may fall between 10⁻⁷ and 10⁻³ mols, preferably between 10⁻⁶ and 5×10⁻⁴ mols, per mol of the silver halide.

Though not specifically defined, the condition for chemical sensitization in the invention may be such that the pH falls between 5 and 8, the pAg falls between 6 and 11, and the temperature falls between 40 and 95° C. or so.

If desired, a thiosulfonic acid compound may be added to the silver halide emulsions for use in the invention, according to the method described in EP-A No. 293,917.

Preferably, the photosensitive silver halide grains in the invention are processed with a reducing agent. Concretely, preferred examples of the compounds for reduction sensitization are ascorbic acid, thiourea dioxide, as well as stannous chloride, aminoiminomethanesulfinic acid, hydrazine derivatives, borane compounds, silane compounds and polyamine compounds. The reduction sensitizer may be added to the grains in any stage of preparing the photosensitive emulsions including the stage of grain growth to just before coating the emulsions. Preferably, the emulsions are subjected to such reduction sensitization while they are kept ripened at a pH of 7 or more or at a pAg of 8.3 or less. Also preferably, they may be subjected to reduction sensitization while the grains are formed with a single addition part of silver ions being introduced thereinto. 9) Compound of which one-electron oxidation product formed through one-electron oxidation can release one or more electrons:

Preferably, the photothermographic material of the invention contains a compound of which one-electron oxidation product formed through one-electron oxidation can release one or more electrons. The compound may be used singly or as combined with any other various chemical sensitizer such as those mentioned above, and it increases the sensitivity of silver halides.

The photothermographic material of the invention preferably comprises a compound that can be one-electron-oxidized to provide a one-electron oxidation product, which can release further 1 or more electron. The compound is used alone or in combination with the above-mentioned various chemical sensitizers, to increase the sensitivity of the silver halide.

The compound is selected from compounds of Types 1 to 5.

Type 1: a compound that can be one-electron-oxidized to provide a one-electron oxidation product, which can release 2 or more electrons in or after a subsequent bond cleavage reaction.

Type 2: a compound that has 2 or more adsorbent groups to the silver halide and can be one-electron-oxidized to provide a one-electron oxidation product, which can release 1 electron in or after a subsequent bond cleavage reaction.

Type 3: a compound that can be one-electron-oxidized to provide a one-electron oxidation product, which can release 1 or more electron after a subsequent bond formation.

Type 4: a compound that can be one-electron-oxidized to provide a one-electron oxidation product, which can release 1 or more electron after a subsequent ring cleavage reaction.

Type 5: a compound represented by X—Y, in which X represents a reducing group and Y represents a leaving group, and convertable by one-electron-oxidizing the reducing group to a one-electron oxidation product, which can be converted into an X radical by eliminating the leaving group Y in a subsequent X—Y bond cleavage reaction, and 1 electron is capable of being released from the X radical.

Each compound of Types 1 and 3 to 5 preferably has an adsorbent group to the silver halide, or a spectrally sensitizing dye moiety, more preferably has the adsorbent group to the silver halide. Each compound of Types 1 to 4 more preferably has a nitrogen-containing heterocyclic group substituted by 2 or more mercapto group as the adsorbent group.

The compounds of Types 1 to 5 are described in detail below.

In the compound of Type 1, the term “the bond cleavage reaction” specifically means a cleavage reaction of a bond of carbon-carbon, carbon-silicon, carbon-hydrogen, carbon-boron, carbon-tin or carbon-germanium. Cleavage of a carbon-hydrogen bond may be caused with the cleavage reaction. The compound of Type 1 can be one-electron-oxidized to be converted into the one-electron oxidation product, and thereafter can release further 2 or more electrons, preferably 3 or more electrons, with the bond cleavage reaction.

The compound of Type 1 is preferably represented by any one of formulae (A), (B), (i), (ii) and (iii).

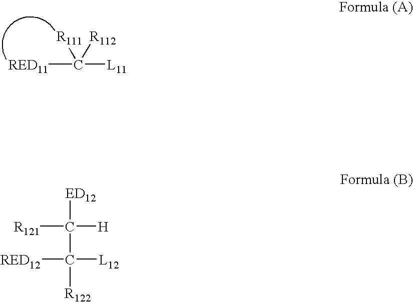

In the formula (A), RED₁₁ represents a reducing group that can be one-electron-oxidized, and L₁₁ represents a leaving group. R₁₁₂ represents a hydrogen atom or a substituent. R₁₁₁ represents a nonmetallic atomic group to form a ring structure corresponding to a tetrahydro-, hexahydro- or octahydro-derivative of a 5- or 6-membered aromatic ring including aromatic heterocycles with a carbon atom C and RED₁₁.

In the formula (B), RED₁₂ represents a reducing group that can be one-electron-oxidized, and L₁₂ represents a leaving group. R₁₂₁ and R₁₂₂ each represent a hydrogen atom or a substituent. ED₁₂ represents an electron-donating group. In the formula (B), R₁₂₁ and RED₁₂, R₁₂₁ and R₁₂₂, and ED₁₂ and RED₁₂ may bond together to form a ring structure, respectively.

In the compound represented by the formula (A) or (B), the reducing group of RED₁₁ or RED₁₂ is one-electron-oxidized, and thereafter the leaving group of L₁₁ or L₁₂ is spontaneously eliminated in the bond cleavage reaction. Further 2 or more, preferably 3 or more, electrons can be released with the bond cleavage reaction.

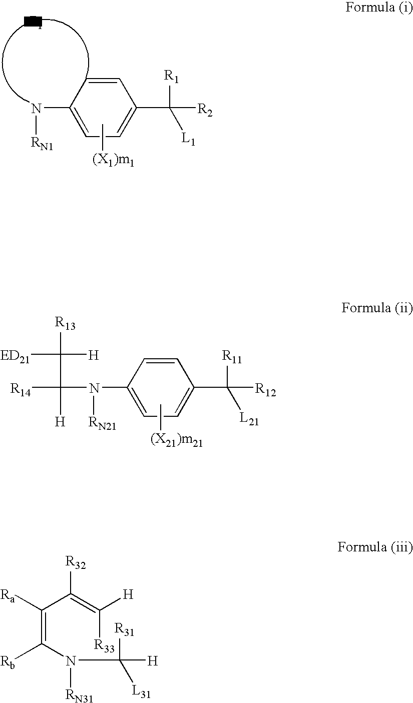

In the formula (i), Z₁ represents an atomic group forming a 6-membered ring with a nitrogen atom and 2 carbon atoms in a benzene ring; R₁, R₂ and R_{N1}, each represent a hydrogen atom or a substituent; X₁ represents a substituent linkable to the benzene ring; m₁ represents an integer of 0 to 3; and L₁ represents a leaving group.

In the formula (ii), ED₂₁, represents an electron-donating group; R₁₁, R₁₂, R_{N21}, R₁₃ and R₁₄ each represent a hydrogen atom or a substituent; X₂₁ represents a substituent linkable to a benzene ring; m₂₁, represents an integer of 0 to 3; and L₂₁ represents a leaving group. R_{N21}, R₁₃, R₁₄, X₂₁ and ED₂₁ may bond to each other to form a ring structure.

In the formula (iii), R₃₂, R₃₃, R₃₁, R_{N31}, Rₐ and R_{b} each represent a hydrogen atom or a substituent; and L₃₁ represents a leaving group. Incidentally, Rₐ and R_{b} bond together to form an aromatic ring when R_{N31} is not an aryl group.

After the compound represented by the formula (i), (ii) or (iii) is one-electron-oxidized, the leaving group of L₁, L₂₁ or L₃₁ is spontaneously eliminated in the bond cleavage reaction. Further 2 or more, preferably 3 or more, electrons can be released with the bond cleavage reaction.

First, the compound represented by the formula (A) will be described in detail below.

In the formula (A), the reducing group of RED₁₁ can be one-electron-oxidized and can bond to after-mentioned R₁₁₁ to form the particular ring structure. Specifically, the reducing group may be a divalent group provided by removing 1 hydrogen atom from the following monovalent group at a position suitable for ring formation.

The monovalent group may be an alkylamino group; an arylamino group such as an anilino group and a naphthylamino group; a heterocyclic amino group such as a benzthiazolylamino group and a pyrrolylamino group; an alkylthio group; an arylthio group such as a phenylthio group; a heterocyclic thio group; an alkoxy group; an aryloxy group such as a phenoxy group; a heterocyclic oxy group; an aryl group such as a phenyl group, a naphthyl group and an anthranil group; or an aromatic or nonaromatic heterocyclic group containing at least one heteroatom selected from the group consisting of a nitrogen atom, a sulfur atom, an oxygen atom and a selenium atom, which has a 5- to 7-membered, monocyclic or condensed ring structure such as a tetrahydroquinoline ring, a tetrahydroisoquinoline ring, a tetrahydroquinoxaline ring, a tetrahydroquinazoline ring, an indoline ring, an indole ring, an indazole ring, a carbazole ring, a phenoxazine ring, a phenothiazine ring, a benzothiazoline ring, a pyrrole ring, an imidazole ring, a thiazoline ring, a piperidine ring, a pyrrolidine ring, a morpholine ring, a benzimidazole ring, a benzimidazoline ring, a benzoxazoline ring and a methylenedioxyphenyl ring. RED₁₁ is hereinafter described as the monovalent group for convenience. The monovalent groups may have a substituent.

In the invention, the term “substituent” means an atom or a group selected from the following examples when a particular explanation is not provided therefor. Examples of the substituent include halogen atoms; alkyl groups including aralkyl groups, cycloalkyl groups, active methine groups, etc.; alkenyl groups; alkynyl groups; aryl groups; heterocyclic groups, which may bond at any position; heterocyclic groups containing a quaternary nitrogen atom such as a pyridinio group, an imidazolio group, a quinolinio group and an isoquinolinio group; acyl groups; alkoxycarbonyl groups; aryloxycarbonyl groups; carbamoyl groups; a carboxy group and salts thereof; sulfonylcarbamoyl groups; acylcarbamoyl groups; sulfamoylcarbamoyl groups; carbazoyl groups; oxalyl groups; oxamoyl groups; a cyano group; carbonimidoyl groups; thiocarbamoyl groups; a hydroxy group; alkoxy groups, which may contain a plurality of ethyleneoxy groups or propyleneoxy groups as a repetition unit; aryloxy groups; heterocyclic oxy groups; acyloxy groups; alkoxy or aryloxy carbonyloxy groups; carbamoyloxy groups; sulfonyloxy groups; amino groups; alkyl, aryl or heterocyclic amino groups; acylamino groups; sulfoneamide groups; ureide groups; thioureide groups; imide groups; alkoxy or aryloxy carbonylamino groups; sulfamoylamino groups; semicarbazide groups; thiosemicarbazide groups; hydrazino groups; ammonio groups; oxamoylamino groups; alkyl or aryl sulfonylureide groups; acylureide groups; acylsulfamoylamino groups; a nitro group; a mercapto group; alkyl, aryl or heterocyclic thio groups; alkyl or aryl sulfonyl groups; alkyl or aryl sulfinyl groups; a sulfo group and salts thereof; sulfamoyl groups; acylsulfamoyl groups; sulfonylsulfamoyl groups and salts thereof; groups containing a phosphoric amide or phosphate ester structure; etc. The substituents may be further substituted by the substituent.

RED₁₁ is preferably an alkylamino group, an arylamino group, a heterocyclic amino group, an aryl group, or an aromatic or nonaromatic, heterocyclic group, more preferably an arylamino group (particularly an anilino group) or an aryl group (particularly a phenyl group). When the groups have a substituent, preferred as the substituent are halogen atoms, alkyl groups, alkoxy groups, carbamoyl groups, sulfamoyl groups, acylamino groups, and sulfoneamide groups.

When RED₁₁ is an aryl group, it is preferred that the aryl group has at least one electron-donating group. The electron-donating group is a hydroxy group; an alkoxy group; a mercapto group; a sulfoneamide group; an acylamino group; an alkylamino group; an arylamino group; a heterocyclic amino group; an active methine group; an electron-excess, aromatic, 5-membered, monocyclic or condensed, heterocyclic group containing at least one nitrogen atom, such as an indolyl group, a pyrrolyl group, an imidazolyl group, a benzimidazolyl group, a thiazolyl group, a benzthiazolyl group and an indazolyl group; a nitrogen-containing, nonaromatic heterocyclic group (or a cyclic amino group) that substitutes at the nitrogen atom, such as a pyrrolidinyl group, an indolinyl group, a piperidinyl group, a piperazinyl group and a morpholino group; etc. The active methine group is a methine group having 2 electron-withdrawing groups, and the electron-withdrawing group is an acyl group, an alkoxycarbonyl group, an aryloxycarbonyl group, a carbamoyl group, an alkylsulfonyl group, an arylsulfonyl group, a sulfamoyl group, a trifluoromethyl group, a cyano group, a nitro group or a carbonimidoyl group. The 2 electron-withdrawing groups may bond together to form a ring structure.

In the formula (A), specific examples of L₁₁ include a carboxy group and salts thereof, silyl groups, a hydrogen atom, triarylboron anions, trialkylstannyl groups, trialkylgermyl groups and a —CR_{C1}R_{C2}R_{C3} group. The silyl group is specifically a trialkylsilyl group, an aryldialkylsilyl group, a triarylsilyl group, etc., and may have a substituent.

When L₁₁ represents a salt of a carboxy group, specific examples of counter ions to form the salt include alkaline metal ions, alkaline earth metal ions, heavy metal ions, ammonium ions, phosphonium ions, etc. The counter ion is preferably an alkaline metal ion or an ammonium ion, the most preferably an alkaline metal ion, particularly Li⁺, Na⁺, or K⁺ ion.

When L₁₁ represents a —CR_{C1}R_{C2}R_{C3} group, R_{C1}, R_{C2} and R_{C3} independently represent a hydrogen atom, an alkyl group, an aryl group, a heterocyclic group, an alkylthio group, an arylthio group, an alkylamino group, an arylamino group, a heterocyclic amino group, an alkoxy group, an aryloxy group or a hydroxy group. R_{C1}, R_{C2} and R_{C3} may bond to each other to form a ring structure, and may have a substituent. Incidentally, when one of R_{C1}, R_{C2} and R_{C3} is a hydrogen atom or an alkyl group, there is no case where the other two of them are a hydrogen atom or an alkyl group. R_{C1}, R_{C2} and R_{C3} are preferably an alkyl group, an aryl group (particularly a phenyl group), an alkylthio group, an arylthio group, an alkylamino group, an arylamino group, a heterocyclic group, an alkoxy group or a hydroxy group, respectively. Specific examples thereof include a phenyl group, a p-dimethylaminophenyl group, a p-methoxyphenyl group, a 2,4-dimethoxyphenyl group, a p-hydroxyphenyl group, a methylthio group, a phenylthio group, a phenoxy group, a methoxy group, an ethoxy group, a dimethylamino group, an N-methylanilino group, a diphenylamino group, a morpholino group, a thiomorpholino group, a hydroxy group, etc. Examples of the ring structure formed by R_{C1}, R_{C2} and R_{C3} include a 1,3-dithiolane-2-yl group, a 1,3-dithiane-2-yl group, an N-methyl-1,3-thiazolidine-2-yl group, an N-benzyl-benzothiazolidine-2-yl group, etc.

It is also preferred that the —CR_{C1}R_{C2}R_{C3} group is the same as a residue provided by removing L₁₁ from the formula (A) as a result of selecting each of R_{C1}, R_{C2} and R_{C3} as above.

In the formula (A), L₁₁ is preferably a carboxy group or a salt thereof, or a hydrogen atom, more preferably a carboxy group or a salt thereof.

When L₁₁ represents a hydrogen atom, the compound represented by the formula (A) preferably has a base moiety. After the compound represented by the formula (A) is oxidized, the base moiety acts to depronate the hydrogen atom of L₁₁ to release an electron.

The base is specifically a conjugate base of an acid with a pKa value of approximately 1 to 10. For example, the base moiety may contain a structure of a nitrogen-containing heterocycle such as pyridine, imidazole, benzoimidazole and thiazole; aniline; trialkylamine; an amino group; a carbon acid such as an active methylene anion; a thioacetic acid anion; carboxylate (—COO⁻); sulfate (—SO₃⁻); amineoxide (>N⁺(O⁻)—); etc. The base is preferably a conjugate base of an acid with a pKa value of approximately 1 to 8, more preferably carboxylate, sulfate or amineoxide, particularly preferably carboxylate. When these bases have an anion, the compound of the formula (A) may have a counter cation. Examples of the counter cation include alkaline metal ions, alkaline earth metal ions, heavy metal ions, ammonium ions, phosphonium ions, etc. The base moiety may be at an optional position of the compound represented by the formula (A). The base moiety may be connected to RED₁₁, R₁₁₁ or R₁₁₂ in the formula (A), or to a substituent thereon.

In the formula (A), R₁₁₂ represents a hydrogen atom or a substituent linkable to a carbon atom. Incidentally, R₁₁₂ cannot represent the same group as L₁₁.

R₁₁₂ is preferably a hydrogen atom; an alkyl group; an aryl group such as a phenyl group; an alkoxy group such as a methoxy group, an ethoxy group and a benzyloxy group; a hydroxy group; an alkylthio group such as a methylthio group and a butylthio group; an amino group; an alkylamino group; an arylamino group; or a heterocyclic amino group. R₁₁₂ is more preferably a hydrogen atom, an alkyl group, an alkoxy group, a hydroxy group, a phenyl group or an alkylamino group.

In the formula (A), the ring structure formed by R₁₁₁ corresponds to a tetrahydro-, hexahydro- or octahydro-derivative of a 5- or 6-membered aromatic ring including aromatic heterocycles. The tetrahydro-, hexahydro- or octahydro-derivative means a ring structure derived by partly hydrogenating carbon-carbon double bonds and/or carbon-nitrogen double bonds of an aromatic ring or an aromatic heterocycle. The tetrahydro-, hexahydro-, or octahydro-derivative means a ring structure derived by hydrogenating 2, 3, or 4 double bonds of carbon-carbon or carbon-nitrogen, respectively. The aromatic ring is hydrogenated and converted into a partly hydrogenated, nonaromatic ring structure.

Specifically, examples of such ring structures include a pyrrolidine ring, an imidazolidine ring, a thiazolidine ring, a pyrazolidine ring, an oxazolidine ring, a piperidine ring, a tetrahydropyridine ring, a tetrahydropyrimidine ring, a piperazine ring, a tetralin ring, a tetrahydroquinoline ring, a tetrahydroisoquinoline ring, a tetrahydroquinazoline ring, a tetrahydroquinoxaline ring, a tetrahydrocarbazole ring, an octahydrophenanthridine ring, etc. These ring structures may have a substituent.

The ring structure formed by R₁₁₁ is more preferably a pyrrolidine ring, an imidazolidine ring, a piperidine ring, a tetrahydropyridine ring, a tetrahydropyrimidine ring, a piperazine ring, a tetrahydroquinoline ring, a tetrahydroisoquinoline ring, a tetrahydroquinazoline ring, a tetrahydroquinoxaline ring, or a tetrahydrocarbazole ring, particularly preferably a pyrrolidine ring, a piperidine ring, a piperazine ring, a tetrahydropyridine ring, a tetrahydroquinoline ring, a tetrahydroisoquinoline ring, a tetrahydroquinazoline ring, or a tetrahydroquinoxaline ring, the most preferably a pyrrolidine ring, a piperidine ring, a tetrahydropyridine ring, a tetrahydroquinoline ring, or a tetrahydroisoquinoline ring.

In the formula (B), RED₁₂ and L₁₂ are the same as RED₁₁ and L₁₁ in the formula (A) with respect to the meanings and preferred embodiments, respectively. Incidentally, RED₁₂ is a monovalent group except for the case of forming a ring structure mentioned below. Specific examples of RED₁₂ are the same as above-mentioned examples of the monovalent group to provide RED₁₁. R₁₂₁ and R₁₂₂ are the same as R₁₁₂ in the formula (A) with respect to the meanings and preferred embodiments, respectively. ED₁₂ represents an electron-donating group. Each combination of R₁₂₁ and RED₁₂, R₁₂₁ and R₁₂₂, and ED₁₂ and RED₁₂ may bond together to form a ring structure.

The electron-donating group of ED₁₂ in the formula (B) is the same as above-mentioned electron-donating group that acts as a substituent on RED₁₁ when RED₁₁ is an aryl group. ED₁₂ is preferably a hydroxy group; an alkoxy group; a mercapto group; a sulfoneamide group; an alkylamino group; an arylamino group; an active methine group; an electron-excess, aromatic, 5-membered, monocyclic or condensed, heterocyclic group containing at least one nitrogen atom in the ring; a nitrogen-containing, nonaromatic heterocyclic group that substitutes at the nitrogen atom; or a phenyl group having a substituent composed thereof. ED₁₂ is more preferably a hydroxy group; a mercapto group; a sulfoneamide group; an alkylamino group; an arylamino group; an active methine group; a nitrogen-containing, nonaromatic heterocyclic group that substitutes at the nitrogen atom; or a phenyl group having a substituent composed thereof such as a p-hydroxyphenyl group, a p-dialkylaminophenyl group and an o,p-dialkoxyphenyl group.

In the formula (B), each combination of R₁₂₁ and RED₁₂, R₁₂₂ and R₁₂₁, and ED₁₂ and RED₁₂ may bond together to form a ring structure. The ring structure is a 5- to 7-membered, monocyclic or condensed, substituted or unsubstituted, carbocyclic or heterocyclic, nonaromatic ring. Specific examples of the ring structures formed by R₁₁₂ and RED₁₂ include a pyrroline ring, an imidazoline ring, a thiazoline ring, a pyrazoline ring, an oxazoline ring, an indane ring, a morpholine ring, an indoline ring, a tetrahydro-1,4-oxazine ring, a 2,3-dihydrobenzo-1,4-oxazine ring, a tetrahydro-1,4-thiazine ring, a 2,3-dihydrobenzo-1,4-thiazine ring, a 2,3-dihydrobenzofuran ring, 2,3-dihydrobenzothiophene ring, etc. in addition to examples of the ring structures formed by R₁₁₁ in the formula (A). When ED₁₂ and RED₁₂ form a ring structure, ED₁₂ preferably represents an amino group, an alkylamino group or an arylamino group, and specific examples of the ring structures include a tetrahydropyrazine ring, a piperazine ring, a tetrahydroquinoxaline ring, a tetrahydroisoquinoline ring, etc. When R₁₂₂ and R₁₂₁ form a ring structure, specific examples of the ring structures include a cyclohexane ring, a cyclopentane ring, etc.

Next, the formulae (i) to (iii) will be described below.

In the formulae (i) to (iii), R₁, R₂, R₁₁, R₁₂ and R₃₁ are the same as R₁₁₂ in the formula (A) with respect to the meanings and preferred embodiments, respectively. L₁, L₂₁ and L₃₁ independently represent a leaving group with examples the same as those of L₁₁ in the formula (A). X₁ and X₂₁ independently represent a substituent with examples and preferred embodiments the same as those of the substituent on RED₁₁ in the formula (A). Each of m₁ and m₂₁ is preferably an integer of 0 to 2, more preferably 0 or 1.

When R_{N1}, R_{N21} or R_{N31} is a substituent, the substituent is preferably an alkyl group, an aryl group or a heterocyclic group, and may further have a substituent. Each of R_{N1}, R_{N21} and R_{N31} is preferably a hydrogen atom, an alkyl group or an aryl group, more preferably a hydrogen atom or an alkyl group.

When R₁₃, R₁₄, R₃₃, Rₐ, or R_{b} is a substituent, the substituent is preferably an alkyl group, an aryl group, an acyl group, an alkoxycarbonyl group, a carbamoyl group, a cyano group, an alkoxy group, an acylamino group, a sulfoneamide group, a ureide group, a thiouredide group, an alkylthio group, an arylthio group, an alkylsulfonyl group, an arylsulfonyl group, or a sulfamoyl group.

In the formula (i), the 6-membered ring formed by Z₁ is a nonaromatic heterocycle condensed with the benzene ring in the formula (i). The ring structure containing the nonaromatic heterocycle and the benzene ring to be condensed is specifically a tetrahydroquinoline ring, a tetrahydroquinoxaline ring, a tetrahydroquinazoline ring, etc., preferably a tetrahydroquinoline ring or a tetrahydroquinoxaline ring. The ring structure may have a substituent.

In the formula (ii), ED₂₁ is the same as ED₁₂ in the formula (B) with respect to the meanings and preferred embodiments.

In the formula (ii), any two of R_{N21}, R₁₃, R₁₄, X₂₁ and ED₂₁ may be bonded together to form a ring structure. The ring structure formed by R_{N21} and X₂₁ is preferably a 5- to 7-membered, carbocyclic or heterocyclic, nonaromatic ring structure condensed with a benzene ring, and specific examples thereof include a tetrahydroquinoline ring, a tetrahydroquinoxaline ring, an indoline ring, a 2,3-dihydro-5,6-benzo-1,4-thiazine ring, etc. Preferred are a tetrahydroquinoline ring, a tetrahydroquinoxaline ring and an indoline ring.

When R_{N31} is a group other than an aryl group in the formula (iii), Rₐ and R_{b} bond together to form an aromatic ring. The aromatic ring is an aryl group such as a phenyl group and a naphthyl group, or an aromatic heterocyclic group such as a pyridine ring group, a pyrrole ring group, a quinoline ring group and an indole ring group, preferably an aryl group. The aromatic ring group may have a substituent.

In the formula (iii), Rₐ and R_{b} preferably bond together to form an aromatic ring, particularly a phenyl group.

In the formula (iii), R₃₂ is preferably a hydrogen atom, an alkyl group, an aryl group, a hydroxy group, an alkoxy group, a mercapto group or an amino group. According to a preferred embodiment, R₃₃ is an electron-withdrawing group when R₃₂ is a hydroxy group. The electron-withdrawing group is the same as above-described one, preferably an acyl group, an alkoxycarbonyl group, a carbamoyl group or a cyano group.

The compound of Type 2 will be described below.

The bond cleavage reaction of the compound of Type 2 is a cleavage reaction of a bond of carbon-carbon, carbon-silicon, carbon-hydrogen, carbon-boron, carbon-tin or carbon-germanium. Cleavage of a carbon-hydrogen bond may be caused with the cleavage reaction.

The compound of Type 2 has 2 or more, preferably 2 to 6, more preferably 2 to 4, adsorbent groups to the silver halide. The adsorbent group is further preferably a mercapto-substituted, nitrogen-containing, heterocyclic group. The number of the adsorbent groups is preferably 2 to 6, more preferably 2 to 4. The adsorbent group will hereinafter be described.

The compound of Type 2 is preferably represented by the following formula (C).

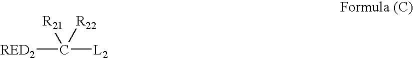

In the compound represented by the formula (C), the reducing group represented by RED₂ is one-electron-oxidized, and thereafter the leaving group of L₂ is spontaneously eliminated in the bond cleavage reaction. Further 1 electron can be released in the bond cleavage reaction.

In the formula (C), RED₂ is the same as RED₁₂ in the formula (B) with respect to the meanings and preferred embodiments. L₂ is the same as L₁₁ in the formula (A) with respect to the meanings and preferred embodiments. Incidentally, when L₂ is a silyl group, the compound of the formula (C) has 2 or more mercapto-substituted, nitrogen-containing, heterocyclic groups as the adsorbent groups. R₂₁ and R₂₂ each represent a hydrogen atom or a substituent, and are the same as R₁₁₂ in the formula (A) with respect to the meanings and preferred embodiments. RED₂ and R₂₁ may bond together to form a ring structure.

The ring structure is a 5- to 7-membered, monocyclic or condensed, carbocyclic or heterocyclic, nonaromatic ring, and may have a substituent. Incidentally, there is no case where the ring structure corresponds to a tetrahydro-, hexahydro- or octahydro-derivative of an aromatic ring or an aromatic heterocycle. The ring structure is preferably such that corresponds to a dihydro-derivative of an aromatic ring or an aromatic heterocycle, and specific examples thereof include a 2-pyrroline ring, a 2-imidazoline ring, a 2-thiazoline ring, a 1,2-dihydropyridine ring, a 1,4-dihydropyridine ring, an indoline ring, a benzoimidazoline ring, a benzothiazoline ring, a benzoxazoline ring, a 2,3-dihydrobenzothiophene ring, a 2,3-dihydrobenzofuran ring, a benzo-α-pyran ring, a 1,2-dihydroquinoline ring, a 1,2-dihydroquinazoline ring, a 1,2-dihydroquinoxaline ring, etc. Preferred are a 2-imidazoline ring, a 2-thiazoline ring, an indoline ring, a benzoimidazoline ring, a benzothiazoline ring, a benzoxazoline ring, a 1,2-dihydro pyridine ring, a 1,2-dihydroquinoline ring, a 1,2-dihydroquinazoline ring and a 1,2-dihydroquinoxaline ring, more preferred are an indoline ring, a benzoimidazoline ring, a benzothiazoline ring and a 1,2-dihydroquinoline ring, particularly preferred is an indoline ring.

The compound of Type 3 will be described below.

In the bond formation of the compound of Type 3, a bond of carbon-carbon, carbon-nitrogen, carbon-sulfur, carbon-oxygen, etc. is formed.

It is preferable that the one-electron oxidation product releases 1 or more electron after an intramolecular bond-forming reaction between the one-electron-oxidized portion and a reactive group portion such as a carbon-carbon double bond, a carbon-carbon triple bond, an aromatic group and a benzo-condensed, nonaromatic heterocyclic group.

In more detail, the compound of Type 3 is one-electron-oxidized to provide the one-electron oxidation product (a cation radical or a neutral radical provided by eliminating a proton therefrom), and the one-electron oxidation product intramolecularly reacts with the reactive group to form a bond, thereby generating another radical having a ring structure. Another electron is released from the radical directly or along with elimination of a proton.

Thus-provided 2-electron oxidation product may be subjected to hydrolysis or tautomerization reaction with proton shift, and then may release further 1 or more, generally 2 or more electrons. The 2-electron oxidation product may directly release further 1 or more, generally 2 or more electrons without the tautomerization reaction.

The compound of Type 3 is preferably represented by the following formula (D).

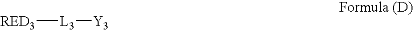

In the formula (D), RED₃ represents a reducing group that can be one-electron-oxidized, and Y₃ represents a reactive group that reacts with the one-electron-oxidized RED₃, specifically an organic group containing a carbon-carbon double bond, a carbon-carbon triple bond, an aromatic group or a benzo-condensed, nonaromatic heterocyclic group. L₃ represents a linking group that connects RED₃ and Y₃.

RED₃ has the same meanings as RED12 in the formula (B). RED₃ is preferably an arylamino group, a heterocyclic amino group, an aryloxy group, an arylthio group, an aryl group, or an aromatic or nonaromatic heterocyclic group (particularly a nitrogen-containing heterocyclic group). RED₃ is more preferably an arylamino group, a heterocyclic amino group, an aryl group, or an aromatic or nonaromatic heterocyclic group. Preferred as the heterocyclic group are a tetrahydroquinoline ring group, a tetrahydroquinoxaline ring group, a tetrahydroquinazoline ring group, an indoline ring group, an indole ring group, a carbazole ring group, a phenoxazine ring group, a phenothiazine ring group, a benzothiazoline ring group, a pyrrole ring group, an imidazole ring group, a thiazole ring group, a benzoimidazole ring group, a benzoimidazoline ring group, a benzothiazoline ring group, a 3,4-methylenedioxyphenyl-1-yl group, etc.

Particularly preferred as RED₃ are an arylamino group (particularly an anilino group), an aryl group (particularly a phenyl group), and an aromatic or nonaromatic heterocyclic group.

The aryl group represented by RED₃ preferably has at least one electron-donating group. The electron-donating group is the same as described above.

When RED₃ is an aryl group, a substituent on the aryl group is more preferably an alkylamino group, a hydroxy group, an alkoxy group, a mercapto group, a sulfoneamide group, an active methine group, and a nitrogen-containing, or nonaromatic heterocyclic group that substitutes at the nitrogen atom, furthermore preferably an alkylamino group, a hydroxy group, an active methine group, or a nitrogen-containing, nonaromatic heterocyclic group that substitutes at the nitrogen atom, and the most preferably an alkylamino group or a nitrogen-containing, nonaromatic heterocyclic group that substitutes at the nitrogen atom.

When an organic group containing a carbon-carbon double bond (such as a vinyl group) represented by Y₃ has a substituent, the substituent is preferably an alkyl group, a phenyl group, an acyl group, a cyano group, an alkoxycarbonyl group, a carbamoyl group, an electron-donating group, etc. The electron-donating group is preferably an alkoxy group; a hydroxy group, which may be protected by a silyl group, such as a trimethylsilyloxy group, a t-butyldimethylsilyloxy group, a triphenylsilyloxy group, a triethylsilyloxy group and a phenyldimethylsilyloxy group; an amino group; an alkylamino group; an arylamino group; a sulfoneamide group; an active methine group; a mercapto group; an alkylthio group; or a phenyl group having a substituent composed thereof.

Incidentally, when the organic group containing the carbon-carbon double bond has a hydroxy group as a substituent, Y₃ contains a moiety of >C₁═C₂(—OH)—, which may be tautomerized into a moiety of >C₁H—C₂(═O)—. In this case, it is preferred that a substituent on the C₁ carbon is an electron-withdrawing group, and as a result, Y₃ has a moiety of an active methylene group or an active methine group. The electron-withdrawing group, which can provide such a moiety of an active methylene group or an active methine group, may be the same as above-mentioned electron-withdrawing group on the methine group of the active methine group.

When an organic group containing a carbon-carbon triple bond such as an ethynyl group represented by Y₃ has a substituent, preferred as the substituent are an alkyl group, a phenyl group, an alkoxycarbonyl group, a carbamoyl group, an electron-donating group, etc.

When Y₃ is an organic group containing an aromatic group, preferred as the aromatic group are an aryl group (particularly a phenyl group) having an electron-donating group as a substituent, and an indole ring group. The electron-donating group is preferably a hydroxy group that may be protected by a silyl group, an alkoxy group, an amino group, an alkylamino group, an active methine group, a sulfoneamide group, or a mercapto group.

When Y₃ is an organic group containing a benzo-condensed, nonaromatic heterocyclic group, preferred as the benzo-condensed, nonaromatic heterocyclic group are groups having an aniline moiety, such as an indoline ring group, a 1,2,3,4-tetrahydroquinoline ring group, a 1,2,3,4-tetrahydroquinoxaline ring group and a 4-quinolone ring group.

The reactive group of Y₃ is more preferably an organic group containing a carbon-carbon double bond, an aromatic group, or a benzo-condensed, nonaromatic heterocyclic group. The reactive group is furthermore preferably a phenyl group having a carbon-carbon double bond or an electron-donating group as a substituent; an indole ring group; or a benzo-condensed, nonaromatic heterocyclic group having an aniline moiety. The carbon-carbon double bond more preferably has at least one electron-donating group as a substituent.

It is also preferred that the reactive group represented by Y₃ in the formula (D) contains a moiety equal to the reducing group represented by RED₃ as a result of selecting the reactive group as above.

L₃ represents a linking group that connects RED₃ and Y₃, specifically a single bond, an alkylene group, an arylene group, a heterocyclic group, —O—, —S—, —NR_{N}—, —C(═O)—, —SO₂—, —SO—, —P(═O)—, or a combination thereof. R_{N} represents a hydrogen atom, an alkyl group, an aryl group or a heterocyclic group. The linking group represented by L₃ may have a substituent. The linking group represented by L₃ may bond to each of RED₃ and Y₃ at an optional position such that the linking group substitutes optional 1 hydrogen atom of each RED₃ and Y₃.

Preferred examples of L₃ include a single bond; alkylene groups, particularly a methylene group, an ethylene group and a propylene group; arylene groups, particularly a phenylene group; a —C(═O)— group; an —O— group; an —NH— group; an —N(alkyl)— groups; and divalent linking groups of combinations thereof.

It is preferred that a cation radical (X⁺.) provided by oxidizing RED₃ or a radical (X.) provided by eliminating a proton therefrom reacts with the reactive group represented by L₃ to form a bond, to form a 3 to 7-membered ring structure containing the linking group represented by L₃. Thus, the radical (X⁺. or X.), the reactive group of Y, and L are preferably connected though 3 to 7 atoms.

Next, the compound of Type 4 will be described below.

The compound of Type 4 has a reducing group-substituted ring structure. After the reducing group is one-electron-oxidized, the compound can release further 1 or more electron with a ring structure cleavage reaction. The ring cleavage reaction proceeds as follows.

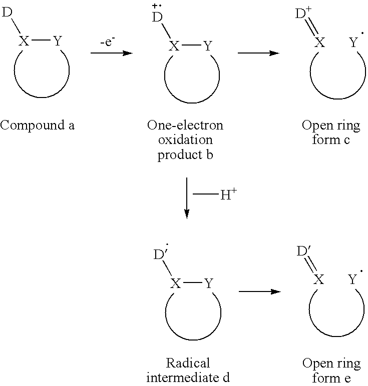

In the formula, Compound a is the compound of Type 4. In Compound a, D represents a reducing group, and X and Y each represent an atom forming a bond in the ring structure, which is cleaved after the one-electron oxidation. First, Compound a is one-electron-oxidized to generate One-electron oxidation product b. Then, the X—Y bond is cleaved with conversion of the D—X single bond into a double bond, whereby Decyclization derivative c is provided. Alternatively, there is a case where One-electron oxidation product b is converted into Radical intermediate d along with deprotonation, and Decyclization derivative e is provided in the same manner. Subsequently, further 1 or more electron is released from thus-provided Decyclization derivative c or e.

The ring structure in the compound of Type 4 is a 3 to 7-membered, carbocyclic or heterocyclic, monocyclic or condensed, saturated or unsaturated, nonaromatic ring. The ring structure is preferably a saturated ring structure, more preferably 3- or 4-membered ring. Preferred examples of such ring structures include a cyclopropane ring, a cyclobutane ring, an oxirane ring, an oxetane ring, an aziridine ring, an azetidine ring, an episulphide ring and a thietane ring. More preferred are a cyclopropane ring, a cyclobutane ring, an oxirane ring, an oxetane ring and an azetidine ring, particularly preferred are a cyclopropane ring, a cyclobutane ring and an azetidine ring. The ring structure may have a substituent.

The compound of Type 4 is preferably represented by the following formula (E) or (F).

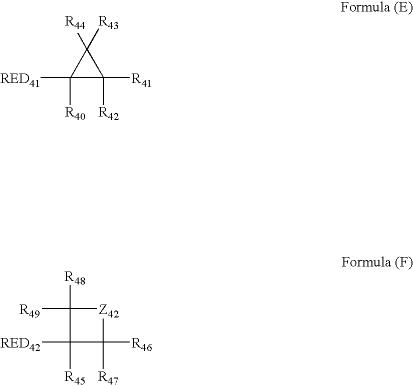

In the formulae (E) and (F), RED₄₁ and RED₄₂ are the same as RED₁₂ in the formula (B) with respect to the meanings and preferred embodiments, respectively. R₄₀ to R₄₄ and R₄₅ to R₄₉ each represent a hydrogen atom or a substituent. In the formula (F), Z₄₂ represents —CR₄₂₀R₄₂₁—, —NR₄₂₃—, or —O—. R₄₂₀ and R₄₂₁ each represent a hydrogen atom or a substituent, and R₄₂₃ represents a hydrogen atom, an alkyl group, an aryl group or a heterocyclic group.

In the formulae (E) and (F), each of R₄₀ and R₄₅ is preferably a hydrogen atom, an alkyl group, an aryl group, or a heterocyclic group, more preferably a hydrogen atom, an alkyl group, or an aryl group. Each of R41 to R₄₄ and R₄₆ to R₄₉ is preferably a hydrogen atom, an alkyl group, an alkenyl group, an aryl group, a heterocyclic group, an arylthio group, an alkylthio group, an acylamino group, or a sulfoneamide group, more preferably a hydrogen atom, an alkyl group, an aryl group, or a heterocyclic group.

It is preferred that at least one of R₄₁ to R₄₄ is a donor group, and it is also preferred that both of R₄₁ and R₄₂, or both of R₄₃ and R₄₄ are an electron-withdrawing group. It is more preferred that at least one of R₄₁ to R₄₄ is a donor group. It is furthermore preferred that at least one of R₄₁ to R₄₄ is a donor group and R₄₁ to R44 other than the donor group are selected from a hydrogen atom and alkyl groups.

The donor group is an electron-donating group, or an aryl group having at least one electron-donating group. The donor group is preferably an alkylamino group; an arylamino group; a heterocyclic amino group; an electron-excess, 5-membered, monocyclic or condensed, aromatic heterocyclic group having at least one nitrogen atom in the ring; a nitrogen-containing, nonaromatic heterocyclic group that substitutes at the nitrogen atom; or a phenyl group having at least one electron-donating group as a substituent. The donor group is more preferably an alkylamino group; an arylamino group; an electron-excess, 5-membered, monocyclic or condensed, aromatic heterocyclic group having at least one nitrogen atom in the ring, wherein the aromatic heterocycle is an indole ring, a pyrrole ring or a carbazole ring; or a phenyl group having an electron-donating group as a substituent, such as phenyl groups having 3 or more alkoxy groups and phenyl groups having a hydroxy group or an alkylamino group or an arylamino group. The donor group is particularly preferably an arylamino group; an electron-excess, 5-membered, monocyclic or condensed, aromatic heterocyclic group having at least one nitrogen atom in the ring, particularly a 3-indolyl group; or a phenyl group having an electron-donating group as a substituent, particularly a phenyl group having a trialkoxyphenyl group, an alkylamino group or an arylamino group.

Z₄₂ is preferably —CR₄₂₀R₄₂₁— or —NR₄₂₃—, more preferably —NR₄₂₃—. Each of R₄₂₀ and R₄₂₁ is preferably a hydrogen atom, an alkyl group, an aryl group, a heterocyclic group, an acylamino group, or a sulfoneamino group, more preferably a hydrogen atom, an alkyl group, an aryl group, or a heterocyclic group. R₄₂₃ is preferably a hydrogen atom, an alkyl group, an aryl group or an aromatic heterocyclic group, more preferably a hydrogen atom, an alkyl group, or an aryl group.

The substituent represented by each of R₄₀ to R₄₉, R₄₂₀, R₄₂₁ and R₄₂₃ preferably has 40 or less carbon atoms, more preferably has 30 or less carbon atoms, particularly preferably 15 or less carbon atoms. The substituents of R₄₀ to R₄₉, R₄₂₀, R₄₂₁ and R₄₂₃ may bond to each other or to the other portion such as RED₄₁, RED₄₂ and Z₄₂, to form a ring.

In the compounds of Types 1 to 4 used in the invention, the adsorbent group to the silver halide is such a group that is directly adsorbed on the silver halide or promotes adsorption of the compound onto the silver halide. Specifically, the adsorbent group is a mercapto group or a salt thereof; a thione group (—C(═S)—); a heterocyclic group containing at least one atom selected from the group consisting of a nitrogen atom, a sulfur atom, a selenium atom and a tellurium atom; a sulfide group; a cationic group; or an ethynyl group. Incidentally, the adsorbent group in the compound of Type 2 is not a sulfide group.

The mercapto group or a salt thereof used as the adsorbent group may be a mercapto group or a salt thereof itself, and is more preferably a heterocyclic group, an aryl group or an alkyl group having at least one mercapto group or a salt thereof as a substituent. The heterocyclic group is a 5- to 7-membered, monocyclic or condensed, aromatic or nonaromatic, heterocyclic group. Examples thereof include an imidazole ring group, a thiazole ring group, an oxazole ring group, a benzimidazole ring group, a benzthiazole ring group, a benzoxazole ring group, a triazole ring group, a thiadiazole ring group, an oxadiazole ring group, a tetrazole ring group, a purine ring group, a pyridine ring group, a quinoline ring group, an isoquinoline ring group, a pyrimidine ring group, a triazine ring group, etc. The heterocyclic group may contain a quaternary nitrogen atom, and in this case, the mercapto group bonding to the heterocyclic group may be dissociated into a mesoion. Such heterocyclic group may be an imidazolium ring group, a pyrazolium ring group, a thiazolium ring group, a triazolium ring group, a tetrazolium ring group, a thiadiazolium ring group, a pyridinium ring group, a pyrimidinium ring group, a triazinium ring group, etc. Preferred among them are triazolium ring groups such as a 1,2,4-triazolium-3-thiolate ring group. Examples of the aryl groups include a phenyl group and a naphthyl group. Examples of the alkyl groups include straight, branched or cyclic alkyl groups having 1 to 30 carbon atom. When the mercapto group forms a salt, a counter ion of the salt may be a cation of an alkaline metal, an alkaline earth metal, a heavy metal, etc. such as Li⁺, Na⁺, K³⁰ , Mg²⁺, Ag⁺ and Zn²⁺; an ammonium ion; a heterocyclic group containing a quaternary nitrogen atom; a phosphonium ion; etc.

Further, the mercapto group used as the adsorbent group may be tautomerized into a thione group. Specific examples of the thione groups include a thioamide group (herein a —C(═S)—NH— group); and groups containing a structure of the thioamide group, such as linear or cyclic thioamide groups, a thiouredide group, a thiourethane group and a dithiocarbamic acid ester group. Examples of such cyclic thioamide groups include a thiazolidine-2-thione group, an oxazolidine-2-thione group, a 2-thiohydantoin group, a rhodanine group, an isorhodanine group, a thiobarbituric acid group, a 2-thioxo-oxazolidine-4-one group, etc.

The thione group used as the adsorbent group, as well as the thione group derived from the mercapto group by tautomerization, may be a linear or cyclic, thioamide, thiouredide, thiourethane or dithiocarbamic acid ester group that cannot be tautomerized into the mercapto group or has no hydrogen atom at α-position of the thione group.

The heterocyclic group containing at least one atom selected from the group consisting of a nitrogen atom, a sulfur atom, a selenium atom and tellurium atom, which is used as the adsorbent group, is a nitrogen-containing heterocyclic group having an —NH— group that can form a silver imide (>NAg) as a moiety of the heterocycle; or a heterocyclic group having an —S— group, an —Se— group, a —Te— group or an ═N— group, which can form a coordinate bond with a silver ion, as a moiety of the heterocycle. Examples of the former include a benzotriazole group, a triazole group, an indazole group, a pyrazole group, a tetrazole group, a benzimidazole group, an imidazole group, a purine group, etc. Examples of the latter include a thiophene group, a thiazole group, an oxazole group, a benzothiazole group, a benzoxazole group, a thiadiazole group, an oxadiazole group, a triazine group, a selenazole group, a benzselenazole group, a tellurazole group, a benztellurazole group, etc. The former is preferable.

The sulfide group used as the adsorbent group may be any group with an —S— moiety, and preferably has a moiety of alkyl or alkylene—S—alkyl or alkylene; aryl or arylene—S—alkyl or alkylene; or aryl or arylene—S—aryl or arylene. The sulfide group may form a ring structure, and may have an —S—S— group. Specific examples of the ring structures include groups with a thiolane ring, a 1,3-dithiolane ring, a 1,2-dithiolane ring, a thiane ring, a dithiane ring, a tetrahydro- 1,4-thiazine ring (a thiomorpholine ring), etc. Particularly preferred as the sulfide group are groups having a moiety of alkyl or alkylene—S—alkyl or alkylene.

The cationic group used as the adsorbent group is a quaternary nitrogen-containing group, specifically a group with an ammonio group or a quaternary nitrogen-containing heterocyclic group. Incidentally, there is no case where the cationic group partly composes an atomic group forming a dye structure, such as a cyanine chromophoric group. The ammonio group may be a trialkylammonio group, a dialkylarylammonio group, an alkyldiarylammonio group, etc., and examples thereof include a benzyldimethylammonio group, a trihexylammonio group, a phenyldiethylammonio group, etc. Examples of the quaternary nitrogen-containing heterocyclic groups include a pyridinio group, a quinolinio group, an isoquinolinio group, an imidazolio group, etc. Preferred among them are a pyridinio group and an imidazolio group, and particularly preferred is a pyridinio group. The quaternary nitrogen-containing heterocyclic group may have an optional substituent. Preferred examples of the substituents on the pyridinio group and the imidazolio group include alkyl groups, aryl groups, acylamino groups, a chlorine atom, alkoxycarbonyl groups and carbamoyl groups. The substituent on the pyridinio group is particularly preferably a phenyl group.

The ethynyl group used as the adsorbent group means a —C≡CH group, in which the hydrogen atom may be substituted.

The above-mentioned adsorbent groups may have an optional substituent.

Specific examples of the adsorbent groups further include ones described in pages 4 to 7 of a specification of JP-A No. 11-95355.

Preferred as the adsorbent group used in the invention are mercapto-substituted, nitrogen-containing, heterocyclic groups such as a 2-mercaptothiadiazole group, a 3-mercapto-1,2,4-triazole group, a 5-mercaptotetrazole group, a 2-mercapto-1,3,4-oxadiazole group, a 2-mercaptobenzoxazole group, a 2-mercaptobenzthiazole group and a 1,5-dimethyl-1,2,4-triazolium-3-thiolate group; and nitrogen-containing heterocyclic groups having an —NH— group that can form a silver imide (>NAg) as a moiety of the heterocycle, such as a benzotriazole group, a benzimidazole group and an indazole group. Particularly preferred as the adsorbent group are a 5-mercaptotetrazole group, a 3-mercapto-1,2,4-triazole group and a benzotriazole group, and the most preferred are a 3-mercapto-1,2,4-triazole group and a 5-mercaptotetrazole group.

It is particularly preferred that the compound used in the invention has 2 or more mercapto group as a moiety. The mercapto group (—SH) may be converted into a thione group in the case where it can be tautomerized. The compound may have 2 or more adsorbent groups containing above-mentioned mercapto or thione group as a moiety, such as a cyclic thioamide group, an alkylmercapto group, an arylmercapto group and a heterocyclic mercapto group. Further, the compound may have 1 or more adsorbent group containing 2 or more mercapto or thione groups as a moiety, such as a dimercapto-substituted, nitrogen-containing, heterocyclic group.

Examples of the adsorbent groups containing 2 or more mercapto groups, such as a dimercapto-substituted, nitrogen-containing, heterocyclic group, include a 2,4-dimercaptopyrimidine group, a 2,4-dimercaptotriazine group, a 3,5-dimercapto-1,2,4-triazole group, a 2,5-dimercapto-1,3-thiazole group, a 2,5-dimercapto-1,3-oxazole group, a 2,7-dimercapto-5-methyl-s-triazolo(1,5-A)-pyrimidine group, a 2,6,8-trimercaptopurine group, a 6,8-dimercaptopurine group, a 3,5,7-trimercapto-s-triazolotriazine group, a 4,6-dimercaptopyrazolo pyrimidine group, a 2,5-dimercapto-imidazole group, etc. Particularly preferred are a 2,4-dimercaptopyrimidine group, a 2,4-dimercaptotriazine group, and a 3,5-dimercapto-1,2,4-triazole group.

The adsorbent group may be connected to any position of the compound represented by each of the formulae (A) to (F) and (i) to (iii). Preferred portions, which the adsorbent group bonds to, are RED₁₁, RED₁₂, RED₂ and RED₃ in the formulae (A) to (D); RED₄₁, R₄₁, RED₄₂, and R₄₆ to R₄₈ in the formulae (E) and (F); and optional portions other than R₁, R₂, R₁₁, R₁₂, R₃₁, L₁, L₂₁ and L₃₁ in the formulae (i) to (iii). Further, more preferred portions are RED₁₁ to RED₄₂ in the formulae (A) to (F).

The spectrally sensitizing dye moiety is a group containing a spectrally sensitizing dye chromophore, which is a residual group provided by removing an optional hydrogen atom or substituent from a spectrally sensitizing dye compound. The spectrally sensitizing dye moiety may be connected to any position of the compound represented by each of the formulae (A) to (F) and (i) to (iii). Preferred portion, which the spectrally sensitizing dye moiety bonds to, are RED₁₁, RED₁₂, RED₂ and RED₃ in the formulae (A) to (D); RED₄₁, R₄₁, RED₄₂, and R₄₆ to R₄₈ in the formulae (E) and (F); and optional portions other than R₁, R₂, R₁₁, R₁₂, R₃₁, L₁, L₂₁ and L₃₁ in the formulae (i) to (iii). Further, more preferred portions are RED₁₁ to RED₄₂ in the formulae (A) to (F). The spectrally sensitizing dye is preferably such that typically used in color sensitizing techniques, and examples thereof include cyanine dyes, composite cyanine dyes, merocyanine dyes, composite merocyanine dyes, homopolar cyanine dyes, styryl dyes, and hemicyanine dyes. Typical spectrally sensitizing dyes are disclosed in Research Disclosure, Item 36544, September 1994. The dyes can be synthesized by one skilled in the art according to procedures described in the above Research Disclosure and F. M. Hamer, The Cyanine dyes and Related Compounds, Interscience Publishers, New York, 1964. Further, dyes described in pages 7 to 14 of a specification of JP-A No. 11-95355 (U.S. Pat. No. 6,054,260) may be used in the invention.

The total number of carbon atoms in the compounds of Types 1 to 4 is preferably 10 to 60, more preferably 15 to 50, furthermore preferably 18 to 40, particularly preferably 18 to 30.

When a silver halide photosensitive material using the compounds of Types 1 to 4 is exposed, the compound is one-electron-oxidized. After the subsequent reaction, the compound is further oxidized while releasing 1 or more electron, or 2 or more electrons depending on Type. An oxidation potential in the first one-electron oxidation is preferably 1.4 V or less, more preferably 1.0 V or less. This oxidation potential is preferably higher than 0 V, more preferably higher than 0.3 V. Thus, the oxidation potential is preferably approximately 0 to 1.4 V, more preferably approximately 0.3 to 1.0 V.

The oxidation potential may be measured by a cyclic voltammetry technique. Specifically, a sample is dissolved in a solution of acetonitrile/water=80/20 volume % (containing 0.1 M lithium perchlorate), nitrogen gas is passed through the resultant solution for 10 minutes, and then the oxidation potential is measured at 25° C. at a potential scanning rate of 0.1 V/second by using a glassy carbon disk as a working electrode, using a platinum wire as a counter electrode, and using a calomel electrode (SCE) as a reference electrode. The oxidation potential per SCE is obtained at peak potential of cyclic voltammetric curve.

In the case where the compound of Types 1 to 4 is one-electron-oxidized and release further 1 electron after the subsequent reaction, an oxidation potential in the subsequent oxidation is preferably −0.5 to −2 V, more preferably −0.7 to −2 V, furthermore preferably −0.9 to −1.6 V.

In the case where the compound of Types 1 to 4 is one-electron-oxidized and release further 2 or more electrons after the subsequent reaction, oxidation potentials in the subsequent oxidation are not particularly limited. The oxidation potentials in the subsequent oxidation often cannot be measured precisely, because the oxidation potential in releasing the second electron cannot be clearly differentiated from the oxidation potential in releasing the third or later electron.

Next, the compound of Type 5 will be described.

The compound of Type 5 is represented by X—Y, in which X represents a reducing group and Y represents a leaving group. The reducing group represented by X can be one-electron-oxidized to provide a one-electron oxidation product, which can be converted into an X radical by eliminating the leaving group Y with a subsequent X—Y bond cleavage reaction. The X radical can further release 1 electron. The oxidation reaction of the compound of Type 5 may be represented by the following formula.

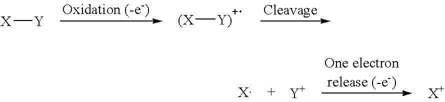

The compound of Type 5 exhibits an oxidation potential of preferably 0 to 1.4 V, more preferably 0.3 to 1.0 V. The radical X. provided in the formula exhibits an oxidation potential of preferably −0.7 to −2.0 V, more preferably −0.9 to −1.6 V.

The compound of Type 5 is preferably represented by the following formula (G).

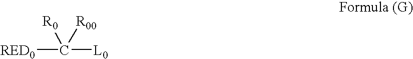

In the formula (G), RED₀ represents a reducing group, L₀ represents a leaving group, and R₀ and R₀₀ each represent a hydrogen atom or a substituent. RED₀ and R₀, and R₀ and R₀₀ may be bond together to form a ring structure, respectively. RED₀ is the same as RED₂ in the formula (C) with respect to the meanings and preferred embodiments. R₀ and R₀₀ are the same as R₂₁ and R22 in the formula (C) with respect to the meanings and preferred embodiments, respectively. Incidentally, R₀ and R₀₀ are not the same as the leaving group of L₀ respectively, except for a hydrogen atom. RED₀ and R₀ may bond together to form a ring structure with examples and preferred embodiments the same as those of the ring structure formed by bonding RED₂ and R₂₁ in the formula (C). Examples of the ring structure formed by R₀ and R₀₀ include a cyclopentane ring, a tetrahydrofuran ring, etc. In the formula (G), L₀ is the same as L₂ in the formula (C) with respect to the meanings and preferred embodiments.

The compound represented by the formula (G) preferably has an adsorbent group to the silver halide, or a spectrally sensitizing dye moiety. However, the compound does not have 2 or more adsorbent groups when L₀ is a group other than a silyl group. Incidentally, the compound may have 2 or more sulfide groups as the adsorbent groups, not depending on L₀.

The adsorbent groups to the silver halide in the compound represented by the formula (G) may be the same as those in the compounds of Types 1 to 4. Further, examples of the adsorbent groups in the compound represented by the formula (G) include ones described as “silver halide adsorbent groups” in pages 4 to 7 of the specification of JP-A No. 11-95355, and the preferred embodiment thereof described in the specification may be applied to the invention.

The spectrally sensitizing dye moiety in the compound represented by the formula (G) is the same as in the compounds of Types 1 to 4. Examples of the spectrally sensitizing dye moieties in the compound represented by the formula (G) include ones described as “light absorbing groups” in pages 7 to 14 of the specification of JP-A No. 11-95355, and the preferred embodiment thereof described in the specification may be applied to the invention.

Specific examples of the compounds of Types 1 to 5 are illustrated below without intention of restricting the scope of the invention.

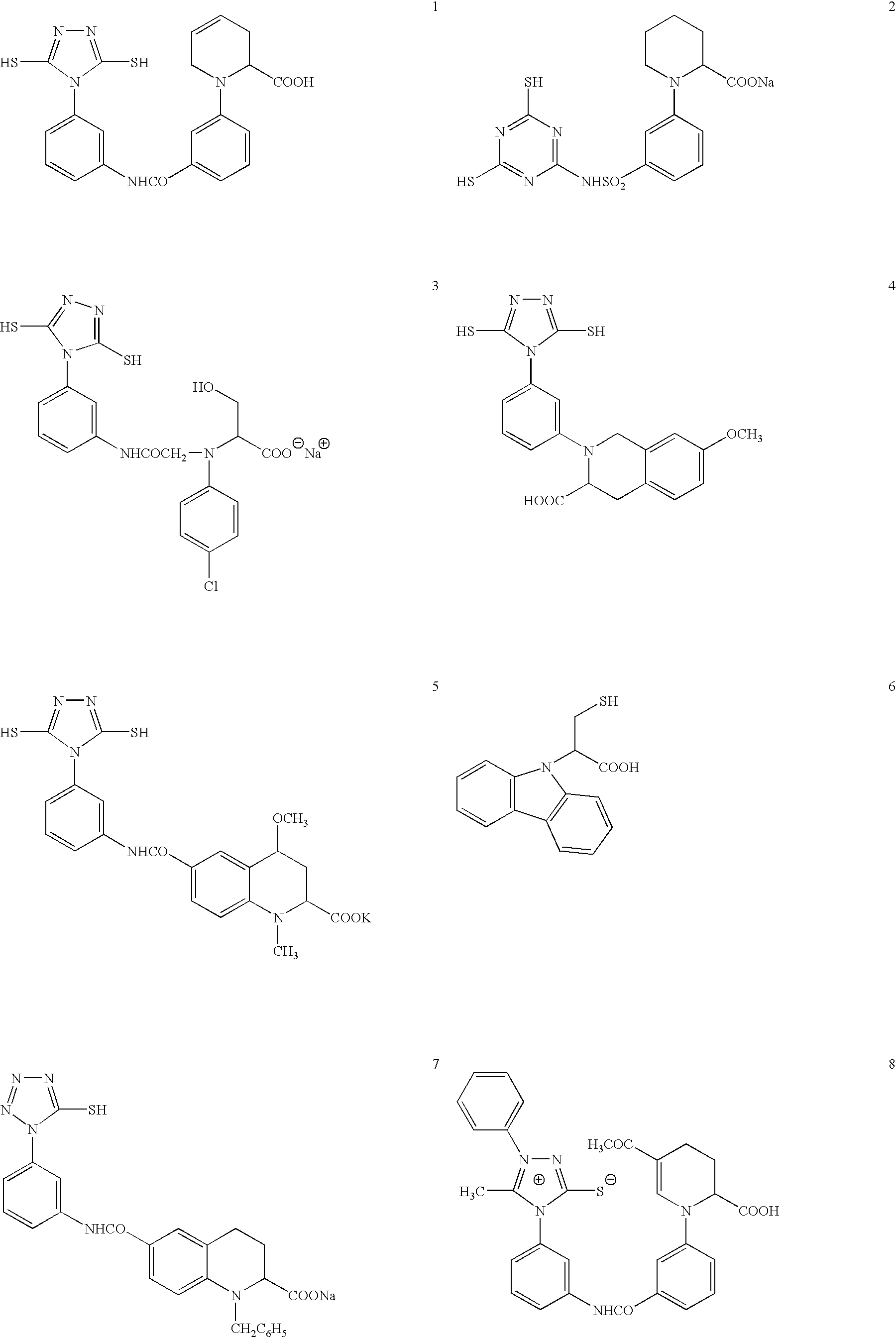

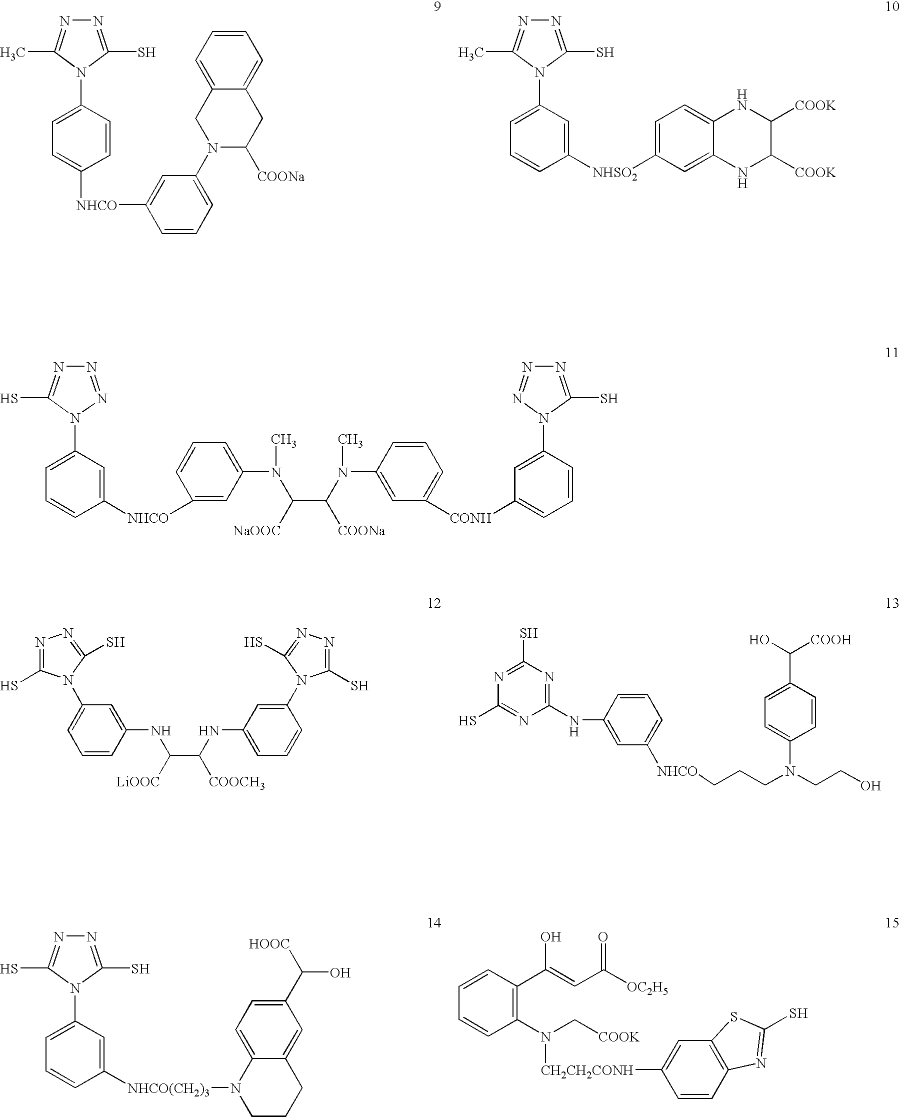

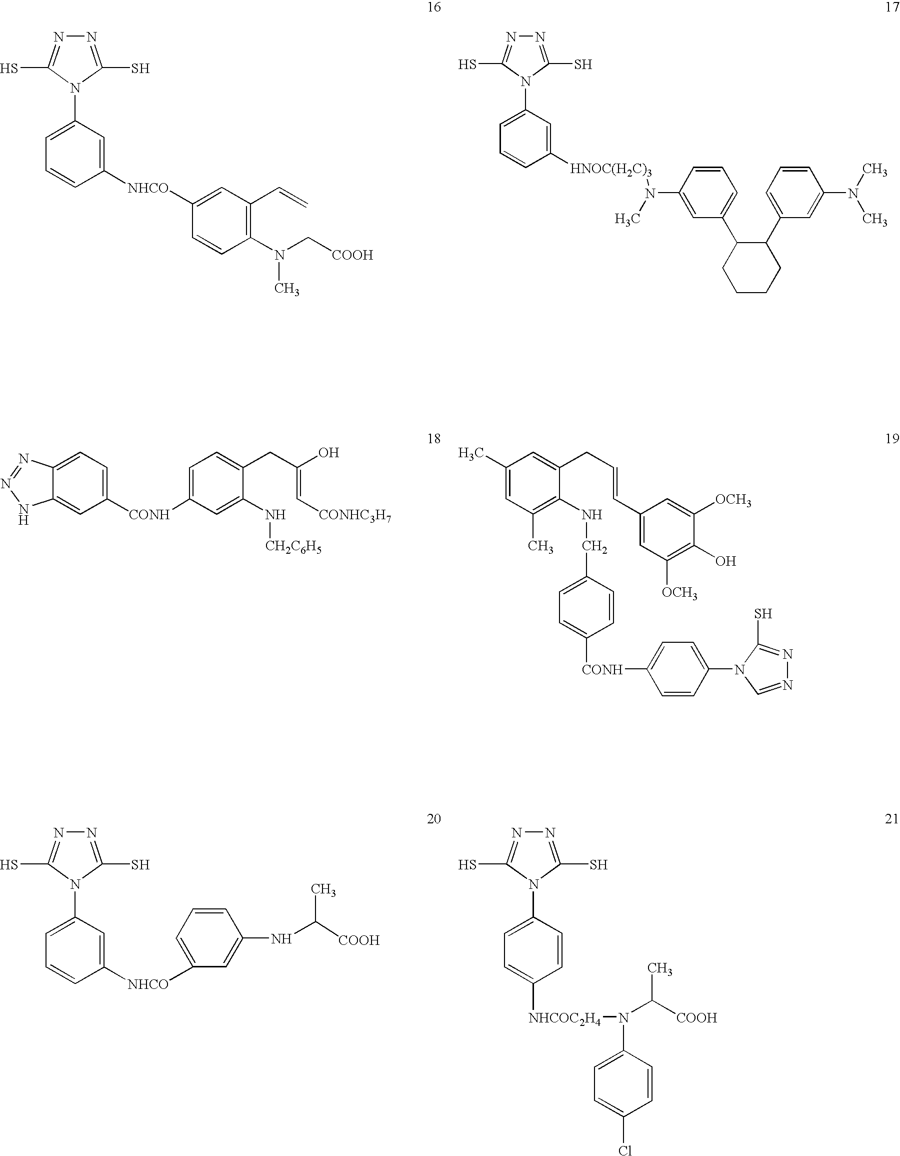

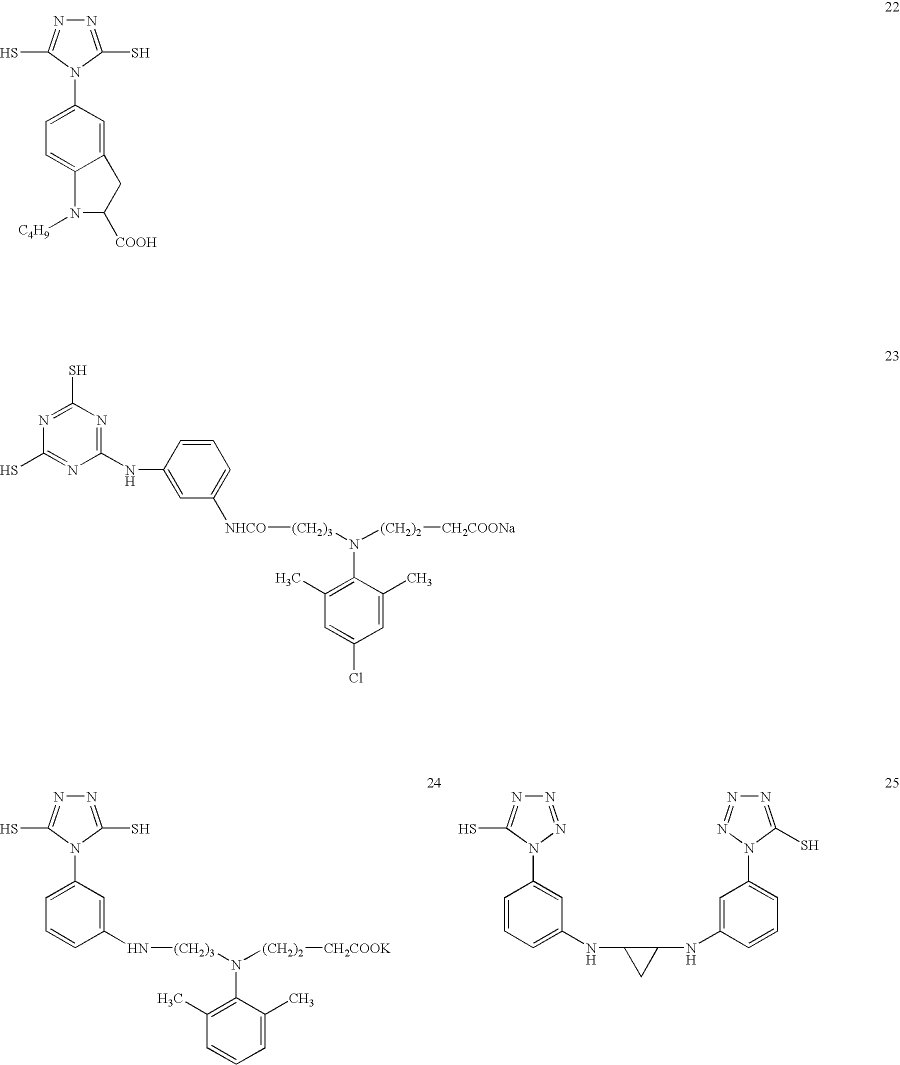

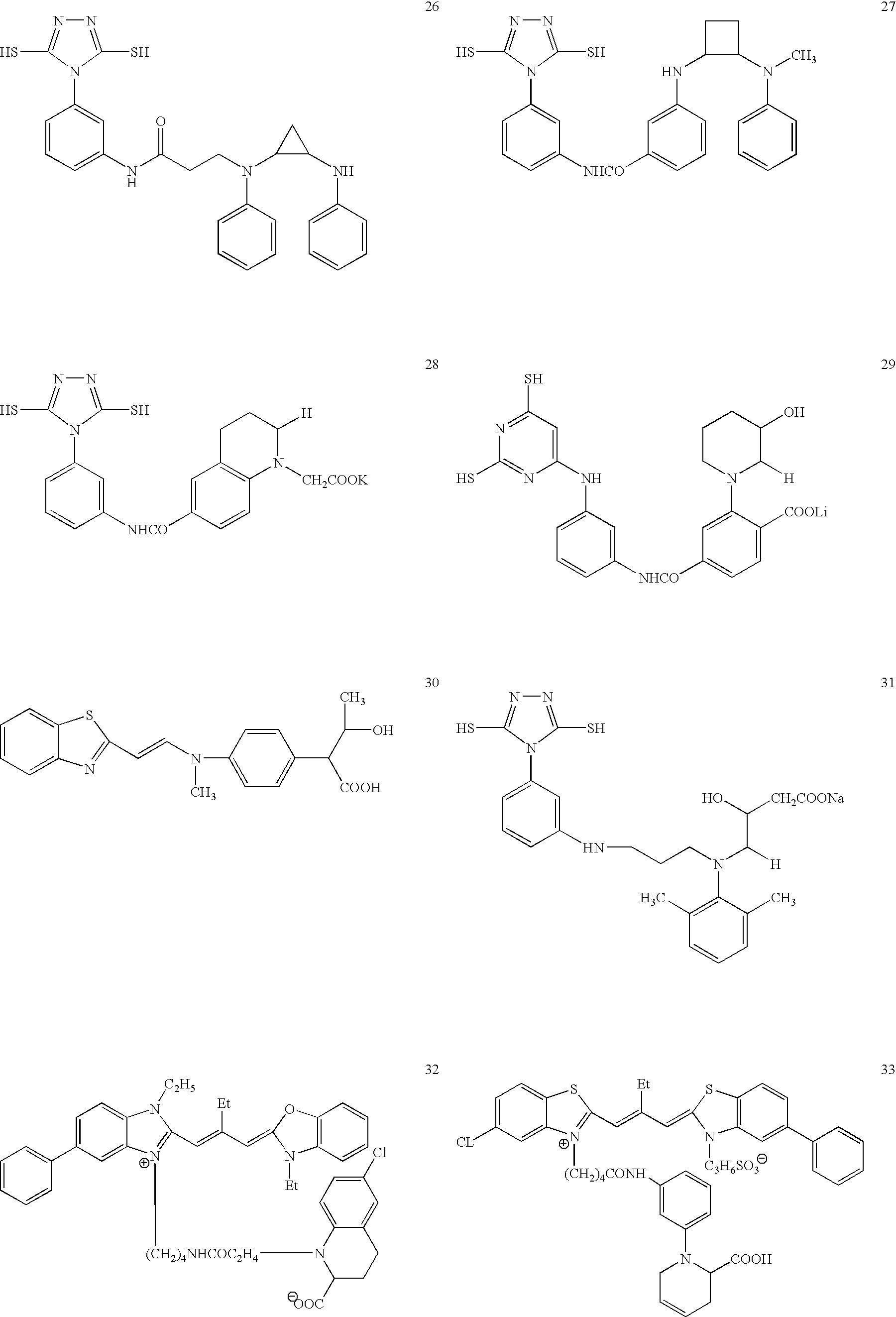

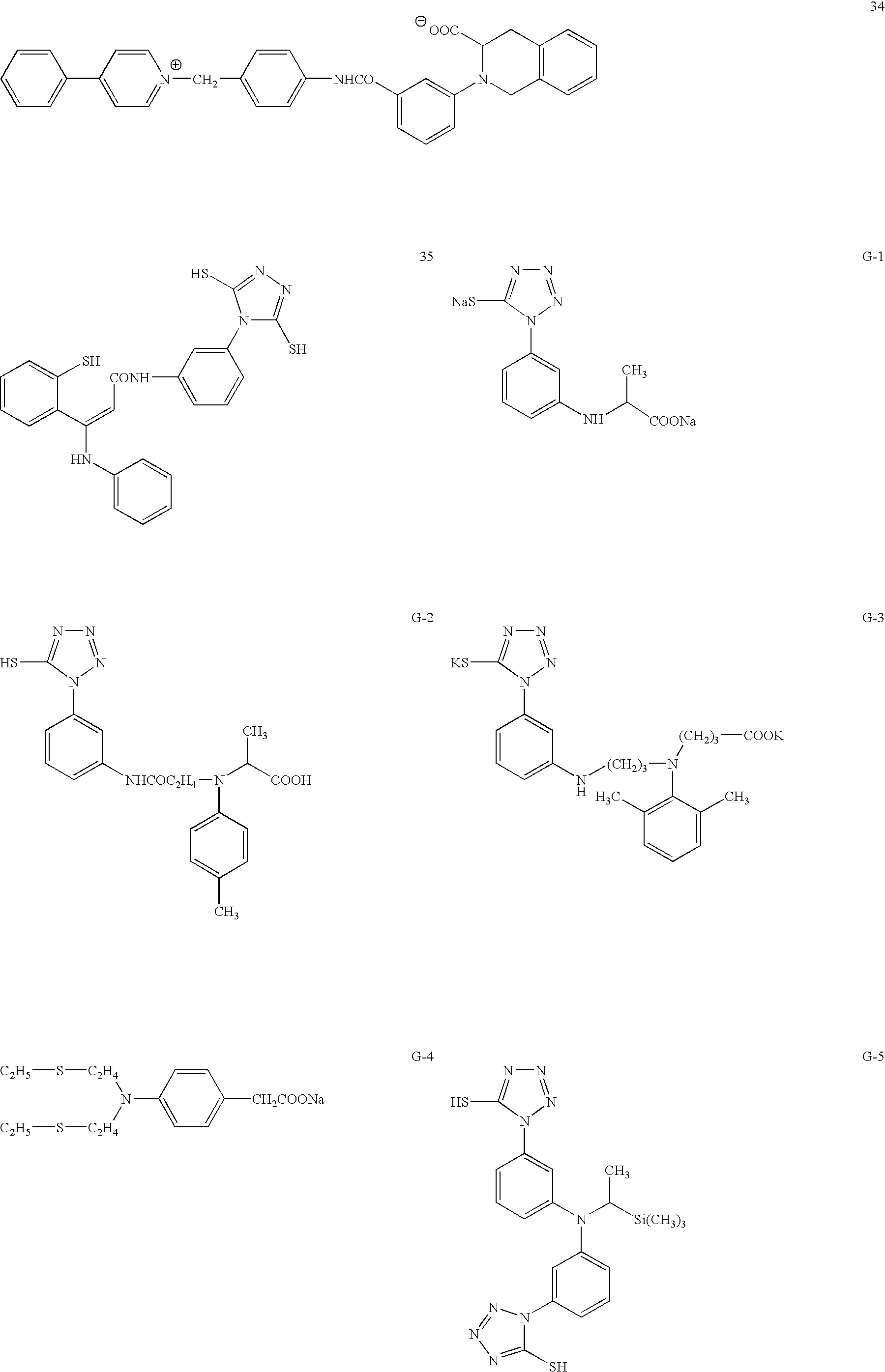

The compounds of Types 1 to 4 used in the invention are the same as compounds described in detail in JP-A Nos. 2003-114487, 2003-114486, 2003-140287, 2003-75950 and 2003-114488. Specific examples of the compounds of Types 1 to 4 further include example compounds described in these patent specifications. Further, synthesis examples of the compounds of Types 1 to 4 may be the same as described in these patent specifications.

Specific examples of the compounds of Type 5 further include compounds described as “one-photon two-electron sensitizer” or “deprotonating electron donating sensitizer” in JP-A Nos. 9-211769 (Compounds PMT-1 to S-37 described in Tables E and F in pages 28 to 32), 9-211774 and 11-95355 (Compounds INV 1 to 36); JP-W No. 2001-500996 (Compounds 1 to 74, 80 to 87, and 92 to 122); U.S. Pat. Nos. 5,747,235 and 5,747,236; EP Nos. 786692A1 (Compounds INV 1 to 35) and 893732A1; U.S. Pat. Nos. 6,054,260 and 5,994,051, etc.

The compounds of Types 1 to 5 may be used at any time during preparation of the photosensitive silver halide emulsion and production of the photothermographic material. For example, the compound may be used, in a photosensitive silver halide grains-forming step, in a desalination step, in a chemical sensitization step, before application, etc. The compound may be added in plural times, in these steps. The compound is preferably added, after the photosensitive silver halide grains-forming step and before the desalination step; in the chemical sensitization step (just before the chemical sensitization to immediately after the chemical sensitization); or before the application. The compound is more preferably added, from the chemical sensitization step to before mixing with the non-photosensitive organic silver salt.

It is preferred that the compounds of Types 1 to 5 used in the invention are dissolved in water, a water-soluble solvent such as methanol and ethanol, or a mixed solvent thereof, to be added. When the compound is dissolved in water, the pH value of the solvent may be increased or decreased to dissolve and add the compound in the case where the solubility of the compound is improved by increasing or decreasing the pH value.

The compounds of Types 1 to 5 are preferably added to the emulsion layer comprising the photosensitive silver halide and the non-photosensitive organic silver salt. The compound may be added to a protective layer, an intermediate layer, etc. as well as the emulsion layer, and may be diffused in the application step. The compounds may be added before or after addition of a sensitizing dye. The mol value of the compounds per 1 mol of the silver halide is preferably 1×10⁻⁹ to 5×10⁻¹ mol, more preferably 1×10⁻⁸ to 5×10⁻² mol, in the silver halide emulsion layer.

10) Use of Plural Silver Halides in Combination

A photosensitive silver halide emulsion in a photosensitive material used in the invention may be one kind, or two or more kinds (e.g. having different average particle sizes, different halogen compositions, different crystal habits, different chemical sensitization conditions) may be used in combination. Gradation can be regulated by using a plurality of photosensitive silver halides having the different sensitivities. Examples of the techniques regarding them include those described in JP-A Nos. 57-119341, 53-106125, 47-3929, 48-55730, 46-5187, 50-73627, and 57-150841. It is preferable that a sensitivity difference is 0.2 logE or more in each emulsion.

11) Coating Amount

An amount of photosensitive silver halide to be used is preferably 0.03 to 0.6 g/m², more preferably 0.05 to 0.4 g/m², most preferably 0.07 to 0.3 g/m² in terms of a coating silver amount per 1 m² of a photosensitive material, and photosensitive silver halide is preferably not smaller than 0.01 mol and not larger than 0.5 mol, more preferably not smaller than 0.02 and not larger than 0.3 mol, more preferably not smaller than 0.03 mol and not larger than 0.2 mol.

12) Mixing of Photosensitive Silver Halide and Organic Silver Salt

For a method of mixing separately prepared photosensitive silver halide and organic silver salt and mixing conditions, there are a method of mixing separately having prepared silver halide particle and organic silver salt with a high speed stirrer, a ball mill, a sand mill, a colloid mill, a vibration mill, a homogenizer or the like, and a method of mixing photosensitive silver halide for which preparation has been completed at any timing during preparation of an organic silver salt, but a method is not particularly limited as far as the effect of the invention is sufficiently manifested. In addition, mixing of two or more kinds of organic silver salt water dispersions and two or more kinds of photosensitive silver salt water dispersions is a preferable method for regulating the photographic properties.

13) Mixing of Silver Halide into Coating Solution

A preferable time for adding silver halide in the invention to an image forming layer coating solution is from 180 minutes before coating to immediately before coating, preferably from 60 minutes before to 10 seconds before, and a mixing method and mixing conditions are not particularly limited as far as the effect of the invention is sufficiently manifested. As a specific mixing method, there are a method of mixing in a tank so that an average retention time calculated from an addition flow rate and an amount of a solution to be supplied to a coater becomes a desired time, and a method of employing a static mixer described in Liquid Mixing Technology authored by N. Harnby, M. F. Edwards, A. W. Mienow, translated by Koji TAKAHASHI (published by The Nikkan Kogyo Shimbun, Ltd., 1989), Chapter 8.

### Description of Binder

The binder to be in the image-forming layer in the invention may be polymer of any type, but is preferably transparent or semitransparent and is generally colorless. For it, for example, preferred are natural resins, polymers and copolymers; synthetic resins, polymers and copolymers; and other film-forming media. More concretely, they include, for example, gelatins, rubbers, poly(vinyl alcohols), hydroxyethyl celluloses, cellulose acetates, cellulose acetate butyrates, poly(vinylpyrrolidones), casein, starch, poly(acrylic acids), poly(methyl methacrylates), poly(vinyl chlorides), poly(methacrylic acids), styrene-maleic anhydride copolymers, styrene-acrylonitrile copolymers, styrene-butadiene copolymers, poly(vinylacetals) (e.g., poly(vinylformal), poly(vinylbutyral)), poly(esters), poly(urethanes), phenoxy resins, poly(vinylidene chlorides), poly(epoxides), poly(carbonates), poly(vinyl acetates), poly(olefins), cellulose esters, and poly(amides). The binder may be prepared from water or an organic solvent or an emulsion through microencapsulation.

The glass transition point of the binder to be in the organic silver salt-containing layer in the invention preferably falls between 0C and 80° C. (the binder of the type will be hereinafter referred to as a high-Tg binder), more preferably between 10° C. and 70° C., even more preferably between 15° C. and 60° C.

Tg as referred to herein has the same meaning as that referred to in the description of the back-surface protective layer given hereinabove.

If desired, two or more different types of binders may be combined and used herein. For example, a binder having a glass transition point of 20° C. or higher and a binder having a glass transition point of lower than 20° C. may be combined. In case where at least two polymers that differ in Tg are blended for use herein, it is desirable that the weight-average Tg of the resulting blend falls within the range defined as above.

In the invention, it is desirable that the organic silver salt-containing layer is formed by applying a coating liquid, in which at least 30% by mass of the solvent is water, onto the substrate followed by drying it.

In case where the organic silver salt-containing layer in the invention is formed by using such a coating liquid in which at least 30% by mass of the solvent is water, followed by drying it, and in case where the binder in the organic silver salt-containing layer is soluble or dispersible in an aqueous solvent (watery solvent), especially when the binder in the organic silver salt-containing layer is a polymer latex that has an equilibrium water content at 25° C. and 60% RH of at most 2% by mass, the photothermographic material having the layer of the type enjoys better properties. Most preferably, the binder for use in the invention is so designed that its ionic conductivity is at most 2.5 mS/cm. For preparing the binder of the type, for example, employable is a method of preparing a polymer for the binder followed by purifying it through a functional membrane for fractionation.

The aqueous solvent in which the polymer binder is soluble or dispersible is water or a mixed solvent of water and at most 70% by mass of a water-miscible organic solvent. The water-miscible organic solvent includes, for example, alcohols such as methyl alcohol, ethyl alcohol, propyl alcohol; cellosolves such as methyl cellosolve, ethyl cellosolve, butyl cellosolve; ethyl acetate, and dimethylformamide.

The terminology “aqueous solvent” referred to herein can apply also to polymer systems in which the polymer is not thermodynamically dissolved but is seemingly dispersed.

The “equilibrium water content at 25° C. and 60% RH” referred to herein for polymer latex is represented by the following equation, in which W₁ represents the weight of a polymer in humidity-conditioned equilibrium at 25° C. and 60% RH, and W₀ represents the absolute dry weight of the polymer at 25° C.

Equilibrium water content at 25° C. and 60% RH=[(W₁−W₀)/W₀]×100 (mas. %)

For the details of the definition of water content and the method for measuring it, for example, referred to is Polymer Engineering, Lecture 14, Test Methods for Polymer Materials (by the Polymer Society of Japan, Chijin Shokan Publishing).

Preferably, the equilibrium water content at 25° C. and 60% RH of the binder polymer for use in the invention is at most 2% by mass, more preferably from 0.01 to 1.5% by mass, even more preferably from 0.02 to 1% by mass.

Polymers that serve as the binder in the invention are preferably dispersible in aqueous solvents. Polymer dispersions include, for example, a type of hydrophobic polymer latex with water-insoluble fine polymer particles being dispersed, and a type of molecular or micellar polymer dispersion with polymer molecules or micelles being dispersed. Any of these are usable herein, but preferred are particles dispersed as latex. The particles in the polymer dispersions preferably have a mean particle size falling between 1 and 50000 nm, more preferably between 5 and 1000 nm, even more preferably between 10 and 500 nm, still more preferably between 50 and 200 nm. The particle size distribution of the dispersed polymer particles is not specifically defined. For example, the dispersed polymer particles may have a broad particle size distribution, or may have a particle size distribution of monodispersion. If desired, two or more different types of polymer particle monodispersions may be combined for use herein, and it is desirable for controlling the physical properties of coating liquids.

In preferred embodiments of the photothermographic material of the invention, favorably used are hydrophobic polymers that are dispersible in aqueous solvents. The hydrophobic polymers of the type include, for example, acrylic polymers, poly(esters), rubbers (e.g., SBR resins), poly(urethanes), poly(vinyl chlorides), poly(vinyl acetates), poly(vinylidene chlorides), and poly(olefins). These polymers may be linear, branched or crosslinked ones. They may be homopolymers from one type of monomer, or copolymers from two or more different types of monomers. The copolymers may be random copolymers or block copolymers. The polymers for use herein preferably have a number-average molecular weight falling between 5000 and 1000000, more preferably between 10000 and 200000. Polymers of which the molecular weight is too small are unfavorable to the invention, since the mechanical strength of the image-forming layer comprising such a polymer is low; but others of which the molecular weight is too large are also unfavorable since their workability into films is not good. Crosslinked polymer latex is especially preferred for use herein.

### Examples of Latex

Preferred examples of polymer latex for use herein are mentioned below. They are expressed by the constituent monomers, in which each numeral parenthesized represents the proportion, in terms of % by mass, of the monomer unit, and the molecular weight of each constituent monomer is in terms of the number-average molecular weight thereof. Polyfunctional monomers form a crosslinked structure in polymer latex comprising them, to which, therefore, the concept of molecular weight does not apply. The polymer latex of the type is referred to as “crosslinked”, and the molecular weight of the constituent monomers is omitted. Tg represents the glass transition point of the polymer latex.

PP-1: Latex of -MMA(70)-EA(27)-MAA(3)-(molecular weight 37000, Tg 61° C.)

PP-2: Latex of -MMA(70)-2EHA(20)-St(5)-AA(5)-(molecular weight 40000, Tg 59° C.)

PP-3: Latex of -St(50)-Bu(47)-MAA(3)-(crosslinked, Tg −17° C.)

PP-4: Latex of -St(68)-Bu(29)-AA(3)-(crosslinked, Tg 17° C.)

PP-5: Latex of -St(71)-Bu(26)-AA(3)-(crosslinked, Tg 24° C.)

PP-6: Latex of -St(70)-Bu(27)-IA(3)-(crosslinked)

PP-7: Latex of -St(75)-Bu(24)-AA(l)-(crosslinked, Tg 29° C.)

PP-8: Latex of -St(60)-Bu(35)-DVB(3)-MAA(2)-(crosslinked)

PP-9: Latex of -St(70)-Bu(25)-DVB(2)-AA(3)-(crosslinked)

PP-10: Latex of -VC(50)-MMA(20)-EA(20)-AN-(5)-AA(5)-(molecular weight 80000)

PP-11: Latex of -VDC(85)-MMA(5)-EA(5)-MAA(5)-(molecular weight 67000)

PP-12: Latex of -Et(90)-MAA(10)-(molecular weight 12000)

PP-13: Latex of -St(70)-2EHA(27)-AA(3)-(molecular weigh: 130000, Tg 43° C.)

PP-14: Latex of -MMA(63)-EA(35)-AA(2)-(molecular weight 33000, Tg 47° C.)

PP-15: Latex of -St(70.5)-Bu(26.5)-AA(3)-(crosslinked, Tg 23° C.)

PP-16: Latex of -St(69.5)-Bu(27.5)-AA(3)-(crosslinked, Tg 20.5° C.)

Abbreviations of the constituent monomers are as follows:

MMA: methyl methacrylate

EA: ethyl acrylate

MAA: methacrylic acid

2EHA: 2-ethylhexyl acrylate

St: styrene

Bu: butadiene

AA: acrylic acid

DVB: divinylbenzene

VC: vinyl chloride

AN: acrylonitrile

VDC: vinylidene chloride

Et: ethylene

IA: itaconic acid

The polymer latexes mentioned above are available on the market. Some commercial products employable herein are mentioned below. Examples of acrylic polymers are CEBIAN A-4635, 4718, 4601 (all from Daicel Chemical Industries), and NIPOL Lx811, 814, 821, 820, 857 (all from Nippon Zeon); examples of poly(esters) are FINETEX ES650, 611, 675, 850 (all from Dai-Nippon Ink & Chemicals), and WD-SIZE, WMS (both from Eastman Chemical); examples of poly(urethanes) are HYDRAN AP10, 20, 30, 40 (all from Dai-Nippon Ink & Chemicals); examples of rubbers are LACSTAR 7310K, 3307B, 4700H, 7132C (all from Dai-Nippon Ink & Chemicals), and NIPOL Lx416, 410, 438C, 2507 (all from Nippon Zeon); examples of poly(vinyl chlorides) are G351, G576 (both from Nippon Zeon); examples of poly(vinylidene chlorides) are L502, L513 (both from Asahi Kasei); and examples of poly(olefins) are CHEMIPEARL S120, SA100 (both from Mitsui Petrochemical).

These polymer latexes may be used either singly or as combined in any desired manner.

### Preferred Latex

For the polymer latex for use herein, especially preferred is styrene-butadiene copolymer latex. In the styrene-butadiene copolymer, the ratio of styrene monomer units to butadiene monomer units preferably falls between 40/60 and 95/5 by weight. Also preferably, the styrene monomer units and the butadiene monomer units account for from 60 to 99% by mass of the copolymer. Still preferably, the polymer latex in the invention contains from 1 to 6% by mass, more preferably from 2 to 5% by mass of acrylic acid or methacrylic acid based on the sum of styrene and butadiene. Even more preferably, the polymer latex in the invention contains acrylic acid. The preferred range of the molecular weight of the polymer latex is the same as that mentioned hereinabove.

Preferred examples of the styrene-butadiene copolymer latex for use in the invention are the above-mentioned PP-3 to PP-8 and PP-15, and commercial products, LACSTAR-3307B, 7132C, and NIPOL Lx416.

The organic silver salt-containing layer of the photothermographic material of the invention may, if necessary, contain a hydrophilic polymer such as gelatin, polyvinyl alcohol, methyl cellulose, hydroxypropyl cellulose or carboxymethyl cellulose. The amount of the hydrophilic polymer that may be in the layer is preferably at most 30% by mass, more preferably at most 20% by mass of all the binder in the organic silver salt-containing layer.

Preferably, the polymer latex as above is used in forming the organic silver salt-containing layer (that is, the image-forming layer) of the photothermographic material of the invention. Concretely, the amount of the binder in the organic silver salt-containing layer is such that the ratio by weight of total binder/organic silver salt falls between 1/10 and 10/1, more preferably between 1/3 and 5/1, even more preferably between 1/1 and 3/1.

The organic silver salt-containing layer is a photosensitive layer (emulsion layer) generally containing a photosensitive silver salt, that is, a photosensitive silver halide. In the layer, the ratio by weight of total binder/silver halide preferably falls between 5 and 400, more preferably between 10 and 200.

The total amount of the binder in the image-forming layer of the photothermographic material of the invention preferably falls between 0.2 and 30 g/m², more preferably between 1 and 15 g/m², even more preferably between 2 and 10 g/m². The image-forming layer in the invention may, if necessary, contain a crosslinking agent, and a surfactant which is for improving the coatability of the coating liquid for the layer.

### Preferred Solvent for Coating Liquid

Preferably, the solvent for the coating liquid for the organic silver salt-containing layer of the photothermographic material of the invention is an aqueous solvent that contains at least 30% by mass of water. The solvent referred to herein is meant to indicate both solvent and dispersion medium for simple expression. Except water, the other components of the aqueous solvent may be any organic solvents that are miscible with water, including, for example, methyl alcohol, ethyl alcohol, isopropyl alcohol, methyl cellosolve, ethyl cellosolve, dimethylformamide, ethyl acetate. The water content of the solvent for the coating liquid is preferably at least 50% by mass, more preferably at least 70% by mass. Preferred examples of the solvent composition are water alone, water/methyl alcohol=90/10, water/methyl alcohol=70/30, water/methyl alcohol/dimethylformamide=80/15/5, water/methyl alcohol/ethyl cellosolve=85/10/5, water/methyl alcohol/isopropyl alcohol=85/10/5. The ratio is % by mass.

### Description of Antifoggant

Antifoggants, stabilizers and stabilizer precursors usable in the invention are described, for example, in JP-A No. 10-62899, paragraph [0070]; EP-A No. 0803764A1, from page 20, line 57 to page 21, line 7; JP-A Nos. 9-281637 and 9-329864; U.S. Pat. Nos. 6,083,681; and EP No. 1,048,975. Antifoggants preferred for use in the invention are organic halides. These are described, for example, in JP-A No. 11-65021, paragraphs [0111] to [0112]. Especially preferred are organic halides of formula (P) in JP-A No. 2000-284399; organic polyhalogen compounds of formula (II) in JP-A No. 10-339934; and organic polyhalogen compounds in JP-A Nos. 2001-31644 and 2001-33911.

Description of Polyhalogen Compound:

Organic polyhalogen compounds preferred for use in the invention are described concretely. Preferably, the polyhalogen compounds for use in the invention are represented by the following formula (H):

Q—(Y)n—C(Z₁)(Z₂)X Formula (H)

wherein Q represents an alkyl, aryl or heterocyclic group; Y represents a divalent linking group; n represents 0 or 1; Z₁ and Z₂ each represent a halogen atom; and X represents a hydrogen atom or an electron-attracting group.

In formula (H), Q is preferably an aryl group or a heterocyclic group.

When Q in formula (H) is a heterocyclic group, it is preferably a nitrogen-containing heterocyclic group that contains one or two nitrogen atoms, more preferably a 2-pyridyl group or a 2-quinolyl group.

When Q in formula (H) is an aryl group, it is preferably a phenyl group substituted with an electron-attracting group having a positive Hammett's substituent constant σₚ. For the Hammett's substituent constant, referred to is, for example, Journal of Medicinal Chemistry, 1973, Vol. 16, No. 11, 1207-1216. Preferred examples of the electron-attracting group are a halogen atom (fluorine atom with σₚ of 0.06, chlorine atom with σₚ of 0.23, bromine atom with σₚ of 0.23, iodine atom with σₚ of 0.18), a trihalomethyl group (tribromomethyl with σₚ of 0.29, trichloromethyl with σₚ of 0.33, trifluoromethyl with σₚ of 0.54), a cyano group (with σₚ of 0.66), a nitro group (with σₚ of 0.78), an aliphatic, aryl or heterocyclic sulfonyl group (e.g., methanesulfonyl with σₚ of 0.72), an aliphatic, aryl or heterocyclic acyl group (e.g., acetyl with σₚ of 0.50, benzoyl with σₚ of 0.43), an alkynyl group (e.g., C≡CH with σₚ of 0.23), an aliphatic, aryl or heterocyclic oxycarbonyl group (e.g., methoxycarbonyl with σₚ of 0.45, phenoxycarbonyl with σₚ of 0.44), a carbamoyl group (with σₚ of 0.36), a sulfamoyl group (with σₚ of 0.57), a sulfoxide group, a heterocyclic group, and a phosphoryl group. The σₚ of the electron-attracting group preferably falls between 0.2 and 2.0, more preferably between 0.4 and 1.0. Of the preferred examples of the electron-attracting group mentioned above, more preferred are a carbamoyl group, an alkoxycarbonyl group, an alkylsulfonyl group and an alkyIphosphoryl group, and most preferred is a carbamoyl group.

X is preferably an electron-attracting group, more preferably a halogen atom, an aliphatic, aryl or heterocyclic sulfonyl group, an aliphatic, aryl or heterocyclic acyl group, an aliphatic, aryl or heterocyclic oxycarbonyl group, a carbamoyl group, or a sulfamoyl group. Even more preferably, it is a halogen atom. For the halogen atom for X, preferred are chlorine, bromine and iodine atoms, more preferred are chlorine and bromine atoms, and even more preferred is a bromine atom.

Y is preferably —C(═O)—, —SO— or —SO₂—, more preferably —C(═O)— or —SO₂—, even more preferably —SO₂—. n is 0 or 1, but preferably 1.

Specific examples of the compounds of formula (H) for use in the invention are mentioned below.

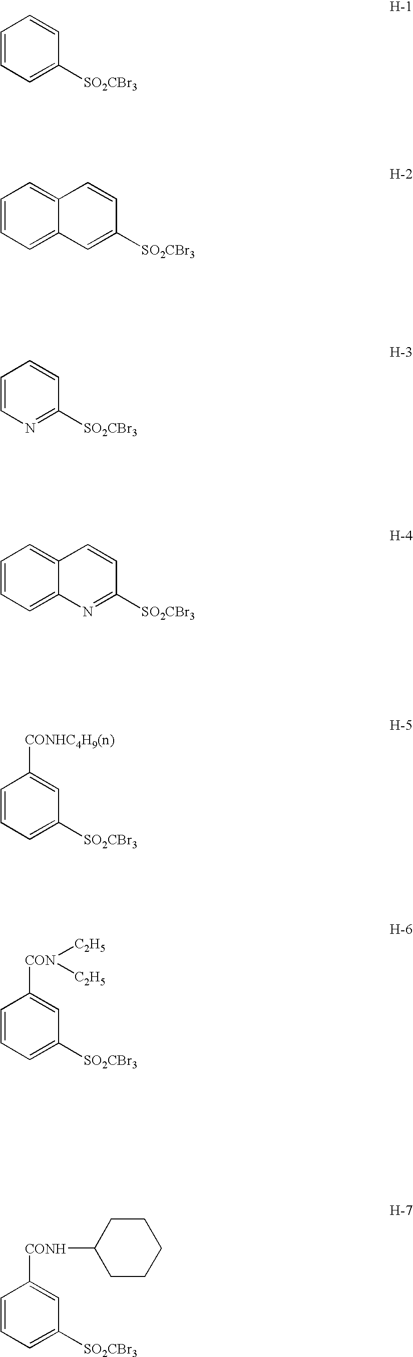

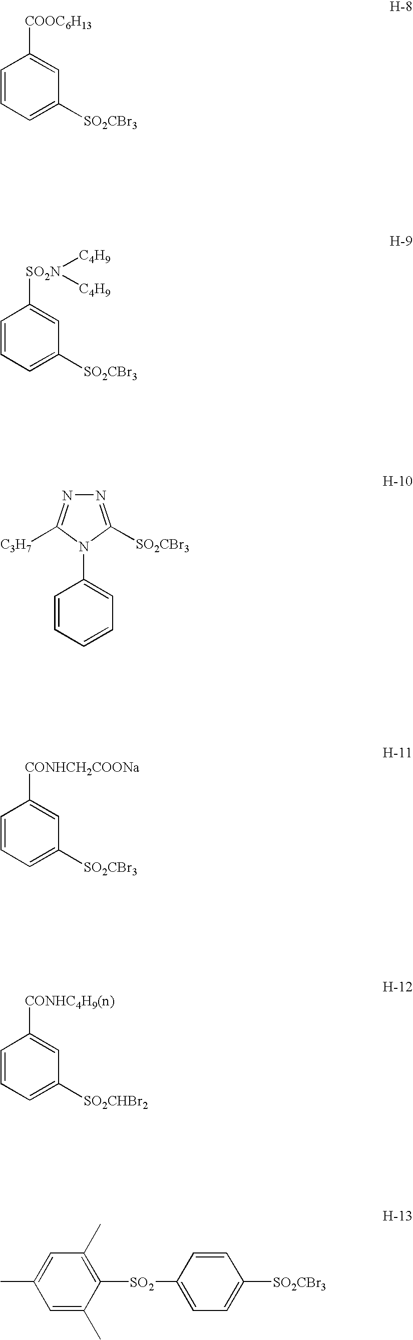

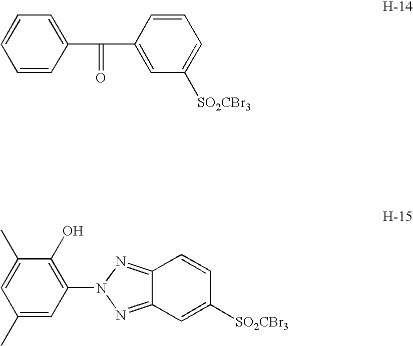

Other preferred polyhalogen compounds usable herein than the above are described in JP-A 2001-31644, 2001-56526 and 2001-209145.

Preferably, the amount of the compound of formula (H) to be in the photothermographic material of the invention falls between 10⁻⁴ and 1 mol, more preferably between 10⁻³ and 0.5 mols, even more preferably between 1×10⁻² and 0.2 mols per mol of the non-photosensitive silver salt in the image-forming layer of the material.

The antifoggant may be incorporated into the photothermographic material of the invention in the same manner as that mentioned hereinabove for incorporating the reducing agent thereinto. Preferably, the organic polyhalogen compound is in the form of a fine solid particle dispersion when it is incorporated into the material.

### Other Antifoggants

Other antifoggants usable herein are mercury(II) salts as in JP-A No. 11-65021, paragraph [0113]; benzoic acids as in JP-A No. 11-65021, paragraph [0114]; salicylic acid derivatives as in JP-A No. 2000-206642; formalin scavenger compounds of formula (S) in JP-A No. 2000-221634; triazine compounds claimed in claim 9 in JP-A No. 11-352624; compounds of formula (III) in JP-A No. 6-11791; and 4-hydroxy-6-methyl-1,3,3a,7-tetrazaindene.

The photothermographic material of the invention may also contain an azolium salt serving as an antifoggant. The azolium salt includes, for example, compounds of formula (XI) in JP-A No. 59-193447, compounds as in JP-B No. 55-12581, and compounds of formula (II) in JP-A No. 60-153039. The azolium salt may be present in any site of the photothermographic material, but is preferably in some layer on the surface of the material on which is present a photosensitive layer. More preferably, it is added to the organic silver salt-containing layer of the material. Regarding the time at which the azolium salt is added to the material, it may be added to the coating liquid at any stage of preparing the liquid. In case where it is to be present in the organic silver salt-containing layer, the azolium salt may be added to any of the reaction system to prepare the organic silver salt or the reaction system to prepare the coating liquid at any stage of preparing them. Preferably, however, it is added to the coating liquid after the stage of preparing the organic silver salt and just before the stage of coating with the liquid. The azolium salt to be added may be in any form of powder, solution or fine particle dispersion. It may be added along with other additives such as sensitizing dye, reducing agent and color toning agent, for example, in the form of their solution. The amount of the azolium salt to be added to the photothermographic material of the invention is not specifically defined, but preferably falls between 1×10⁻⁶ mols and 2 mols, more preferably between 1×10⁻³ mols and 0.5 mols, per mol of silver in the material.

### Other Additives

1) Mercapto Compounds, Disulfide Compounds and Thione Compounds:

The photothermographic material of the invention may, if necessary, contain any of mercapto compounds, disulfide compounds and thione compounds which are for retarding, promoting or controlling the developability of the material, or for enhancing the spectral sensitivity thereof, or for improving the storage stability thereof before and after development. For the additive compounds, for example, referred to are JP-A No. 10-62899, paragraphs [0067] to [0069]; compounds of formula (I) in JP-A No. 10-186572, and their examples in paragraphs [0033] to [0052]; and EP-A No. 0803764A1, page 20, lines 36 to 56. Especially preferred are the mercapto-substituted hetero-aromatic compounds described in JP-A Nos. 9-297367, 9-304875 and 2001-100358, 2002-303954 and 2002-303951.

2) Color Toning Agent:

Adding a color toning agent to the photothermographic material of the invention is preferred. Examples of the color toning agent usable herein are described in JP-A No. 10-62899, paragraphs [0054] to [0055], EP-A No. 0803764A1, page 21, lines 23 to 48; and JP-A Nos. 2000-356317 and 2000-187298. Preferred for use herein are phthalazinones (phthalazinone, phthalazinone derivatives and their metal salts, e.g., 4-(1-naphthyl)phthalazinone, 6-chlorophthalazinone, 5,7-dimethoxyphthalazinone, 2,3-dihydro-1,4-phthalazinedione); combinations of phthalazinones and phthalic acids (e.g., phthalic acid, 4-methylphthalic acid, 4-nitrophthalic acid, diammonium phthalate, sodium phthalate, potassium phthalate, tetrachlorophthalic anhydride); phthalazines (phthalazine, phthalazine derivatives and their metal salts, e.g., 4-(1-naphthyl)phthalazine, 6-isopropylphthalazine, 6-tert-butylphthalazine, 6-chlorophthalazine, 5,7-dimethoxyphthalazine, 2,3-dihydrophthalazine); combinations of phthalazines and phthalic acids. More preferred are combinations of phthalazines and phthalic acids. Even more preferred is a combination of 6-isopropylphthalazine and phthalic acid or 4-methylphthalic acid.

3) Plasticizer, Lubricant:

Plasticizer and lubricant that may be in the image-forming layer of the photothermographic material of the invention are described in, for example, JP-A No. 11-65021, paragraph [0117]. Sliding agent that may be in the layer is described in, for example, JP-A .11-84573, paragraphs [0061]to [0064], and JP-A No. 2001-83679, paragraphs [0055] to [0065].

4) Dye, Pigment:

The photosensitive layer of the photothermographic material of the invention may contain various types of dyes and pigments (e.g., C.I. Pigment Blue 60, C.I. Pigment Blue 64, C.I. Pigment Blue 15:6) for improving the color image tone, for preventing interference fringes during laser exposure, and for preventing irradiation. The details of such dyes and pigments are described in, for example, W098/36322, and JP-A Nos. 10-268465 and 11-338098.

5) Ultra-hard Gradation Enhancing Agent:

For forming ultra-hard images suitable to printing plates, it is desirable to add an ultra-hard gradation enhancing agent to the image-forming layer of the photothermographic material of the invention. For the ultra-hard gradation enhancing agent, the method of using it, and its amount applicable to the invention, for example, referred to are JP-A No. 11-65021, paragraph [0118]; JP-A No. 11-223898, paragraphs [0136] to [0193]; compounds of formula (H), those of formulae (1) to (3) and those of formulae (A) and (B) in JP-A No. 2000-284399; and compounds of formulae (III) to (V) in JP-A No. 2000-347345. For hardening promoters also applicable to the invention, referred to are JP-A No. 11-65021, paragraph [0102]; and JP-A No. 11-223898, paragraphs [0194] to [0195].

In case where formic acid or its salt is used for a strong foggant in the invention, it may be added to the side of the photothermographic material that has thereon a photosensitive silver halide-containing, image-forming layer, and its amount is preferably at most 5 mmols, more preferably at most 1 mmol per mol of silver in the layer.

In case where an ultra-hard gradation enhancing agent is used in the photothermographic material of the invention, it is preferably combined with an acid formed through hydration of diphosphorus pentoxide or its salt. The acid to be formed through hydration of diphosphorus pentoxide and its salts include, for example, metaphosphoric acid (and its salts), pyrophosphoric acid (and its salts), orthophosphoric acid (and its salts), triphosphoric acid (and its salts), tetraphosphoric acid (and its salts), and hexametaphosphoric acid (and its salts). For the acid to be formed through hydration of diphosphorus pentoxide and its salts, preferred for use herein are orthophosphoric acid (and its salts), and hexametaphosphoric acid (and its salts). Concretely, their salts are sodium orthophosphate, sodium dihydrogen-orthophosphate, sodium hexametaphosphate, and ammonium hexametaphosphate.

The amount of the acid to be formed through hydration of diphosphorus pentoxide or its salt to be used herein (that is, the amount thereof to be in the unit area, one m², of the photothermographic material) may be any desired one and may be defined in any desired manner depending on the sensitivity, the fogging resistance and other properties of the material. Preferably, however, it falls between 0.1 and 500 mg/m², more preferably between 0.5 and 100 mg/m².

In the invention, the reducing agent, the hydrogen bond-forming compound, the development promoter and the polyhalogen compounds are preferably in the form of their solid dispersions, and preferred production methods for these solid dispersions are descried in JP-A No. 2002-55405.

### Preparation of Coating Liquid and Coating with it

The temperature at which the coating liquid for the image-forming layer of the invention is prepared preferably falls between 30° C. and 65° C., more preferably between 35° C. and lower than 60° C., even more preferably between 35° C. and 55° C. Also preferably, the temperature of the coating liquid is kept between 30° C. and 65° C. immediately after a polymer latex is added thereto.

### Layer Thickness

Though not specifically defined, the thickness of the image-forming layer in the invention is preferably at most 15 μm, more preferably at most 13 μm, even more preferably from 4 μm to 13 μm. If thicker than 15 μm, the layer is unfavorable since it will be unevenly formed and may form uneven images. The layer is preferably thinner, since the materials for it may be economized. Therefore, the development in the art will be toward thinner layers.

<Back Layer>

The photothermographic material of the invention may have a back layer formed on the side of the substrate opposite to the image-forming layer formed thereon. For the back layer applicable to the invention, referred to is the description in JP-A No. 11-65021, paragraphs [0128] to [0130].

In the invention, a coloring agent having an absorption maximum in the range falling between 300 and 450 nm may be added to the photothermographic material for improving the silver tone and the image stability of the material. The coloring agent is described in, for example, JP-A Nos. 62-210458, 63-104046, 63-103235, 63-208846, 63-306436, 63-314535, 01-61745, and 2001-100363.

In general, the amount of the coloring agent to be added to the material falls between 0.1 mg/m² and 1 g/m². Preferably, it is added to the back layer that is opposite to the photosensitive layer of the material.

Also preferably, the photothermographic material of the invention contains a dye that has an absorption peak within a range of from 580 to 680 nm for controlling the base color of the material. For the dye for that purpose, preferred are those having a low absorption intensity in the side of short wavelength as in JP-A No. 4-359967; oil-soluble azomethine dyes as in JP-A No. 4-359968; and water-soluble phthalocyanine dyes as in JP-A No. 2003-295388. The dye may be added to any layer of the material, but preferably to the non-photosensitive layer on the side coated with emulsion layers or to the side of back face.

<Antihalation Layer>

An antihalation layer may be disposed in the photothermographic material of the invention remoter from the light source than the photosensitive layer therein.

The antihalation layer is described in, for example, JP-A No. 11-65021, paragraphs [0123] to [0124]; JP-A Nos. 11-223898, 9-230531, 10-36695, 10-104779, 11-231457, 11-352625 and 11-352626.

The antihalation layer contains an antihalation dye capable of absorbing the light to which the photothermographic material is exposed. In case where the photothermographic material is exposed to IR rays, IR-absorbing dyes may be used for antihalation. In that case, it is desirable that the dyes do not absorb visible light.

On the other hand, in case where visible light-absorbing dyes are used for antihalation, it is desirable that the dyes used are substantially decolored after image formation on the material, for which, for example, usable are decoloring agents that have the ability to decolor the dyes when heated in the step of thermal development. Preferably, a thermal decoloring dye and a base precursor are added to a non-photosensitive layer so that the layer containing them may function as an antihalation layer. The details of this technique are described in, for example, JP-A No. 11-231457.

The amount of the decoloring dye to be added shall be determined, depending on the use of the dye. In general, its amount is so determined that the dye added could ensure an optical density (absorbance), measured at an intended wavelength, of larger than 1.0. The optical density preferably falls between 0.15 and 2, more preferably between 0.2 and 1. The amount of the dye capable of ensuring the optical density falling within the range may be generally from 0.001 to 1 g/m² or so.

Decoloring the dyes in the photothermographic material in that manner can lower the optical density of the material to 0.1 or less after thermal development. Two or more different types of decoloring dyes may be in the thermodecoloring recording material or the photothermographic material. Similarly, two or more different types of base precursors may be in the material.

In the thermodecoloring material of the type that contains such a decoloring dye and a base precursor, it is desirable in view of the thermodecoloring ability of the material that the base precursor therein is combined with a substance which, when mixed with the base precursor, can lower the melting point of the mixture by at least 3° C. (e.g., diphenyl sulfone, 4-chlorophenyl(phenyl) sulfone, 2-naphthyl benzoate), for example, as in JP-A No. 11-352626.

<Constitution of Other Layers>

In addition to the above-mentioned layers, the photothermographic material of the invention may have any other layers, for example, an interlayer formed between plural image-forming layers or between an image-forming layer and a protective layer, and an undercoat layer formed between an image-forming layer and a substrate.

<Other Constituent Components>

### Matting Agent

Preferably, the photothermographic material of the invention contains a matting agent which is for improving the transferability of the material. Matting agents are described in JP-A No. 11-65021, paragraphs [0126]to [0127]. The amount of the matting agent to be added to the photothermographic material of the invention preferably falls between 1 and 400 mg/m², more preferably between 5 and 300 mg/m² of the material.

Regarding its morphology, the matting agent for use in the invention may be in any form of regular or irregular particles, but preferred are regular spherical particles. The mean particle size of the particles preferably falls between 0.5 and 10 μm, more preferably between 1.0 and 8.0 μm, even more preferably between 2.0 and 6.0 μm. The fluctuation coefficient of the particle size distribution is preferably at most 50%, more preferably at most 40%, even more preferably at most 30%. The particle size fluctuation coefficient is represented by (standard deviation of particle size)/(mean value of particle size)×100. Also preferably, two different types of matting agents are combined for use herein, both having a small fluctuation coefficient but differing from each other in the ratio of the mean particle size of the two by more than 3.

The degree to which the surface of the emulsion layer of the photothermographic material of the invention is matted is not specifically defined, so far as the matted layer surface is free from star dust trouble, but is preferably such that the Beck's smoothness of the matted surface could fall between 30 seconds and 2000 seconds, more preferably between 40 seconds and 1500 seconds. The Beck's smoothness is readily obtained according to JIS P8119 (method of testing surface smoothness of paper and paper boards with Beck tester), and to TAPPI Standard T479.

Regarding the matting degree of the back layer of the photothermographic material of the invention, the Beck's smoothness of the matted back layer preferably falls between 10 seconds and 1200 seconds, more preferably between 20 seconds and 800 seconds, even more preferably between 40 seconds and 500 seconds.

Preferably, the photothermographic material of the invention contains a matting agent in the outermost surface layer, or in a layer functioning as an outermost surface layer, or in a layer nearer to the outermost surface of the material. Also preferably, it may contain a matting agent in a layer of the material that functions as a protective layer.

Regarding the relationship between the morphology of the matting agent and the dynamic friction factor, the possibility that B/A could be 1 or more may increase when the matting agent is in the form of large spherical particles which, however, do not drop off from the layer that contains it.

Regarding the relationship between the amount of the matting agent and the dynamic friction factor, B/A may be more readily 1 or more when the amount of the agent is larger, and the uppermost limit of the amount shall be determined depending on the haze of the layer that contains the agent.

Accordingly, one preferred embodiment of using the matting agent for satisfying the formula (1) is that a spherical matting agent having a mean sphere-corresponding radius of from 0.1 μm to 10 μm is added to the layer in an amount of 5 mg/m² to 200 mg/m².

### Surface pH-Controlling Agent

Preferably, the surface of the photothermographic material of the invention has a pH of at most 7.0, more preferably at most 6.6, before developed under heat. The lowermost limit of the pH is not specifically defined, but may be at least 3 or so. Most preferably, the pH range falls between 4 and 6.2. For controlling the surface pH of the photothermographic material, employable are nonvolatile acids, for example, organic acids such as phthalic acid derivatives, or sulfuric acid, or nonvolatile bases such as ammonia. These are preferred as effective for reducing the surface pH of the material. Especially preferred for the surface pH-lowering agent is ammonia, as it is highly volatile, and therefore can be readily removed during coating or before thermal development.

Also preferred is combining ammonia with a nonvolatile base such as sodium hydroxide, potassium hydroxide or lithium hydroxide. For measuring the surface pH of the photothermographic material, referred to is the description in JP-A No. 2000-284399, paragraph [0123].

### Hardening Agent

A hardening agent may be added to the photosensitive layer, the protective layer, the back layer and other layers constituting the photothermographic material of the invention. The details of the hardening agent applicable to the invention are described in T. H. James' The Theory of the Photographic Process, 4th Ed. (Macmillan Publishing Co., Inc., 1977), pp. 77-87. For example, preferred for use herein are chromium alum, 2,4-dichloro-6-hydroxy-s-triazine sodium salt, N,N-ethylenebis(vinylsulfonacetamide), N,N-propylenebis(vinylsulfonacetamide); as well as polyvalent metal ions described on page 78 of that reference; polyisocyanates described in U.S. Pat. No. 4,281,060 and JP-A No. 6-208193; epoxy compounds described in U.S. Pat. No. 4,791,042; and vinylsulfone compounds described in JP-A No. 62-89048.

The hardening agent is added to the coating liquids in the form of its solution. The time at which the solution is added to the coating liquid for the protective layer may fall between 180 minutes before coating with the liquid and a time just before the coating, preferably between 60 minutes before the coating and 10 seconds before it. However, there is no specific limitation thereon, so far as the method and the condition employed for adding the hardening agent to the coating liquid ensure the advantages of the invention. Concretely for adding it, employable is a method of mixing a hardening agent with a coating liquid in a tank in such a controlled manner that the mean residence time of the agent as calculated from the amount of the agent added and the flow rate of the coating liquid to a coater could be a predetermined period of time; or a method of mixing them with a static mixer, for example, as in N. Harnby, M. F. Edwards & A. W. Nienow's Liquid Mixing Technology, Chap. 8 (translated by Koji Takahashi, published by Nikkan Kogyo Shinbun, 1989).

### Substrate

The substrate of the photothermographic material of the invention may be a transparent substrate. For the transparent substrate, preferred are bi-oriented films of polyesters, especially polyethylene terephthalate heated at a temperature falling between 130 and 185° C. The heat treatment is for removing the internal strain that may remain in the bi-oriented films and for preventing the film substrates from being thermally shrunk during thermal development of the material. In case where the photothermographic material is for medical treatment, the transparent substrate for it may be colored with a blue dye (for example, with Dye-1 used in the examples in JP-A No. 8-240877), or may not be colored. Preferably, the substrate of the photothermographic material of the invention is undercoated, for example, with a water-soluble polyester as in JP-A No. 11-84574; a styrene-butadiene copolymer as in JP-A No. 10-186565; or a vinylidene chloride copolymer as in JP-A No. 2000-39684 or in JP-A No. 2001-83679, paragraphs [0066] to [0074]. While the substrate is coated with an emulsion layer or a back layer, its water content is preferably at most 0.5% by mass.

### Other Additives

The photothermographic material of the invention may, if necessary, contain an antioxidant, a stabilizer, a plasticizer, a UV absorbent or a coating aid. Such additives may be in any of the photosensitive layers or the non-photosensitive layers of the material. For the additives, for example, referred to are W098/36322, EP-A No. 803764A 1, and JP-A Nos. 10-186567 and 10-186568.

### Wrapping Material

Preferably, the photothermographic material of the invention is wrapped with a material of low oxygen and/or moisture permeability for preventing its photographic properties from varying and for preventing it from curling or from having a curled habit while stored as unprocessed stocks. Preferably, the oxygen permeability at 25° C. of the wrapping material for use herein is at most 50 ml/atm·m²·day, more preferably at most 10 ml/atm·m²·day, even more preferably at most 1.0 ml/atm·m²·day. Also preferably, the moisture permeability thereof is at most 10 g/atm·m²·day, more preferably at most 5 g/atm·m²·day, even more preferably at most 1 g/atm·m²·day.

Preferred examples of the wrapping material of low oxygen and/or moisture permeability for use herein are described, for example, in JP-A Nos. 8-254793 and 2000-206653.

### Other Employable Techniques

Other techniques applicable to the photothermographic material of the invention are, for example, in EP-A Nos. 803764A1 and 883022A1, W098/36322; JP-A Nos. 56-62648, 58-62644, 9-43766, 9-281637, 9-297367, 9-304869, 9-311405, 9-329865, 10-10669, 10-62899, 10-69023, 10-186568, 10-90823, 10-171063, 10-186565, 10-186567, 10-186569 to 10-186572, 10-197974, 10-197982, 10-197983, 10-197985 to 10-197987, 10-207001, 10-207004, 10-221807, 10-282601, 10-288823, 10-288824, 10-307365, 10-312038, 10-339934, 11-7100, 11-15105, 11-24200, 11-24201, 11-30832, 11-84574, 11-65021, 11-109547, 11-125880, 11-129629, 11-133536 to 11-133539, 11-133542, 11-133543, 11-223898, 11-352627, 11-305377, 11-305378, 11-305384, 11-305380, 11-316435, 11-327076, 11-338096, 11-338098, 11-338099, 11-343420, 2000-187298, 2000-10229, 2000-47345, 2000-206642, 2000-98530, 2000-98531, 2000-112059, 2000-112060, 2000-112104, 2000-112064 and 2000-171936.

When the photothermographic material of the invention is a multi-color photothermographic material, the individual emulsion layers are differentiated and spaced from the others via a functional or non-functional barrier layer between the adjacent emulsion layers, for example, as in U.S. Pat. No. 4,460,681.

Regarding its constitution, the multi-color photothermographic material may have combinations of two layers for different colors, or may contain all the necessary ingredients in a single layer, for example, as in U.S. Pat. No. 4,708,928.

<Coating Mode>

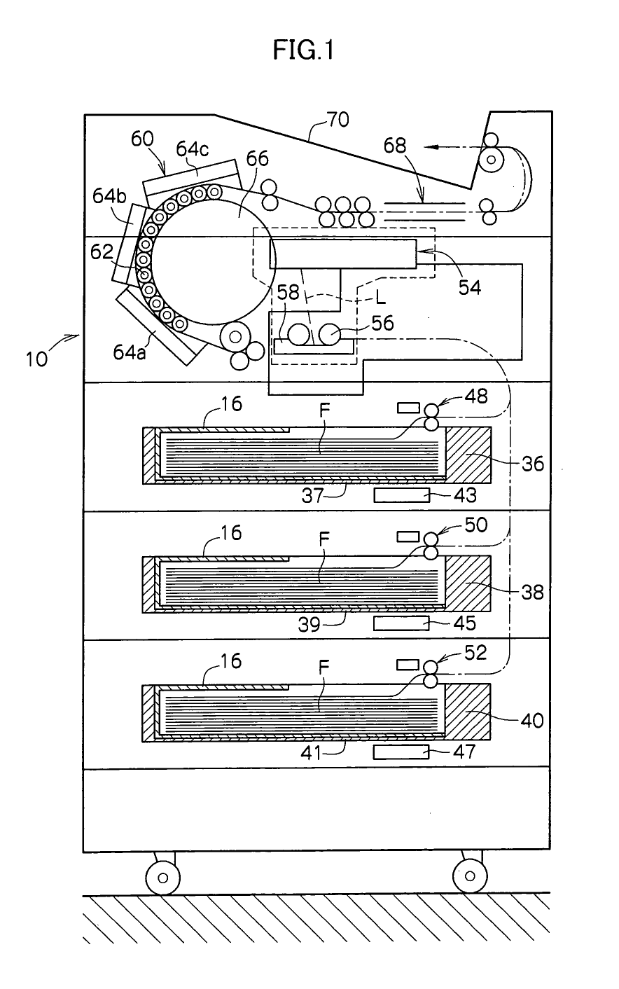

To fabricate the photothermographic material of the invention, the coating liquids may be applied onto the substrate in any desired manner. Concretely, various types of coating techniques are employable herein, including, for example, extrusion coating, slide coating, curtain coating, dipping, knife coating, and flow coating. Various types of hoppers for extrusion coating employable herein are described in U.S. Pat. No. 2,681,294. Preferred for the photothermographic material of the invention is extrusion coating or slide coating described in Stephen F. Kistler & Petert M. Schweizer's Liquid Film Coating (Chapman & Hall, 1997), pp. 399-536. More preferred is slide coating. One example of the shape of a slide coater for slide coating is in FIG. 11b-1, on page 427 of that reference. If desired, two or more layers may be formed at the same time, for example, according to the methods described from page 399 to page 536 of that reference, or to the methods described in U.S. Pat. No. 2,761,791 and BP No. 837,095. Coating methods preferred for the invention are described in, for example, JP-A Nos. 2001-194748, 2002-153808, 2002-153803 and 2002-182333.

Preferably, the coating liquid for the organic silver salt-containing layer of the photothermographic material of the invention is a thixotropic flow. For it, referred to is the technique described in JP-A No. 11-52509. Preferably, the coating liquid for the organic silver salt-containing layer in the invention has a viscosity falling between 400 mPa·s and 100,000 mPa·s, more preferably between 500 mPa·s and 20,000 mPa·s, at a shear rate of 0.1 sec⁻¹. Also preferably, the viscosity falls between 1 mPa·s and 200 mPa·s, more preferably between 5 mPa·s and 80 mPa·s, at a shear rate of 1000 sec-⁻¹.

When two liquids are mixed to prepare the coating liquid of the invention, preferably used is a known in-line mixer or in-plant mixer. In-line mixer preferred for the invention is described in JP-A No. 2002-85948; and in-plant mixer also preferred for the invention is in JP-A 2002-90940.

The coating liquid of the invention is preferably defoamed for bettering the condition of the surface coated with it. For example, the defoaming method described in JP-A 2002-66431 is preferred for the invention.

It is also desirable that the substrate is, before it is coated with coating liquids of the invention, discharged for preventing it from charging to attract dust and others. For example, the discharging method preferred for the invention is described in JP-A No. 2002-143747.

In the invention, it is a matter of importance to accurately control the drying air and the drying temperature in drying the coating liquid for non-set image-forming layer. The drying method preferred for the invention is described in detail in JP-A Nos. 2001-194749 and 2002-139814.

In fabricating the photothermographic material of the invention, it is desirable that, just after the coating liquids have been applied to the substrate to form the layers thereon and dried, the thus-prepared material is heated for improving the film-forming ability of the coating liquids. The heating temperature is preferably from 60° C. to 100° C. measured on the surface of the substrate, and the heating time is preferably from 1 second to 60 seconds. More preferably, the heating temperature is from 70 to 90° C. and the heating time is from 2 to 10 seconds. The heating method preferred for the invention is described in JP-A No. 2002-107872.

For stable and continuous production of the photothermographic material of the invention, preferred are the producing methods described in JP-A Nos. 2002-156728 and 2002-182333.

Preferably, the photothermographic material of the invention is of a monosheet type. The monosheet type does not require any additional sheet to receive images thereon such as an image-receiving material, but may directly form images on itself.

<Workability and Accumulability>

The photothermographic material of the invention has good workability and accumulability. “Good workability and accumulability” means that, after the material is coated, the material may be well rolled up and its roll hardly deforms, and, when the material is cut into sheets, the sheets may be well piled up with no difficulty.

<Image-Forming Method>

1) Exposure:

The photographic material of the invention may be exposed to any of red to IR-emitting He-Ne lasers, red semiconductor lasers, blue to green-emitting Ar⁺, He—Ne or He—Cd lasers, or blue semiconductor lasers. Preferred are red to IR semiconductor lasers. The peak wavelength of the laser rays may fall between 600 nm and 900 nm, preferably between 620 nm and 850 nm. On the other hand, modules of SHG (secondary harmonics generator) integrated with semiconductor laser, and blue semiconductor lasers have been developed recently, and short wavelength laser output devices have become much highlighted in the art. Blue semiconductor lasers enable high-precision image recording, further having the advantages of recoding density increase and stable long-life output, and therefore it is expected that the demand for them will much increase in future. The peak wavelength of blue laser rays may fall between 300 nm and 500 nm, preferably between 400 nm and 500 nm.

In addition, laser rays that multi-oscillate in the machine direction through high-frequency superimposition are also preferred for use in the invention.

2) Thermal Development:

The photothermographic material of the invention may be developed in any manner. In general, after having been imagewise exposed, it is developed under heat. Preferably, the temperature for the thermal development falls between 80 and 250° C., more preferably between 100 and 140° C., even more preferably between 110 and 130° C. The time for the development preferably falls between 1 and 60 seconds, more preferably between 3 and 30 seconds, even more preferably between 5 and 25 seconds, still more preferably between 7 and 15 seconds.

For thermal development of the photothermographic material, employable is any of a drum heater system or a plate heater system, but preferred is a plate heater system. For the plate heater system for the material, preferred is the method described in JP-A No. 11-133572. The plate heater system described therein is for thermal development of photothermographic materials, in which a photothermographic material having been exposed to have a latent image thereon is brought into contact with a heating unit in a zone for thermal development to thereby convert the latent image into a visible image. In this, the heating unit comprises a plate heater, and multiple presser rolls are disposed in series on one surface of the plate heater. The exposed photothermographic material is passed between the multiple pressure rolls and the plate heater, whereby it is developed under heat. The plate heater is sectioned into 2 to 6 stages, and it is desirable that the temperature of the top stage is kept lower by 1 to 10° C. or so than that of the others. For example, four pairs of plate heaters of which the temperature is independently controllable may be used, and they are set at 112° C., 119° C., 121° C. and 120° C. The system of the type is described in JP-A No. 54-30032. In the plate heater system, water and the organic solvent that remain in the photothermographic material being processed can be removed out of the material. In this, in addition, the substrate of the photothermographic material is prevented from being rapidly heated and deformed.

For down-sizing the thermal developer and for shortening the time for thermal development for the material of the invention, it is desirable that the heaters used can be controlled more stably. In addition, it is also desirable that, when exposure of one sheet material is started from its top, thermal development of the material being exposed is started before its exposure is finished at its end. Imagers that enable rapid processing favorably for the invention are described in, for example, JP-A Nos. 2002-289804 and 2002-287668. The imagers enable thermal development with three-stage plate heaters separately controlled, for example, at 107° C.-121° C.-121° C. within a period of 14 seconds, and the output time for one sheet may be shortened to about 60 seconds. For such rapid development, it is desirable to combine and use the photothermographic material of the invention that has high sensitivity and is hardly influenced by ambient temperatures. A thermal developing machine favorable to the invention is shown in FIG. 1. In FIG. 1, 10 is an image-recording device; 16 is a filler paper cord; 36, 38 and 40 are trays; 37, 39 and 41 are bar code read windows; 43, 45 and 47 are bar code readers; 48, 50 and 52 are sheeters; 54 is an image-recording unit; 56 is a roller; 58 is a plate; 60 is a thermal development unit; 62 is a roller; 64a, 64b and 64c are plate heaters; 66 is a drum; 68 is a cooling unit; 70 is a delivery area; F is a film; L is a laser beam.

The photothermographic material of the invention may be processed for image formation thereon with a thermal developing machine having a thermal development unit with a driving roller and plate heaters therein. The surface of the material having an image-forming layer thereon is kept in contact with the driving roller while the back thereof having a back layer thereon is in contact with the plate heaters, and the material is thus developed under heat in that condition for image formation thereon. Since the photothermographic material of the invention has extremely good transferability, it may be thermally developed while its surface is kept in contact with the driving roller and the plate heaters.

In addition, since the coated surface condition of the photothermographic material of the invention is good, the material can be uniformly heated even when the transfer linear speed of the material is 30 mm/sec or more, and therefore has few image mottles. Further, even when the transfer linear speed of the material is 45 mm/sec or more, good images with few mottles may be outputted on the material. The photothermographic material of the invention may be processed at an increased high transfer linear speed, and the time for processing it may be shortened.

3) System:

Examples of laser imagers for medical treatment equipped with an exposure unit and a thermal development unit that are applicable to the invention are Fuji Medical Dry Laser Imager FM-DPL, and DRYPIX 7000. The system FM-DPL is described in Fuji Medical Review No. 8, pp. 39-55. Needless-to-say, the technique disclosed therein is applicable to laser imagers for the photothermographic material of the invention. In addition, the photothermographic material of the invention can be processed with the laser imager in the AD Network which Fuji Medical System has proposed for a network system under DICOM Standards.

<Applications of the Invention>

The photothermographic material of the invention forms a monochromatic image based on silver, and is favorable for use in medical diagnosis, industrial photography, printing, and COM.

Embodiments of the present invention are described below.

The first embodiment of the invention provides a photothermographic material comprising: a substrate; at least one image-forming layer, which is disposed on a surface of the substrate, comprising at least a photosensitive silver halide, a non-photosensitive organic silver salt, a reducing agent and a binder; at least one surface-protective layer, which is disposed on a side of the substrate on which the at least one image-forming layer is disposed; and at least one back-surface protective layer, which is disposed on a back surface of the substrate opposite to the surface on which the at least one image-forming layer is disposed, wherein at least one of the surface-protective layer and the back-surface protective layer satisfies the following formula (1):

B/A ≧1 Formula (1)

wherein A represents a dynamic friction factor measured at a sliding velocity of 100 mm/min, and B represents a dynamic friction factor measured at a sliding velocity of 2000 mm/min.

The second embodiment of the invention provides the photothermographic material of the first embodiment, wherein a value of B/A in formula (1) is in a range of 1 to 5.

The third embodiment provides the photothermographic material of the first embodiment, wherein a value of B/A in formula (1) is in a range of 1 to 3.

The fourth embodiment of the invention provides the photothermographic material of the first embodiment, wherein a value of B/A in formula (1) is in a range of 1 to 2.

The fifth embodiment of the invention provides the photothermographic material of any one of the first to fourth embodiments, wherein the surface-protective layer comprises a binder that comprises at least one selected from the group consisting of gelatin, hydrophobic polymer latex, a water-soluble polymer, and a hydrophobic polymer.

The sixth embodiment of the invention provides the photothermographic material of any one of the first to fourth embodiments, wherein the back-surface protective layer comprises a binder that comprises at least one selected from the group consisting of gelatin, hydrophobic polymer latex, a water-soluble polymer, and a hydrophobic polymer.

The seventh embodiment of the invention provides the photothermographic material of the sixth embodiment, wherein the binder is gelatin.

The eighth embodiment of the invention provides the photothermographic material of any one of the fifth to seventh embodiments, wherein the binder is a hydrophobic polymer having a glass transition temperature of −30° C. to 40° C.

The ninth embodiment of the invention provides the photothermographic material of the fifth or sixth embodiment, the binder is cellulose acetate butyrate.

The tenth embodiment of the invention provides the photothermographic material of any one of the first to ninth embodiments, wherein at least one of the surface-protective layer and the back-surface protective layer comprises a sliding agent.

The eleventh embodiment of the invention provides the photothermographic material of any one of the first to tenth embodiments, wherein a total silver amount coated on the photothermographic material is from 1.1 g/m² to 1.9 g/m².

The twelfth embodiment of the invention provides the photothermographic material of any one of the first to eleventh embodiments, wherein silver iodide is contained in the silver halide in an amount of at least 5 mol %.

The thirteenth embodiment of the invention provides the photothermographic material of any one of the first to twelfth embodiments, wherein an antistatic agent is contained in the photothermographic material in a coating amount of 60 mg/m² to 150 mg/m².

The fourteenth embodiment of the invention provides the photothermographic material of any one of the first to thirteenth embodiments, further comprising a fluorine-containing surfactant.

The fifteenth embodiment of the invention provides the photothermographic material of any one of the first to fourteenth embodiments, wherein the image-forming layer has a thickness of 15 μm or less.

The sixteenth embodiment of the invention provides a method for forming an image on the photothermographic material of any one of the first to fifteenth embodiments, the method comprising exposing the photothermographic material and thermally developing the photothermographic material, wherein a transfer linear velocity of the photothermographic material during thermal developing of the photothermographic material is 30 mm/sec or more.

The seventeenth embodiment of the invention provides a method for forming an image on the photothermographic material of any one of the first to fifteenth embodiments, the method comprising exposing the photothermographic material and thermally developing the photothermographic material, wherein a transfer linear velocity of the photothermographic material during thermal developing of the photothermographic material is 45 mm/sec or more.

### EXAMPLES

The present invention will be described in more detail with reference to the following Examples. However, the examples should not be construed to limit the scope of the invention.

### Example 1

### Formation of PET Substrate

1) Formation of Base Film:

From terephthalic acid and ethylene glycol, formed was PET in an ordinary manner, which had an intrinsic viscosity, IV of 0.66 (measured in phenol/tetrachloroethane=6/4 by weight at 25° C.). This was pelletized, then dried at 130° C. for 4 hours, and melted at 300° C. The PET melt was extruded out through a T-die, and rapidly cooled to be a non-oriented film, of which the thickness was controlled to be 175 μm after thermal fixation.

The film was stretched 3.3 times in MD (machine direction), for which were used rolls rotating at different speeds. Next, this was stretched 4.5 times in CD (cross direction) in a tenter. The temperature for MD and CD stretching was 110° C. and 130° C., respectively. Next, this was thermally fixed at 240° C. for 20 seconds, and then relaxed by 4% in CD at the same temperature. Next, the chuck of the tenter was released, the both edges of the film was knurled, and the film was rolled up under 4 kg/cm². The rolled film had a thickness of 175 μm.

2) Surface Corona Discharge Treatment:

Both surfaces of the substrate were subjected to corona treatment at room temperature at a speed of 20 m/min, for which was used a Pillar's solid-state corona processor, Model 6KVA. From the data of the current and the voltage read on the device, it was seen that the substrate was processed at 0.375 kV·A·min/m². The frequency for the treatment was 9.6 kHz, and the gap clearance between the electrode and the dielectric roll was 1.6 mm.

3) Undercoating Treatment:

1) Preparation of Coating Liquid for Undercoat layer:

Formulation <1> (for undercoat layer on the photosensitive layer side):

| | | |
|---|---|---|
| Takamatsu Yushi's PESURESIN A-520 (30 mas. % solution) | 59 | g |
| Polyethylene glycol monononylphenyl ether (mean number of | 5.4 | g |
| ethylene oxides = 8.5, 10 mas. % solution) | | |
| Soken Chemical's MP-1000 (fine polymer particles having a | 0.91 | g |
| mean particle size 0.4 μm) | | |
| Distilled water | 935 | ml |

Formulation <2> (for first back layer):

| | | |
|---|---|---|
| Styrene-butadiene copolymer latex (solid content 40 mas. %, | 158 | g |
| styrene/butadiene = 68/32 by weight) | | |
| 2,4-Dichloro-6-hydroxy-S-triazine sodium salt (8 mas. % | 20 | g |
| aqueous solution) | | |
| Sodium laurylbenzenesulfonate (1 mas. % aqueous solution) | 10 | ml |
| Distilled water | 854 | ml |

Formulation <3> (for second back layer):

| | | |
|---|---|---|
| SnO₂/SbO (9/1 by mass, mean particle size 0.038 μm, 17 | 84 | g |
| mas. % dispersion) | | |
| Gelatin (10 mas. % aqueous solution) | 89.2 | g |
| Shin-etsu Chemical's METOLOSE TC-5 (2 mas. % aqueous | 8.6 | g |
| solution) | | |
| Soken Chemical's MP-1000 | 0.01 | g |
| Sodium dodecylbenzenesulfonate (1 mas. % aqueous solution) | 10 | ml |
| NaOH (1 mas. %) | 6 | ml |
| PROXEL (from ICI) | 1 | ml |
| Distilled water | 805 | ml |

2) Undercoating Treatment:

Both surfaces of the bi-oriented polyethylene terephthalate substrate (thickness: 175 μm) were subjected to corona discharge treatment in the manner as above. One surface (to have a photosensitive layer thereon) of the substrate was coated with the coating liquid of back layer formulation <1 > by the use of a wire bar, and then dried at 180° C. for 5 minutes. The wet volume of the layer formed was 6.6 ml/m² (one surface). Next, the other surface (back surface) of the substrate was coated with the back layer formulation <2> by the use of a wire bar, and then dried at 180° C. for 5 minutes. The wet volume of the layer formed was 5.7 ml/M². The thus-coated back surface was further coated with the back layer formulation <3> by the use of a wire bar, and then dried at 180° C. for 6 minutes. The wet volume of the layer formed was 7.7 ml/m². In that manner, the substrate was undercoated. The coating amount of SnO₂/SbO (antistatic agent) was 0.11 g/m².

### Back Layer

1) Preparation of Coating Liquid for Back Layer:

### Preparation of Dispersion (a) of Fine Solid Particles of Base Precursor)

2.5 kg of a base precursor compound 1,300 g of a surfactant (trade name, DEMOLE by Kao), 800 g of diphenyl sulfone and 1.0 g of benzoisothiazolinone sodium salt were mixed in distilled water to be 8.0 kg in total. The resulting mixture was milled in a horizontal sand mill (UVM-2, by Imex) with beads. Concretely, the mixture was fed into UVM-2 filled with zirconia beads of 0.5 mm in the mean particle diameter via a diaphragm pump, and milled therein under an inner pressure of at least 50 hPa into particles having a desired mean particle size.

The dispersion was measured on the spectral absorption and dispersed until the absorbance ratio (D450/D650) of the absorbance at 450 nm in the spectral absorption of the dispersion to the absorbance at 650 nm became 3.0. The obtained dispersion was diluted with distilled water to have a base precursor concentration of 25% by weight, filtered (through a polypropylene-made filter having an average pore size of 3 μm) to remove impurities, and used in practice.

2) Preparation of Fine Solid Particle Dispersion of Dye)

6.0 kg of a cyanine dye Compound 1, 3.0 kg of sodium p-dodecylbenzenesulfonate, 0.6 kg of a surfactant (trade name, DEMOLE SNB by Kao) and 0.15 kg of a defoaming agent (trade name, SURFINOL 104E by Nisshin Chemical) were mixed with distilled water to be 60 kg in total. The mixed solution was milled in a horizontal sand mill (UVM-2 by Imex) with 0.5-mm zirconia beads therein.

The dispersion was measured on the spectral absorption and dispersed until the absorbance ratio (D650/D750) of the absorbance at 650 nm in the spectral absorption of the dispersion to the absorbance at 750 nm became 5.0 or more. The obtained dispersion was diluted with distilled water to have a cyanine dye concentration of 6% by mass, filtered (average pore size, 1 μm) to remove impurities, and used in practice.

3) Preparation of Coating Liquid for Antihalation Layer:

While the temperature of a vessel was maintained at 40° C., 40 g of gelatin, 20 g of monodispersed polymethyl methacrylate particles (mean particle size: 8 μm, standard deviation of particle size: 0.4), 0.1 g of benzoisothiazolinone and 490 ml of water were mixed to dissolve gelatin. Further, 2.3 ml of aqueous sodium hydroxide solution (1 mol/liter), 40 g of the above dye dispersion, 90 g of the above base precursor dispersion (a), 12 ml of aqueous 3% by mass sodium polystyrenesulfonate solution, and 180 g of 10% by mass SBR latex liquid were mixed with it. Just before use for coating, 80 ml of aqueous 4% by mass N,N-ethylenebis(vinylsulfonacetamide) solution was added to it to prepare a coating liquid for antihalation layer.

4) Preparation of Coating Liquid for Back-Surface Protective Layer:

### Preparation of Coating Liquid 1 for Back-Surface Protective Layer)

In a reactor kept at 40° C., 40 g of gelatin, 35 mg of benzoisothiazolinone and 840 ml of water were mixed to dissolve gelatin. To this, added were 5.8 ml of aqueous sodium hydroxide solution (1 mol/liter), 10 ml of aqueous 5% by mass di (2-ethylhexl) sulfosuccinate sodium salt solution, 20 ml of aqueous 3% by mass sodium polystyrenesulfonate solution, and 32 g of 19% by mass methyl methacrylate/styrene/butyl acrylate/hydroxyethyl methacrylate/acrylic acid copolymer (copolymerization ratio, 57/8/28/5/2 by weight) latex solution, and mixed. Just before use for coating, 25 ml of aqueous 4% by mass N,N-ethylenebis(vinylsulfonacetamide) solution was added to it to prepare a coating liquid for back-surface protective layer.

### Preparation of Coating Liquids 2 to 20 for Back-Surface Protective Layer

Coating liquids 2 to 20 for back-surface protective layer were prepared in the same manner as in the preparation of coating liquid 1 for back-surface protective layer, except that the type of binder (gelatin) was changed as shown in Table 4, and 2.4 ml of 2% by mass fluorine-containing surfactant (F-1) solution and 2.4 ml of 2% by mass fluorine-containing surfactant (F-2) were added thereto as shown in Table 4.

### Preparation of Coating Liquids 21 to 30 for Back-Surface Protective Layer

<<Preparation of Sliding Agent Emulsions 1 to 10>>

1.0 kg of a sliding agent, 2.4 liters of water, 30 ml of phenoxyethanol, 10 g of methyl p-hydroxybenzoate and 1.0 kg of gelatin were stirred at 50° C. for 20 minutes and mixed. 250 ml of aqueous 10% by mass sodium oleoylmethyltaurine was added to it, and stirred in a dissolver at 5000 rpm for 60 minutes to prepare an emulsifide dispersion. Water at 40° C. was added to the resulting dispersion to make 10 kg in total. The mean particle size of the dispersion was measured with Horiba's light-scattering particle sizer, LA-920, and was 0.22 μm. <<Preparation of Coating Liquids 21 to 30 for Back-Surface Protective Layer>>

Coating liquids 21 to 30 for back-surface protective layer were prepared in the same manner as in the preparation of coating liquid 1 for back-surface protective layer, except that the type of binder (gelatin) was changed as shown in Table 4, 2.4 ml of 2% by mass fluorine-containing surfactant (F-1) solution and 2.4 ml of 2% by mass fluorine-containing surfactant (F-2) were added thereto as shown in Table 4, and 12 g of any of the sliding agent emulsions 1 to 10 was further added thereto as shown in Table 4.

TABLE 4

| Coating | | | |
|---|---|---|---|
| Liquid for | | | |
| Back-surface | | | |
| protective | | | Sliding |
| Layer | Type of Binder | Surfactant | Agent |
| 1 | gelatin | no | no |
| 2 | gelatin/latex A = 9/1 (by weight) | no | no |
| 3 | gelatin/latex A = 7/3 (by weight) | no | no |
| 4 | gelatin/latex A = 5/5 (by weight) | no | no |
| 5 | gelatin/latex B = 9/1 (by weight) | no | no |
| 6 | gelatin/latex B = 7/3 (by weight) | no | no |
| 7 | gelatin/latex B = 5/5 (by weight) | no | no |
| 8 | gelatin/P-5 = 5/5 (by weight) | no | no |
| 9 | gelatin/PVA-205 = 5/5 (by weight) | no | no |
| 10 | PVA-205 | no | no |
| 11 | gelatin | F-1, F-2 | no |
| 12 | gelatin/latex A = 9/1 (by weight) | F-1, F-2 | no |
| 13 | gelatin/latex A = 7/3 (by weight) | F-1, F-2 | no |
| 14 | gelatin/latex A = 5/5 (by weight) | F-1, F-2 | no |
| 15 | gelatin/latex B = 9/1 (by weight) | F-1, F-2 | no |
| 16 | gelatin/latex B = 7/3 (by weight) | F-1, F-2 | no |
| 17 | gelatin/latex B = 5/5 (by weight) | F-1, F-2 | no |
| 18 | gelatin/P-5 = 5/5 (by weight) | F-1, F-2 | no |
| 19 | gelatin/PVA-205 = 5/5 (by weight) | F-1, F-2 | no |
| 20 | PVA-205 | F-1, F-2 | no |
| 21 | gelatin | F-1, F-2 | L1-101 |
| 22 | gelatin/latex A = 7/3 (by weight) | F-1, F-2 | L1-101 |
| 23 | gelatin/latex A = 7/3 (by weight) | F-1, F-2 | S-20 |
| 24 | gelatin/latex A = 7/3 (by weight) | F-1, F-2 | S-23 |
| 25 | gelatin/latex B = 7/3 (by weight) | F-1, F-2 | L1-101 |
| 26 | gelatin/latex B = 7/3 (by weight) | F-1, F-2 | S-20 |
| 27 | gelatin/latex B = 7/3 (by weight) | F-1, F-2 | S-23 |
| 28 | gelatin/P-5 = 5/5 (by weight) | F-1, F-2 | L1-101 |
| 29 | gelatin/PVA-205 = 5/5 (by weight) | F-1, F-2 | L1-101 |
| 30 | PVA-205 | F-1, F-2 | L1-101 |

Latex A: methyl methacrylate/styrene/butyl acrylate/hydroxyethyl methacrylate/acrylic acid copolymer (copolymerization ratio, 57/8/28/5/2 by weight) latex
Latex B: ethyl acrylate/acrylic acid copolymer (copolymerization ratio, 95/5 by weight)

Formation of Back Layer:

The coating liquid for antihalation layer was applied to the back face of the undercoated substrate. Its amount was 0.52 g/m² in terms of gelatin therein. At the same time, the coating liquid for back surface-protective layer was applied thereto and dried to form a back layer on the antihalation layer. Its amount was 1.7 g/m² in terms of gelatin therein.

### Image-Forming Layer, Interlayer, and Surface-Protective Layer

1. Preparation of Coating Materials:

1) Silver Halide Emulsions:

<<Preparation of Silver Halide Emulsion 1>>

To 1421 ml of distilled water, added were 3.1 ml of aqueous 1 mas. % potassium bromide solution, and then 3.5 ml of aqueous sulfuric acid solution (0.5 mol/liter) and 31.7 g of phthaloylgelatin thereto. The resulting solution was kept stirred at 30° C. in a stainless reactor, to which were added 95.4 ml of a solution A of 22.22 g of silver nitrate diluted with distilled water, and 97. 4 ml of a solution B of 15.3 g of potassium bromide and 0.8 g of potassium iodide diluted with distilled water, as constant double jets within 45 seconds. Next, 10 ml of aqueous 3.5 mas. % hydrogen peroxide and then 10.8 ml of aqueous 10 mas. % solution of benzimidazole were added thereto. Next, 317.5 ml of a solution C of 51.86 g of silver nitrate diluted with distilled water, and 400 ml of a solution D of 44.2 g of potassium bromide and 2.2 g of potassium iodide diluted with distilled water were added thereto, as controlled double jets within 20 minutes of such that the flow rate of the solution C was kept constant while the flow rate of the solution D was so controlled as to make the system have a constant pAg of 8.1. 10 minutes after the start of the addition of the solutions C and D to it, 1×10⁻⁴ mols, per mol of silver in the system, of potassium hexachloroiridate(III) was added thereto. Five seconds after the end of the addition of the solution C, 3×10⁻⁴ mols, per mol of silver in the system, of aqueous potassium hexacyano-iron(II) solution was added to it. The pH of the system was controlled to be 3.8 with sulfuric acid (0.5 mol/liter) added thereto. Stirring this was stopped, and this was precipitated, desalted and washed with water. Its pH was controlled to be 5.9 with sodium hydroxide (1 mol/liter) added thereto. The silver halide dispersion thus prepared had pAg of 8.0.

With stirring the silver halide dispersion at 38° C., 5 ml of 0.34 mas. % 1,2-benzoisothiazolin-3-one in methanol was added thereto. After 40 minutes, this was heated up to 47° C. 20 minutes after the heating, 7.6×10⁻⁵ mols, per mol of silver in the system, of a methanolic solution of sodium benzenethiosulfonate was added to it; and after 5 minutes, 2.9×10⁻⁴ mols, per mol of silver therein, of a methanolic solution of tellurium sensitizer C was added thereto. In that condition, this was ripened for 91 minutes. Then, a solution of spectral-sensitizing dye A and color-sensitizing dye B in a ratio of 3/1 by mol in methanol was added to it. The total amount of the color-sensitizing dyes A and B thus added thereto was 1.2×10⁻³ mols per mol of silver in the system. After 1 minute, 1.3 ml of a methanolic solution of 0.8 mas. % N,N′-dihydroxy-N,N′-diethylmelamine was added to it; and after 4 minutes, 4.8×10⁻³ mols, per mol of silver in the system, of a methanolic solution of 5-methyl-2-mercaptobenzimidazole, 5.4×10⁻³ mols, per mol of silver, of a methanolic solution of 1-phenyl-2-heptyl-5-mercapto-1,3,4-triazole, and 8.5×10⁻³ mols, per mol of silver, of an aqueous solution of 1-(3-methylureidophenyl)-5-mercaptotetrazole were added thereto. Thus prepared, this is silver halide emulsion 1.

The grains in the thus-prepared silver halide emulsion were silver iodobromide grains having a mean sphere-corresponding diameter of 0.042 μm and having a sphere-corresponding diameter fluctuation coefficient of 20%. The iodide content of the grains was 3.5 mol %, and the iodide was uniformly dispersed in the grains. To obtain the grain size, 1000 grains were analyzed with an electronic microscope, and their data were averaged. The {100} plane ratio of the grains was 80%, measured according to the Kubelka-Munk method.

<<Preparation of Silver Halide Emulsion 2>>

Like the silver halide emulsion 1, a silver halide emulsion 2 was prepared, for which, however, the liquid temperature in forming the grains was 47° C. and not 30° C.; the solution B was prepared by diluting 15.9 g of potassium bromide with distilled water to have a volume of 97.4 ml; the solution D was prepared by diluting 45.8 g of potassium bromide with distilled water to have a volume of 400 ml; the solution C was added to the system within 30 minutes; and potassium hexacyano-iron(II) was not added. Also like the silver halide emulsion 1, the silver halide emulsion 2 thus prepared was precipitated, desalted, washed with water and dispersed. Next, also like the silver halide emulsion 1, the silver halide emulsion 2 was spectrally sensitized and chemically sensitized, and 5-methyl-2-mercaptobenzimidazole and 1-phenyl-2-heptyl-5-mercapto-1,3,4-triazole were added thereto. Concretely, the amount of the tellurium sensitizer C added to the emulsion 2 was 1.1×10⁻⁴ mols per mol of silver; the amount of the methanolic solution of the spectral-sensitizing dye A and the spectral-sensitizing dye B (3/1 by mol) added to it was 7.0×10⁻⁴ mols per mol of silver in the system and in terms of the total of the color-sensitizing dyes A and B; the amount of 1-phenyl-2-heptyl-5-mercapto-1,3,4-triazole added thereto was 3.3×10⁻³ mols per mol of silver; and the amount of 1-(3-methylureidophenyl)-5-mercaptotetrazole added thereto was 4.7×10⁻³ mols per mol of silver. The emulsion grains in the thus-prepared silver halide emulsion 2 were cubic, pure silver bromide grains having a mean sphere-corresponding diameter of 0.080 μm and having a sphere-corresponding diameter fluctuation coefficient of 20%.

<<Preparation of Silver Halide Emulsion 3>>

Like the silver halide emulsion 1, a silver halide emulsion 3 was prepared, for which, however, the liquid temperature in forming the grains was 27° C. and not 30° C. Also like the silver halide emulsion 1, the silver halide emulsion 3 thus prepared was precipitated, desalted, washed with water and dispersed. Next, also like the silver halide emulsion 1, the silver halide emulsion 3 was obtained, to which, however, a solid dispersion (in aqueous gelatin) of the spectral-sensitizing dye A and the spectral-sensitizing dye B (1/1 by mol) was added, and its amount added was 6×10⁻³ mols per mol of silver in the system and in terms of the total of the spectral-sensitizing dyes A and B; and the amount of the tellurium sensitizer C added to the emulsion 3 was 5.2×10⁻⁴ mols per mol of silver. Three minutes after the addition of the tellurium sensitizer, bromoauric acid and potassium thiocyanate were added to the emulsion, in a quantity of 5×10⁻⁴ mols and 2×10⁻³ mols, per mol of silver, respectively. The emulsion grains in the thus-prepared silver halide emulsion 3 were silver iodobromide grains having a mean sphere-corresponding diameter of 0.034 μm and having a sphere-corresponding diameter fluctuation coefficient of 20%. The iodide content of the grains was 3.5 mol %, and the iodide was uniformly dispersed in the grains.

<<Preparation of Mixed Emulsion A for Coating Liquid>>

70% by mass of the silver halide emulsion 1, 15% by mass of the silver halide emulsion 2 and 15% by mass of the silver halide emulsion 3 were mixed, to which was added 7×10⁻³ mols, per mol of silver in the system, of an aqueous solution of 1% by mass benzothiazolium iodide. Next, water was added to it to thereby make the resulting mixed emulsion have a silver halide content of 38.2 g, in terms of silver per kg of the emulsion. Then, 1-(3-methylureidophenyl)-5-mercaptotetrazole was added to the emulsion, in a quantity of 0.34 g per kg of the emulsion.

Further, as the “compound of which one-electron oxidation product formed through one-electron oxidation can release one or more electrons”, Compounds 1, 20 and 26 were added to the emulsion, each in a quantity of 2×10⁻³ mols per mol of silver of the silver halide.

2) Preparation of Fatty Acid Silver Salt Dispersion:

<<Preparation of Fatty Acid Silver Salt Dispersion A>>

87.6 kg of benenic acid (Henkel's EDENOR C22-85R), 423 liters of distilled water, 49.2 liters of aqueous NaOH solution (5 mol/liter), and 120 liters of t-butyl alcohol were mixed and reacted with stirring at 75° C. for 1 hour to prepare a sodium behenate solution A. Apart from this, 206.2 liters of an aqueous solution (pH 4.0) of 40.4 kg of silver nitrate was prepared, and kept at 10° C. 635 liters of distilled water and 30 liters of t-butyl alcohol were put into a reactor, and kept at 30° C. With well stirring it, all the sodium behenate solution A prepared previously and all the aqueous silver nitrate solution also prepared previously were fed into the reactor as constant double jets, which took 93 minutes and 15 seconds, and 90 minutes, respectively. Feeding them into the reactor was so controlled that, for 11 minutes after the start of feeding the aqueous silver nitrate solution, only the aqueous silver nitrate solution could be fed into the reactor, then feeding the sodium behenate solution A was started, and for 14 minutes and 15 seconds after feeding the aqueous silver nitrate was finished, only the sodium benenate solution A was fed into the reactor. In this stage, the temperature inside the reactor was 30° C., and the temperature outside it was so controlled that the temperature of the reaction system in the reactor could be kept constant. The pipe line of the feeding system for the sodium behenate solution A was thermally insulated by circulating hot water through the interspace of the double-walled pipe, and the steam opening was so controlled that the temperature of the liquid at the outlet of the nozzle tip could be 75° C. The pipe line of the feeding system for the aqueous silver nitrate solution was thermally insulated by circulating cold water through the interspace of the double-walled pipe. Regarding the position at which the sodium behenate solution A is added to the reaction system and that at which the aqueous silver nitrate solution is added thereto, the two were disposed symmetrically to each other relative to the shaft of the stirrer disposed in the reactor, and the nozzle tips for the two solutions were spaced from the reaction liquid in the reactor.

After adding the sodium behenate solution A was finished, the reaction system was kept stirred for 20 minutes at the determined temperature, and then heated up to 35° C. within 30 minutes. Then, this was ripened for 210 minutes. Immediately after thus ripened, this was centrifuged to take out the solid, which was then washed with water until the conductivity of the wash waste reached 30 μS/cm. The solid thus obtained is of a silver salt of the fatty acid. Not dried, this was stored as wet cake.

The silver behenate grains obtained herein were analyzed for morphology on their images taken through electronmicroscopic photography. Their data were as follows: a=0.14 μm, b=0.4 μm and c=0.6 μm all on average (a, b and c are defined hereinabove). The mean aspect ratio was 5.2. The mean sphere-corresponding diameter was 0.52 μm. The sphere-corresponding fluctuation coefficient was 15%. The grains were identified as scaly crystals by these data.

To the wet cake corresponding to 260 kg of its dry weight, added was 19.3 kg of polyvinyl alcohol (trade name, PVA-2 17) along with water to make 1000 kg in total. The resulting mixture was formed into slurry in a blade dissolver, and then pre-dispersed in a pipe-line mixer (Model PM-10 by Mizuho Industry).

Next, the pre-dispersed stock was processed three times in a dispersion mixer (MICROFLUIDIZER M-610 by Microfluidex International Corporation, equipped with a Z-type interaction chamber) under a controlled pressure of 1260 kg/cm². Thus prepared, this is a silver behenate dispersion. To cool it, bellows-type heat exchangers were disposed before and after the interaction chamber. The temperature of the coolant in these heat exchangers was so controlled that the system could be processed at a constant temperature of 18° C.

<<Preparation of Fatty Acid Silver Salt Dispersion B>>

<Preparation of Recrystallized Behenic Acid>100 kg of benenic acid (Henkel's EDENOR C22-85R) was mixed with 1200 kg of isopropyl alcohol and dissolved at 50° C. Then, this was filtered through a 10-μm filter, cooled to 30° C. and recrystallized. During the recrystallization, the cooling speed was controlled to be 3° C./hour. The resulting crystal was taken out through centrifugation, washed by spraying with 100 kg of isopropyl alcohol, and dried. This was esterified and analyzed through GC-FID. Its behenic acid content was 96 mol %. Apart from it, this contained 2 mol % of lignoceric acid, 2 mol % of arachidic acid and 0.001 mol % of erucic acid.

### <Preparation of Fatty Acid Silver Salt Dispersion B>

88 kg of recrystallized behenic acid, 422 liters of distilled water, 49.2 liters of aqueous NaOH solution (5 mol/liter) and 120 liters of t-butyl alcohol were mixed and reacted with stirring at 75° C. for 1 hour to prepare a sodium behenate solution B. Apart from this, 206.2 liters of an aqueous solution (pH 4.0) of 40.4 kg of silver nitrate was prepared, and kept at 10° C. 635 liters of distilled water and 30 liters of t-butyl alcohol were put into a reactor, and kept at 30° C. With well stirring it, all the sodium behenate solution B prepared previously and all the aqueous silver nitrate solution also prepared previously were fed into the reactor as constant double jets, which took 93 minutes and 15 seconds, and 90 minutes, respectively. Feeding them into the reactor was so controlled that, for 11 minutes after the start of feeding the aqueous silver nitrate solution, only the aqueous silver nitrate solution could be fed into the reactor, then feeding the sodium behenate solution B was started, and for 14 minutes and 15 seconds after feeding the aqueous silver nitrate was finished, only the sodium benenate solution B was fed into the reactor. In this stage, the temperature inside the reactor was 30° C., and the temperature outside it was so controlled that the temperature of the reaction system in the reactor could be kept constant. The pipe line of the feeding system for the sodium behenate solution B was thermally insulated by circulating hot water through the interspace of the double-walled pipe, and the steam opening was so controlled that the temperature of the liquid at the outlet of the nozzle tip could be 75° C. The pipe line of the feeding system for the aqueous silver nitrate solution was thermally insulated by circulating cold water through the interspace of the double-walled pipe. Regarding the position at which the sodium behenate solution B is added to the reaction system and that at which the aqueous silver nitrate solution is added thereto, the two were disposed symmetrically to each other relative to the shaft of the stirrer disposed in the reactor, and the nozzle tips for the two solutions were spaced from the reaction liquid in the reactor.

After adding the sodium behenate solution B was finished, the reaction system was kept stirred for 20 minutes at the determined temperature, and then heated up to 35° C. within 30 minutes. Then, this was ripened for 210 minutes. Immediately after thus ripened, this was centrifuged to take out the solid, which was then washed with water until the conductivity of the wash waste reached 30 μS/cm. The solid thus obtained is of a silver salt of the fatty acid. Not dried, this was stored as wet cake.

The silver behenate grains obtained herein were analyzed for morphology on their images taken through electronmicroscopic photography and as a result it was found that they were crystals having. Their data were as follows: a=0.21 μm, b=0.4 μm and c=0.4 μm all on average (a, b and c are defined hereinabove), the mean aspect ratio of 2.1 and the sphere-corresponding fluctuation coefficient of 11%.

To the wet cake corresponding to 260 kg of its dry weight, added was 19.3 kg of polyvinyl alcohol (trade name, PVA-2 17) along with water to make 1000 kg in total. The resulting mixture was formed into slurry in a blade dissolver, and then pre-dispersed in a pipe-line mixer (Model PM-10 by Mizuho Industry).

Next, the pre-dispersed stock was processed three times in a dispersion mixer (MICROFLUIDIZER M-610 by Microfluidex International Corporation, equipped with a Z-type interaction chamber) under a controlled pressure of 1150 kg/cm². Thus prepared, this is a silver behenate dispersion. To cool it, bellows-type heat exchangers were disposed before and after the interaction chamber. The temperature of the coolant in these heat exchangers was so controlled that the system could be processed at a constant temperature of 18° C.

3) Preparation of Reducing Agent Dispersion:

<<Preparation of Reducing Agent-1 Dispersion>>

10 kg of water was added to 10 kg of a reducing agent 1 (2,2′-methylenebis-(4-ethyl-6-tert-butylphenol)) and 16 kg of aqueous 10 mas. % solution of modified polyvinyl alcohol (Kuraray's POVAL MP203), and well mixed to give a slurry. Via a diaphragm pump, the slurry was fed into a horizontal sand mill (Imex's UVM-2) filled with zirconia beads having a mean diameter of 0.5 mm, and dispersed therein for 3 hours. Then, 0.2 g of benzoisothiazolinone sodium salt was added thereto along with water to prepare a reducing agent dispersion having a concentration of 25% by mass. The dispersion was heated at 60° C. for 5 hours. Thus prepared, this is a reducing agent-1 dispersion. The reducing agent grains in the dispersion had a median diameter of 0.40 μm, and a maximum grain size of at most 1.4 μm. The reducing agent dispersion was filtered through a polypropylene filter having a pore size of 3.0 μm to remove impurities from it, and then stored.

<<Preparation of Reducing Agent-2 Dispersion>>

10 kg of water was added to 10 kg of a reducing agent 2 (6,6′-di-t-butyl-4,4′-dimethyl-2,2′-butylidenediphenol) and 16 kg of aqueous 10 mas. % solution of modified polyvinyl alcohol (Kuraray's POVAL MP203), and well mixed to give a slurry. Via a diaphragm pump, the slurry was fed into a horizontal sand mill (Imex's UVM-2) filled with zirconia beads having a mean diameter of 0.5 mm, and dispersed therein for 3 hours and 30 minutes. Then, 0.2 g of benzoisothiazolinone sodium salt was added thereto along with water to prepare a reducing agent dispersion having a concentration of 25% by mass. The dispersion was then heated at 40° C. for 1 hour, and then at 80° C. for 1 hour. Thus prepared, this is a reducing agent-2 dispersion. The reducing agent grains in the dispersion had a median diameter of 0.50 μm, and a maximum grain size of at most 1.6 μm. The reducing agent dispersion was filtered through a polypropylene filter having a pore size of 3.0 μm to remove impurities from it, and then stored.

4) Preparation of Hydrogen Bond-Forming Compound-1 Dispersion:

10 kg of water was added to 10 kg of a hydrogen bond-forming compound 1 (tri(4-t-butylphenyl)phosphine oxide) and 16 kg of aqueous 10 mas. % solution of modified polyvinyl alcohol (Kuraray's POVAL MP203), and well mixed to give a slurry. Via a diaphragm pump, the slurry was fed into a horizontal sand mill (Imex's UVM-2) filled with zirconia beads having a mean diameter of 0.5 mm, and dispersed therein for 4 hours. Then, 0.2 g of benzoisothiazolinone sodium salt was added thereto along with water to make it have a hydrogen bond-forming compound concentration of 25% by mass. The dispersion was heated at 40° C. for 1 hour and then at 80° C. for 1 hour. Thus prepared, this is a hydrogen bond-forming compound-1 dispersion. The hydrogen bond-forming compound grains in the dispersion had a median diameter of 0.45 μm, and a maximum grain size of at most 1.3 μm. The hydrogen bond-forming compound dispersion was filtered through a polypropylene filter having a pore size of 3.0 μm to remove impurities from it, and then stored.

5) Preparation of Development Promoter-1 Dispersion:

10 kg of water was added to 10 kg of a development promoter 1 and 20 kg of aqueous 10 mas. % solution of modified polyvinyl alcohol (Kuraray's POVAL MP203), and well mixed to give a slurry. Via a diaphragm pump, the slurry was fed into a horizontal sand mill (Imex's UVM-2) filled with zirconia beads having a mean diameter of 0.5 mm, and dispersed therein for 3 hours and 30 minutes. Then, 0.2 g of benzoisothiazolinone sodium salt was added thereto along with water to prepare a development promoter-1 dispersion having a concentration of 20% by mass. The development promoter grains in the dispersion had a median diameter of 0.48 μm, and a maximum grain size of at most 1.4 μm. The development promoter dispersion was filtered through a polypropylene filter having a pore size of 3.0 μm to remove impurities from it, and then stored.

6) Preparation of Development Promoter-2 and Toning Regulator-1 Dispersions:

Like the development promoter-1 dispersion, prepared were development promoter-2 and toning regulator solid dispersions of 20% by mass and 15% by mass, respectively.

7) Preparation of Polyhalogen Compound:

<<Preparation of Organic Polyhalogen Compound-1 Dispersion>>

10 kg of an organic polyhalogen compound-1 (tribromomethanesulfonylbenzene), 10 kg of aqueous 20 mas. % solution of modified polyvinyl alcohol (Kuraray's POVAL MP203), 0.4 kg of aqueous 20 mas. % solution of sodium triisopropylnaphthalenesulfonate, and 14 kg of water were well mixed to prepare a slurry. Via a diaphragm pump, the slurry was fed into a horizontal sand mill (Imex's UVM-2) filled with zirconia beads having a mean diameter of 0.5 mm, and dispersed therein for 5 hours. Then, 0.2 g of benzoisothiazolinone sodium salt was added thereto along with water to prepare a 26 mas. % dispersion of the organic polyhalogen compound. This is an organic polyhalogen compound-1 dispersion. The organic polyhalogen compound grains in the dispersion had a median diameter of 0.41 μm, and a maximum grain size of at most 2.0 μm. The organic polyhalogen compound dispersion was filtered through a polypropylene filter having a pore size of 10.0 μm to remove impurities from it, and then stored.

<<Preparation of Organic Polyhalogen Compound-2 Dispersion>>

10 kg of an organic polyhalogen compound-2 (N-butyl-3-tribromomethanesulfonylbenzamide), 20 kg of aqueous 10 mas. % solution of modified polyvinyl alcohol (Kuraray's POVAL MP203), and 0.4 kg of aqueous 20 mas. % solution of sodium triisopropylnaphthalenesulfonate were well mixed to prepare a slurry. Via a diaphragm pump, the slurry was fed into a horizontal sand mill (Imex's UVM-2) filled with zirconia beads having a mean diameter of 0.5 mm, and dispersed therein for 5 hours. Then, 0.2 g of benzoisothiazolinone sodium salt was added thereto along with water to prepare a 30 mas. % dispersion of the organic polyhalogen compound. The dispersion was heated at 40° C. for 5 hours. Thus prepared, this is an organic polyhalogen compound-2 dispersion. The organic polyhalogen compound grains in the dispersion had a median diameter of 0.40 μm, and a maximum grain size of at most 1.3 μm. The organic polyhalogen compound dispersion was filtered through a polypropylene filter having a pore size of 3.0 μm to remove impurities from it, and then stored.

8) Preparation of Phthalazine Compound-1 Solution:

8 kg of Kuraray's modified polyvinyl alcohol MP203 was dissolved in 174.57 kg of water, to which were added 3.15 kg of aqueous 20 mas. % solution of sodium triisopropylnaphthalenesulfonate and 14.28 kg of aqueous 70% by mass solution of phthalazine compound-1 (6-isopropylphthalazine) to prepare a solution of 5 mas. % phthalazine compound-1.

9) Preparation of Mercapto Compound:

<<Preparation of Aqueous Mercapto Compound-1 Solution>>

7 g of a mercapto compound-1 (1-(3-sulfophenyl)-5-mercaptotetrazole sodium salt) was dissolved in 993 g of water to give an aqueous 0.7 mas. % solution of the mercapto compound.

<<Preparation of Aqueous Mercapto Compound-2 Solution>>

20 g of a mercapto compound-2 (1-(3-methylureidophenyl)-5-mercaptotetrazole) was dissolved in 980 g of water to give an aqueous 2.0 mas. % solution of the mercapto compound.

10) Preparation of Pigment-1 Dispersion:

250 g of water was added to 64 g of C.I. Pigment Blue 60 and 6.4 g of Kao's DEMOLE N, and well mixed to give a slurry. 800 g of zirconia beads having a mean diameter of 0.5 mm were prepared and put into a vessel along with the slurry. The slurry thus in the vessel was milled by the use of a dispersion mill (Imex's ¼G Sand Grinder Mill) for 25 hours, and water was added to it to prepare a pigment-1 dispersion having a pigment concentration of 5% by mass. Thus prepared, the pigment grains in the dispersion had a mean grain size of 0.21 μm.

11) Preparation of SBR Latex:

SBR latex was prepared as follows:

287 g of distilled water, 7.73 g of surfactant (Takemoto Yushi's PIONIN A-43-S, having a solid content of 48.5% by mass), 14.06 ml of NaOH (1 mol/liter), 0.15 g of tetrasodium ethylenediaminetetraacetate, 255 g of styrene, 11.25 g of acrylic acid, and 3.0 g of tert-dodecylmercaptan were put into the polymerization reactor of a gas monomer reaction system (Pressure Glass Industry's TAS-2J Model). The reactor was closed, and the contents therein were stirred at 200 rpm. This was degassed via a vacuum pump, and purged a few times repeatedly with nitrogen. Then, 108.75 g of 1,3-butadiene was introduced into it under pressure, and heated up to 60° C. A solution of 1.875 g of ammonium persulfate dissolved in 50 ml of water was added to it, and stirred as such for 5 hours. This was further heated up to 90° C. and stirred for 3 hours, and after the reaction, this was cooled to room temperature. Then, NaOH and NH₄OH (both 1 mol/liter) were added to it in a molar ratio of Na⁺/NH₄⁺=1/5.3 so as to make it have a pH of 8.4. Next, this was filtered through a polypropylene filter having a pore size of 1.0 μm to remove impurities from it, and then stored. Thus obtained, the SBR latex weighed 774.7 g. Its halide ion content was measured through ion chromatography, and the chloride ion concentration of the latex was 3 ppm. The chelating agent concentration therein was measured through high-performance liquid chromatography, and it was 145 ppm.

The mean grain size of the latex was 90 nm, Tg thereof was 17° C., the solid content thereof was 44% by mass, the equilibrium water content thereof at 25° C. and 60% RH was 0.6% by mass, and the ion conductivity thereof was 4.80 mS/cm. To measure the ion conductivity, used was a Toa Denpa Kogyo's conductometer CM-30S. In the device, the 44 mas. % latex was measured at 25° C.

SBR latexes having a different Tg can be prepared in the same manner as above by suitably varying the ratio of styrene to butadiene.

2. Preparation of Coating Liquids:

1) Preparation of Coating Liquid 1 for Image-Forming Layer:

1000 g of the fatty acid silver salt dispersion A prepared in the above, 135 ml of water, 35 g of the pigment-1 dispersion, 19 g of the organic polyhalogen compound-1 dispersion, 58 g of the organic polyhalogen compound-2 dispersion, 162 g of the phthalazine compound-1 solution, 1060 g of the SBR latex (Tg: 17° C.), 75 g of the reducing agent-1 dispersion, 75 g of the reducing agent-2 dispersion, 106 g of the hydrogen bond-forming compound-1 dispersion, 4.8 g of the development promoter-1 dispersion, 9 ml of the aqueous mercapto compound-1 solution, and 27 ml of the aqueous mercapto compound-2 solution were mixed in order. Just before coating with it, the resulting mixture was well mixed with 118 g of the mixed silver halide emulsion A, and the thus-prepared, coating liquid for image-forming layer was directly fed to a coating die and used for coating.

The viscosity of the coating liquid for image-forming layer, measured with a B-type viscometer (by Tokyo Keiki, with No. 1 rotor at 60 rpm), was 25 [mPa·s] at 40° C.

The viscosity of the coating liquid, measured with Haake's RHEOSTRESS RS150 at 38° C., was 32, 35, 33, 26 and 17 [mPa·s] at a shear rate of 0.1, 1, 10, 100 and 1000 [1/sec], respectively.

The zirconium content of the coating liquid was 0.32 mg/g of Ag.

2) Preparation of Coating Liquid 2 for Image-forming Layer:

1000 g of the fatty acid silver salt dispersion B prepared in the above, 135 ml of water, 36 g of the pigment-1 dispersion, 25 g of the organic polyhalogen compound-1 dispersion, 39 g of the organic polyhalogen compound-2 dispersion, 171 g of the phthalazine compound-1 solution, 1060 g of the SBR latex (Tg: 17° C.), 153 g of the reducing agent-2 dispersion, 55 g of the hydrogen bond-forming compound-1 dispersion, 4.8 g of the development promoter-1 dispersion, 5.2 g of the development promoter-2 dispersion, 2.1 g of the color toning agent-1 dispersion, and 8 ml of the aqueous mercapto compound-2 solution, were mixed in order. Just before coating with it, the resulting mixture was well mixed with 140 g of the mixed silver halide emulsion A, and the thus-prepared, coating liquid for image-forming layer was directly fed to a coating die and used for coating.

The viscosity of the coating liquid for image-forming layer, measured with a B-type viscometer (by Tokyo Keiki, with No. 1 rotor at 60 rpm), was 40 [mPa·s] at 40° C.

The viscosity of the coating liquid, measured with Haake's RHEOSTRESS RS150 at 38° C., was 30, 43, 41, 28 and 20 [mPa·s] at a shear rate of 0., 1, 10, 100 and 1000 [1/sec], respectively.

The zirconium content of the coating liquid was 0.30 mg/g of Ag.

3) Preparation of Coating Liquid for Interlayer:

To 1000 g of a polyvinyl alcohol, Kuraray's PVA-205, 163 g of the pigment-1 dispersion, 33 g of an aqueous solution of blue dye compound-1 (Nippon Kayaku's KAYAFECT TURQUOISE RN LIQUID 150), 27 ml of aqueous 5% by mass di(2-ethylhexyl) sulfosuccinate sodium salt solution, and 4200 ml of 19 mas. % latex solution of methyl methacrylate/styrene/butyl acrylate/hydroxyethyl methacrylate/acrylic acid copolymer (copolymerization ratio 57/8/28/5/2 by weight), added were 27 ml of aqueous 5 mas. % solution of AEROSOL OT (from American Cyanamid), 135 ml of aqueous 20 mas. % solution of diammonium phthalate, and water to make 10000 g in total. This was controlled to have a pH of 7.5 with NaOH added thereto. The resulting mixture is a coating liquid for interlayer. This was fed into a coating die, with its flow rate being so controlled that its coating amount could be 8.9 ml/m².

The viscosity of the coating liquid, measured with a B-type viscometer (with No. 1 rotor at 60 rpm), was 58 [mPa·s] at 40° C.

4) Preparation of Coating Liquid for First Surface-Protective Layer:

100 g of inert gelatin and 10 mg of benzoisothiazolinone were dissolved in 840 ml water, to which were added 180 g of 19.0 mas. % latex solution of methyl methacrylate/styrene/butyl acrylate/hydroxyethyl methacrylate/acrylic acid copolymer (copolymerization ratio 57/8/28/5/2 by weight), 46 ml of 15 mas. % solution of phthalic acid in methanol, and 5.4 ml of aqueous 5% by mass solution of di(2-ethylhexyl) sulfosuccinate sodium salt, and mixed. Just before coating with it, the mixture was mixed with 40 ml of 4% by mass chromium alum by the use of a static mixer, and this was fed into a coating die, with its flow rate being so controlled that its coating amount could be 26.1 ml/m².

The viscosity of the coating liquid, measured with a B-type viscometer (with No. 1 rotor at 60 rpm), was 20 [mPa·s] at 40° C.

5) Preparation of Coating Liquid for Second Surface-Protective Layer:

### Preparation of Coating Liquid 1 for Second Surface-Protective Layer

100 g of inert gelatin and 10 mg of benzoisothiazolinone were dissolved in 800 ml water, to which were added 8.0 g, in terms of liquid paraffin therein, of liquid paraffin emulsion, 180 g of 19.0 mas. % latex solution of methyl methacrylate/styrene/butyl acrylate/hydroxyethyl methacrylate/acrylic acid copolymer (copolymerization ratio 57/8/28/5/2 by weight), 40 ml of 15 mas. % solution of phthalic acid in methanol, 28 ml of aqueous 5% by mass solution of di(2-ethylhexyl) sulfosuccinate sodium salt, 4 g of polymethyl methacrylate particles (mean particle size, 0.7 μm), and 21 g of polymethyl methacrylate particles (mean particle size, 4.5 μm), and mixed. This is a coating liquid for surface-protective layer. This was fed into a coating die, with its flow rate being so controlled that its coating amount could be 8.3 ml/m².

The viscosity of the coating liquid, measured with a B-type viscometer (with No. 1 rotor at 60 rpm), was 19 [mPa·s] at 40° C.

### Preparation of Coating Liquids 2 to 20 for Second Surface-Protective Layer

Coating liquids 2 to 20 for second surface-protective layer were prepared in the same manner as in the preparation of coating liquid 1 for second surface-protective layer, except that the type of binder (gelatin) was changed as shown in Table 5, and 5.5 ml of 1% by mass fluorine-containing surfactant (F-1) solution and 5.5 ml of 1% by mass fluorine-containing surfactant (F-2) were added thereto as shown in Table 5.

TABLE 5

| Coating | | | |
|---|---|---|---|
| Liquid for | | | |
| Second | | | |
| Surface- | | | |
| Protective | | | Sliding |
| Layer | Type of Binder | Surfactant | Agent |
| 1 | gelatin | no | no |
| 2 | gelatin/latex A = 9/1 (by weight) | no | no |
| 3 | gelatin/latex A = 7/3 (by weight) | no | no |
| 4 | gelatin/latex A = 5/5 (by weight) | no | no |
| 5 | gelatin/latex B = 9/1 (by weight) | no | no |
| 6 | gelatin/latex B = 7/3 (by weight) | no | no |
| 7 | gelatin/latex B = 5/5 (by weight) | no | no |
| 8 | gelatin/P-5 = 5/5 (by weight) | no | no |
| 9 | gelatin/PVA-205 = 5/5 (by weight) | no | no |
| 10 | PVA-205 | no | no |
| 11 | gelatin | F-1, F-2 | no |
| 12 | gelatin/latex A = 9/1 (by weight) | F-1, F-2 | no |
| 13 | gelatin/latex A = 7/3 (by weight) | F-1, F-2 | no |
| 14 | gelatin/latex A = 5/5 (by weight) | F-1, F-2 | no |
| 15 | gelatin/latex B = 9/1 (by weight) | F-1, F-2 | no |
| 16 | gelatin/latex B = 7/3 (by weight) | F-1, F-2 | no |
| 17 | gelatin/latex B = 5/5 (by weight) | F-1, F-2 | no |
| 18 | gelatin/P-5 = 5/5 (by weight) | F-1, F-2 | no |
| 19 | gelatin/PVA-205 = 5/5 (by weight) | F-1, F-2 | no |
| 20 | PVA-205 | F-1, F-2 | no |
| 21 | gelatin | F-1, F-2 | L1-101 |
| 22 | gelatin/latex A = 7/3 (by weight) | F-1, F-2 | L1-101 |
| 23 | gelatin/latex A = 7/3 (by weight) | F-1, F-2 | S-20 |
| 24 | gelatin/latex A = 7/3 (by weight) | F-1, F-2 | S-23 |
| 25 | gelatin/latex B = 7/3 (by weight) | F-1, F-2 | L1-101 |
| 26 | gelatin/latex B = 7/3 (by weight) | F-1, F-2 | S-20 |
| 27 | gelatin/latex B = 7/3 (by weight) | F-1, F-2 | S-23 |
| 28 | gelatin/P-5 = 5/5 (by weight) | F-1, F-2 | L1-101 |
| 29 | gelatin/PVA-205 = 5/5 (by weight) | F-1, F-2 | L1-101 |
| 30 | PVA-205 | F-1, F-2 | L1-101 |

Latex A: methyl methacrylate/styrene/butyl acrylate/hydroxyethyl methacrylate/acrylic acid copolymer copolymerization ratio, 57/8/28/5/2 by weight) latex
Latex B: ethyl acrylate/acrylic acid copolymer (copolymerization ratio, 95/5 by weight)

### Preparation of Coating Liquids 21 to 30 for Second Surface Protective Layer

<<Preparation of Sliding Agent Emulsions 1 to 10>>

1.0 kg of a sliding agent as in Table 5, 2.4 liters of water, 30 ml of phenoxyethanol, 10 g of methyl p-hydroxybenzoate and 1.0 kg of gelatin were stirred at 50° C. for 20 minutes and mixed. 250 ml of aqueous 10% by mass sodium oleoylmethyltaurine solution was added to it, and stirred in a dissolver at 5000 rpm for 60 minutes to prepare an emulsifide dispersion. Water at 40° C. was added to the resulting dispersion to make 10 kg in total. The mean particle size of the dispersion was measured with Horiba's light-scattering particle sizer, LA-920, and was 0.22 μm.

<<Preparation of Coating Liquids 21 to 30 for Second Surface-Protective Layer>>

Coating liquids 21 to 30 for second surface-protective layer were prepared in the same manner as in the preparation of coating liquid 1 for second surface-protective layer, except that the type of binder (gelatin) was changed as shown in Table 5, 5.5 ml of 1% by mass fluorine-containing surfactant (F-1) solution and 5.5 ml of 1% by mass fluorine-containing surfactant (F-2) were added thereto as shown in Table 537 g of any of the sliding agent emulsions 1 to 10 was further added thereto as shown in Table 5.

3. Fabrication of Photothermographic Materials 101 and 201:

1) Fabrication of Photothermographic Material 101:

Onto the undercoated surface opposite to the back of the substrate, simultaneously applied were the coating liquid 1 for image-forming layer, that for interlayer, that for first surface-protective layer and that for second surface-protective layer in that order according to a slide bead coating system to fabricate a photothermographic material. Fabricating it, the temperature was so controlled that both the coating liquid for image-forming layer and the coating liquid for interlayer could be at 31° C., the coating liquid for first surface-protective layer could be at 36° C. and the coating liquid for second surface-protective layer could be 37° C.

The coating amount (g/m²) of the constitutive components of the image-forming layer is mentioned below. The total coating amount of silver was 1.3 g/m².

| | |
|---|---|
| Silver behenate | 5.42 |
| Pigment (C.I. Pigment Blue 60) | 0.036 |
| Polyhalogen compound 1 | 0.12 |
| Polyhalogen compound 2 | 0.25 |
| Phthalazine compound 1 | 0.18 |
| SBR latex | 9.70 |
| Reducing agent 1 | 0.40 |
| Reducing agent 2 | 0.40 |
| Hydrogen bond-forming compound 1 | 0.58 |
| Development promoter 1 | 0.02 |
| Mercapto compound 1 | 0.002 |
| Mercapto compound 2 | 0.012 |
| Silver halide (as Ag) | 0.10 |

The coating and drying condition is mentioned below.

The coating speed was 160 m/min. The distance between the coating die tip and the substrate was from 0.10 to 0.30 mm, and the pressure in the degassing chamber was kept lower by 196 to 882 Pa than the atmospheric pressure. Before coated, the substrate was destaticized with an ion blow being applied thereto.

In the subsequent chilling zone, the coated substrate was chilled with an air blow (its dry-bulb temperature fell between 10 and 20° C.) applied thereto. Then, this was conveyed not kept in contact with any other, and in the next helical non-contact drying zone, this was dried with a dry air blow (its dry-bulb temperature fell between 23 and 45° C., and its wet-bulb temperature fell between 15 and 2 1° C.) applied thereto.

After thus dried, this was conditioned at 25° C. and 40 to 60% RH, and then heated so that its surface could have a temperature falling between 70 and 90° C. After thus heated, this was cooled to have a surface temperature of 25° C.

The degree of matting, in terms of the Beck's smoothness, of the thus-prepared photothermographic material was 550 seconds on the photosensitive layer-coated surface thereof and 130 seconds on the back surface thereof. The pH of the photosensitive layer-coated surface of the sample was measured and was 6.0.

The thickness of the image-forming layer was measured through cross-section analysis with a transmission electronic microscope, and was 14.5 μm.

2) Fabrication of Photothermographic Materials 102 to 150:

Photothermographic materials 102 to 150 were prepared in the same manner as in the preparation of photothermographic material 101, except that the coating liquid 1 for back-surface protective layer and the coating liquid 1 for second surface-protective layer were varied as in Table 6.

3) Fabrication of Photothermographic Material 201:

Photothermographic material 201 was prepared in the same manner as in the preparation of photothermographic material 101, except that the coating liquid 1 for image-forming layer was changed to coating liquid 2 for image-forming layer. The thickness of the image-forming layer was measured through cross-section analysis with a transmission electronic microscope, and was 14.0 μm.

The coating amount (g/m²) of the constitutive components of the image-forming layer is mentioned below. The total coating amount of silver was 1.25 g/m².

| | |
|---|---|
| Silver behenate | 5.27 |
| Pigment (C.I. Pigment Blue 60) | 0.036 |
| Polyhalogen compound 1 | 0.14 |
| Polyhalogen compound 2 | 0.28 |
| Phthalazine compound 1 | 0.18 |
| SBR latex | 9.43 |
| Reducing agent 2 | 0.77 |
| Hhydrogen bond-forming compound 1 | 0.28 |
| Development promoter 1 | 0.019 |
| Development promoter 2 | 0.016 |
| Color toning agent 1 | 0.006 |
| Mercapto compound 2 | 0.003 |
| Silver halide (as Ag) | 0.13 |

4) Fabrication of Photothermographic Materials 202 to 250:

Photothermographic materials 202 to 250 were prepared in the same manner as in the preparation of photothermographic material 201, except that the coating liquid 1 for back-surface protective layer and the coating liquid 1 for second surface-protective layer were varied as shown in Table 7.

Chemical structures of the compounds used in the Examples are shown below.

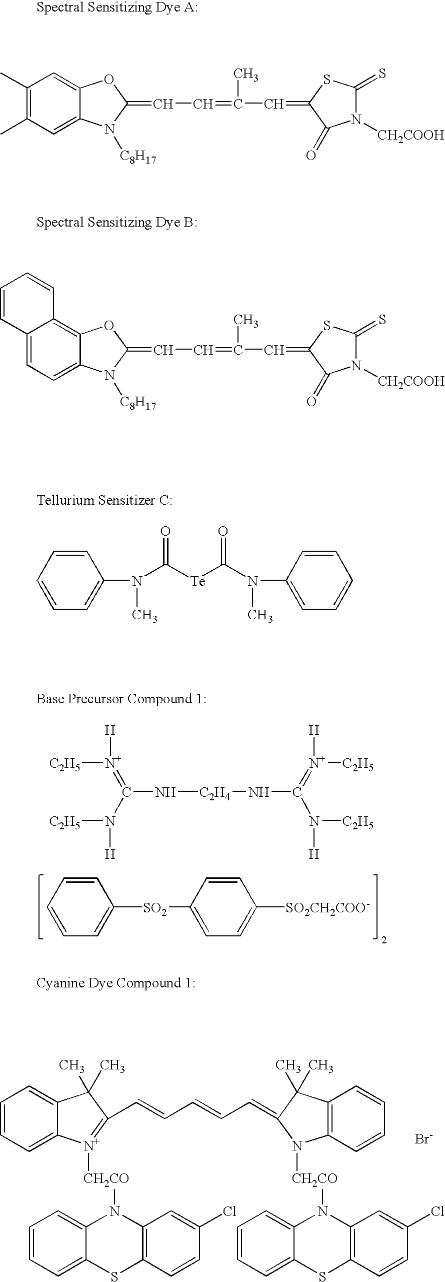

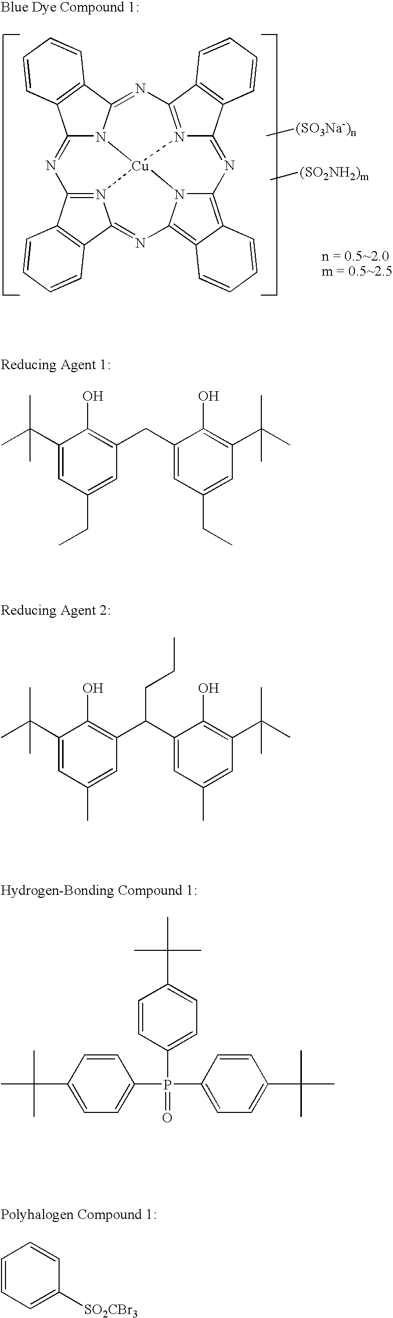

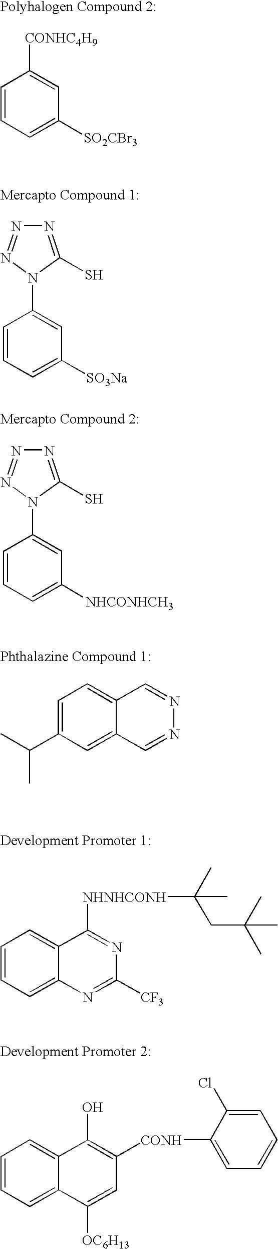

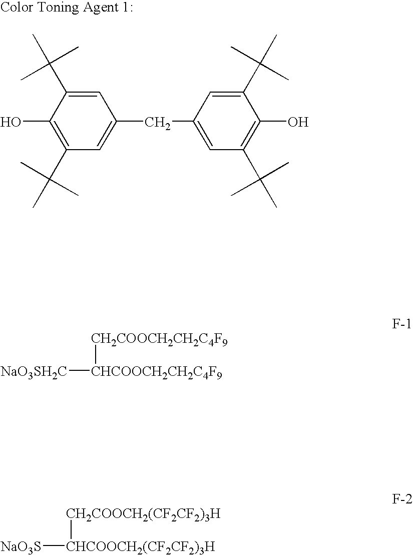

4. Evaluation of Photographic Properties:

1) Preparation:

Each sample thus prepared was cut into pieces of a half-size (43 cm length×35 cm width), wrapped with a wrapping material mentioned below at 25° C. and 50% RH, then stored for 2 weeks at room temperature, and tested according to the test methods mentioned below.

2) Wrapping Material:

The wrapping material used herein is a 50 μm-thick polyethylene film of 10 μm PET/12 μm PE/9 μm aluminium foil/15 μm Ny/3% by mass carbon. Its oxygen permeability is 0.02 ml/atm·m²·25° C.·day; and its moisture permeability is 0.10 g/atm·m²·25° C.·day.

3) Exposure and Development of Photothermographic Materials:

Fuji Medical Dry Laser Imager FM-DPL (equipped with a 660 nm semiconductor laser capable of producing a maximum output of 60 mW (IIIB)) was modified. Using the modified processor, photothermographic materials 101 to 115 were exposed, and thermally developed with four panel heaters set at 112° C., 121° C., 123° C. and 123° C., for 12 seconds in total. The transfer linear speed of the material for thermal development was 34 mm/sec. The images formed were evaluated with a densitometer.

Fuji Medical Dry Laser Imager DRYPIX 7000 (equipped with a 660 nm semiconductor laser capable of producing a maximum output of 50 mW (IIIB)) was modified. Using the modified processor, photothermographic materials 201 to 215 were exposed, and thermally developed with three panel heaters set at 12 1° C., 123° C. and 123° C., for 7 seconds in total. The transfer linear speed of the material for thermal development was 58 mm/sec. The images formed were evaluated with a densitometer.

4) Measurement of Dynamic Friction Factor:

Test samples of the photothermographic materials were conditioned at 25° C. and 60% RH for 2 hours. A slide piece of SUS 316 (degree of surface smoothness) and the test sample were stuck to a tool capable of controlling the temperature of the sample. The size of the slide piece was 3.5×3.5 cm; and the size of the test sample was 15×5 cm. 30 seconds after the sticking, a load of 300 g was applied to the slide piece, and the dynamic friction factor of the test sample was measured.

5) Evaluation of Photographic Properties:

Photothermographic materials 101 to 115 and 201 to 215 were uniformly exposed so that they could have a density of 1.5. 2000 sheets of each sample were processed in the thermal developing machine that was in the above-mentioned running condition, and the number of the copied sheets with uneven development was counted.

6) Evaluation of Workability and Accumulability:

A sample having a size of 500×0.35 m was prepared, and cut into 100 sheets at a transfer speed of 60 meter/min. Thus cut, the sheets were accumulated in a U-shaped box having a size of 0.5 m (length)×0.5 m (width)×0.1 m (height). Of the sheets thus piled up, the number of the sheets having slid by at least 2 cm from the others was counted, and this represents the accumulability of the sample. “A” means that the sheets did not slide at all; “B” means that one sheet slid; “C” means that 2 or 3 sheets slid; and “D” means that 4 or more sheet slid. The acceptable level for practical production is B.

7) Test Results:

The results are given in Tables 6 and 7.

TABLE 6

| | Back-surface | B/A on | | | | |
|---|---|---|---|---|---|---|
| | protective Layer/ | back-surface | B/A on | | Workability | |
| Photothermographic | Surface-Protective | protective | emulsion-protective | Uneven | and | |
| Material | Layer | layer | layer | Development | Accumulability | Remarks |
| 101 | 1/1 | 0.85 | 0.87 | 21 | D | comparison |
| 102 | 2/2 | 1.01 | 1.03 | 5 | B | the invention |
| 103 | 3/3 | 1.02 | 1.04 | 2 | B | the invention |
| 104 | 4/4 | 1.05 | 1.07 | 2 | B | the invention |
| 105 | 5/5 | 1.82 | 1.86 | 0 | A | the invention |
| 106 | 6/6 | 1.95 | 1.99 | 0 | A | the invention |
| 107 | 7/7 | 1.99 | 2.03 | 0 | A | the invention |
| 108 | 8/8 | 1.1 | 1.12 | 0 | B | the invention |
| 109 | 9/9 | 1.15 | 1.17 | 0 | A | the invention |
| 110 | 10/10 | 1.05 | 1.07 | 2 | B | the invention |
| 111 | 11/11 | 1.01 | 1.03 | 3 | B | the invention |
| 112 | 12/12 | 1.21 | 1.23 | 0 | A | the invention |
| 113 | 13/13 | 1.25 | 1.28 | 0 | A | the invention |
| 114 | 14/14 | 1.24 | 1.26 | 0 | A | the invention |
| 115 | 15/15 | 2.01 | 2.05 | 2 | B | the invention |
| 116 | 16/16 | 2.11 | 2.15 | 2 | B | the invention |
| 117 | 17/17 | 2.5 | 2.55 | 3 | B | the invention |
| 118 | 18/18 | 1.3 | 1.33 | 0 | A | the invention |
| 119 | 19/19 | 1.32 | 1.35 | 0 | A | the invention |
| 120 | 20/20 | 1.23 | 1.25 | 0 | A | the invention |
| 121 | 21/21 | 1.25 | 1.28 | 0 | A | the invention |
| 122 | 22/22 | 1.45 | 1.48 | 0 | A | the invention |
| 123 | 23/23 | 1.42 | 1.45 | 0 | A | the invention |
| 124 | 24/24 | 1.46 | 1.49 | 0 | A | the invention |
| 125 | 25/25 | 2.22 | 2.26 | 1 | A | the invention |
| 126 | 26/26 | 2.31 | 2.36 | 2 | A | the invention |
| 127 | 27/27 | 2.4 | 2.45 | 3 | B | the invention |
| 128 | 28/28 | 1.45 | 1.48 | 0 | A | the invention |
| 129 | 29/29 | 1.47 | 1.50 | 0 | A | the invention |
| 130 | 30/30 | 1.38 | 1.41 | 0 | A | the invention |
| 131 | 11/21 | 1.01 | 1.03 | 2 | B | the invention |
| 132 | 12/22 | 1.21 | 1.23 | 0 | A | the invention |
| 133 | 13/23 | 1.25 | 1.28 | 0 | A | the invention |
| 134 | 14/24 | 1.24 | 1.26 | 0 | A | the invention |
| 135 | 15/25 | 2.01 | 2.05 | 0 | B | the invention |
| 136 | 16/26 | 2.11 | 2.15 | 1 | B | the invention |
| 137 | 17/27 | 2.5 | 2.55 | 1 | B | the invention |
| 138 | 18/28 | 1.3 | 1.33 | 0 | A | the invention |
| 139 | 19/29 | 1.32 | 1.35 | 0 | A | the invention |
| 140 | 20/30 | 1.23 | 1.25 | 0 | A | the invention |
| 141 | 21/11 | 1.25 | 1.28 | 0 | A | the invention |
| 142 | 22/12 | 1.45 | 1.48 | 0 | A | the invention |
| 143 | 23/13 | 1.42 | 1.45 | 0 | A | the invention |
| 144 | 24/14 | 1.46 | 1.49 | 0 | A | the invention |
| 145 | 25/15 | 2.22 | 2.26 | 2 | A | the invention |
| 146 | 26/16 | 2.31 | 2.36 | 2 | A | the invention |
| 147 | 27/17 | 2.4 | 2.45 | 2 | A | the invention |
| 148 | 28/18 | 1.45 | 1.48 | 0 | A | the invention |
| 149 | 29/19 | 1.47 | 1.50 | 0 | A | the invention |
| 150 | 30/20 | 1.38 | 1.41 | 0 | A | the invention |

TABLE 7

| | Back-surface | B/A on | | | | |
|---|---|---|---|---|---|---|
| | protective Layer/ | back-surface | B/A on | | Workability | |
| Photothermographic | Surface-Protective | protective | emulsion-protective | Uneven | and | |
| Material | Layer | layer | layer | Development | Accumulability | Remarks |
| 201 | 1/1 | 0.85 | 0.87 | 15 | D | comparison |
| 202 | 2/2 | 1.01 | 1.03 | 4 | B | the invention |
| 203 | 3/3 | 1.02 | 1.04 | 1 | B | the invention |
| 204 | 4/4 | 1.05 | 1.07 | 1 | B | the invention |
| 205 | 5/5 | 1.82 | 1.86 | 0 | A | the invention |
| 206 | 6/6 | 1.95 | 1.99 | 0 | A | the invention |
| 207 | 7/7 | 1.99 | 2.03 | 0 | A | the invention |
| 208 | 8/8 | 1.1 | 1.12 | 0 | B | the invention |
| 209 | 9/9 | 1.15 | 1.17 | 0 | A | the invention |
| 210 | 10/10 | 1.05 | 1.07 | 1 | B | the invention |
| 211 | 11/11 | 1.01 | 1.03 | 2 | B | the invention |
| 212 | 12/12 | 1.21 | 1.23 | 0 | A | the invention |
| 213 | 13/13 | 1.25 | 1.28 | 0 | A | the invention |
| 214 | 14/14 | 1.24 | 1.26 | 0 | A | the invention |
| 215 | 15/15 | 2.01 | 2.05 | 1 | B | the invention |
| 216 | 16/16 | 2.11 | 2.15 | 1 | B | the invention |
| 217 | 17/17 | 2.5 | 2.55 | 2 | B | the invention |
| 218 | 18/18 | 1.3 | 1.33 | 0 | A | the invention |
| 219 | 19/19 | 1.32 | 1.35 | 0 | A | the invention |
| 220 | 20/20 | 1.23 | 1.25 | 0 | A | the invention |
| 221 | 21/21 | 1.25 | 1.28 | 0 | A | the invention |
| 222 | 22/22 | 1.45 | 1.48 | 0 | A | the invention |
| 223 | 23/23 | 1.42 | 1.45 | 0 | A | the invention |
| 224 | 24/24 | 1.46 | 1.49 | 0 | A | the invention |
| 225 | 25/25 | 2.22 | 2.26 | 1 | B | the invention |
| 226 | 26/26 | 2.31 | 2.36 | 1 | B | the invention |
| 227 | 27/27 | 2.4 | 2.45 | 2 | B | the invention |
| 228 | 28/28 | 1.45 | 1.48 | 0 | A | the invention |
| 229 | 29/29 | 1.47 | 1.50 | 0 | A | the invention |
| 230 | 30/30 | 1.38 | 1.41 | 0 | A | the invention |
| 231 | 11/21 | 1.01 | 1.03 | 1 | B | the invention |
| 232 | 12/22 | 1.21 | 1.23 | 0 | A | the invention |
| 233 | 13/23 | 1.25 | 1.28 | 0 | A | the invention |
| 234 | 14/24 | 1.24 | 1.26 | 0 | A | the invention |
| 235 | 15/25 | 2.01 | 2.05 | 0 | B | the invention |
| 236 | 16/26 | 2.11 | 2.15 | 1 | B | the invention |
| 237 | 17/27 | 2.5 | 2.55 | 1 | B | the invention |
| 238 | 18/28 | 1.3 | 1.33 | 0 | A | the invention |
| 239 | 19/29 | 1.32 | 1.35 | 0 | A | the invention |
| 240 | 20/30 | 1.23 | 1.25 | 0 | A | the invention |
| 241 | 21/11 | 1.25 | 1.28 | 0 | A | the invention |
| 242 | 22/12 | 1.45 | 1.48 | 0 | A | the invention |
| 243 | 23/13 | 1.42 | 1.45 | 0 | A | the invention |
| 244 | 24/14 | 1.46 | 1.49 | 0 | A | the invention |
| 245 | 25/15 | 2.22 | 2.26 | 1 | A | the invention |
| 246 | 26/16 | 2.31 | 2.36 | 1 | A | the invention |
| 247 | 27/17 | 2.4 | 2.45 | 1 | A | the invention |
| 248 | 28/18 | 1.45 | 1.48 | 0 | A | the invention |
| 249 | 29/19 | 1.47 | 1.50 | 0 | A | the invention |
| 250 | 30/20 | 1.38 | 1.41 | 0 | A | the invention |

When the value B/A on either the back-surface protective layer of the surface-protective layer is 1 or more, then the photothermographic material has few image mottles and its workability and accumulability was good.

The two thermal developing machines used herein, Fuji Medical Dry Laser Imager FM-DPL and DRYPIX 7000 are driven for thermal development while the image-forming surface of the photothermographic material is contacted with the driving rollers therein and while the back surface thereof is contacted with the plate heaters. Even when processed by the use the thermal developing machine of the type, the photothermographic material of the invention gives good images of few mottles and enjoys good workability and accumulability.

### Example 2

1) Preparation of Silver Halide Emulsion:

### Preparation of Silver Halide Emulsion 1

To 1420 ml of distilled water, added were 4.3 ml of aqueous 1 mas. % potassium iodide solution, and then 3.5 ml of aqueous sulfuric acid solution (0.5 mol/liter) and 36.7 g of phthaloylgelatin thereto. The resulting solution was kept stirred at 42° C. in a stainless reactor, to which were added 195.6 ml of a solution A of 22.22 g of silver nitrate diluted with distilled water, and 218 ml of a solution B of 21.8 g of potassium iodide diluted with distilled water, as constant double jets within 9 minutes. Next, 10 ml of aqueous 3.5 mas. % hydrogen peroxide and then 10.8 ml of aqueous 10 mas. % solution of benzimidazole were added thereto. Next, 317.5 ml of a solution C of 51.86 g of silver nitrate diluted with distilled water, and 600 ml of a solution D of 60 g of potassium iodide diluted with distilled water were added thereto, as controlled double jets within 120 minutes of such that the flow rate of the solution C was kept constant while the flow rate of the solution D was so controlled as to make the system have a constant pAg of 8.1. 10 minutes after the start of the addition of the solutions C and D to it, 1×10⁻⁴ mols, per mol of silver in the system, of potassium hexachloroiridate(III) was added thereto. Five seconds after the end of the addition of the solution C, 3×10⁻⁴ mols, per mol of silver in the system, of aqueous potassium hexacyano-iron(II) solution was added to it. The pH of the system was controlled to be 3.8 with sulfuric acid (0.5 mol/liter) added thereto. Stirring this was stopped, and this was precipitated, desalted and washed with water. Its pH was controlled to be 5.9 with sodium hydroxide (1 mol/liter) added thereto. The silver halide dispersion thus prepared had pAg of 8.0.

With stirring the silver halide dispersion at 38° C., 5 ml of 0.34 mas. % 1,2-benzoisothiazolin-3-one in methanol was added thereto, and then heated up to 47° C. 20 minutes after the heating, 7.6×10⁻⁵ mols, per mol of silver in the system, of a methanolic solution of sodium benzenethiosulfonate was added to it; and after 5 minutes, 2.9×10⁻⁴ mols, per mol of silver therein, of a methanolic solution of tellurium sensitizer B was added thereto. In that condition, this was ripened for 91 minutes.

Then, 1.3 ml of a methanolic solution of 0.8 mas. % N,N′-dihydroxy-N″-diethylmelamine was added to it; and after 4 minutes, 4.8×10⁻³ mols, per mol of silver in the system, of a methanolic solution of 5-methyl-2-mercaptobenzimidazole, and 5.4×10⁻³ mols, per mol of silver, of a methanolic solution of 1-phenyl-2-heptyl-5-mercapto-1,3,4-triazole were added thereto. Thus prepared, this is silver halide emulsion 1.

The grains in the thus-prepared silver halide emulsion were pure silver iodide grains having a mean sphere-corresponding diameter of 0.040 μm and having a sphere-corresponding diameter fluctuation coefficient of 18%. The grains were tetradecahedral grains having (001), {100} and {101} planes. Analyzed through X-ray powdery diffractiometry, the ratio of the γ-phase of the grains was 30%. To obtain the grain size, 1000 grains were analyzed with an electronic microscope, and their data were averaged.

### Preparation of Silver Halide Emulsion 2

Like the silver halide emulsion 1, a silver halide emulsion 2 was prepared, for which, however, the liquid temperature in forming the grains was changed to 65° C.; 5 ml of a methanolic solution of 5% 2,2′-(ethylenedithio)diethanol was added after the addition of the solutions A and B; the solution D was added as controlled double jets at pAg of 10.5; and 3 minutes after the addition of the tellurium sensitizer in chemical sensitization, 5×10⁻⁴ mols, per mol of silver, of bromoauric acid and 2×10⁻³ molls, per mol of silver, of potassium thiocyanate were added.

The grains in the thus-prepared silver halide emulsion 2 were tabular, pure silver bromide grains having a mean circle-corresponding diameter, based on the projected area thereof, of 0.164 μm, a grain thickness of 0.032 μm, a mean aspect ratio of 5, a mean sphere-corresponding diameter of 0.11 μm and a sphere-corresponding diameter fluctuation coefficient of 23%. Analyzed through X-ray powdery diffractiometry, the ratio of the γ-phase of the grains was 80%. To obtain the grain size, 1000 grains were analyzed with an electronic microscope, and their data were averaged.

### Preparation of Silver Halide Emulsion 3

Like the silver halide emulsion 1, a silver halide emulsion 3 was prepared, for which, however, the temperature of the reaction solution was changed to 27° C.; and the solution D was added as controlled double jets at pAg of 10.2.

The grains in the thus-prepared silver halide emulsion 2 were pure silver bromide grains having a mean sphere-corresponding diameter of 0.022 μm and a sphere-corresponding diameter fluctuation coefficient of 17%. The grains were tetradecahedral grains having (001), {1(−1)0} and {101} planes. Analyzed through X-ray powdery diffractiometry, the grains were almost completely β-phase silver iodide. To obtain the grain size, 1000 grains were analyzed with an electronic microscope, and their data were averaged.

### Preparation of Mixed Emulsion B for Coating Liquid

Silver halide emulsions 1, 2 and 3 were mixed in a ratio, by mol of Ag, of 5/2/3, to which was added 7×10−3 mols, per mol of Ag, of aqueous 1% by mass benzothiazolium iodide. Next, water was added to it to thereby make the resulting mixed emulsion have a silver halide content of 38.2 g, in terms of silver per kg of the emulsion. Then, 1-(3-methylureido)-5-mercaptotetrazole sodium salt was added to the emulsion, in a quantity of 0.34 g per kg of the emulsion.

Further, as the “compound of which one-electron oxidation product formed through one-electron oxidation can release one or more electrons”, Compounds 2, 20 and 26 were added to the emulsion, each in a quantity of 2×10⁻³ mols per mol of silver of the silver halide.

In addition, as the “compound having an adsorbing group and a reducing group”, compounds (19), (49) and (71) were added to the emulsion, each in a quantity of 8×10⁻³ mols per mol of silver of the silver halide.

2) Fabrication of Photothermographic Materials 301 to 350:

Photothermographic materials 301 to 350 were prepared in the same manner as in the preparation of photothermographic materials 101 to 150 in Example 1, except that the mixed emulsion B was used in place of the mixed emulsion A.

3) Exposure, Development:

A semiconductor laser source, Nichia Chemical Industry's semiconductor laser NLHV3000E was fitted to the exposure zone of Fuji Medical Dry Laser Imager FM-DPL, and its beam diameter was narrowed down to 100 μm. With the intensity of laser light on the surface of the photothermographic material sample controlled to be 0 or within a range of from 1 mW/mm² to 1000 mW/mm², the sample was exposed to the laser light for 10⁻⁶ seconds. The exposed sample was developed in the same manner as in samples 101 to 150 in Example 1.

4) Test Results:

The results are given in Table 8.

TABLE 8

| | Back-surface | B/A on | | | | |
|---|---|---|---|---|---|---|
| | protective Layer/ | back-surface | B/A on | | Workability | |
| Photothermographic | Surface-Protective | protective | emulsion-protective | Uneven | and | |
| Material | Layer | layer | layer | Development | Accumulability | Remarks |
| 301 | 1/1 | 0.85 | 0.87 | 19 | D | comparison |
| 302 | 2/2 | 1.01 | 1.03 | 5 | B | the invention |
| 303 | 3/3 | 1.02 | 1.04 | 2 | B | the invention |
| 304 | 4/4 | 1.05 | 1.07 | 2 | B | the invention |
| 305 | 5/5 | 1.82 | 1.86 | 0 | A | the invention |
| 306 | 6/6 | 1.95 | 1.99 | 0 | A | the invention |
| 307 | 7/7 | 1.99 | 2.03 | 0 | A | the invention |
| 308 | 8/8 | 1.1 | 1.12 | 0 | B | the invention |
| 309 | 9/9 | 1.15 | 1.17 | 0 | A | the invention |
| 310 | 10/10 | 1.05 | 1.07 | 2 | B | the invention |
| 311 | 11/11 | 1.01 | 1.03 | 3 | B | the invention |
| 312 | 12/12 | 1.21 | 1.23 | 0 | A | the invention |
| 313 | 13/13 | 1.25 | 1.28 | 0 | A | the invention |
| 314 | 14/14 | 1.24 | 1.26 | 0 | A | the invention |
| 315 | 15/15 | 2.01 | 2.05 | 2 | B | the invention |
| 316 | 16/16 | 2.11 | 2.15 | 2 | B | the invention |
| 317 | 17/17 | 2.5 | 2.55 | 3 | B | the invention |
| 318 | 18/18 | 1.3 | 1.33 | 0 | A | the invention |
| 319 | 19/19 | 1.32 | 1.35 | 0 | A | the invention |
| 320 | 20/20 | 1.23 | 1.25 | 0 | A | the invention |
| 321 | 21/21 | 1.25 | 1.28 | 0 | A | the invention |
| 322 | 22/22 | 1.45 | 1.48 | 0 | A | the invention |
| 323 | 23/23 | 1.42 | 1.45 | 0 | A | the invention |
| 324 | 24/24 | 1.46 | 1.49 | 0 | A | the invention |
| 325 | 25/25 | 2.22 | 2.26 | 1 | B | the invention |
| 326 | 26/26 | 2.31 | 2.36 | 2 | B | the invention |
| 327 | 27/27 | 2.4 | 2.45 | 3 | B | the invention |
| 328 | 28/28 | 1.45 | 1.48 | 0 | A | the invention |
| 329 | 29/29 | 1.47 | 1.50 | 0 | A | the invention |
| 330 | 30/30 | 1.38 | 1.41 | 0 | A | the invention |
| 331 | 11/21 | 1.01 | 1.03 | 2 | B | the invention |
| 332 | 12/22 | 1.21 | 1.23 | 0 | A | the invention |
| 333 | 13/23 | 1.25 | 1.28 | 0 | A | the invention |
| 334 | 14/24 | 1.24 | 1.26 | 0 | A | the invention |
| 335 | 15/25 | 2.01 | 2.05 | 0 | B | the invention |
| 336 | 16/26 | 2.11 | 2.15 | 1 | B | the invention |
| 337 | 17/27 | 2.5 | 2.55 | 1 | B | the invention |
| 338 | 18/28 | 1.3 | 1.33 | 0 | A | the invention |
| 339 | 19/29 | 1.32 | 1.35 | 0 | A | the invention |
| 340 | 20/30 | 1.23 | 1.25 | 0 | A | the invention |
| 341 | 21/11 | 1.25 | 1.28 | 0 | A | the invention |
| 342 | 22/12 | 1.45 | 1.48 | 0 | A | the invention |
| 343 | 23/13 | 1.42 | 1.45 | 0 | A | the invention |
| 344 | 24/14 | 1.46 | 1.49 | 0 | A | the invention |
| 345 | 25/15 | 2.22 | 2.26 | 2 | A | the invention |
| 346 | 26/16 | 2.31 | 2.36 | 2 | A | the invention |
| 347 | 27/17 | 2.4 | 2.45 | 2 | A | the invention |
| 348 | 28/18 | 1.45 | 1.48 | 0 | A | the invention |
| 349 | 29/19 | 1.47 | 1.50 | 0 | A | the invention |
| 350 | 30/20 | 1.38 | 1.41 | 0 | A | the invention |

As in Table 8, the same results were obtained even when the silver iodide content of the silver halide was 5 mol % or more and was high, so far as the value B/A on the back-surface protective layer or the surface-protective layer was 1 or more. In particular the samples having a higher silver iodide content had few image mottles and were good.

As described in detail hereinabove with reference to its preferred embodiments, the invention provides a photothermographic material having the advantages of good coatability and good workability and accumulability and capable of forming good images with few development mottles, and provides a method for forming an image thereon.

What is claimed is:

1. A photothermographic material comprising:
a substrate;
at least one image-forming layer, which is disposed on a surface of the substrate and comprises at least a photosensitive silver halide, a non-photosensitive organic silver salt, a reducing agent and a binder;
at least one surface-protective layer, which is disposed on a side of the substrate on which the at least one image-forming layer is disposed; and
at least one back-surface protective layer, which is disposed on a back surface of the substrate opposite to the surface on which the at least one image-forming layer is disposed,
wherein at least one of the surface-protective layer and the back-surface protective layer satisfies the following formula (1):
B/A ≧1 Formula (1)
wherein A represents a dynamic friction factor measured at a sliding velocity of 100 mm/min, and B represents a dynamic friction factor measured at a sliding velocity of 2000 mm/min.

2. The photothermographic material of claim 1, wherein a value of B/A in formula (1) is in a range of 1 to 5.

3. The photothermographic material of claim 1, wherein a value of B/A in formula (1) is in a range of 1 to 3.

4. The photothermographic material of claim 1, wherein a value of B/A in formula (1) is in a range of 1 to 2.

5. The photothermographic material of claim 1, wherein the surface-protective layer comprises a binder that comprises at least one selected from the group consisting of gelatin, hydrophobic polymer latex, a water-soluble polymer, and a hydrophobic polymer.

6. The photothermographic material of claim 1, wherein the back-surface protective layer comprises a binder that comprises at least one selected from the group consisting of gelatin, hydrophobic polymer latex, a water-soluble polymer, and a hydrophobic polymer.

7. The photothermographic material of claim 6, wherein the binder contained in the back-surface protective layer is gelatin.

8. The photothermographic material of claim 5, wherein the binder contained in the surface-protective layer is a hydrophobic polymer having a glass transition temperature of −30° C. to 40° C.

9. The photothermographic material of claim 6, wherein the binder contained in the back-surface protective layer is a hydrophobic polymer having a glass transition temperature of −30° C. to 40° C.

10. The photothermographic material of claim 5, wherein the binder contained in the surface-protective layer is cellulose acetate butyrate.

11. The photothermographic material of claim 6, wherein the binder contained in the back-surface protective layer is cellulose acetate butyrate.

12. The photothermographic material of claim 1, wherein at least one of the surface-protective layer and the back-surface protective layer comprises a sliding agent.

13. The photothermographic material of claim 12, wherein a coating amount of the sliding agent in at least one of the surface-protective layer and the back-surface protective layer is from 1 mg/m² to 500 mg/m².

14. The photothermographic material of claim 1, wherein a total silver amount coated on the photothermographic material is from 1.1 g/m² to 1.9 g/m².

15. The photothermographic material of claim 1, wherein silver iodide is contained in the silver halide in an amount of at least 5 mol %.

16. The photothermographic material of claim 1, wherein an antistatic agent is contained in the photothermographic material in a coating amount of 60 mg/m² to 150 mg/m².

17. The photothermographic material of claim 16, wherein the antistatic agent is a metal oxide.

18. The photothermographic material of claim 1, further comprising a fluorine-containing surfactant.

19. The photothermographic material of claim 1, wherein the image-forming layer has a thickness of 15 μm or less.

20. The photothermographic material of claim 1, wherein a matting agent having a mean sphere-corresponding radius of 0.1 μm to 10 μm is contained in at least one of the surface-protective layer and the back-surface protective layer in a coating amount of 5 mg/m² to 200 mg/m².

21. A method for forming an image on the photothermographic material of claim 1, the method comprising exposing the photothermographic material and thermally developing the photothermographic material, wherein a transfer linear velocity of the photothermographic material during thermal developing of the photothermographic material is 30 mm/sec or more.

22. The method of claim 21, wherein the transfer linear velocity of the photothermographic material is 45 mm/sec or more.
